(19) United States
(12) Patent Application Publication
(10) Pub. No.: US 2025/0187293 A1
(43) Pub. Date: Jun. 12, 2025

(54) A RECONFIGURABLE WEB AND IMPLEMENTATIONS THEREFOR

(71) Applicant: Avinoam ZADOK, Kiryat Ono (IL)

(72) Inventor: Avinoam ZADOK, Kiryat Ono (IL)

(21) Appl. No.: 18/843,590

(22) PCT Filed: Mar. 2, 2023
(86) PCT No.: PCT/IL2023/050214

§ 371 Date: Sep. 3, 2024

(30) Foreign Application Priority Data
Mar. 2, 2022 (IL) 291069
Sep. 13, 2022 (IL) 296455

(51) Int. Cl. B32B 3/06; E04D 5/10

(52) U.S. Cl. CPC B32B 3/06; B32B 2419/06; E04D 5/10

(57) ABSTRACT

A reconfigurable web having opposite web faces includes a direction-sensitive displacement facilitating element to displace the web in at least one direction to form a unidirectionally stiff and leveled surface, and a force transmitting element allowing the web, when leveled, to be rolled or folded in at least one direction and stiff in at least one other direction in emulation of a rigid monolithic plate. In some embodiments, a main web face is continuous or semi-continuous. The web is able to be implemented in many ways including for covering a solid uneven base surface and reconfiguring a surface, and in conjunction with a coupling panel connecting system, parquet system, link material leveling system, and a hinge for uninterrupted surfaces.

This is a continuation-in-part application of international patent application PCT/IL2023/050214 filed on Mar. 2, 2023, which claims priority from Israeli patent application 296455 filed on Sep. 13, 2022 and from Israeli patent application 291069 filed on Mar. 2, 2022.

### FIELD OF THE INVENTION

The present invention relates to the field of reconfigurable elements. More particularly, the present invention relates to a reconfigurable web and implementations therefor, including an unrollable coupling panel connecting system, which may be embodied by an unrollable tongue and groove connecting system.

### BACKGROUND OF THE INVENTION

It is known to cover large areas of even base surfaces, including walls and ceilings, with a rollable web having a length of many meters, such as ten meters or more, when slowly unrolled. Typical surface-coverable rollable webs include wallpaper, bituminous waterproofing covering for covering roofs, and PVC sheets for wall cladding. Although such rollable webs effectively cover a base surface, they are practicably used to cover only even base surfaces. If prior art rollable webs were applied onto uneven base surfaces, the covering would assume the shape of the uneven base surface and become unattractive. When a thick layer of link material is applied between the web and the base surface, an amorphous web shape generally results since the web is incapable of becoming leveled on a predefined surface.

Stiff monolithic boards such as plasterboard having standard dimensions, such as 260×120 cm, are able to be applied onto an uneven base surface while retaining their planar shape and providing an esthetic appearance. Nevertheless, there are various disadvantages associated with covering base surfaces with monolithic boards. Firstly, monolithic boards are small sized relative to rollable webs and have to be individually applied onto a base surface by a time consuming operation especially when the board is attached entirely to the base surface. Secondly, another time consuming operation is needed in order to conceal the interfaces formed between each adjacent monolithic board. Thirdly, a monolithic board with such relatively large standard dimensions suffers from poor portability at a construction site due to the limited field of view of a construction worker carrying the board and due to the difficulty in maneuvering it across obstacles and through small openings and small-clearance passageways at the construction site. Fourthly, carrying large-dimensioned monolithic boards on scaffolding constitutes a security risk. A security risk is also encountered by a construction worker who is carrying a large board outside, such as on scaffolding or on an inclined building roof, and has to cope with gusts of wind attempting to overturn the board,

It would be desirable to provide a web that is a synthesis of a foldable or rollable web and a monolithic surface to benefit from the advantages of both of these types of surfaces.

It would be desirable to provide a reconfigurable web that is able to become leveled on both even and uneven surfaces, to produce an esthetic appearance. The web of the present invention has this capability and is consequently able to pave the way for a countless number of useful applications, as will become apparent as the description proceeds.

It is an object of the present invention to provide a new type of web that has predefined characteristics that are scaled between a foldable or rollable web and a monolithic surface.

It is an object of the present invention to provide a reconfigurable web that is able to become reliably leveled on both even and uneven surfaces.

It is an additional object of the present invention to provide a reconfigurable web that combines the advantages of both a rollable web and a stiff monolithic board.

It is an additional object of the present invention to provide a versatile reconfigurable web that is able to be implemented in many different ways.

Other objects and advantages of the invention will become apparent as the description proceeds.

### SUMMARY OF THE INVENTION

The present invention deals with a reconfigurable web that has the characteristics of both a reconfigurable web that does not resist a change in shape and also of a monolithic plate in at least one range of configurations and in at least one direction that does resist a change in shape. These two characteristics are achievable in many embodiments by use of interactable components that are designed to emulate the appearance and functionality of a reconfigurable web and of a monolithic plate.

A reconfigurable web having opposite web faces including a main web face comprises direction-sensitive displacement facilitating means provided within a thickness of said web for facilitating rolling or folding of at least one portion of said web in at least one direction to form a unidirectionally stiff and leveled surface; and force transmitting means which is suitable to set said web at a predetermined configuration by which said web, when leveled, is rollable or foldable in at least one direction and stiff in at least one other direction,
A. wherein said web is a first web that is segmented and further comprises additional force transmitting means which facilitate transmission of forces derived from moments, axial forces and shear forces within segments of said first web and that is imparted with all of the following characteristics:
   a. said main web face is continuous or semi-continuous;
   b. said first web, when comprising a common sheet or a lamination layer that is attached to a continuous or semi-continuous surface of the segments, is configured to ensure that said common sheet or said lamination layer remains undamaged and undetached at any attached point and for any configuration of said first web, wherein said common sheet or said lamination layer, when used, provides an illusive appearance of a monolithic plate;
   c. said first web is capable of comprising both said additional force transmitting means and said common sheet or said lamination layer while being configured to prevent transmission of forces to said common sheet and to said lamination layer, when used and when said first web is subjected to moments, axial forces producing tensile or compressive forces, or shear forces, at any configuration of said first web;
   d. said first web is configured to transmit axial forces producing tensile or compressive forces, shear forces and moments within the segments exclusively by using the additional force transmitting means in any configuration of said first web; and
   e. stress within said web is dispersable in more than one direction at any configuration of the first web; or
B. wherein said web is a second web that is segmented and further comprises a common sheet and optionally a lamination layer, and additional force transmitting means which facilitate transmission, within segments of said second web exclusively, of shear forces and moments which are derived from an attempt to displace the segments in the at least one other direction, and of axial forces producing tensile or compressive forces, when said second web is leveled, and wherein said second web is imparted with all of the following characteristics:
   f. said main web face is continuous or semi-continuous;
   g. said common sheet or lamination layer is attached to a continuous or semi-continuous surface of the segments, and said second web is configured to ensure that said common sheet and said lamination layer when used remains undamaged and undetached at any attached point and for any configuration of said second web, wherein said common sheet and said lamination layer when used provides an illusive appearance of a monolithic plate;
   h. said second web in conjunction with said force transmitting means and with said additional force transmitting means, when leveled and subjected to shear forces and moments which are derived from an attempt to displace the segments in the at least one other direction or subjected to axial forces producing tensile or compressive forces, is configured to prevent transmission of forces to said common sheet and to said lamination layer when used;
   i. said second web is configured to transmit axial forces producing tensile or compressive forces, shear forces and moments within the segments exclusively by using the additional force transmitting means when said second web is leveled and subjected to moments or shear forces which are derived from an attempt to displace the segments in the at least one other direction or subjected to axial forces producing tensile or compressive forces; and
   j. stress within said second web is dispersable in more than one direction when said second web is leveled and loaded by an attempt to displace the segments in the at least one other direction or by tension or compression of said second web; or
C. wherein said web is a third web that is segmented, and further comprises a common sheet and optionally a lamination layer, and is imparted with all of the following characteristics:
   k. said main web face is continuous or semi-continuous;
   l. said common sheet or lamination layer is attached to a continuous or semi-continuous surface of the segments, and said third web is configured to ensure that said common sheet and said lamination layer when used remains undamaged and undetached at any attached point and for any configuration of said third web, wherein said common sheet and said lamination layer when used provides an illusive appearance of a monolithic plate;
   m. said third web in conjunction with said force transmitting means is configured, when leveled and subjected to moments or shear forces which are derived from an attempt to displace segments of said third web in the at least one other direction, to prevent transmission of forces to said common sheet and to said lamination layer when used;
   n. said third web is configured to transmit shear forces and moments within the segments exclusively when said third web is leveled and subjected to moments or shear forces which are derived from an attempt to displace the segments in the at least one other direction; and
   o. stress within said third web is dispersable in more than one direction, when said third web is leveled and loaded by an attempt to displace the segments in the at least one other direction; or
D. wherein said web is a fourth web which is an unsegmented web.

The web imparted with characteristics a-e will be referred to as a “strengthened web”.

The following definitions are provided to assist the reader in the practice of the invention:
1) The term “web” means a flexible, foldable, rollable or rigid repositionable element, segmented or unsegmented, wherein at least one of its absolute dimensions is changed when reset from an unleveled condition to a leveled condition, or vice versa. The thickness of a web may range from a thickness in the order of a millimeter to a thickness in the order of meters. Any conventional sheet such as a rug, wallpaper, and flexible sheet for surface coverings is also considered as a web.
2) The term “main web face” means a functional web face which interacts with another surface, is directed towards a user, and at times is constituted by a common sheet or a lamination layer.
3) The term “direction” means the direction toward which at least one point of the web is directed when undergoing translational or rotational displacement, for example forwardly or rearwardly with respect to translational displacement and clockwise or counterclockwise with respect to rotational displacement.
4) The term “direction-sensitive displacement facilitating means” means one or more elements that together define the relative displacement of different portions of the web. In some embodiments, the direction-sensitive displacement facilitating means functions as a stopper to limit the range of displacement of the web in a specific direction. In some embodiments, the direction-sensitive displacement facilitating means also functions as the force transmitting means.
5) The term “force transmitting means” means one or more elements that transmit all forces generated within the web when the web is leveled and is subsequently rolled or folded in at least one direction for which the web behaves as a monolithic plate.
6) The term “foldable” or “rollable” relates to a change in angular disposition of a first web portion relative to a second web portion without any noticeable resistance of the web to a folding or rolling operation, whether as a result of sufficiently small-magnitude internal moments that are able to be overcome by manual force or as a result of the lack of formation of internal moments. A folding operation is performable even without producing a distinctive fold line. In contrast, a “flexible web” is elastically deformable by overcoming noticeable resistance of the web while generally retaining a continuous curvature. Also, an element that is capable of being rolled or folded by definition is not necessarily foldable or rollable, and may have to overcome noticeable resistance of the web to a folding or rolling operation.
7) The term “leveled” means a single designed predetermined configuration, which is generally planar, but which can be of other shapes as well, whereby the web is instantly transformed to a web having the characteristics of a monolithic plate. “Leveling” may be a specific characteristic of the web which is a result of the web's structure in order to achieve a leveled configuration, but also may be only a desired configuration of the web that is not a result of a specific web structure.
8) The term “stiff” means having characteristics of a monolithic plate which has resistance to deformation.
9) The term “unidirectionally stiff” means a condition whereby there is at least one direction of a leveled web that behaves as a monolithic plate and has resistance to deformation, including bending deformation, and there is at least one other direction of the leveled web that can be rolled or folded without restraint. The unidirectionally stiff and leveled web is not plastically deformable or damaged when being applied by muscular force, unless the web is weakened due to economic and implementation related considerations.
10) A “continuous web face” means that any line within the main web face has an unchanging length for all configurations of the web. A “semi-continuous web face” means that the axis of rotation is spaced from the main web face in a manner that does not cause any damage to an attached lamination or other types of fine coverings.
11) The term “segmented” means that the web comprises an array of serially interjoined discrete members and internal web surfaces, such that at at least one internal web surface contact is intermittently established and terminated or corresponding internal web surfaces slide along each other during folding or rolling. Conversely, the term “unsegmented” means a web that lacks any internal web surface whereat contact is intermittently established and terminated or corresponding internal web surfaces slide along each other during folding or rolling.
12) The term “common sheet” means an element that is a force transmitting element during folding or rolling, or under certain conditions when the web is tensioned, which, when applied, is able to transmit forces between different portions of a segmented web.
13) The terms “lamination sheet”, “lamination layer” and “lamination” are interchangeable and mean a sheet, when applied, that is of esthetic value and is not a force transmitting element. A common sheet is able to function as a lamination sheet. When the lamination layer is adhered to the adhered common sheet, the common sheet constitutes the main web face.
14) The term “or” includes the meaning “and/or”.

The direction-sensitive displacement facilitating means is configured to prevent transmission of shear forces and axial forces to a lamination layer or common sheet when the strengthened web is unleveled. When the common sheet constitutes the direction-sensitive displacement facilitating means, the common sheet absorbs the transmitted shear forces and axial forces. In some embodiments for which both a common sheet and an additional direction-sensitive displacement facilitating means are employed, shear forces and axial forces are generally prevented from being transmitted to the common sheet.

By using the strengthened web to form a unidirectionally stiff and leveled surface, a novel method to perform countless operations that heretofore have been performed in different ways is able to be introduced. Countless applications are also advantageously able to be implemented with use of the strengthened web. The strengthened web therefore provides at least the following advantages relative to the prior art:
a product that is a substitute for both a prior art rollable web and a prior art stiff monolithic board, depending on the implementation
quicker application to a base surface, more efficient and often more esthetic
webs in different sizes and strength levels
the force transmitting means is able to be independent of the displacement facilitating means, and therefore the performance of both the force transmitting means and the displacement facilitating means is able to be improved, and a high strength level and small deformations are achievable when the web is leveled
different configurations are designable
a product based on the web is mass producible, enabling each user to customize a desired mass producible implementation
enables all types of laminations and spray coverings to be applied, without any tears or folds appearing therein for all web configurations
a leveled web emulates the strength of a rigid and undeformable monolithic board
the axis of rotation is able to be pinpointed so as to coincide with any location in the vicinity of the main web face including the main web face itself
stiffness elements that do not protrude from a web surface
the web is able to be rolled or folded without any noticeable resistance
the web includes locking elements when needed for temporary or permanent locking
pivot producing elements that are loaded only during rolling to achieve a reliable stiff web that is needed when leveled
pivot producing elements to which is transmitted only a negligible load during rolling or folding, and which are completely unloaded when the web is leveled
suitable to be joined with an outer rigid layer
a plurality of webs are able to constitute a frame
the web is able to be cut with a desired size and design while retaining all of its characteristics, without any loss in terms of external appearance and functionality
versatility whereby the web is suitable for a wide range of implementations

In one aspect, the strengthened web is capable of being cut through said opposite web faces while retaining all of the characteristics a-f.

In one embodiment, the strengthened web is segmented and adjacent portions of the segmented web that are each configured with the direction-sensitive displacement facilitating means and the force transmitting means are suitably interjoined to facilitate foldable displacement in either a first direction or in a second direction.

In one embodiment, the strengthened web has maximum lengthwise and axial dimensions and comprises direction-sensitive angular displacement facilitating means and angular force transmitting means for facilitating angular displacement of said strengthened web about an axis of a roll defined by said web in a first rotational direction in order to be maintained in roll form and in a second rotational direction opposite to the first rotational direction to form the unidirectionally stiff and leveled surface of a desired lengthwise dimension that is less than or equal to said maximum lengthwise dimension, when unrolled relative to a portion of said strengthened web remaining in roll form.

In one aspect, the strengthened web is segmented and adjacent portions of the segmented strengthened web that are each configured with the direction-sensitive angular displacement facilitating means are suitably interjoined to facilitate the angular displacement in either the first rotational direction or in the second rotational direction.

In one aspect, a first of two lengthwise interjoined portions is angularly displaceable relative to a second of said two lengthwise interjoined portions about a corresponding axis of rotation coinciding with, or spaced from, the main web face of the strengthened web, wherein, when the strengthened web is leveled, each of a plurality of said lengthwise interjoined portions is angularly displaceable in the first rotational direction about the axis of the roll relative to an adjacent lengthwise interjoined portion and is prevented from being angularly displaced in the second rotational direction in emulation of a rigid monolithic plate.

In one aspect, the strengthened web is additionally configured with a plurality of axially interjoined portions provided in at least one of the plurality of lengthwise interjoined portions and are interjoined with another one of the plurality of lengthwise interjoined portions, wherein the direction-sensitive angular displacement facilitating means provided between each two of said axially interjoined portions facilitates unidirectional angular displacement of a first of said two axially interjoined portions relative to a second of said two axially interjoined portions about a corresponding lengthwise axis of rotation coinciding with the main face of the strengthened web.

In one aspect, the strengthened web further comprises a common sheet applied to the segmented web. Strain developed within the common sheet and overlying a local axis of rotation between first and second adjacent portions of the segmented web when the first portion is angularly displaced with respect to the second portion is in an elastic regime.

In one embodiment, the strengthened web is unsegmented and flexible, and the direction-sensitive angular displacement facilitating means comprises inextensible means provided along a cross section of the strengthened web that is influential to facilitate direction-sensitive angular displacement when the roll is unrolled in the second rotational direction, wherein, when the web is leveled, the web is angularly displaceable in the first rotational direction about the axis of the roll and is prevented from being angularly displaced in the second rotational direction.

In one aspect, the unidirectionally stiff and leveled surface is in contact with a base surface.

In one aspect, the continuous main web face is capable of being adhesively, chemically or mechanically attached to the common sheet while preserving the appealing appearance and functionality of the common sheet, for each configuration of the web.

In one aspect, the direction-sensitive displacement comprises the force transmitting means.

In one aspect, the strengthened web comprises at least first and second portions, wherein a rolling direction of the first portion is opposite to the rolling direction of the second portion and the main web face of the first and second portions is located at a same face of the strengthened web.

An unrollable link material leveling system for covering even and uneven surfaces comprises:
i. means for applying link material to an exposed constructed surface;
ii. an elongated sheet, at least a portion of which positioned in force applying relation with said constructed surface; and
iii. means for differentially applying a force to said elongated sheet which comprises at least one of the web defined rolls, such that said applied link material becomes compressed upon application of the force to said elongated sheet and that an interior surface of said elongated sheet becomes uniformly leveled upon solidification of said compressed link material.

As referred to herein, “link material” means material that becomes linked to another material or links two or more elements together.

In one aspect, said elongated sheet is configured with an uninterrupted interiorly faceable surface, a plurality of vertically extending and exteriorly facing cavities, an inter-cavity protrusion provided between an adjacent pair of the cavities, and a plurality of vertically spaced and longitudinally extending recesses,
wherein the means for differentially applying a force to said elongated sheet is a rolled structure of the sheet by which a differential curved sheet portion is urged in pressing relation with the constructed surface and which is capable of being horizontally leveled by a plurality of the web defined rolls,
wherein each of the web defined rolls is inserted with a corresponding one of the recesses and attached to the interiorly faceable surface to constitute a reinforcement band for the sheet, wherein a uniform volume of unsolidified link material applied to the constructed surface is forced to flow into each of the cavities which are in fluid communication with the unsolidified link material upon application of an unrolling force to a roll of the elongated sheet having a vertical axis and attached reinforcement bands, to ensure that the interiorly facing surface will be leveled while secured to the building wall following solidification of the link material.

In one aspect, each of the inter-cavity protrusions is a rounded T-shaped inter-cavity protrusion.

In one aspect, the leveling system further comprises a sheet holding structure for maintaining the flow of a uniform volume of the unsolidified link material into each of the cavities while the elongated sheet therewithin is being unrolled.

In one aspect, a first section of the holding structure is configured to compress and level the elongated sheet against the link material that has already been applied to the building wall, and a second section of the holding structure is configured to maintain vertical stiffness of the holding structure to ensure leveling of the elongated sheet against the wall.

In one aspect, the holding structure comprises a plurality of the web defined rolls which are arranged in a coiled formation such that an outer loop surrounds an inner loop adjacent to the outer loop, to provide a gap between each pair of adjacent loops within which the elongated sheet is received prior to being applied onto the building wall.

In one aspect, each of the web defined rolls comprises a plurality of coupling panels that are each interjoined with an adjacent panel and two of the coupling panels which are peripherally adjacent to each other are interconnected by a vertically oriented pivot element extending throughout a height of the holding structure.

A parquet system comprises a plurality of rollable or foldable parquet segments, wherein each of said parquet segments comprises the strengthened web and is interconnectable with an adjacent parquet segment upon being unrolled or folded.

A system for applying paneling material to an existing constructed surface comprises a rollable or foldable paneling material unit comprising the strengthened web; a stationary member associated with said constructed surface; and a plurality of spaced connecting means provided with one or both of said paneling material unit and said stationary member, wherein each of said connecting means is configured to cause a region of said paneling material unit to be connected with a corresponding region of said stationary member upon unrolling or unfolding said paneling material unit until the unrolled paneling material unit is leveled.

In one embodiment, the connecting means comprises a plurality of lengthwise separated protruding pins; and a plurality of lengthwise separated pin-receiving apertures, wherein one of the plurality of pins and the plurality of pin-receiving apertures is provided with said paneling material unit and the other is provided with the stationary member, wherein each of said plurality of pins has a length that is less than a depth of each of said plurality of apertures, in each of said apertures a corresponding one of said pins is securely receivable upon unrolling a roll of said paneling material unit until the unrolled paneling material unit is leveled.

In one aspect, when the paneling material unit is provided with the plurality of pins, each of the pins is releasable therefrom upon being received in a corresponding aperture formed in the member associated with the existing wall.

In one aspect, the connecting means comprises adhesively connectable elements or chemically connectable means provided in one or both of the paneling material unit and the stationary member.

A hinge for continuous and uninterrupted surfaces, which is the strengthened web, wherein said strengthened hinge comprises two sections exclusively that are pivotally displaceable one relative to the other about an axis of rotation and each of said sections comprises the direction-sensitive displacement facilitating means and the force transmitting means, wherein each of said two sections is connectable to a corresponding planar board in such a way to produce completely coplanar surfaces that include both of said two sections and said two boards when said hinge is set to an unpivoted position and the axis of rotation of said hinge is coincident with, or spaced from, a main web face of said two sections.

A coupling panel connecting system comprises the strengthened web, wherein each of a plurality of the interjoined portions of the strengthened segmented web is a coupling panel that is interjoined with an adjacent coupling panel, such that each of said plurality of coupling panels is displaceable with respect to an adjacent coupling panel and each pair of said plurality of coupling panels are lockingly joinable together when leveled and prevented from being displaced in the second direction to form a unidirectionally stiff and leveled composite surface.

In one aspect, each of the plurality of interjoined portions is a lengthwise interjoined portion that is interjoined in a way such that each of said plurality of coupling panels is angularly displaceable with respect to an adjacent coupling panel about the corresponding axis of rotation which coincides with, or is spaced from, a common edge adjoining two adjacent coupling panels.

In one aspect, each of the plurality of coupling panels is configured with a first planar surface and with a second surface parallel to said first surface.

In one aspect, the coupling panel connecting system is a tongue and groove connecting system, wherein each or most of the plurality of coupling panels is configured with a tongue and an opposed groove.

In one aspect, the coupling panel connecting system further comprises the common sheet which is attached to the first surface of each of the plurality of coupling panels, wherein the corresponding axis of rotation about which each of the plurality of coupling panels is angularly displaceable coincides with, or is spaced from, a visible face of the common sheet, and each pair of the plurality of coupling panels are lockingly joinable together after the tongue of a first coupling panel has been completely inserted within the groove of a second coupling panel.

In one aspect, the plurality of coupling panels are storable in a roll or folded form, and are unrollable or foldable unidirectionally, for example when contacting a base surface.

In one aspect, each of the plurality of coupling panels is additionally configured with a plurality of pairs of orthogonal surfaces arranged such that each of said pairs of orthogonal surfaces of the first coupling panel is positionable in abutting relation with a corresponding pair of orthogonal surfaces of the second coupling panel which is complementary to the pair of orthogonal surfaces of the first coupling panel, to assist in lockingly joining together the first and second coupling panels.

In one aspect, in a leveled configuration, rotation of the first coupling panel in the second rotational direction is restricted by the abutting relation of the complementary pairs of orthogonal surfaces of the first and second coupling panels and is unrestricted in the first rotational direction.

In one aspect, in an unleveled configuration, the tongue of the first coupling panel undergoes interference-free rotation within the groove of the second coupling panel when the first coupling panel is angularly displaced with respect to the second coupling panel.

In one aspect, the groove is formed between the first and second surfaces to define a first wall coinciding with the first surface and a second wall coinciding with the second surface, and is delimited by a planar third surface which coincides with said first wall and is parallel with the first surface, a planar fourth surface which coincides with said second wall and is parallel with the second surface, and a fifth surface extending between the first and second walls.

In one aspect, the tongue is configured with coplanar sixth and seventh surfaces, the sixth surface of the first coupling panel being completely abuttable with the third surface of the second coupling panel and the seventh surface of the first coupling panel being completely abuttable with the fourth surface of the second coupling panel, when the first and second coupling panels are lockingly joined together.

In one aspect, the interference-free rotation is facilitated when the sixth surface of the first coupling panel has a length which is less than the length of the third surface of the second coupling panel.

In one aspect, an intersection between the third and fifth surfaces of the second coupling panel is spaced from the corresponding axis of rotation by a distance which is equal to, or greater than, the length from the corresponding axis of rotation to the seventh surface of the first coupling panel.

In one aspect, the interference-free rotation is also facilitated when a distance between any point on an eighth surface of the first coupling panel extending between the sixth and seventh surfaces, or between a ninth surface and the seventh surface, and the corresponding axis of rotation is less than the length from the corresponding axis of rotation to the seventh surface of the first coupling panel, said ninth surface is a surface which is perpendicular to the sixth surface and is a truncation of an intersection of the sixth and eighth surfaces.

In one aspect, both the tongue and the groove are arcuate and the tongue of the first coupling panel is displaceable along an arcuate path within the groove of the second coupling panel.

In one aspect, each of the plurality of coupling panels is additionally configured with a stopper element which is engageable with a coupling panel region at a terminal end of the arcuate groove, wherein rotation of the first coupling panel in the second rotational direction is restricted when the tongue abuts the stopper element and is unrestricted in the first rotational direction.

In one aspect, the coupling panel connecting system further comprises two semicircular end plates attached to opposite walls, respectively, of a first cavity formed within a first coupling panel, and an intermediate semicircular plate interposed between said end plates and attached to a wall of a second cavity formed within a second coupling panel adjacent to said first coupling panel,
wherein each of said end plates is configured with a corresponding inwardly protruding semicircular protrusion and each face of said intermediate plate is formed with a semicircular recess within which the corresponding protrusion is receivable and rotatable,
wherein said intermediate plate, upon undergoing rotation about the axis of rotation, forces said second coupling panel to pivot relative to said first coupling panel.

In one aspect, the coupling panel connecting system further comprises a continuous joint comprising an elastic and elongated strap which is interconnected to a corresponding wall of first and second coupling panels of the plurality of coupling panels, wherein a face of said strap develops a continuous curvature when the first and second coupling panels undergo relative angular displacement.

In one aspect, first and second coupling panels have a completely solid and rectangular cross section.

Apparatus comprising the reconfigurable strengthened web is selected from the group consisting of:
i. a bi-directionally rigid and displaceable surface;
ii. an extendable table or shelf which is retractable into a wall;
iii. a partition capable of being folded;
iv. a door capable of being folded;
v. a unidirectional sliding door that is slidable to a transversal end of a retaining structure;
vi. a storage structure with shelves that are capable of being folded and to redefine internal storage spaces;
vii. wire shelving capable of being folded;
viii. a completely coplanar hinge that is capable of being folded up to and including 180 degrees;
ix. a unidirectionally stiff and leveled surface used for fence coverings;
x. a unidirectionally stiff and leveled surface used for roof coverings;
xi. a television or screen capable of being rolled or folded and which is mountable, when leveled, on a surface area for example of greater than 4 cm² for mobile telephone screens and up to approximately 16 m² for television screens that are able to mounted on walls without any external supports, with the exception of anchoring elements;
xii. a surface capable of being rolled or folded such as temporary floors, walls, advertising space, bridges, and addition applications without need of discrete elements for rebuilding and disassembling the surface, for example of a surface area up to approximately 400 m² when leveled, and capable of being transported in a transportation vehicle such as a medium sized truck when unleveled, for example having a width of 2 m (an unleveled strengthened web having dimensions of 10 m×20 m);
xiii. a protective garment; and
xiv. a chair, table, or bed capable of being rolled and which comprises the strengthened web and also legs which are storable in a core of the strengthened web when rolled.

In one aspect, the strengthened web is provided with a permanently applied or releasable lamination layer.

In one aspect, the bi-directionally rigid and displaceable surface is prestressed.

In one aspect, the unidirectionally stiff and leveled surface is applied to palisade fencing or to a metal fence.

In one aspect, the unidirectionally stiff and leveled surface is applied to a fence made of a concrete slab.

In one aspect, the unidirectionally stiff and leveled surface used for roof coverings is maintained in roll form when undeployed.

In one aspect, the unidirectionally stiff and leveled surface used for roof coverings is folded or stacked when undeployed.

In one aspect, the unidirectionally stiff and leveled surface used for roof coverings comprises a plurality of photovoltaic cells.

In one aspect, a plastic covering separate from a common sheet or lamination layer is applied to the main web face in order to protect the web and enhance its durability and accuracy in terms of relative displacement of adjacent web portions.

In one aspect, a displayable device capable of being rolled, such as a television, screen, art object, and advertisement sign capable of being rolled, is permanently attached to a holding structure while being protected within a gap between adjacent loops thereof.

In one aspect, the displayable device capable of being rolled is detachable from the holding structure.

A reconfigurable web having opposite web faces including a main web face, said web comprising direction-sensitive displacement facilitating means provided within a thickness of said web for facilitating rolling or folding of at least one portion of said web in at least one direction to form a unidirectionally leveled surface; and force transmitting means which is suitable to set said web at a predetermined configuration by which said web, when leveled, is rollable or foldable in at least one direction and unidirectionally stiff in at least one other direction, wherein said web is imparted with the following characteristics:
a. load bearing capacity in at least one direction which is sufficient to facilitate leveling of said web; and
b. stress within said force transmitting means is dispersed in at least one direction, when said web is leveled and loaded during use.

The web imparted with characteristics a-b will be referred to as a “weakened web”. A weakened web may have lower load bearing capacity than a strengthened web, and the center of rotation of each adjacent coupling panel may not be coplanar with the upper or lower face of the weakened web.

With respect to link material, for example, a weakened web is able to be designed with a smaller resistance than a strengthened web when being rolled in the at least one other direction from a leveled disposition. As a result of the distributed forces that the link material applies onto the sheet corresponding to the forces by which the sheet is pressed against a surface such as a wall, a reduction in the bending resistance of a leveled sheet is made possible. In this situation, a weakened web applying a force onto the sheet for the given implementation is able to suffice.

When a strengthened or weakened web is provided with standard dimensions and a diverse or ornamental external appearance, the strengthened or weakened web is mass producible as an additional alternative to monolithic plates such as cement, wood, PVC and plaster boards regardless of its inner structure, and is readily available at any selling location accessible to any private purchaser.

Recitations of the segmented weakened web and the unsegmented weakened web that do not require the flexibility of the web when leveled are applicable to the strengthened web.

In one aspect, said weakened web is unsegmented and flexible and comprises first and second layers that are attached together to constitute said direction-sensitive displacement facilitating means, said first layer being longitudinally deformable under tension and substantially undeformable under compression, and said second layer being longitudinally deformable under compression and substantially undeformable under tension, such that said unsegmented web, when subjected to a first magnitude of force, is capable of bending in only a first rotational direction but cannot be bent in a second rotational direction opposite to said first rotational direction unless said unsegmented web is subjected to a second magnitude of force greater than said first magnitude of force when said unsegmented web is leveled.

In one aspect, said weakened web is segmented and adjacent portions of said segmented web are suitably interjoined to facilitate rollable or foldable displacement in either a first direction or a second direction.

In one aspect, said direction-sensitive displacement facilitating means comprising one or more means selected from a continuous joint, an inner axis, a folding tongue and groove coupling panel connected with said continuous joint or said inner axis, an inverse folding tongue and groove coupling panel, an inverse folding tongue and groove coupling panel, connected with said continuous joint or said inner axis, a polygonal middle axis coupling panel, and a composite coupling panel.

In one aspect, the weakened web is capable of being cut through said opposite web faces while retaining all of the characteristics a and b.

In one aspect, the direction-sensitive displacement facilitating means of the weakened web comprises the force transmitting means.

In one aspect, the weakened web comprises at least first and second portions, wherein a rolling direction of the first portion is opposite to the rolling direction of the second portion and the main web face of the first and second portions is located at a same face of the weakened web.

An unrollable link material leveling system for covering even and uneven surfaces comprises:
i. means for applying link material to an exposed constructed surface;
ii. an elongated sheet, at least a portion of which positioned in force applying relation with said constructed surface; and
iii. means for differentially applying a force to said elongated sheet which comprises at least one roll defined by the weakened web, such that said applied link material becomes compressed upon application of the force to said elongated sheet and that an interior surface of said elongated sheet becomes uniformly leveled upon solidification of said compressed link material.

A parquet system comprises a plurality of rollable and foldable parquet segments, wherein each of said parquet segments comprises the weakened web and is interconnectable with an adjacent parquet segment upon being unrolled.

A system for applying paneling material to an existing constructed surface comprises a rollable or foldable paneling material unit comprising the weakened web; a stationary member associated with said constructed surface; and a plurality of spaced connecting means provided with one or both of said paneling material unit and said stationary member, wherein each of said connecting means is configured to cause a region of said paneling material unit to be connected with a corresponding region of said stationary member upon unrolling or unfolding said paneling material unit until the unrolled or unfolded paneling material unit is leveled.

A hinge for continuous and uninterrupted surfaces, which is the weakened web, wherein said hinge comprises two sections exclusively that are pivotally displaceable one relative to the other about an axis of rotation and each of said sections comprises the direction-sensitive displacement facilitating means and the force transmitting means,
wherein each of said two sections is connectable to a corresponding planar board in such a way to produce completely coplanar surfaces that include both of said two sections and said two boards when said hinge is set to an unpivoted position and the axis of rotation of said hinge is coincident with, or spaced from, a main web face of said two sections.

A coupling panel connecting system comprises a segmented weakened web, wherein each of a plurality of interjoined portions of the segmented web is a coupling panel that is interjoined with an adjacent coupling panel, such that each of said plurality of coupling panels is displaceable with respect to an adjacent coupling panel in both the first and second directions, wherein when said coupling panel connecting system is leveled, each pair of said plurality of coupling panels are displaceable in the first direction and are lockingly joined to resist displacement in the second direction.

Apparatus comprising a reconfigurable weakened web is selected from the group consisting of:
i. a bi-directionally rigid and displaceable surface;
ii. an extendable table or shelf which is retractable into a wall;
iii. a partition capable of being folded;
iv. a door capable of being folded;
v. a unidirectional sliding door that is slidable to a transversal end of a retaining structure;
vi. a storage structure with shelves that are capable of being folded to redefine internal storage spaces;
vii. wire shelving capable of being folded;
viii. a completely coplanar hinge that is capable of being folded up to and including 180 degrees;
ix. a unidirectionally stiff and leveled surface used for fence coverings;
x. a unidirectionally stiff and leveled surface used for roof coverings;
xi. a television or screen capable of being rolled or folded;
xii. a surface capable of being rolled or folded without need of discrete elements for rebuilding and disassembling the surface, and capable of being transported in a transportation vehicle when unleveled;
xiii. a safety garnent; and
xiii. a chair, table, or bed capable of being rolled or folded and comprising the web and also legs which are storable in a core of the web when rolled.

A method of covering a solid uneven base surface, whereby the solid uneven base surface is covered by reconfiguring a web capable of being rolled or folded until said web is leveled and applied to the solid uneven base surface, or by leveling material applied to the solid uneven base surface using a structure that is capable of being rolled or folded.

Said web may be a strengthened web, a weakened web, or any other suitable web. Said structure is preferably reusable.

In one aspect, the method further comprises covering a solid even base surface by reconfiguring the web until the web is leveled and applied to the solid even base surface, or by leveling the material which is applied to the solid even base surface using the structure.

In one embodiment, the web that is reconfigured is a weakened web that comprises direction-sensitive displacement facilitating means provided within a thickness of said weakened web for facilitating rolling or folding of at least one portion of said weakened web in at least one direction to form a unidirectionally leveled surface; and force transmitting means which is suitable to set said weakened web at a predetermined configuration by which said weakened web, when leveled, is rollable or foldable in at least one direction and unidirectionally stiff in at least one other direction, wherein said weakened web is imparted with the following characteristics:
a. load bearing capacity in at least one direction which is sufficient to facilitate leveling of said weakened web; and
b. stress within said force transmitting means is dispersed in at least one direction, when said weakened web is leveled and loaded during use.

In one embodiment, the web that is reconfigured is a strengthened web that comprises direction-sensitive displacement facilitating means provided within a thickness of said strengthened web for facilitating rolling or folding of at least one portion of said strengthened web in at least one direction to form a unidirectionally stiff and leveled surface; and force transmitting means which is suitable to set said web at a predetermined configuration by which said web, when leveled, is rollable or foldable in at least one direction and stiff in at least one other direction in emulation of a rigid monolithic plate,
wherein said strengthened web is imparted with the following characteristics:
a. said main web face is continuous or semi-continuous;
b. said continuous main web face is capable of being attached to a common sheet optionally configured with additional force transmitting means or to a lamination layer while said common sheet or said lamination layer remains undamaged and undetached at any attached point and for any configuration of said web, wherein said common sheet or said lamination layer, when used, provides an illusive appearance of a stiff monolithic plate;
c. load bearing capacity and deformation resistance in at least one direction similar to that of a rigid monolithic plate, when said web is leveled;
d. said direction-sensitive displacement facilitating means, when not constituted by the common sheet, is configured to prevent transmission of shear forces and axial forces to said common sheet and said lamination layer when used for any configuration of said web;
e. said force transmitting means is configured to prevent transmission of forces to said common sheet and said lamination layer, when used and when said web is leveled; and
f. stress within said web is dispersed in more than one direction, when said web is leveled and loaded during use.

In one aspect, the method further comprises the step of inserting the web, such as an elongated sheet, into the structure which is a holding structure constituted by an additional web that is the strengthened or weakened web.

In one aspect, the material applied to the solid even or uneven base surface includes an elongated sheet and the structure applies a force to the sheet when a plurality of external supports are anchored to the solid even or uneven base surface.

In one aspect, an additional material is applied to the sheet that produces an adhesive or chemical connection with link material applied to the base surface.

In one aspect, the method further comprises the steps of:
a) applying link material to the solid even or uneven base surface;
b) positioning at least a portion of the elongated sheet in force applying relation with the solid even or uneven base surface;
c) differentially applying a force to the elongated sheet by at least one of the webs, such that the applied link material becomes compressed upon application of the force to the elongated sheet; and
d) producing an interior surface of the elongated sheet that is uniformly leveled, upon solidification of said compressed link material.

In one aspect, the solid even or uneven base surface is covered by unrolling a plurality of the webs each of which is capable of being rolled or folded and is a separate parquet segment, such that a first of the parquet segments becomes interconnected with a second of the parquet segments upon being unrolled.

In one aspect, the solid even or uneven base surface is a vertical wall which is configured with, or a post connected to said vertical wall is configured with, a plurality of spaced connecting means, and wherein the web is capable of being rolled or folded and is a paneling material unit which has adjacent regions that are designed to be connected to one or more of said connecting means, the method further comprising the step of:
unrolling a roll of the web so that one or more of said connecting means will be connected to corresponding regions of a portion of the unrolled web and the unrolled web portion will be urged to be leveled.

In one aspect, the method further comprises the steps of:
a) applying link material to the solid even or uneven base surface;
b) leveling the link material applied to the solid even or uneven base surface using the structure; and
c) following solidification of the applied link material, mounting a sheet onto the leveled and solidified link material.

In one aspect, the material is link material.

In one aspect, the solid even or uneven base surface is a roof surface, and the base roof surface is covered by unrolling a roll of the web that is sufficiently strong to withstand a stepping force applied upon the web, wherein roofing material for the base roof surface is constituted by elements of the web or by a layer of the web which is a multi-layer web.

In one aspect, the roofing material comprises a plurality of photovoltaic cells.

A monolithic construction member that is integratable with link material applied to a base surface comprises an uninterrupted interiorly faceable surface and an exteriorly faceable section inseparable from said interiorly faceable surface, wherein said exteriorly faceable section is provided with reinforcing means which are anchorable or connectable with the applied link material, and wherein said construction member has a weight less than an adherence strength of the applied link material with respect to said base surface or said construction member both prior to and following solidification of the link material.

In one aspect, the exteriorly faceable section comprises a plurality of spaced frame elements that are each anchorable with the applied link material.

In one aspect, the interiorly faceable surface is a flexible sheet.

In one aspect, the anchorable reinforcing means comprises a plurality of exteriorly facing protrusions that protrude from the interiorly faceable surface and that extend in a common direction, wherein a cavity is defined between each pair of the protrusions within which a uniform volume of unsolidified link material is receivable, to ensure that the interiorly facing surface will be leveled and anchored following solidification of the link material.

In one aspect, the connectable reinforcing means are mechanical means or chemical means.

A method for reconfiguring a surface comprises providing a continuous and uninterrupted main surface which is a surface of a unidirectionally stiff and continuous or semi-continuous segmented web; configuring said main surface to be of a first length such that all segments of said main surface are stiff, continuous or semi-continuous and coplanar, and have a center of rotation which is coincident with, or separated from, said main surface; and reconfiguring said main surface by angularly displacing at least one of the segments in a lengthwise direction until coplanar segments of said main surface which have not been angularly displaced define a second length shorter than said first length and are stiff and coplanar; or coplanar segments of said main surface define a third length longer than said first length and are stiff and coplanar.

In one aspect, a single lamination or common sheet is applied to the main surface to emulate an appearance of a monolithic plate.

In one aspect, the method further comprises the step of reconfiguring the main surface by angularly displacing at least one of the segments in a widthwise direction until the main surface has a second width greater than or less than a first width.

### BRIEF DESCRIPTION OF THE DRAWINGS

### In the Drawings:

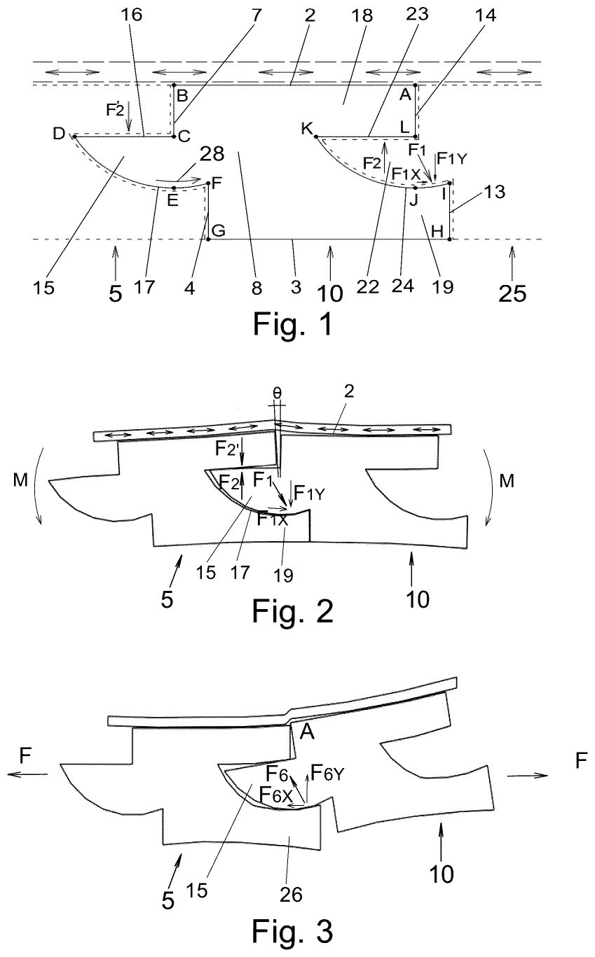

FIG. 1 is a side view of a prior art coupling panel, schematically indicating forces that are applied thereto when coupled with adjacent panels;

FIGS. 2 and 3 are a side view of the prior art coupling panel of FIG. 1, showing two deficiencies, respectively, relating to the use thereof;

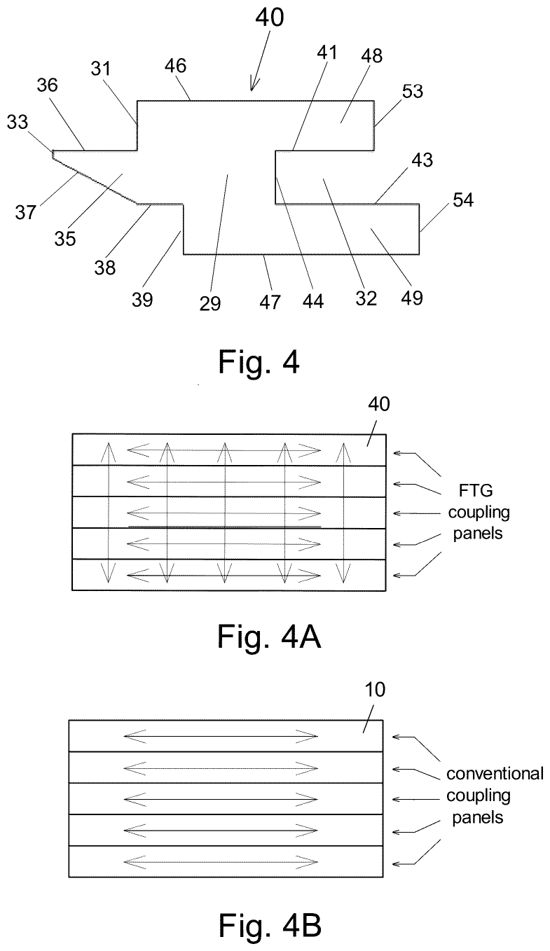

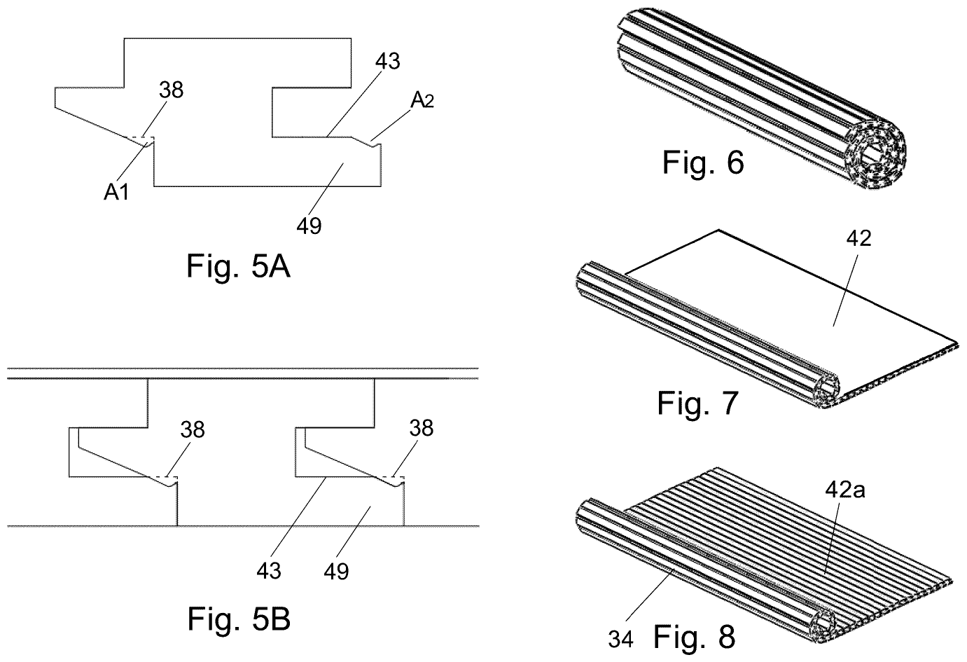

FIG. 4 is a side view of a coupling panel according to an embodiment of the invention;

FIG. 4A is a top view of a coupling panel system comprising the coupling panels of FIG. 4, schematically illustrating its advantageous multi-directional load dispersing ability;

FIG. 4B is a top view of a coupling panel system comprising the coupling panels of FIG. 1, schematically illustrating its limited unidirectional load dispersing ability;

FIGS. 5A and 5B are a side view of the coupling panel of FIG. 4 which has been modified with an interlocking element and of a coupling system employing two of the modified coupling panels, respectively;

FIG. 6 is a perspective view of a plurality of the coupling panels of FIG. 4 when stored in roll form;

FIGS. 7 and 8 are a perspective view of two rolls of FIG. 6 which are covered and uncovered, respectively, by a common sheet, shown when partially unrolled;

FIGS. 9A-C are a side view of a connecting system configured with a prestressed wire, shown prior to being prestressed, after being prestressed, and loaded without any vertical deformations according to the prestressed process, respectively;

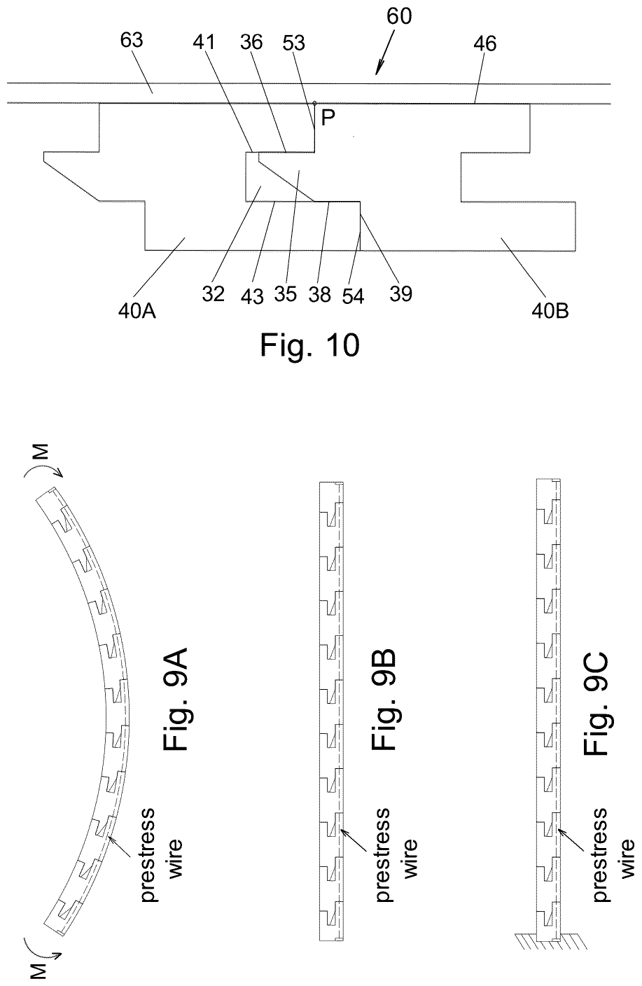

FIG. 10 is a side view of a tongue and groove connecting system comprising two coupling panels of FIG. 4, when lockingly joined together;

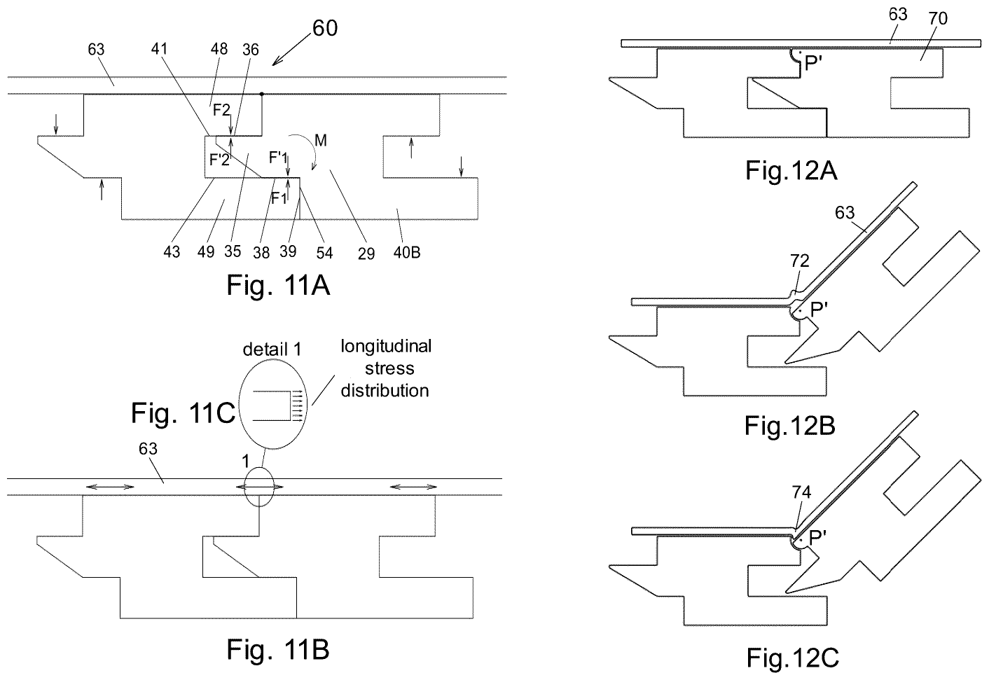

FIG. 11A is a side view of the two coupling panels of FIG. 10, schematically illustrating the absorption of a moment and of a force when lockingly joined together;

FIG. 11B is a side view of the two coupling panels of FIG. 10, schematically illustrating longitudinal stress distribution that is developed within the common sheet when lockingly joined together;

FIG. 11C illustrates Detail 1 of FIG. 11B, schematically illustrating the longitudinal elastic strain that has developed;

FIG. 12A is a side view of two coupling panels of a prior art tongue and groove connecting system, schematically illustrating the location of the axis of rotation therebetween;

FIGS. 12B and 12C are a side view of the two prior art coupling panels of FIG. 12A, when one is angularly displaced with respect to the other, schematically illustrating two different impaired conditions, respectively, which are liable to be formed in a common sheet attached to the two coupling panels;

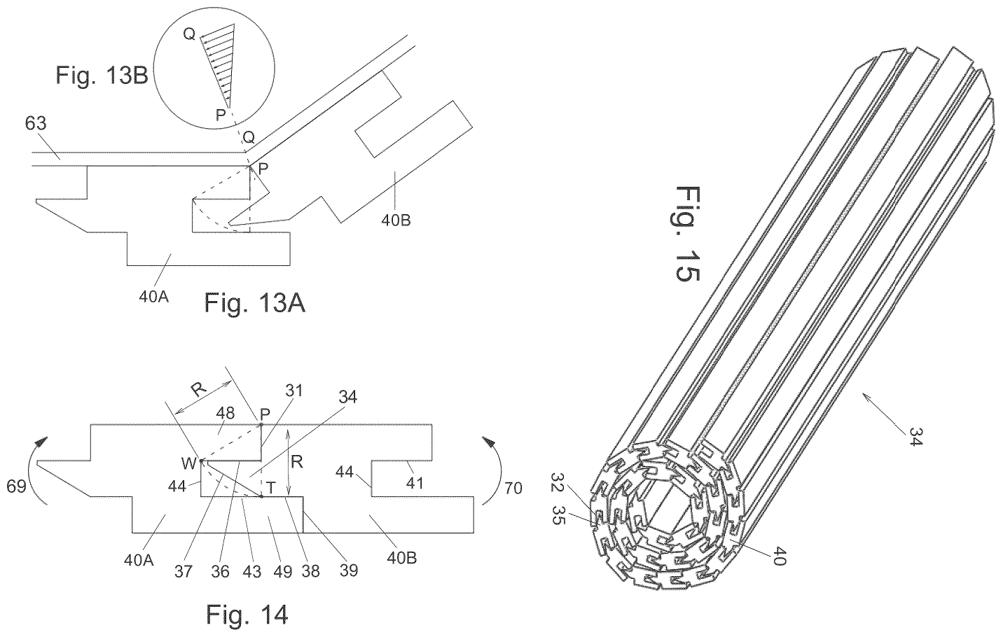

FIG. 13A is a side view of the two coupling panels of FIG. 10, when one is angularly displaced with respect to the other;

FIG. 13B is a stress distribution diagram of a crease formed within the common sheet during the angular displacement of FIG. 13A which is shown to be in the linear elastic regime;

FIG. 14 is a side view of the two coupling panels of FIG. 10, illustrating geometrical considerations relating to an unrolling operation;

FIG. 15 is a perspective view of a roll formed from a plurality of the coupling panels of FIG. 4, each of which is shown at a different angular disposition;

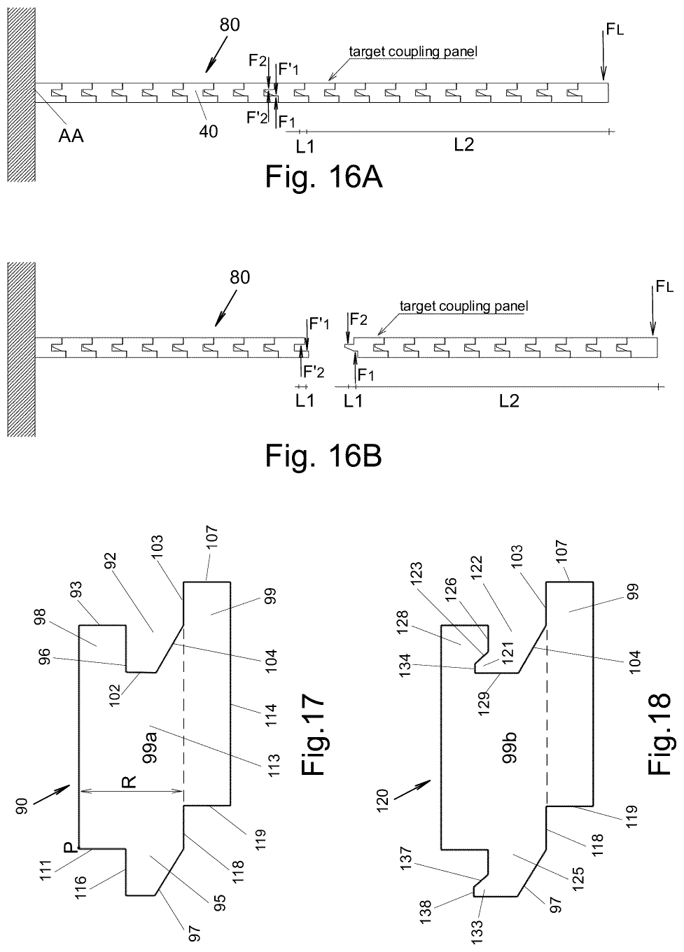

FIGS. 16A-B are a side view of a tongue and groove connecting system comprising the coupling panels of FIG. 4, FIG. 16A schematically illustrating the internal forces which interact between each adjacent coupling panel in response to a downwardly directed concentrated load and FIG. 16B illustrating more clearly which internal forces act on each one of the adjacent coupling panels;

FIG. 17 is a side view of another embodiment of a coupling panel;

FIG. 18 is a side view of another embodiment of a coupling panel;

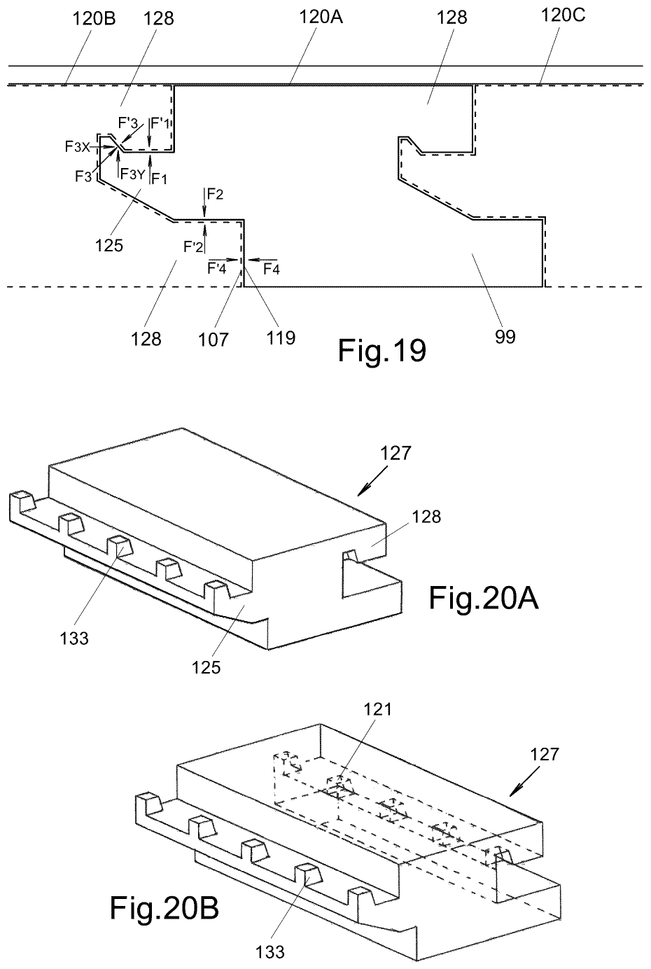

FIG. 19 is a side view of a connecting system comprising three of the coupling panels of FIG. 18, schematically illustrating the ability to resist axial forces and bending when lockingly joined together;

FIGS. 20A and 20B are a perspective view from the side and top of the coupling panel of FIG. 18, shown in solid and partial transparent form respectively;

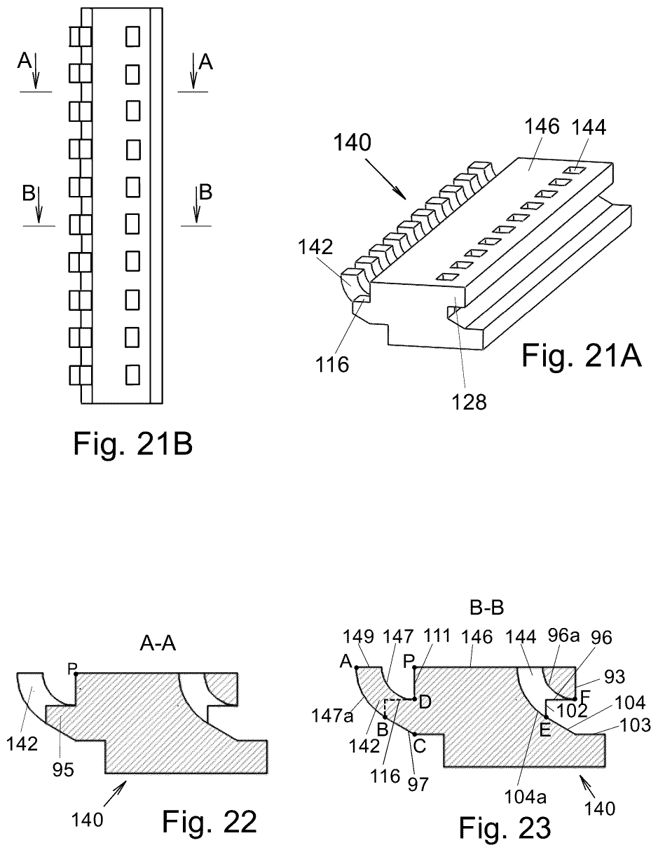

FIG. 21A is a perspective view from the side and top of another embodiment of a coupling panel;

FIG. 21B is a top view of the coupling panel of FIG. 21A;

FIG. 22 is a cross sectional view of the coupling panel of FIG. 21A, cut along plane A-A;

FIG. 23 is a cross sectional view of the coupling panel of FIG. 21A, cut along plane B-B;

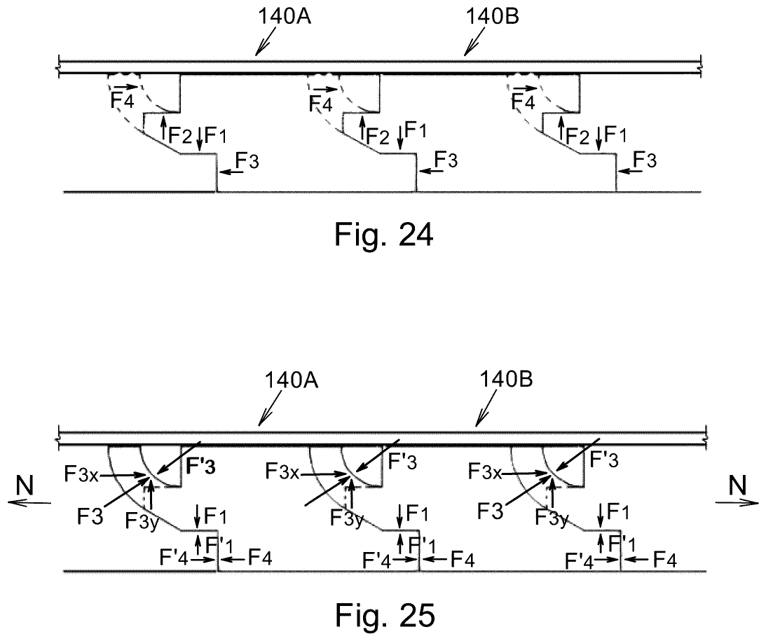

FIG. 24 is a side view of a connecting system comprising two of the coupling panels of FIG. 21A when cut along plane A-A, schematically illustrating forces that are transmitted between adjacent coupling panels;

FIG. 25 is a side view of a connecting system comprising two of the coupling panels of FIG. 21A when cut along plane B-B, schematically illustrating forces that are transmitted between adjacent coupling panels;

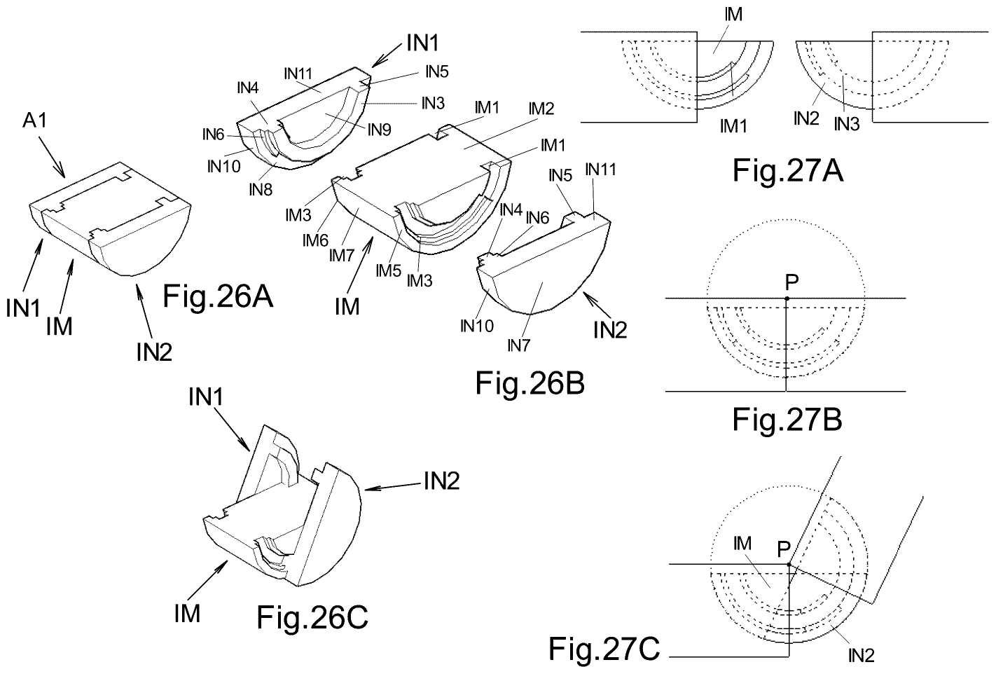

FIG. 26A is a perspective assembled view of an inner axis unit;

FIG. 26B is an exploded view of the inner axis unit of FIG. 26A;

FIG. 26C is a perspective view of the inner axis unit of FIG. 26A when angularly displaced to a pivoted position;

FIG. 27A is a side and partially hidden view of an end plate of the inner axis unit of FIG. 26A when connected to a first coupling panel and a side and partially hidden view of an intermediate plate of the inner axis unit of FIG. 26A when connected to a second coupling panel which is spaced from and not interjoined with the first coupling panel;

FIG. 27B is a side view of a connecting system that includes the first and second coupling panels of FIG. 27A, showing the end and intermediate plates when interjoined together at an unpivoted position;

FIG. 27C is a side view of the first and second coupling panels of FIG. 27B, showing the end and intermediate plates when interjoined together at a pivoted position;

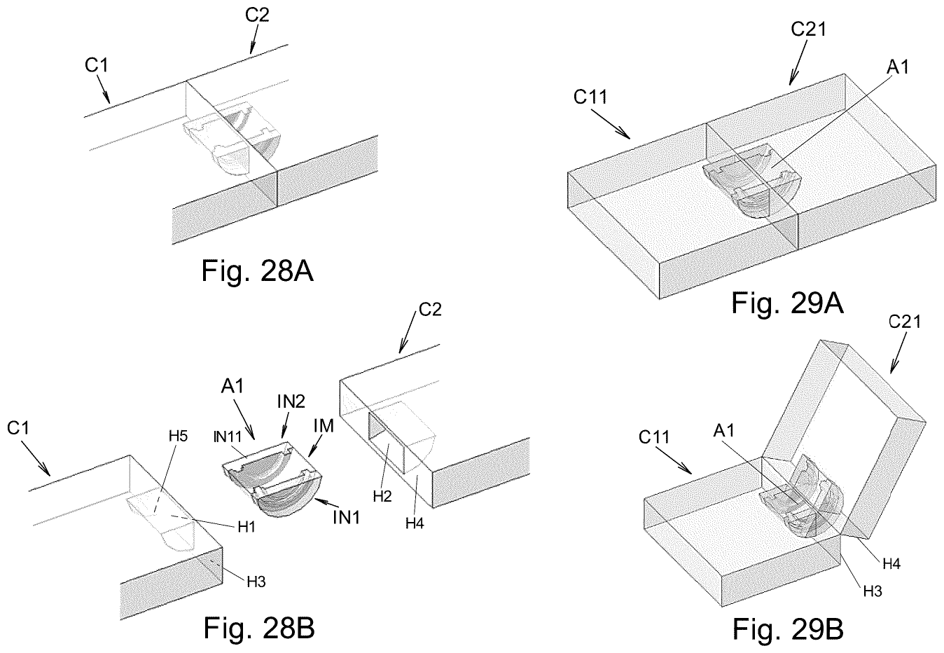

FIG. 28A is an exploded view of the connecting system of FIG. 27B and a partially hidden view of the first and second coupling panels, showing a cavity of each in which the inner axis unit is introducible;

FIG. 28B is a perspective view of the first and second coupling panels of FIG. 27A when assembled together with the inner axis unit;

FIGS. 29A and 29B are another perspective view of the first and second coupling panels of FIG. 27A, showing the inner axis unit in unpivoted and pivoted positions, respectively;

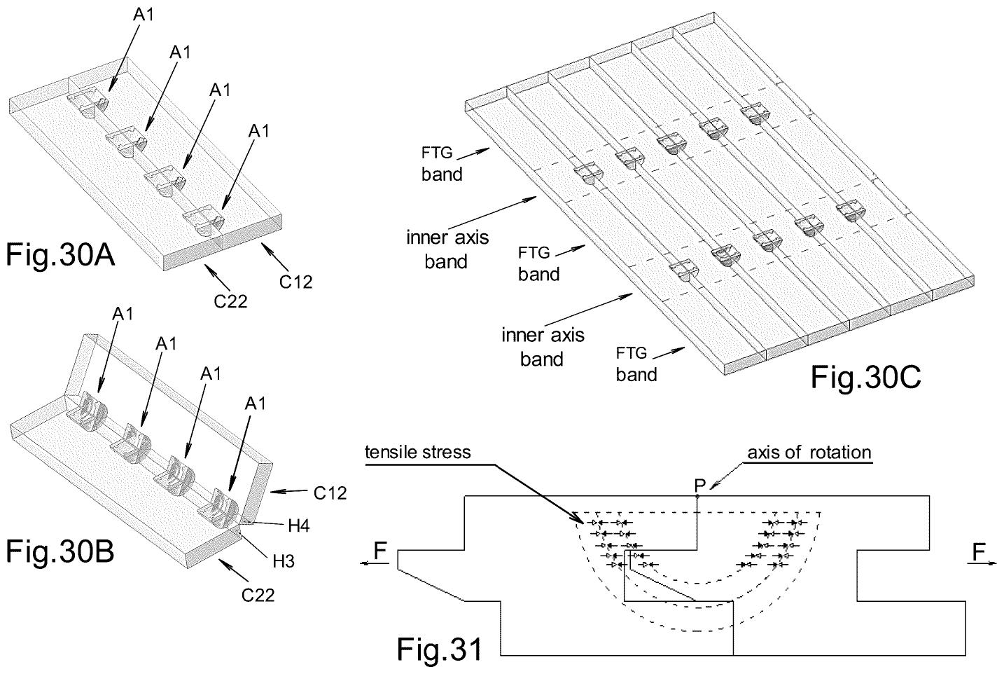

FIGS. 30A and 30B are a perspective view of two elongated coupling panels which are interjoined with a plurality of the inner axis units of FIG. 26A, shown in unpivoted and pivoted positions, respectively;

FIG. 30C is a perspective view of a connecting system comprising a plurality of bands of IAU coupling panels which are embedded perpendicularly to FTG coupling panels;

FIG. 31 is a side view of a connecting system comprising FTG coupling panels and inner axis units, schematically illustrating the longitudinal transmission of forces between end and intermediate plates of an inner axis unit;

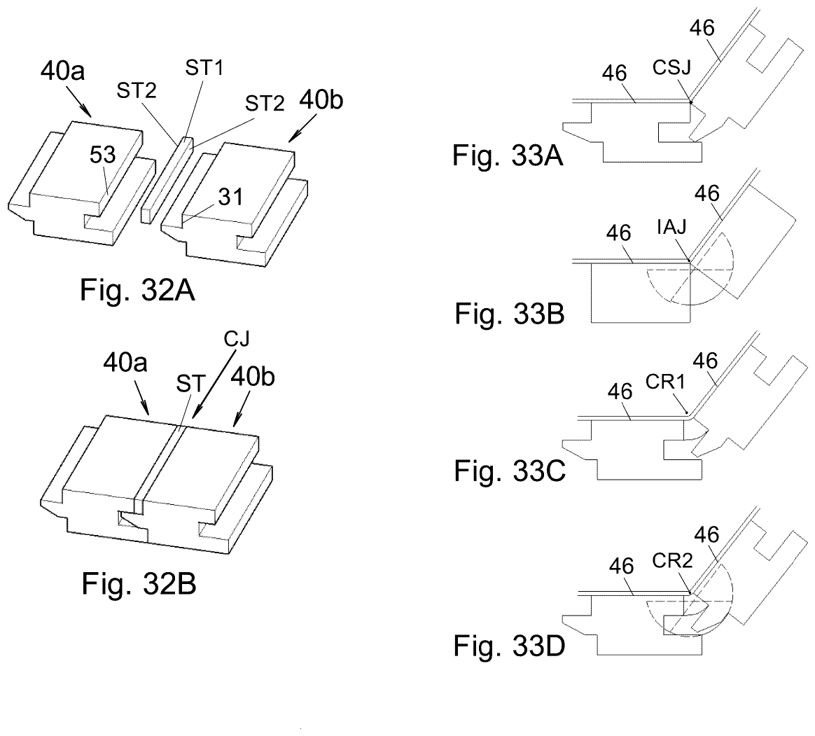

FIGS. 32A and 32B are a perspective view of a connecting system comprising a continuous joint, shown in exploded and perspective assembled views, respectively;

FIGS. 33A-33D are a side view of a connecting system comprising a common sheet junction, an inner axis junction, a continuous junction and a combined inner axis and continuous junction, respectively, schematically illustrating the relative location of the corresponding axis of rotation;

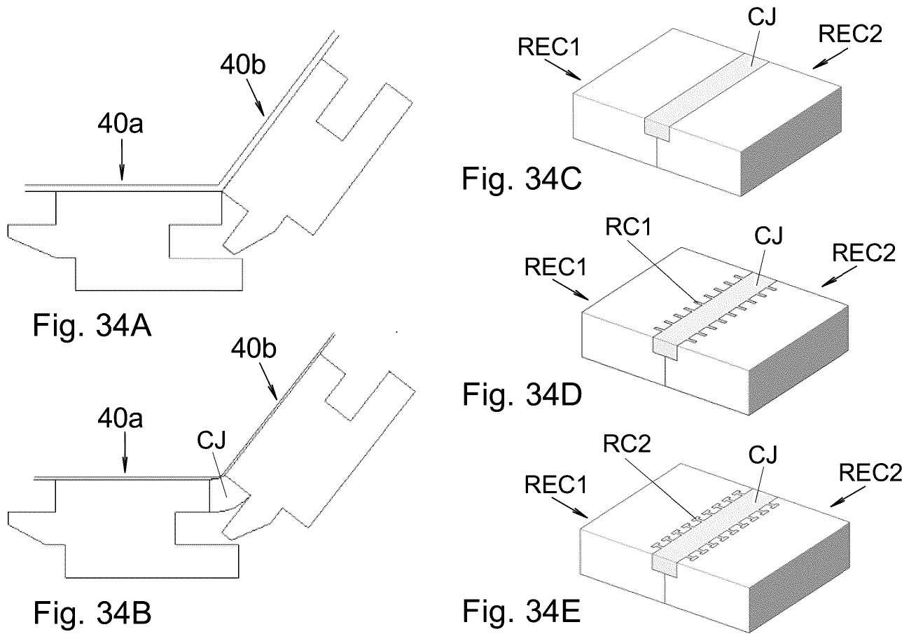

FIGS. 34A and 34B are a side view of a connecting system comprising a common sheet junction and a continuous junction, respectively, showing the corresponding common sheet thickness that may be used;

FIGS. 34C-34E are a perspective view from the top of three embodiments, respectively, of a continuous joint anchored within two adjacent coupling panels;

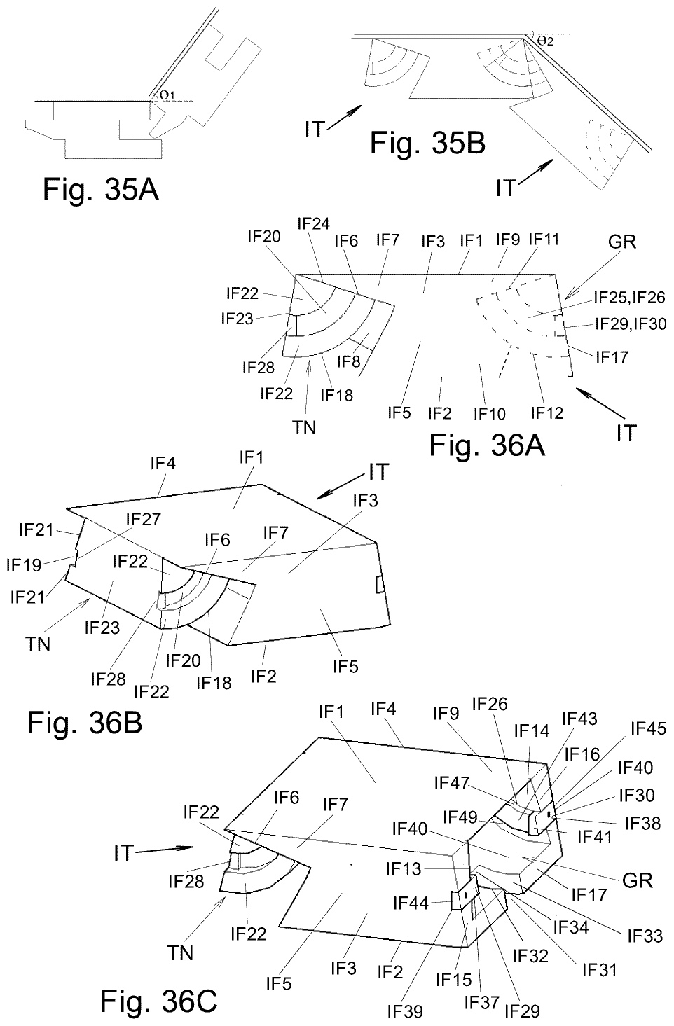

FIGS. 35A and 35B are a side view of a pair of interjoined FTG and IFTG coupling panels, respectively, set to a pivoted position, showing their different direction of angular displacement;

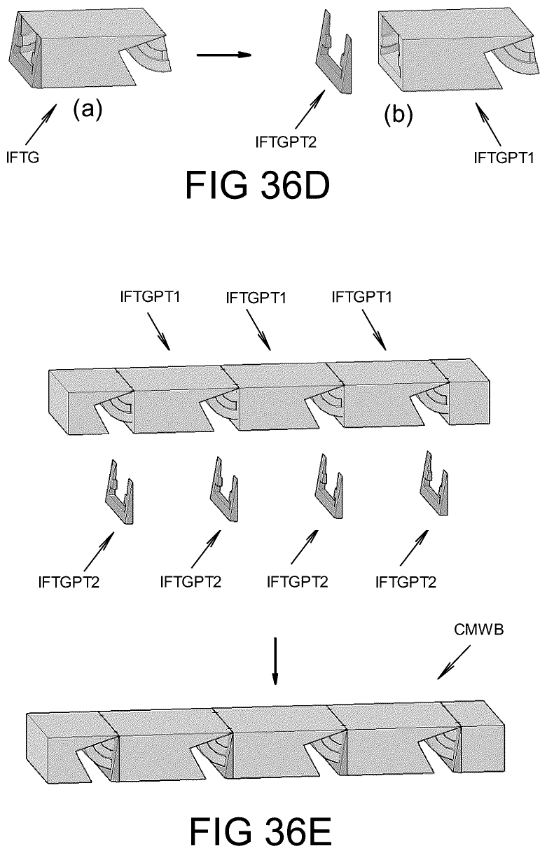

FIG. 36A is a side view of an IFTG coupling panel, according to one embodiment;

FIG. 36B is a perspective view of the coupling panel of FIG. 36A from the front and side;

FIG. 36C is a perspective view of the coupling panel of FIG. 36A from the rear and side;

FIGS. 36D-E illustrate the assembly of another embodiment of a coupling panel;

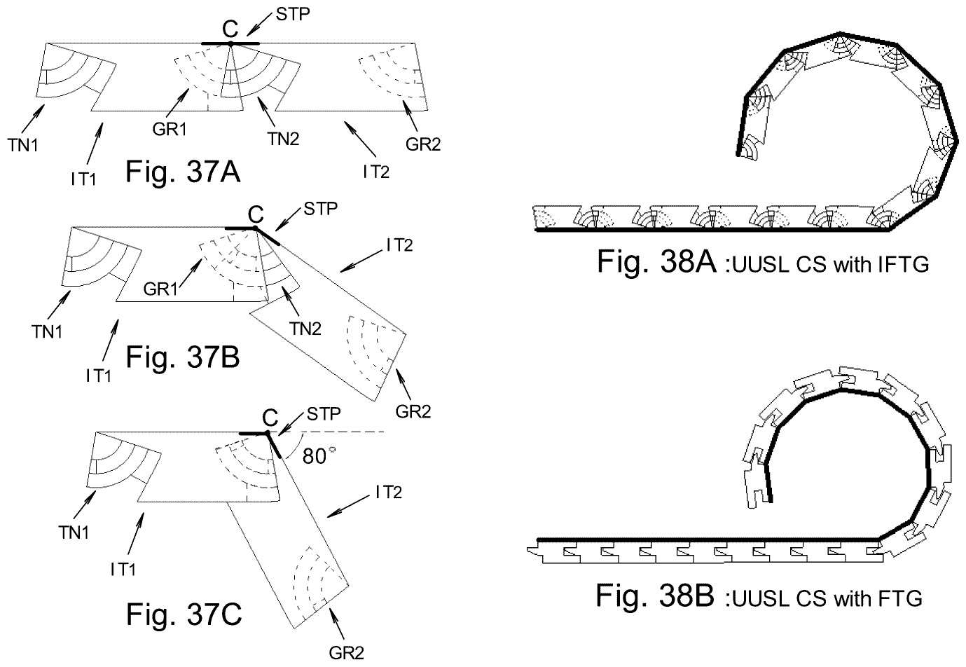

FIG. 37A is a side view of a connecting system comprising two of the coupling panels of FIG. 36A, shown in an unpivoted position;

FIGS. 37B and 37C are a side view of a connecting system comprising two of the coupling panels of FIG. 36A, shown in two pivoted positions, respectively;

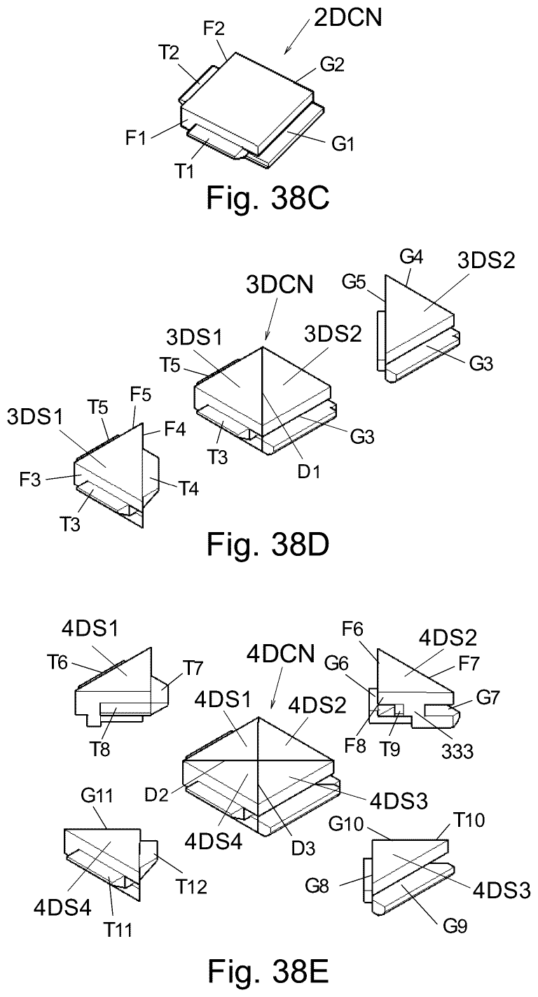

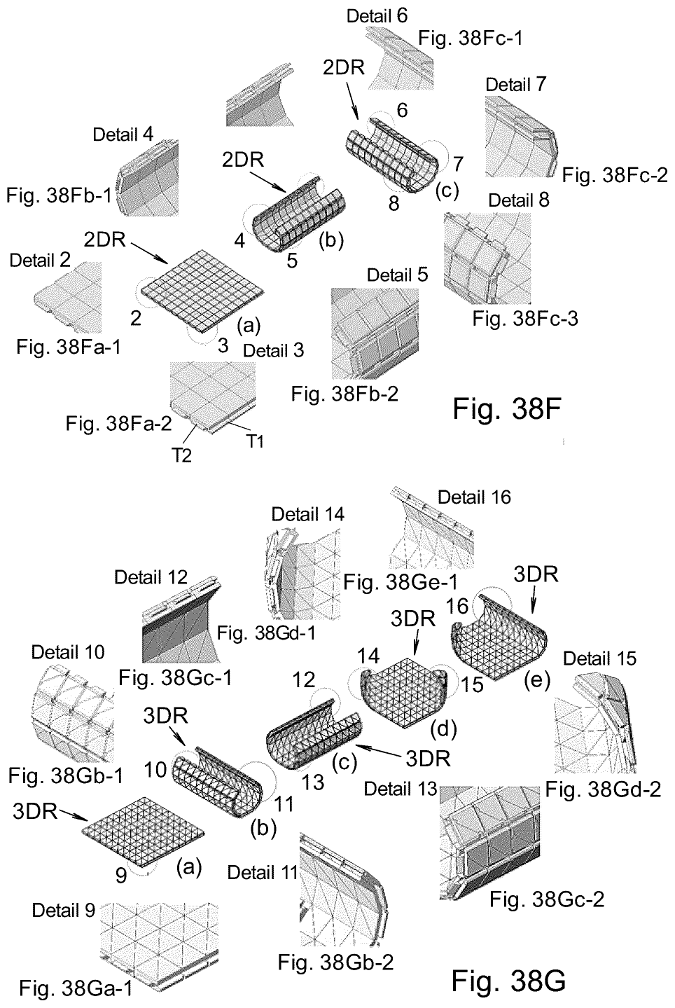

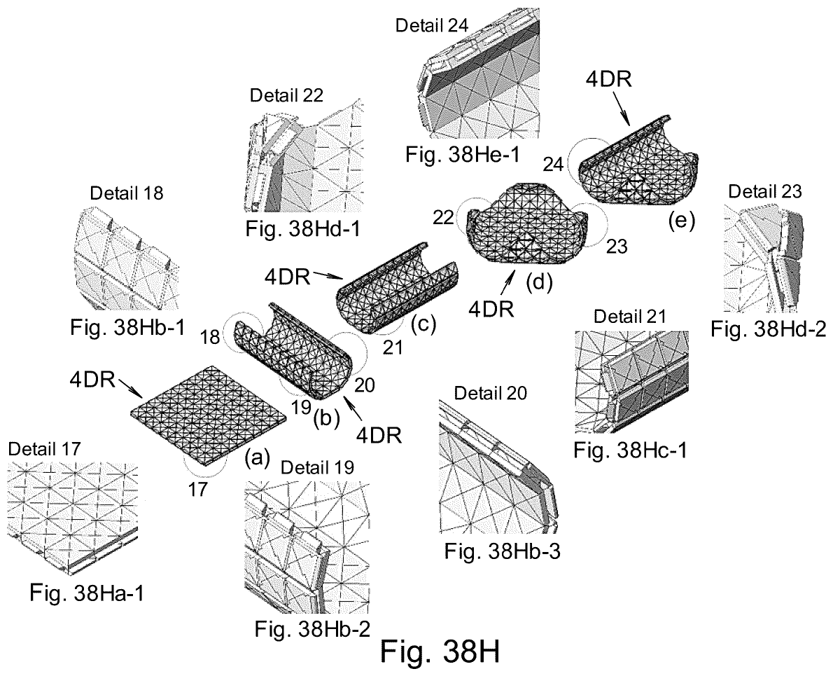

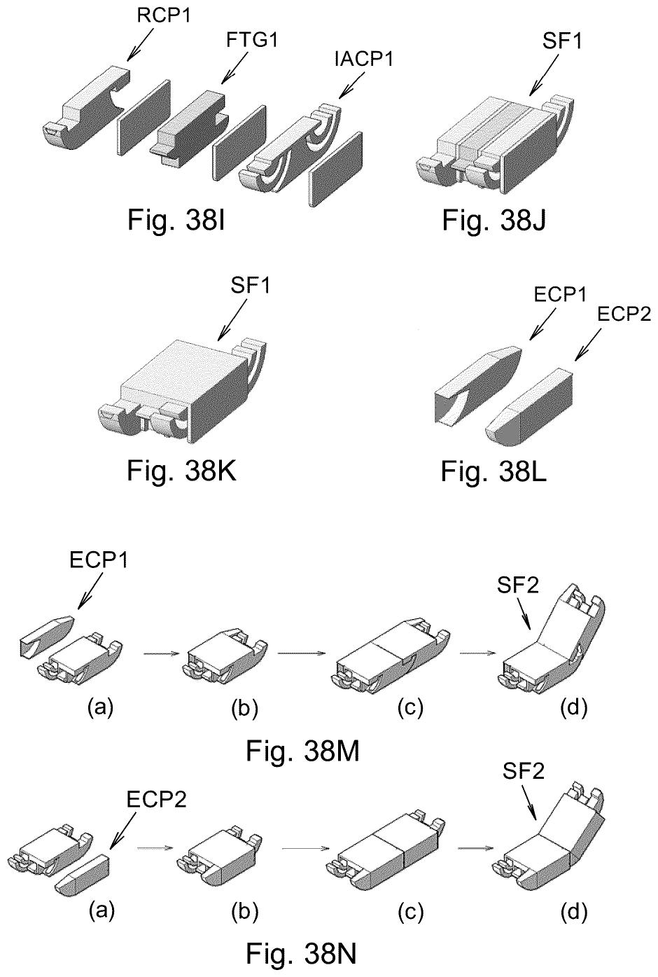

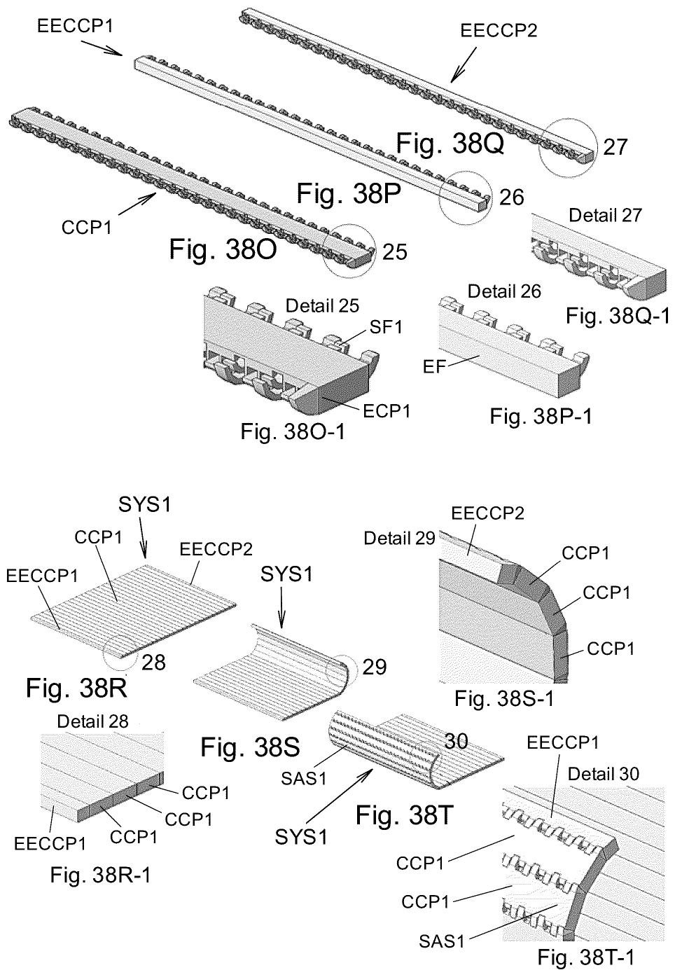

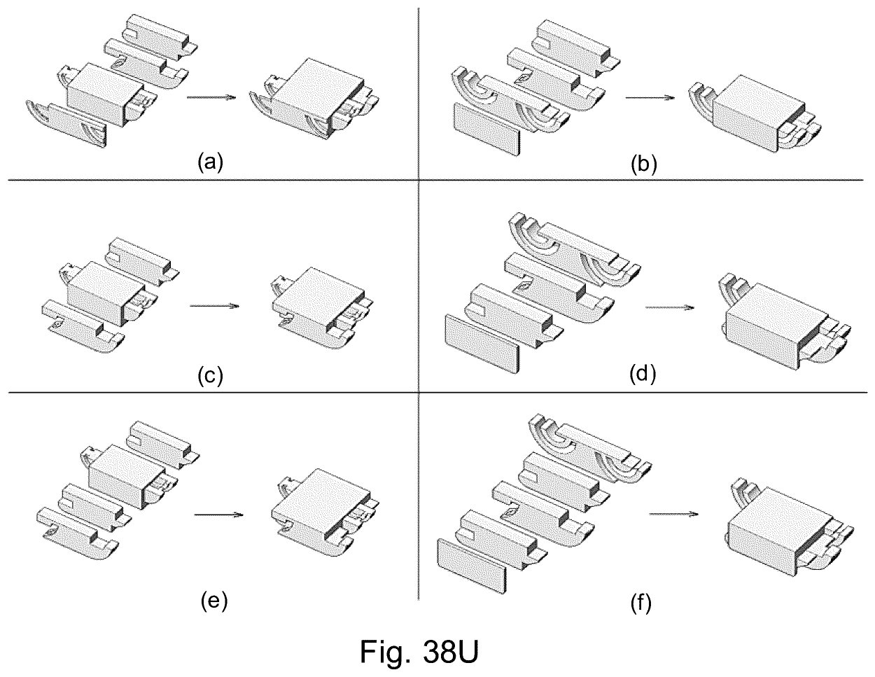

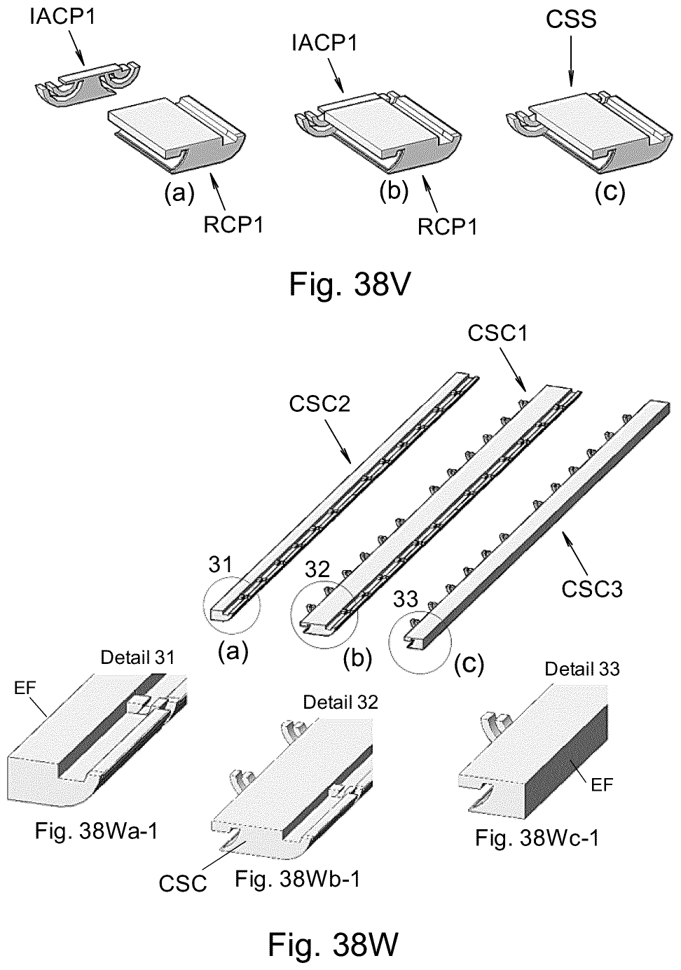

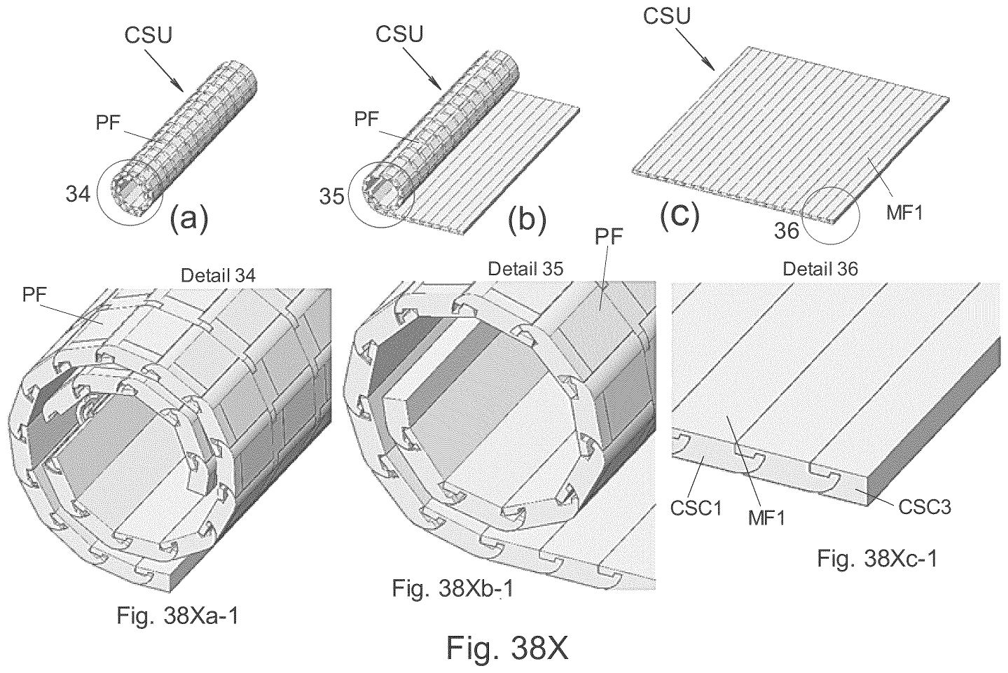

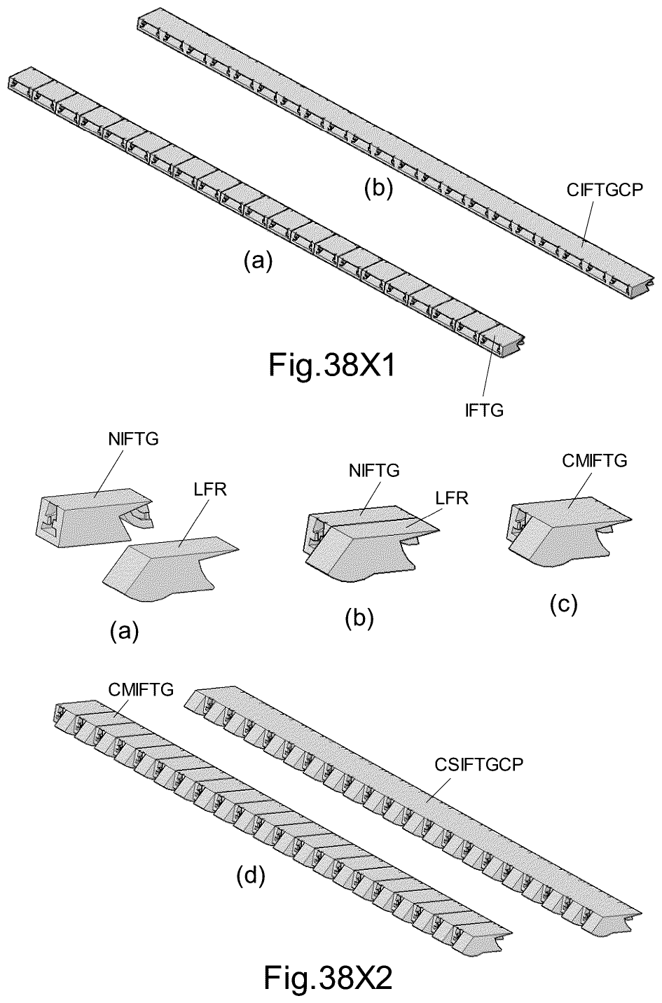

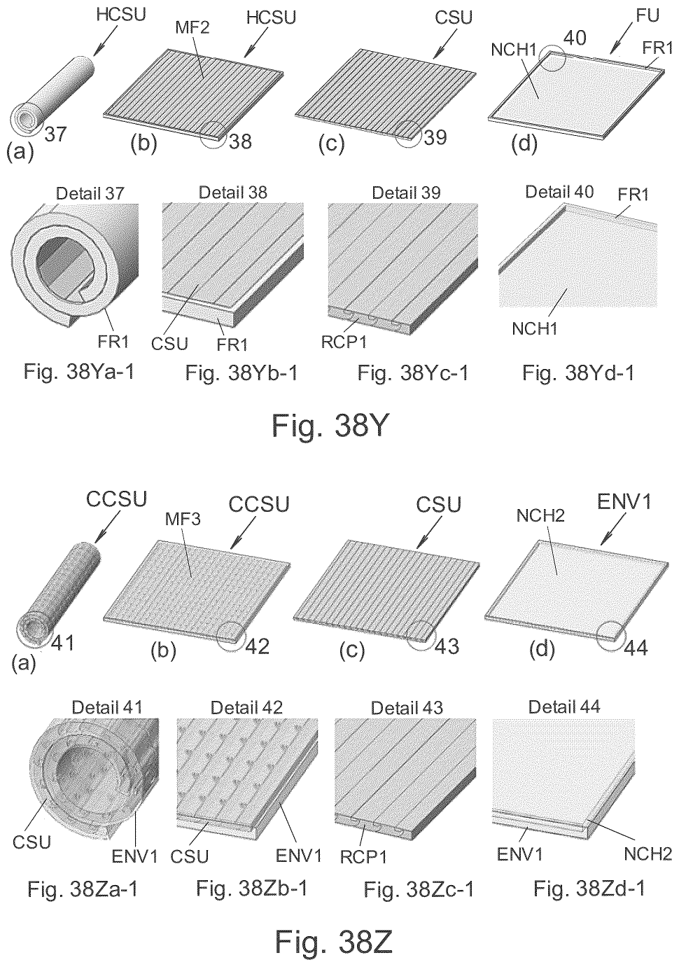

FIGS. 38A and 38B are a side view of a connecting system comprising a plurality of IFTG and FTG coupling panels, respectively, showing the different direction of angular displacement with respect to the common sheet when rolled;

FIG. 38C is a perspective view of one embodiment of a multi-directional coupling panel;

FIG. 38D is a perspective view of another embodiment of a multi-directional coupling panel, shown in both assembled and exploded form;

FIG. 38E is a perspective view of another embodiment of a multi-directional coupling panel, shown in both assembled and exploded form;

FIG. 38F illustrates in perspective view a connecting system comprising the multi-directional coupling panels of FIG. 38C, which is shown in a leveled configuration in FIG. 38Fa wherein Details 2 and 3 thereof are enlarged in FIGS. 38Fa-1 and 38Fa-2, respectively, and shown to be rolled in a first direction in FIG. 38Fb wherein Details 4 and 5 thereof are enlarged in FIGS. 38Fb-1 and 38Fb-2, respectively, and shown to be rolled in a second direction in FIG. 38Fc wherein Details 6-8 thereof are enlarged in FIGS. 38Fc-1, 38Fc-2 and 38Fc-3, respectively;

FIG. 38G illustrates in perspective view a connecting system comprising the multi-directional coupling panels of FIG. 38D, which is shown in a leveled configuration in FIG. 38Ga wherein Detail 9 thereof is enlarged in FIGS. 38Ga-1, and shown to be rolled in a first direction in FIG. 38Gb wherein Details 10 and 11 thereof are enlarged in FIGS. 38Gb-1 and 38Gb-2, respectively, shown to be rolled in a second direction in FIG. 38Gc wherein Details 12 and 13 thereof are enlarged in FIGS. 38Gc-1 and 38Gc-2, respectively, shown to be folded in a third direction in FIG. 38Gd wherein Details 14 and 15 thereof are enlarged in FIGS. 38Gd-1 and 38Gd-2, respectively, and shown to be both rolled in the first direction and folded in the third direction in FIG. 38Ge wherein Detail 16 thereof is enlarged in FIG. 38Ge-1;

FIG. 38H illustrates in perspective view a connecting system comprising the multi-directional coupling panels of FIG. 38E, which is shown in a leveled configuration in FIG. 38Ha wherein Detail 17 thereof is enlarged in FIGS. 38Ha-1, and shown to be rolled in a first direction in FIG. 38Hb wherein Details 18-20 thereof are enlarged in FIGS. 38Hb-1, 38Hb-2 and 38Hb-3, respectively, shown to be rolled in a second direction in FIG. 38Hc wherein Detail 21 thereof is enlarged in FIGS. 38Hc-1, shown to be folded in third and fourth directions in FIG. 38Hd wherein Details 22 and 23 thereof are enlarged in FIGS. 38Hd-1 and 38Hd-2, respectively, and shown to be both rolled in the second direction and folded in the third direction in FIG. 38He wherein Detail 24 thereof is enlarged in FIG. 38He-1;

FIG. 38I is a perspective exploded view of an embodiment of a composite coupling panel;

FIG. 38J is a perspective view of the composite coupling panel of FIG. 38I, showing the constituent coupling panels that are positioned in abutment to each other;

FIG. 38K is a perspective assembled view of the composite coupling panel of FIG. 38I, shown when the constituent coupling panels are cast together;

FIG. 38L is a perspective view of two sub-coupling panels suitable for use at a corresponding free side of a composite coupling panel, showing injury preventing rounded internal edges generally smaller than normal finger sizes;

FIGS. 38M and 38N are a perspective view of two embodiments, respectively, of assembling and angularly displacing a composite coupling panel system during four distinct stages;

FIG. 38O is a perspective view of an elongated composite coupling panel cast with a plurality of the composite coupling panel of FIG. 38K, while FIG. 38O-1 is an enlargement of Detail 25 of FIG. 38O;

FIGS. 38P and 38Q are a perspective view of two cast end elongated composite coupling panels that are interjoinable with the elongated panel of FIG. 38O, respectively, while FIGS. 38P-1 and 38Q-1 are an enlargement of Details 26 and 27 thereof, respectively;

FIGS. 38R, 38S and 38T are a perspective view of a connecting system comprising a plurality of the elongated coupling panels of FIG. 38O, shown in a leveled configuration, a first partially rolled configuration and a second partially rolled configuration, respectively, and in an enlargement of Details 28-30 thereof in FIGS. 38R-1, 38S-1 and 38T-1, respectively;

FIG. 38U is a perspective view of six types of composite coupling panels, each shown in both exploded and assembled form;

FIG. 38V is a perspective view of another embodiment of a composite coupling panel, wherein FIG. 38Va is an exploded view of the sub-coupling panels thereof, FIG. 38Vb is an assembled view when the sub-coupling panels of FIG. 38Va are positioned in abutment to each other, and FIG. 38Vc is an assembled view when the sub-coupling panels of FIG. 38Va are cast together;

FIG. 38W is a perspective view of another embodiment of an elongated composite coupling panel, wherein FIG. 38Wb is an intermediate elongated composite coupling panel therefor comprising a plurality of the composite coupling panels of 38Vc and FIG. 38Wb-1 is an enlargement of Detail 32 of FIG. 38Wb, and FIGS. 38Wa and 38Wc are two end elongated composite coupling panels therefor that are interjoinable with the intermediate panel of FIG. 38Wb, while FIGS. 38Wa-1 and 38Wc-1 are an enlargement of Details 31 and 33 of FIGS. 38Wa and 38Wc, respectively;

FIG. 38X is a perspective view of a connecting system comprising the elongated composite coupling panels of FIG. 38W, which is shown in a rolled configuration, a partially unrolled configuration and leveled configuration in FIGS. 38Xa, 38Xb and 38Xc, while FIGS. 38Xa-1, 38Xb-1 and 38Xc are an enlargement of Details 34-36 of FIGS. 38Xa-c, respectively;

FIG. 38X1 is a perspective view of another embodiment of a composite coupling panel, wherein FIG. 38X1a is an assembled view when the sub-coupling panels are positioned in abutment to each other, and FIG. 38X1b is an assembled view when the sub-coupling panels of FIG. 38X1a are cast together;

FIG. 38X2 is a perspective view of another embodiment of a composite coupling panel, wherein FIG. 38X2a is an exploded view of two coupling panels of a sub-coupling panel, FIG. 38Xb is an assembled view when the two coupling panels of FIG. 38X2a are positioned in abutment to each other, FIG. 38Xc is an assembled view when the two coupling panels of FIG. 38X2b are cast together to form a sub-coupling panel, and FIG. 38X2d is an assembled view of a first arrangement when the sub-coupling panels of FIG. 38X2c are positioned in abutment to each other and of a second arrangement when the sub-coupling panels of FIG. 38X2c are cast together;

FIG. 38Y is a perspective view of a half-concealed and sealed unit, which is shown in a rolled configuration and a leveled configuration in FIGS. 38Ya and 38Yb, while FIGS. 38Ya-1 and 38Yb-1 are an enlargement of Details 37-38 thereof, respectively, wherein FIG. 38Yc shows the connecting system of 38Xc and FIG. 38Yd shows a frame unit within which the connecting system is insertable, while FIGS. 38Yc-1 and 38Yd-1 are an enlargement of Details 39-40 thereof, respectively;

FIG. 38Z is a perspective view of a completely-concealed and sealed unit whose concealing-facilitating envelope is rendered transparent, which is shown in a rolled configuration and a leveled configuration in FIGS. 38Za and 38Zb, while FIGS. 38Za-1 and 38Zb-1 are an enlargement of Details 41-42 thereof, respectively, wherein FIG. 38Zc shows the connecting system of 38Xc and FIG. 38Zd shows the transparent-rendered envelope within which the connecting system is insertable, while FIGS. 38Zc-1 and 38Zd-1 are an enlargement of Details 43-44 thereof, respectively;

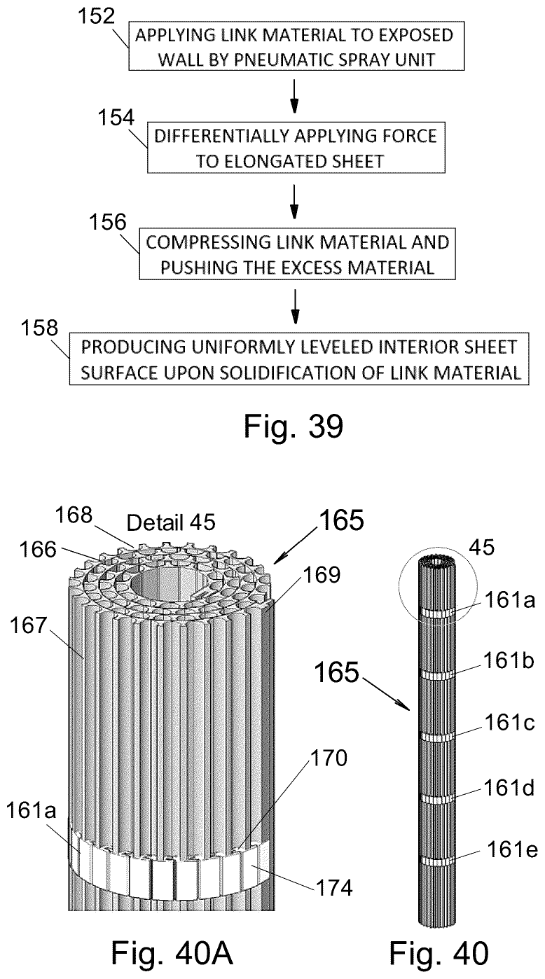

FIG. 39 is a method for uniformly applying link material onto a wall of a building;

FIG. 40 is a perspective view of a roll configured as a link material leveling system;

FIG. 40A is an enlargement of Detail 45 of FIG. 40;

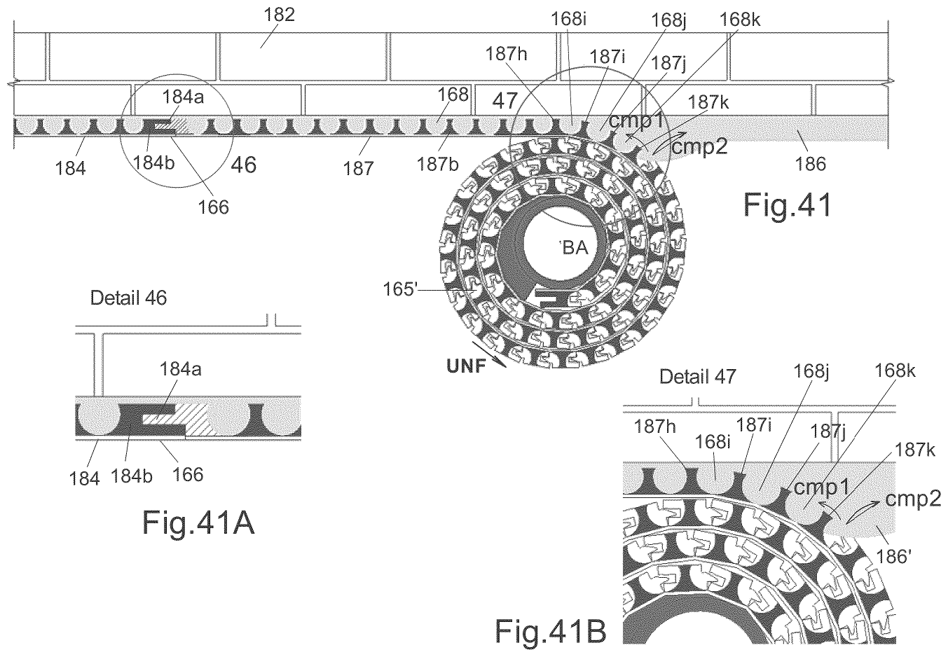

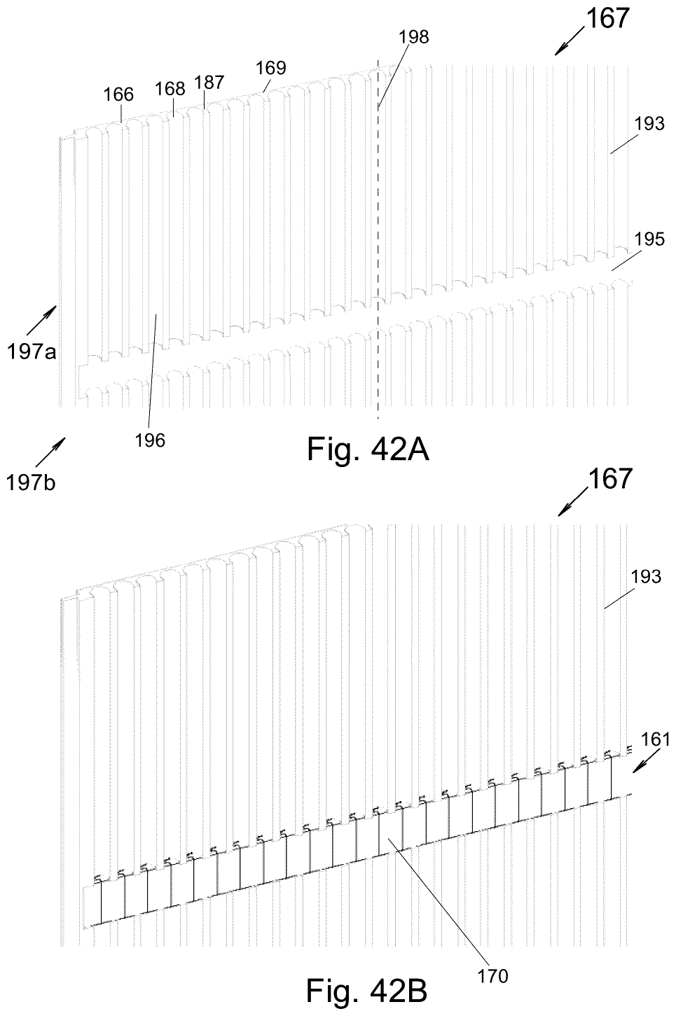

FIG. 41 is a plan view of the roll of FIG. 40, illustrating the leveled application of an interiorly facing surface thereof onto a wall, and FIGS. 41A and 42B are an enlargement of Details 46-47 thereof, respectively;

FIG. 42A is an exterior view of a portion of a sheet associated with the roll of FIG. 40, showing a longitudinal recess thereof when unrolled;

FIG. 42B is an exterior view of a portion of a sheet associated with the roll of FIG. 40, when unrolled and when a reinforcement band is inserted in a corresponding recess thereof;

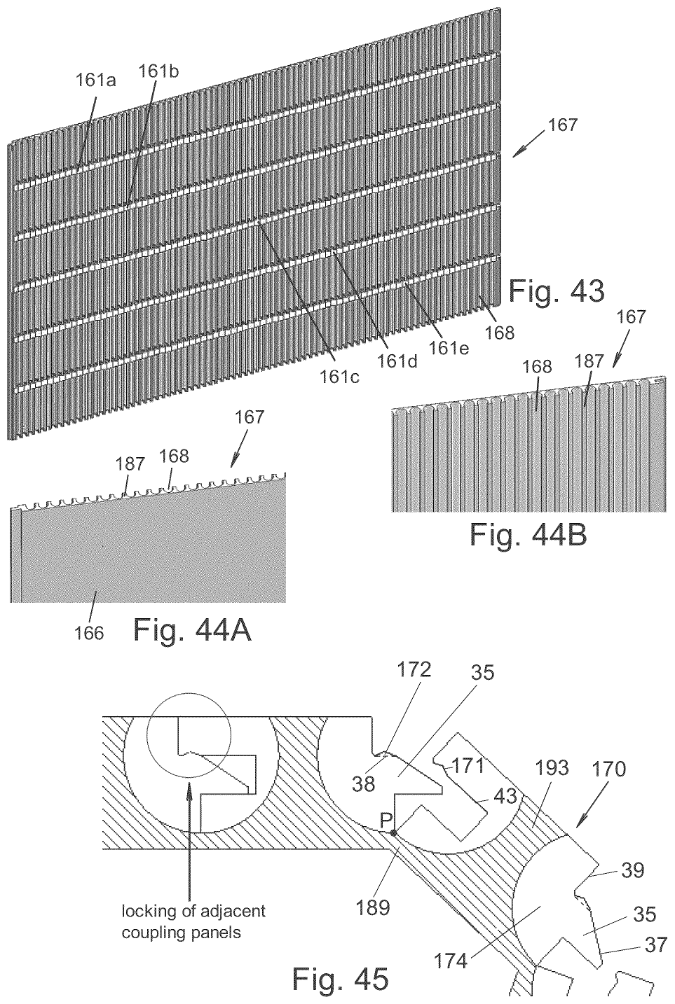

FIG. 43 is a perspective exterior view of a completely opened sheet associated with the roll of FIG. 40 that is provided with a plurality of reinforcement bands;

FIGS. 44A and 44B are a perspective interior and exterior view, respectively, of a portion of a completely opened sheet associated with the roll of FIG. 40;

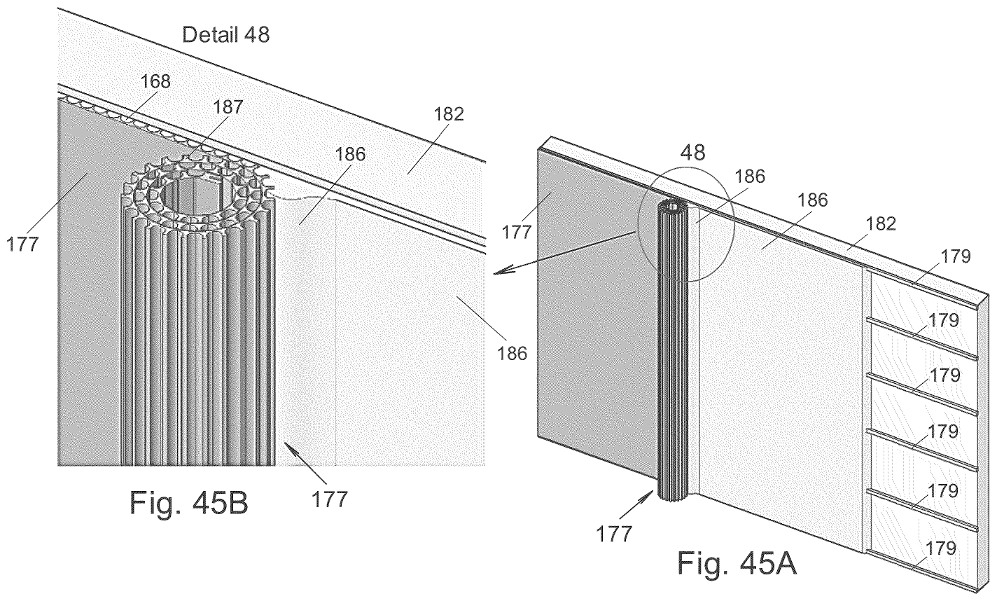

FIG. 45 is a side view of two coupling panels which are adapted for use in conjunction with the link material leveling system of FIG. 40, when one coupling panel is angularly displaced with respect to the other and further showing a third coupling panel in locked engagement with a fourth coupling panel;

FIG. 45A is a perspective view of another embodiment of an unrollable link material leveling system shown when the sheet is partially applied to the building wall and FIG. 45B is an enlargement of Detail 48 thereof;

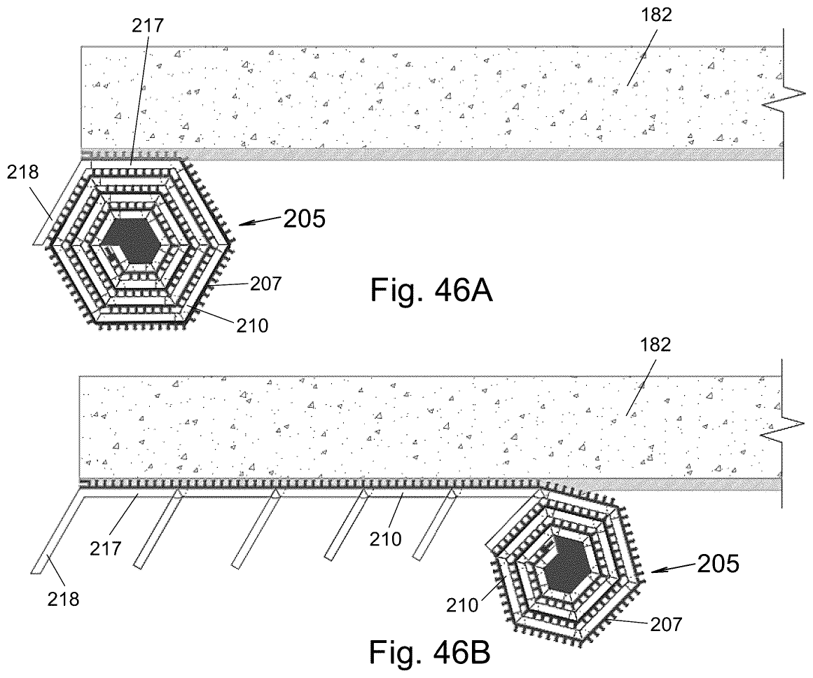

FIGS. 46A-B are a plan view of an unrollable link material leveling system, according to another embodiment, shown when the sheet is in a rolled form and when being applied to the building wall, respectively;

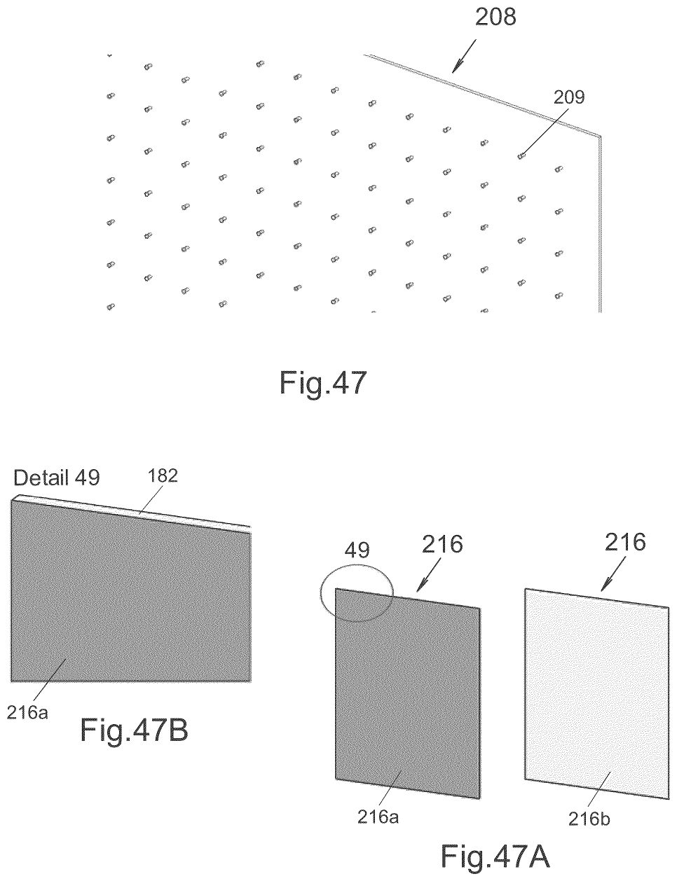

FIG. 47 is an exterior perspective view of a portion of a sheet usable with the unrollable link material leveling system of FIG. 46A, according to one embodiment;

FIG. 47A is a perspective view of exterior and interior faces of another embodiment of a wall securable sheet, and FIG. 47B is an enlargement of Detail 49 thereof;

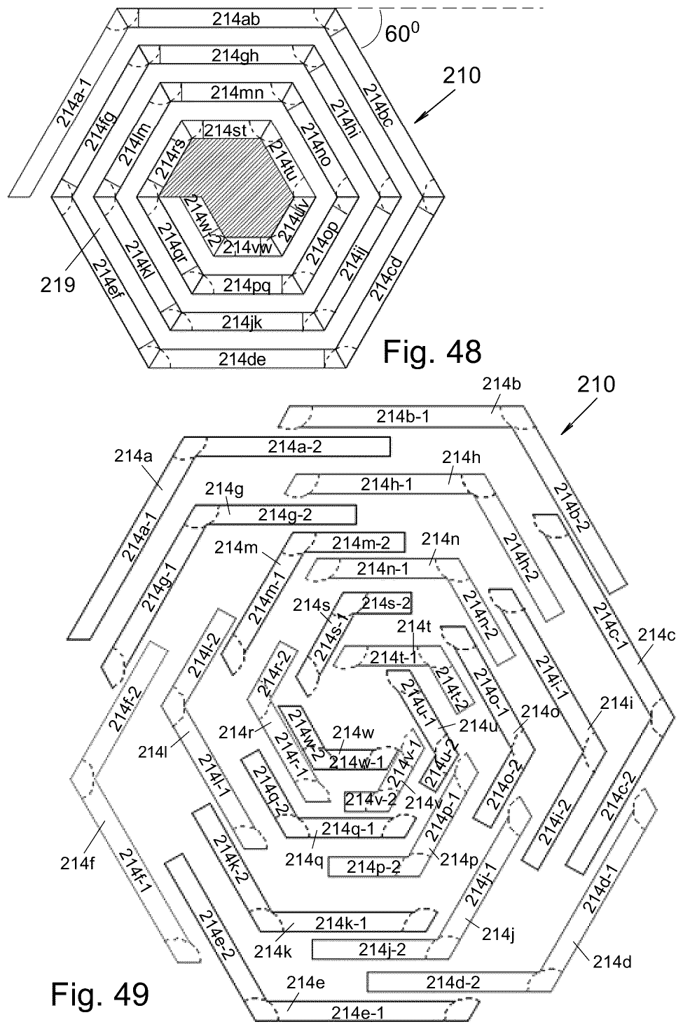

FIG. 48 is a plan view of a holding structure usable in conjunction with the unrollable link material leveling system of FIG. 46 and configured with a plurality of serially interjoined coupling panels arranged in a coiled formation, shown without the sheet;

FIG. 49 is a plan view of a plurality of separated coupling panels usable in conjunction with the holding structure of FIG. 48, wherein each of the coupling panels consists of two side sections;

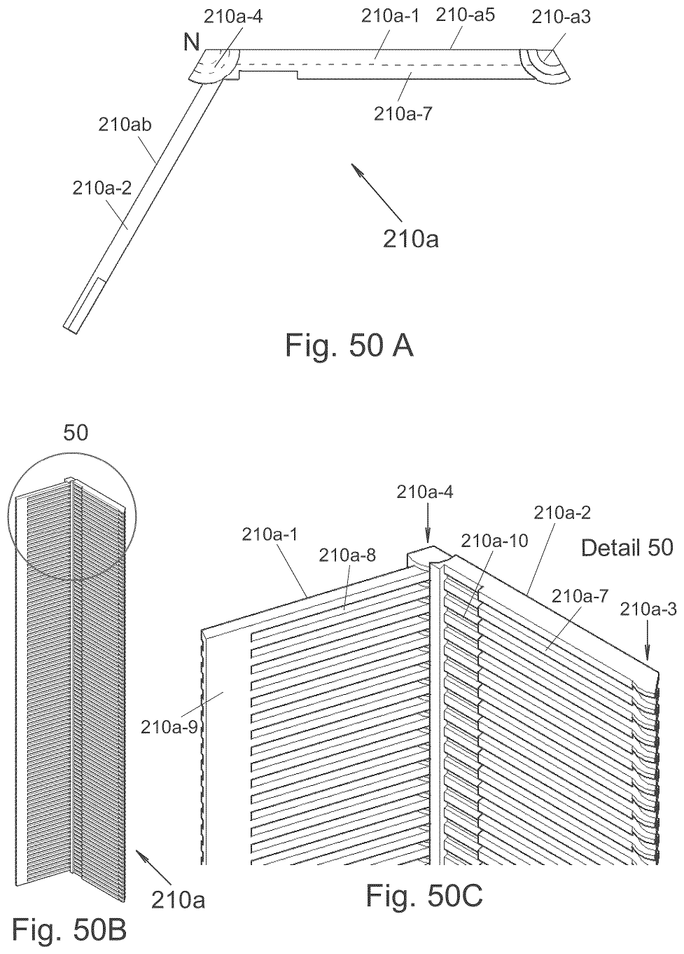

FIG. 50A is a plan view of a PMA coupling panel usable in conjunction with the holding structure of FIG. 48;

FIG. 50B is a perspective view of the coupling panel of FIG. 50A and FIG. 50C is an enlargement of Detail 50 thereof;

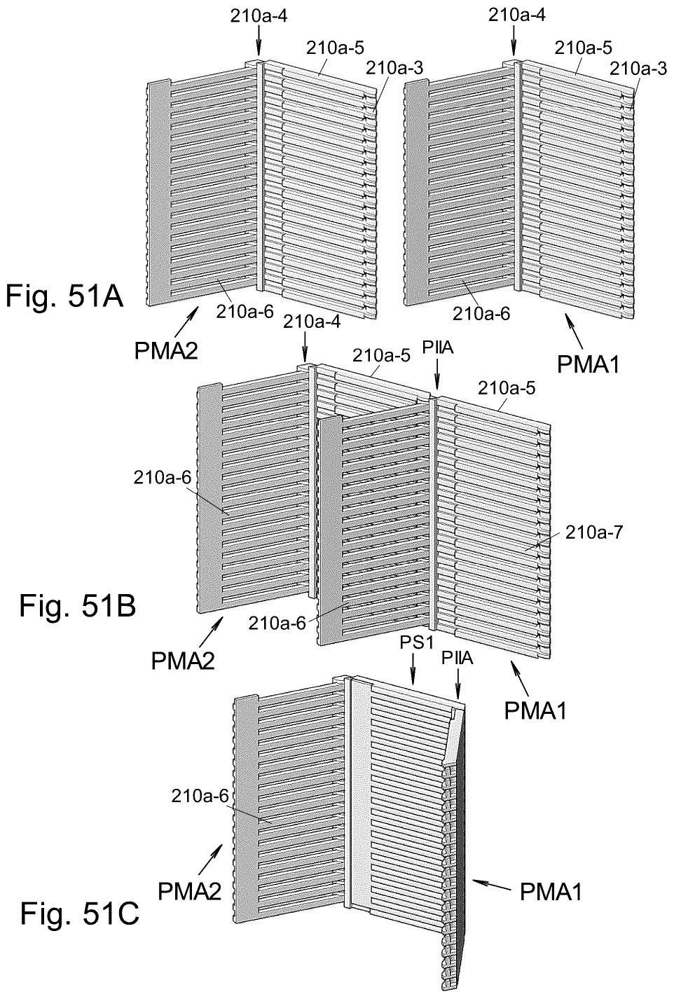

FIG. 51A is a perspective view of two pairs of peripherally adjacent PMA coupling panels usable in conjunction with the holding structure of FIG. 48, shown when separated from each other;

FIG. 51B is a perspective view of the two pairs of peripherally adjacent PMA coupling panels of FIG. 51A, shown when interconnected by their built-in inner axis;

FIG. 51C is a perspective view of the two interconnected pairs of peripherally adjacent PMA coupling panels of FIG. 51B, shown when a coupling panel of each of the pairs is releasably interjoined with each other;

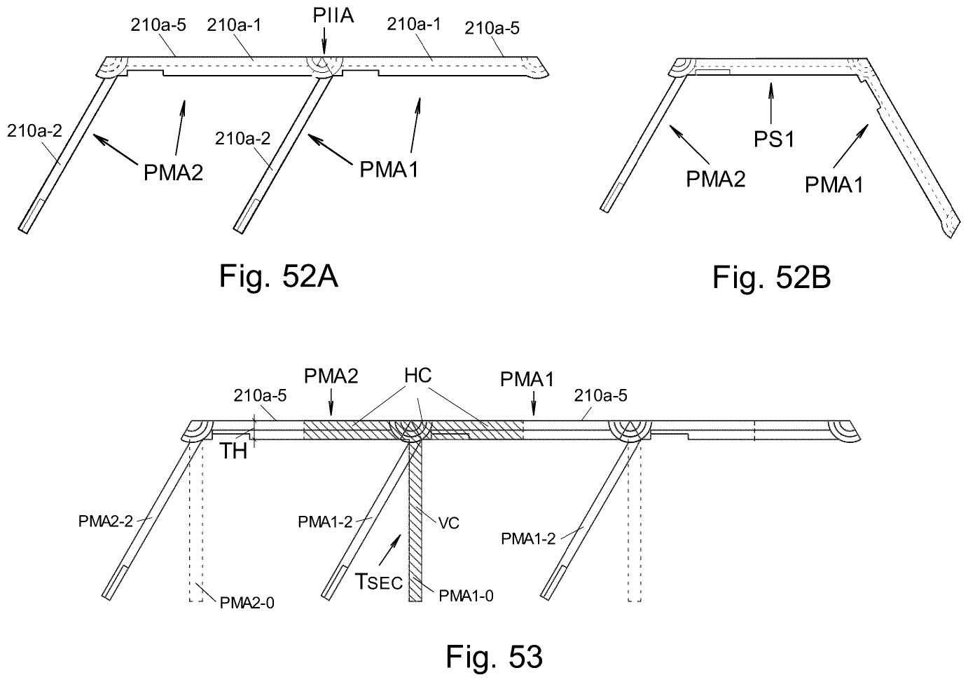

FIGS. 52A and 52B are a plan view of two PMA coupling panels of FIG. 50A interconnected by a built-in inner axis, shown in expanded and retracted conditions, respectively;

FIG. 53 is a plan view of an unrolled region of the holding structure of FIG. 46B, schematically illustrating means for increasing the vertical stiffness of PMA coupling panels;

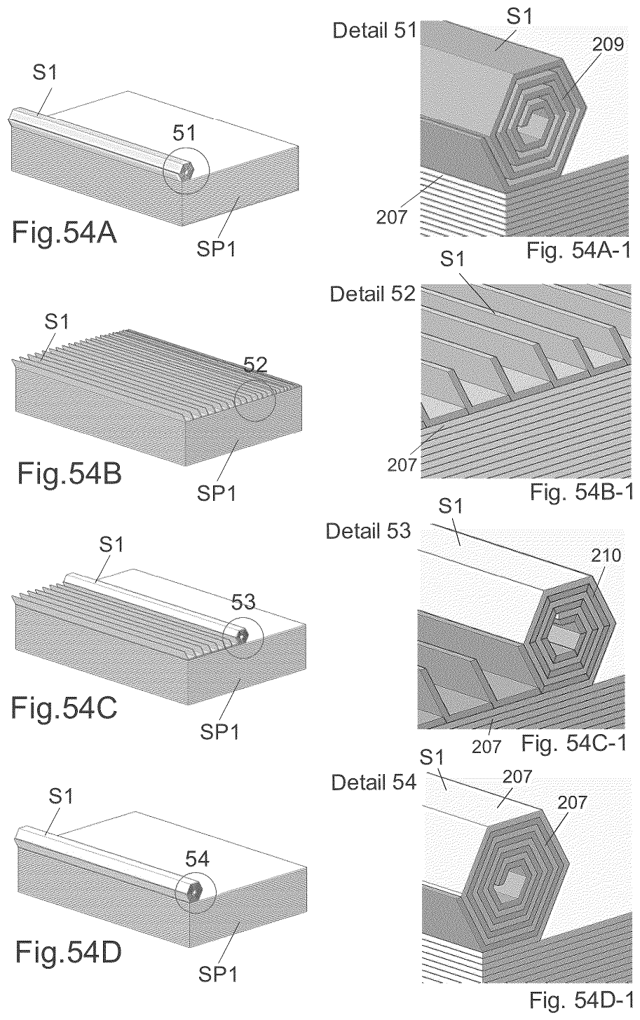

FIGS. 54A-54D are a perspective view of four stages, respectively, of a process for causing a sheet to be inserted into the inter-loop gap of the holding structure of FIG. 48, wherein FIGS. 54A-1-54D-1 are enlargements of Details 51-54 thereof, respectively;

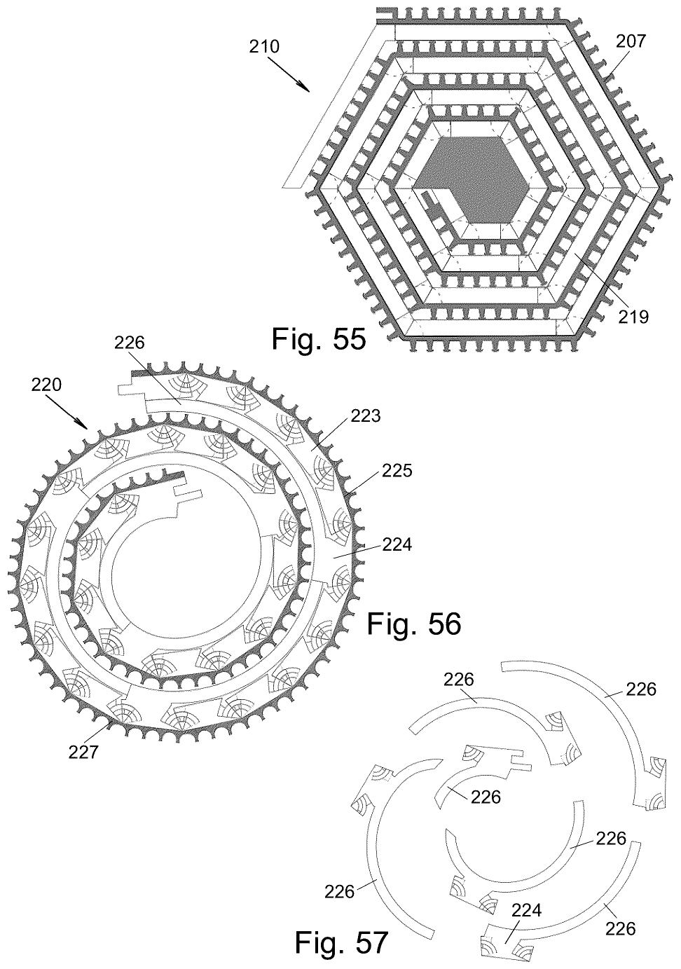

FIG. 55 is a plan view of the holding structure of FIG. 48, shown after a sheet has been inserted into the inter-loop gap;

FIG. 56 is a plan view of a holding structure according to another embodiment in rolled form, shown when a sheet is inserted into its inter-loop gap;

FIG. 57 is an exploded view of the holding structure of FIG. 56, showing in plan view only coupling panels thereof configured with a reinforcing section;

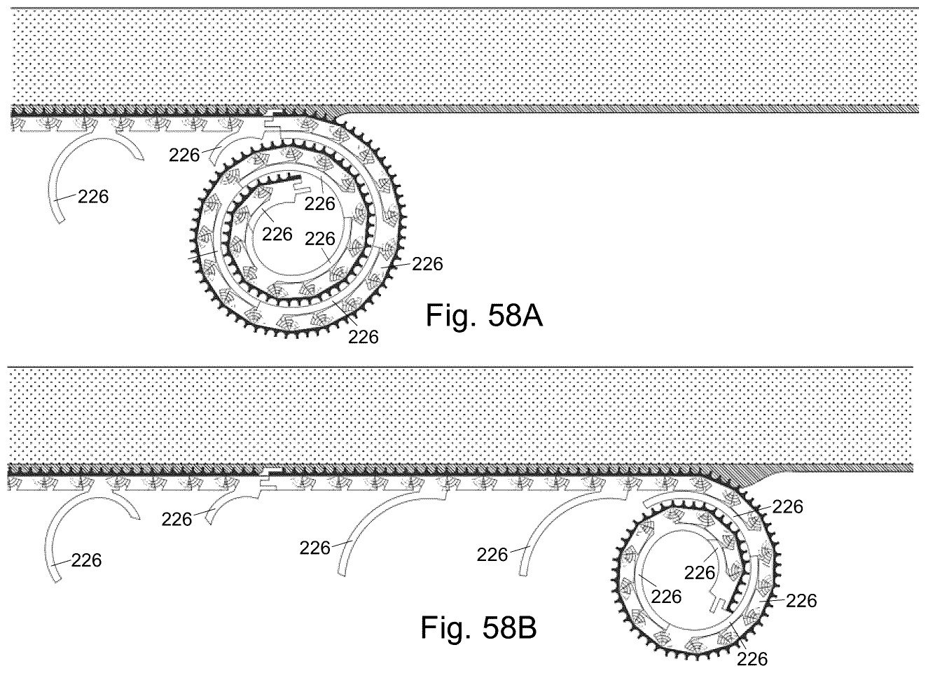

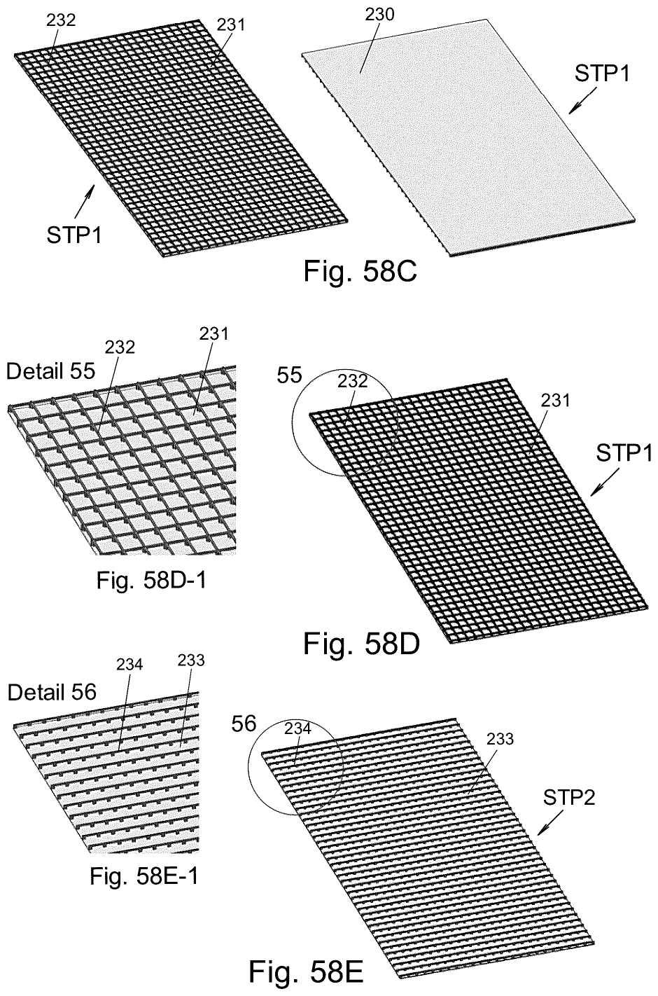

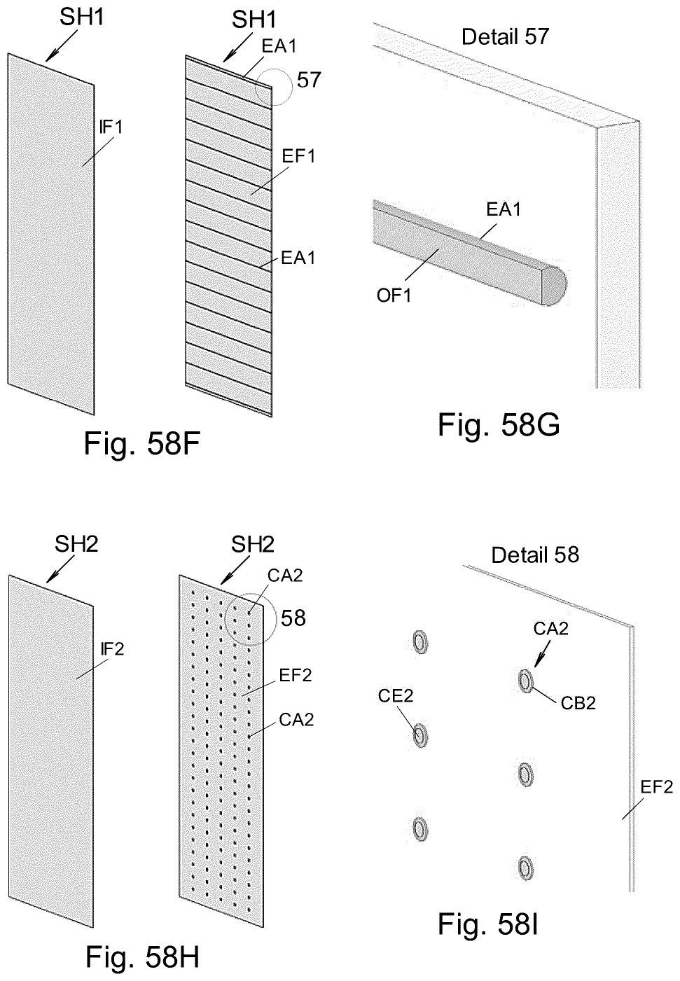

FIGS. 58A-B are a plan view of the holding structure of FIG. 56, shown in a rolled form and when partially applied to a building wall, respectively;

FIG. 58C is a perspective view of an embodiment of stiff plate that is integratable with linking material, showing interior and exterior faces thereof;

FIG. 58D is a perspective view of the exterior face of the stiff plate of FIG. 58C and FIG. 58D-1 is an enlargement of Detail 55 thereof;

FIG. 58E is a perspective view of the exterior face of another embodiment of a stiff plate and FIG. 58E-1 is an enlargement of Detail 56 thereof;

FIG. 58F is a perspective view of the interior and exterior faces of another embodiment of a link material integratable sheet and FIG. 58G is an enlargement of Detail 57 thereof showing an aperture within which link material has been introduced when the sheet is rendered transparent;

FIG. 58H is a perspective view of the interior and exterior faces of another embodiment of a link material integratable sheet and FIG. 58I is an enlargement of Detail 58 thereof, shown when the sheet is rendered transparent;

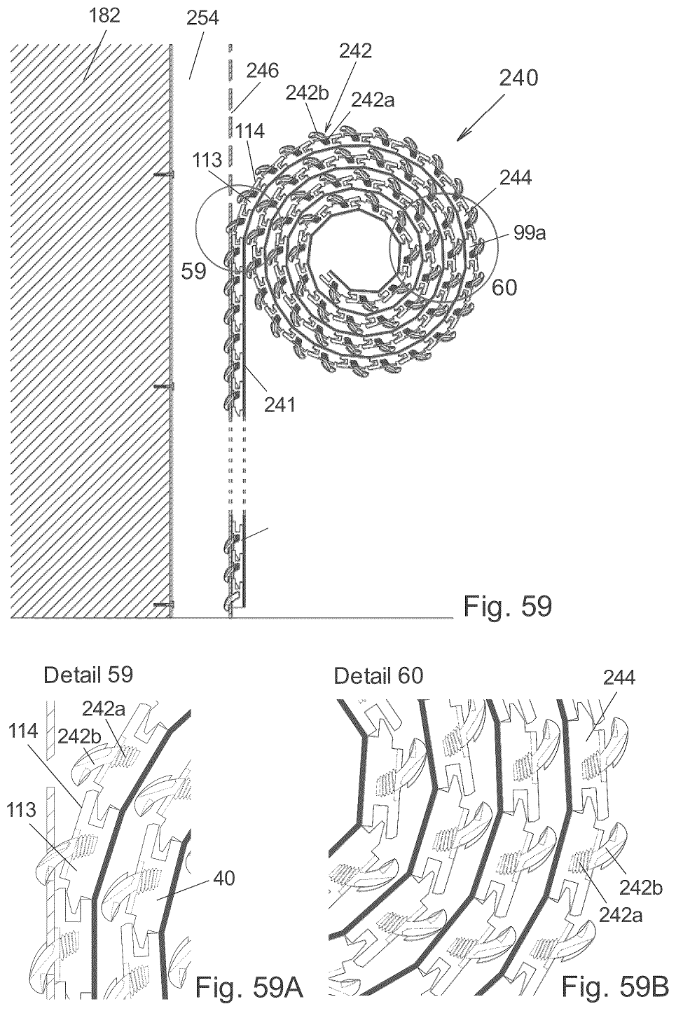

FIG. 59 is a cross sectional view of a vertical wall and of a framing element attached thereto, showing a roll of coupling panels of a paneling system being mounted thereon, wherein FIGS. 59A and 59B are an enlargement of Details 59 and 60 thereof, respectively;

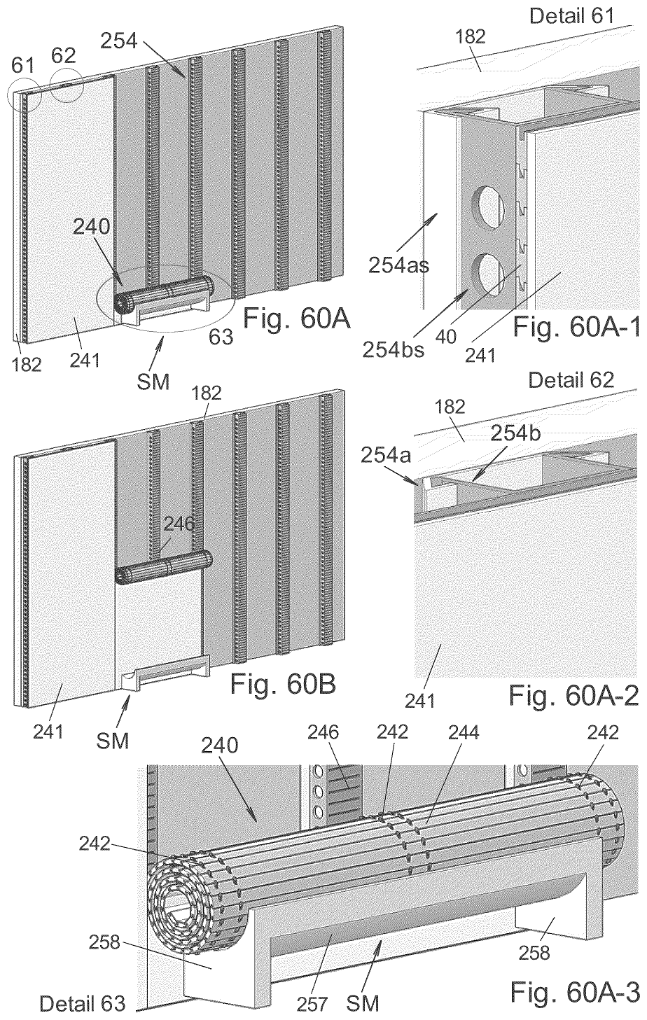

FIG. 60A is a front view of the paneling system of FIG. 59, wherein FIGS. 60A-1, 60A-2 and 60A-3 are an enlargement of Details 61-63 thereof, respectively;

FIG. 60B is a front view of the paneling system of FIG. 59, showing the roll of coupling panels

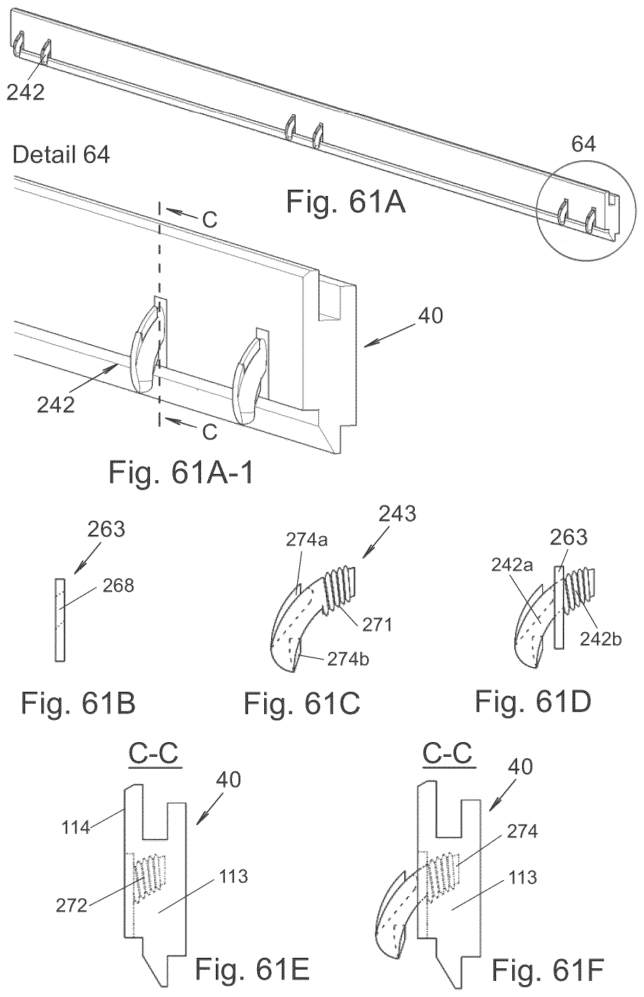

FIG. 61A is a perspective front view of a coupling panel used in conjunction with the paneling system of FIG. 59, showing a protruding pin that is embedded therewithin, wherein FIG. 61A-1 is an enlargement of Detail 64 thereof;

FIGS. 61B-61D are a side cutaway view of the apparatus use to connect the protruding pin of FIG. 61A to the coupling panel, wherein FIG. 61B shows a cover plate, FIG. 61C shows the pin, and FIG. 61D shows a combination of the cover plate and pin while protruding from the cover plate;

FIGS. 61E and 61F are a cross sectional view of the coupling panel of FIG. 61A-1 when cut along plane C-C of FIG. 61A-1 including hidden lines indicative of a serrated aperture formed therewithin, shown when unconnected and connected, respectively, to the pin;

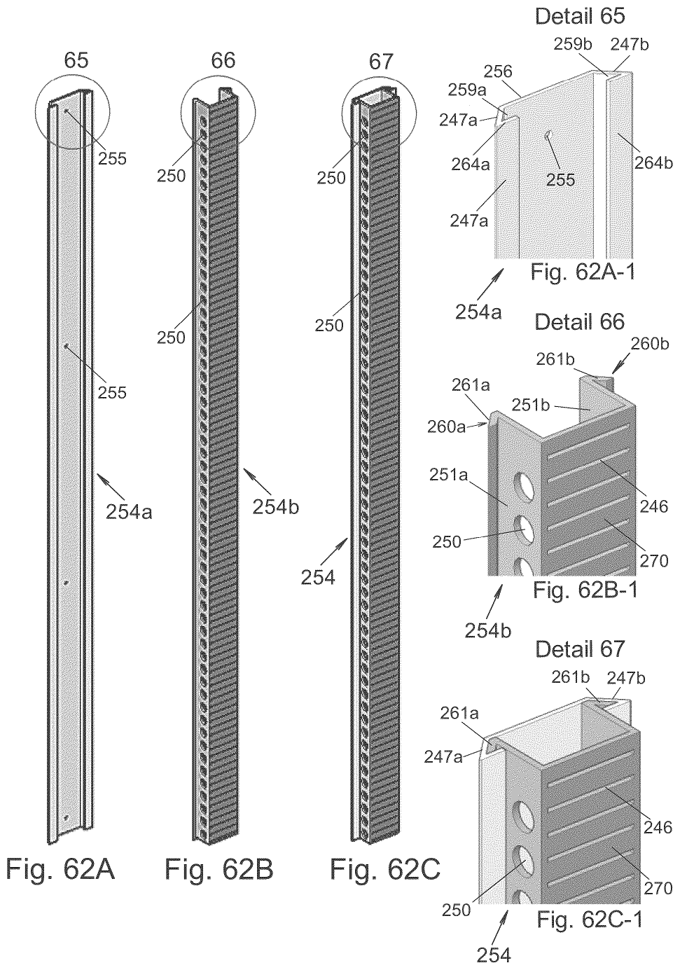

FIG. 62A is a perspective view from the front of a rail for use in conjunction with the paneling system of FIG. 59, wherein FIG. 62A-1 is an enlargement of Detail 65 thereof;

FIG. 62B is a perspective view from the front of a slitted profile capable of being coupled with the rail of FIG. 62A, wherein FIG. 62B-1 is an enlargement of Detail 66 thereof;

FIG. 62C is a perspective view from the front of a framing element that is assembled from the slitted profile of FIG. 62B and a corresponding rail, wherein FIG. 62C-1 is an enlargement of Detail 67 thereof;

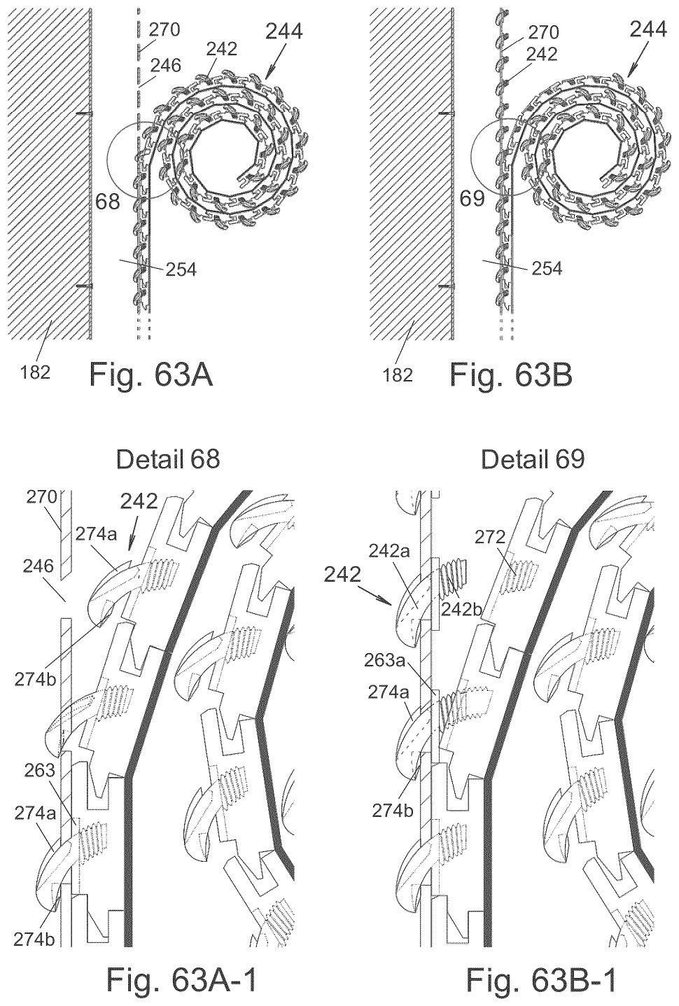

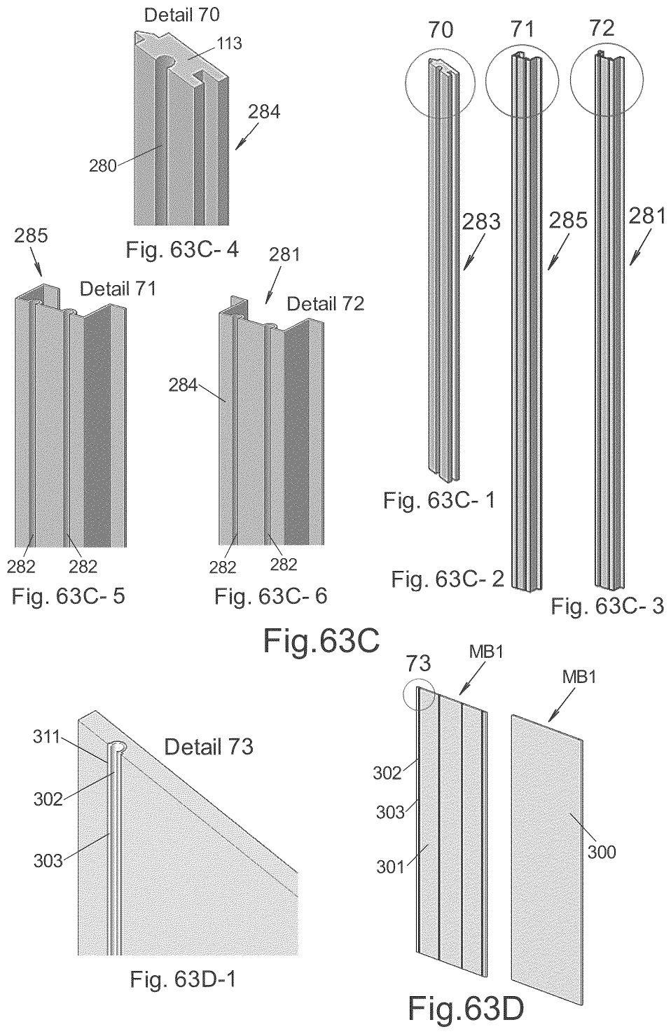

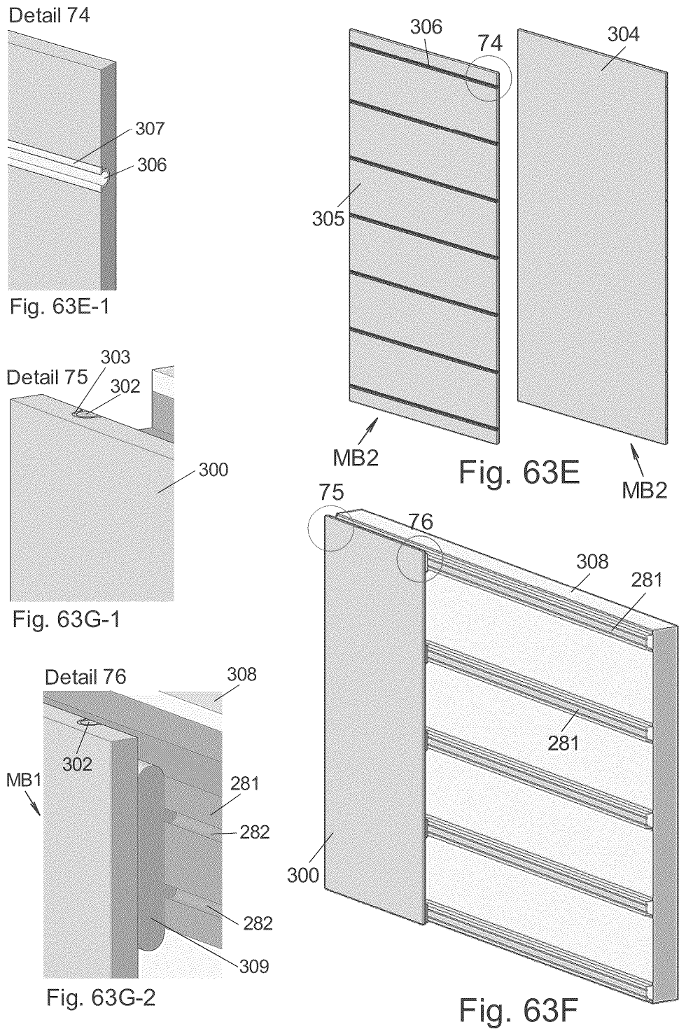

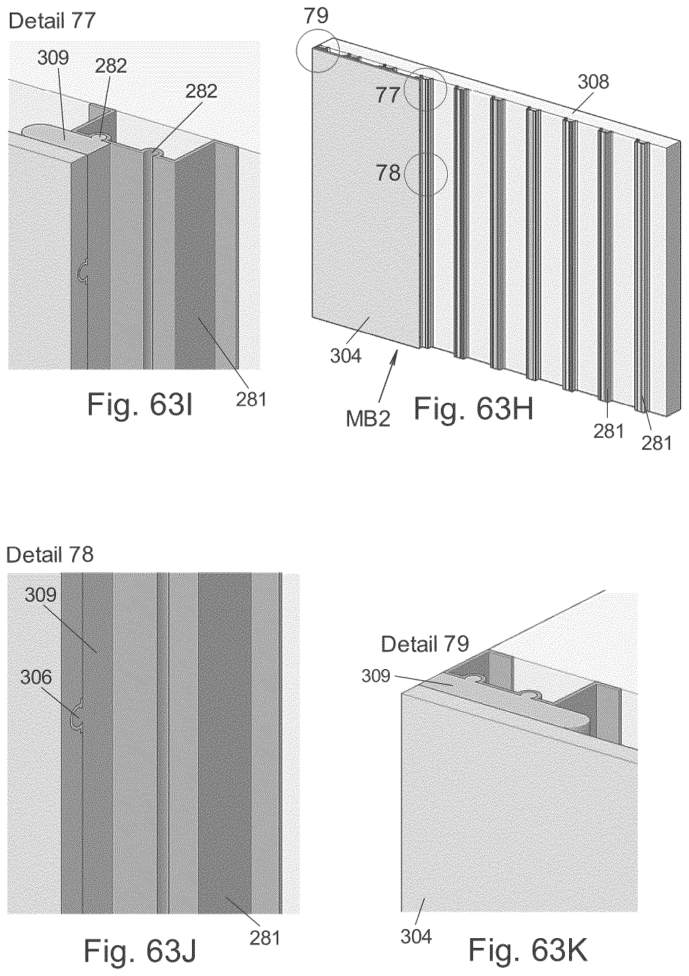

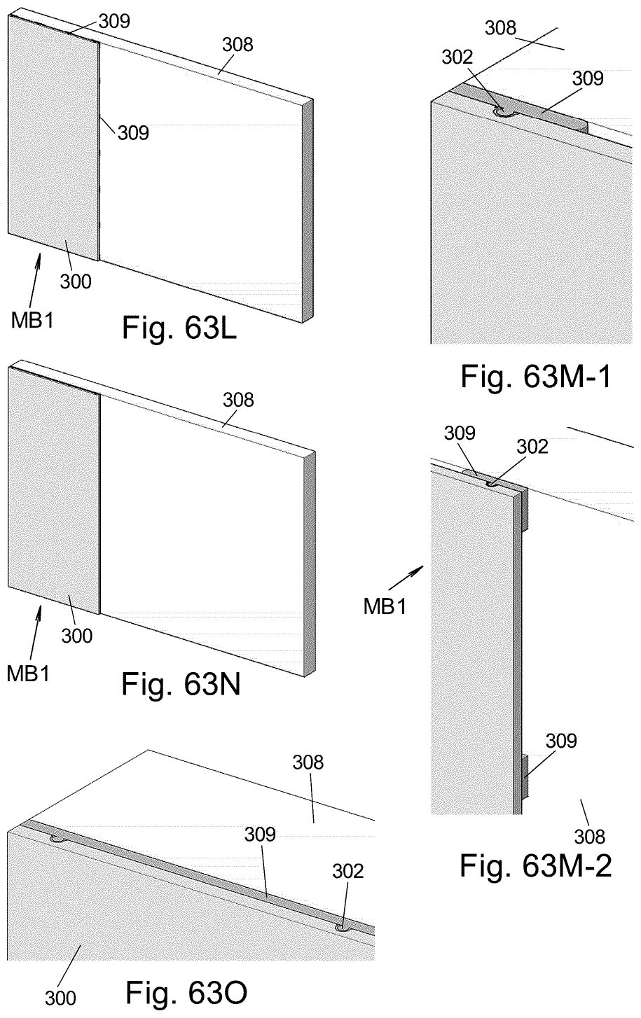

FIG. 63A is a schematic illustration in side view of an unrolling operation involving the roll of FIG. 59, wherein FIG. 63A-1 is an enlargement of Detail 68 thereof;

FIG. 63B is a schematic illustrations in side view of a rolling operation involving the roll of FIG. 59, wherein FIG. 63B-1 is an enlargement of Detail 69 thereof;

FIG. 63C is a perspective view from the top and front of adhesively connectable components for use in a paneling system according to another embodiment, wherein FIG. 63C-1 is an illustration of a coupling panel, FIGS. 63C-2 and 63C-3 are an illustration of two different types of studs, and FIGS. 63C-4, 63c-5 and 63C-6 are enlargements of Details 70-72 thereof, respectively;

FIG. 63D is a perspective view of the interior and exterior faces of a monolithic board according to one embodiment, wherein FIG. 63D-1 is an enlargement of Detail 73 thereof;

FIG. 63E is a perspective view of the interior and exterior faces of a monolithic board according to another embodiment, wherein FIG. 63E-1 is an enlargement of Detail 74 thereof;

FIG. 63F is a perspective view of the monolithic board of FIG. 63D when mounted on horizontal studs, wherein FIGS. 63G-1 and 63G-2 are an enlargement of Details 75 and 76 thereof, respectively;

FIG. 63H is a perspective view of the monolithic board of FIG. 63E when mounted on vertical studs, wherein FIGS. 631-K are an enlargement of Details 77-79 thereof, respectively;

FIG. 63L is a perspective view of the monolithic board of FIG. 63D to which link material is applied at specific discrete points directly onto an exposed wall, wherein FIGS. 63M-1 and 63M-2 are an enlargement from above and from the side of the board, respectively;

FIG. 63N is a perspective view of the monolithic board of FIG. 63D to which link material is entirely applied onto an exposed wall, wherein FIG. 63O is an enlargement from above the board;

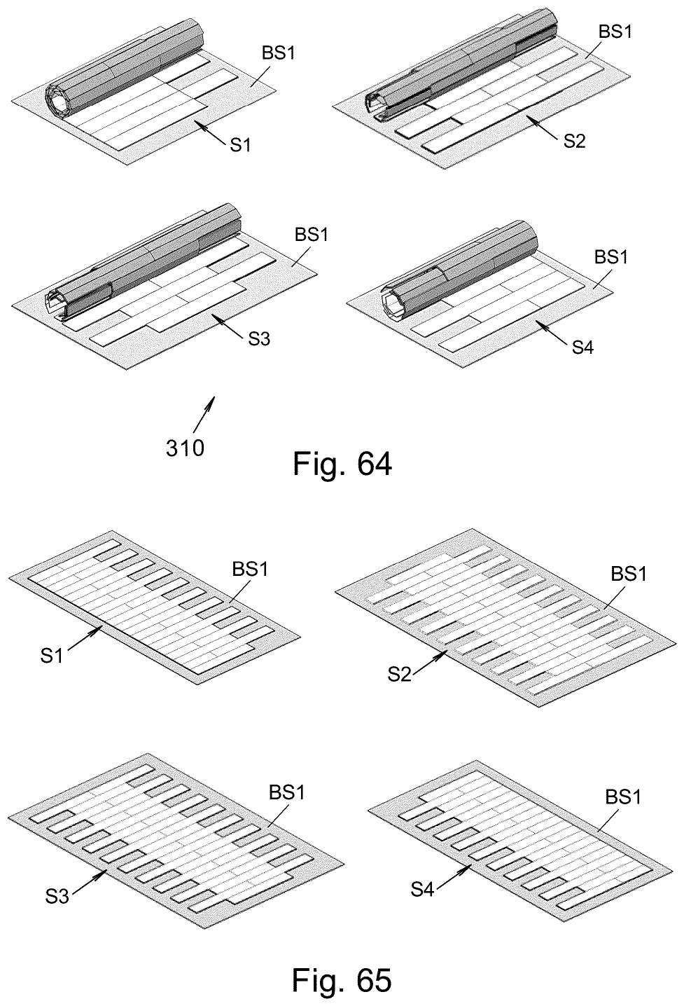

FIG. 64 is a perspective view from above of four unconnected structures of a parquet system when partially unrolled on top of a base surface;

FIG. 65 is a perspective view from above of the four unconnected structures of the parquet system of FIG. 64 when completely unrolled on the base surface;

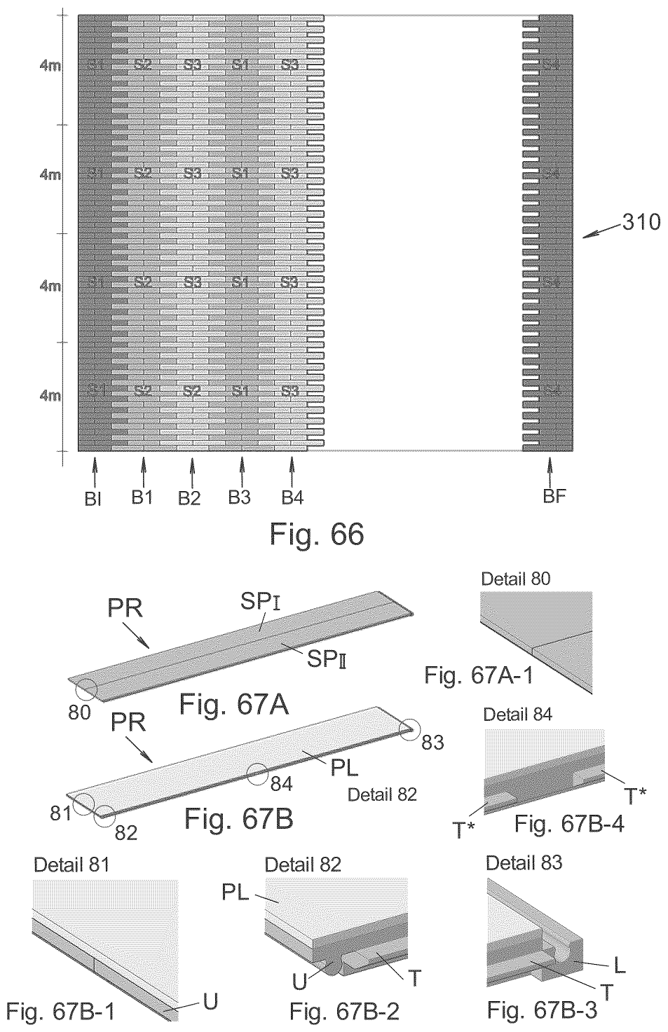

FIG. 66 is a plan view of the parquet system of FIG. 64, when the four structures are interjoined and completely unrolled on the base surface, schematically illustrating a method for interjoining the structures;

FIG. 67A is a perspective view from above of a parquet segment comprising two interjoined coupling panels, shown without a lamination layer, wherein FIG. 67A-1 is an enlargement of Detail 80 thereof;

FIG. 67B is a perspective view from above of the parquet segment of FIG. 67A, shown when applied with a lamination layer, wherein FIGS. 67B-1, 67B-2, 67B-3 and 67B-4 are an enlargement of Details 81-4 thereof, respectively, showing an exemplary arrangement of profile portions;

FIG. 68 is a perspective view from above of the parquet segment of FIG. 67B, shown in both non-pivoted and in pivoted forms;

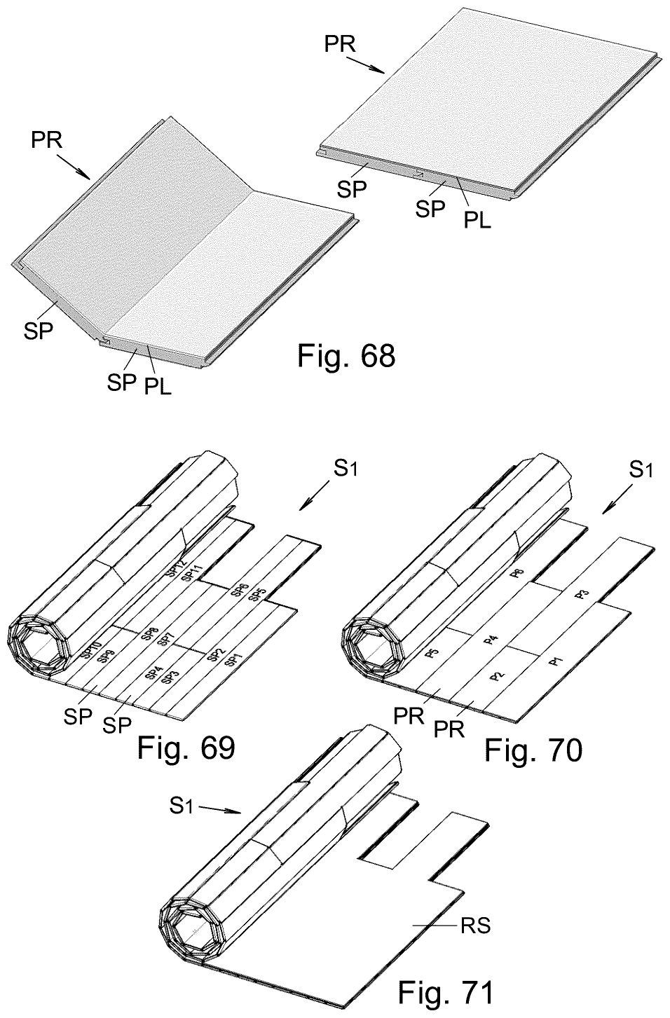

FIG. 69 is a perspective view from above of a partially unrolled structure comprising a plurality of interjoined coupling panels for use in the parquet system of FIG. 64, shown without a lamination layer and without a removable common sheet;

FIG. 70 is a perspective view from above of the partially unrolled structure of FIG. 69, shown with lamination layers and without a removable common sheet while illustrating the various parquet segments;

FIG. 71 is a perspective view from above of the partially unrolled structure of FIG. 69, shown with lamination layers and with a removable common sheet;

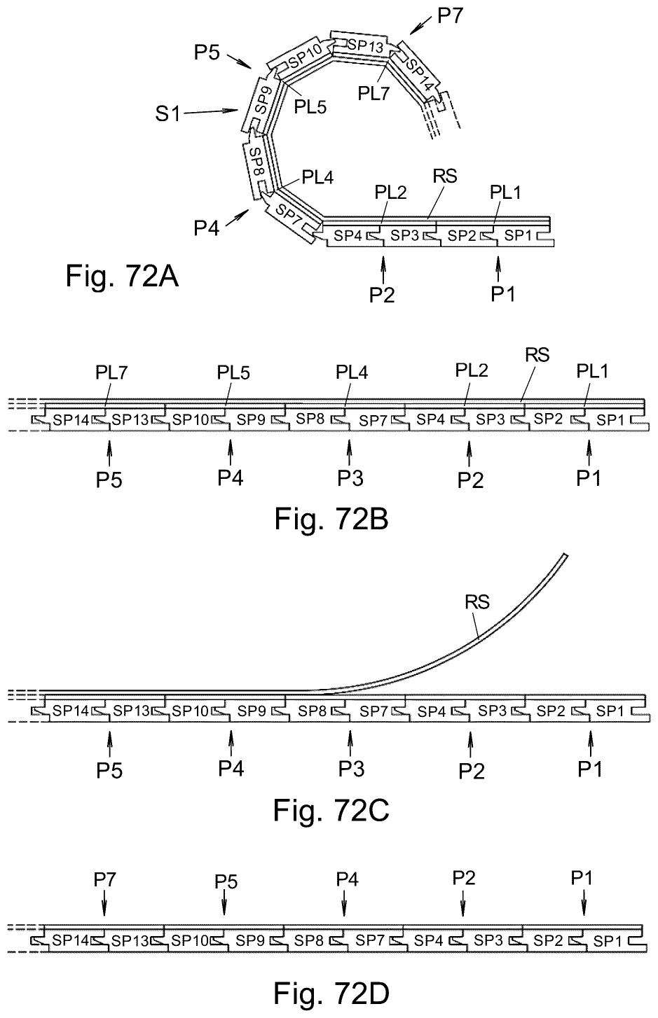

FIG. 72A is a side view of a portion of the partially unrolled structure of FIG. 71;

FIG. 72B is a side view of a portion of the structure of FIG. 72A, when completely unrolled;

FIG. 72C is a side view of a portion of the structure of FIG. 72A, when completely unrolled and the common sheet is partially removed;

FIG. 72D is a side view of a portion of the structure of FIG. 72A, when completely unrolled and the common sheet is completely removed;

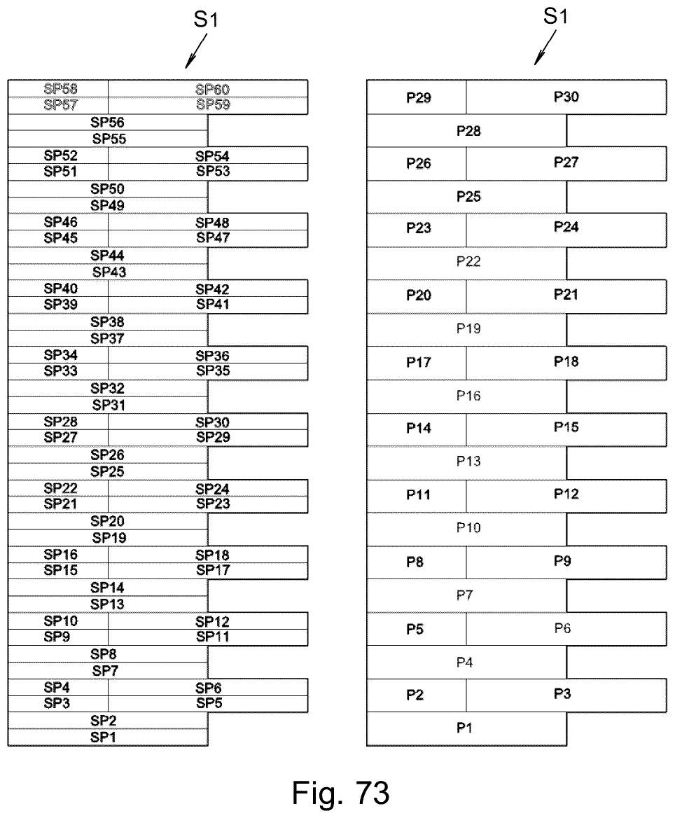

FIG. 73 is a top view of the structure of FIG. 69, showing both the interjoined coupling panels and the corresponding parquet segments;

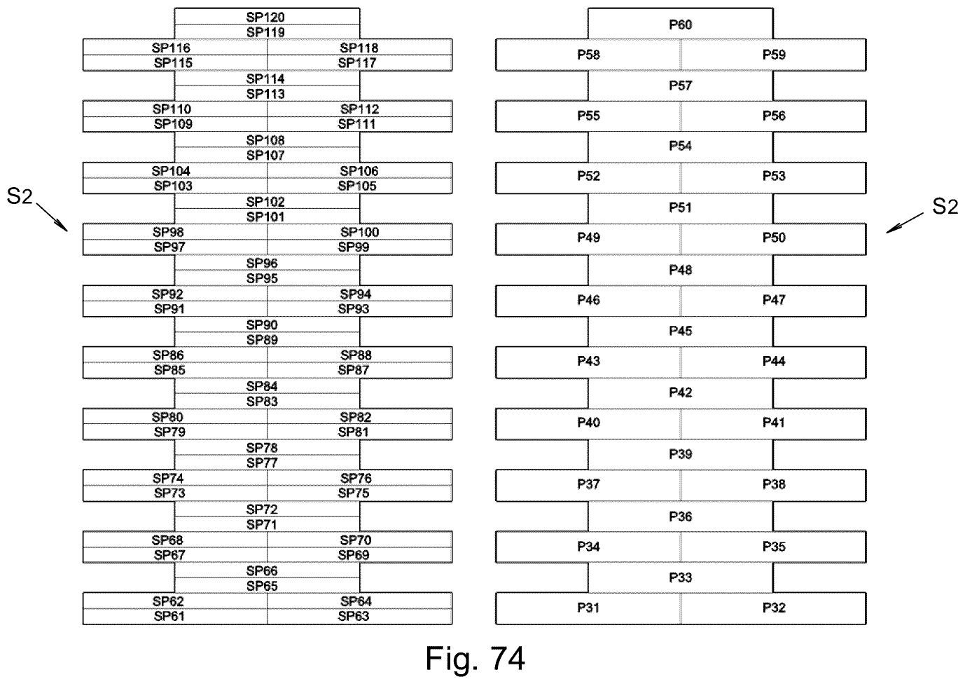

FIGS. 74-76 are a top view of three other structures, respectively, each showing both the interjoined coupling panels and the corresponding parquet segments;

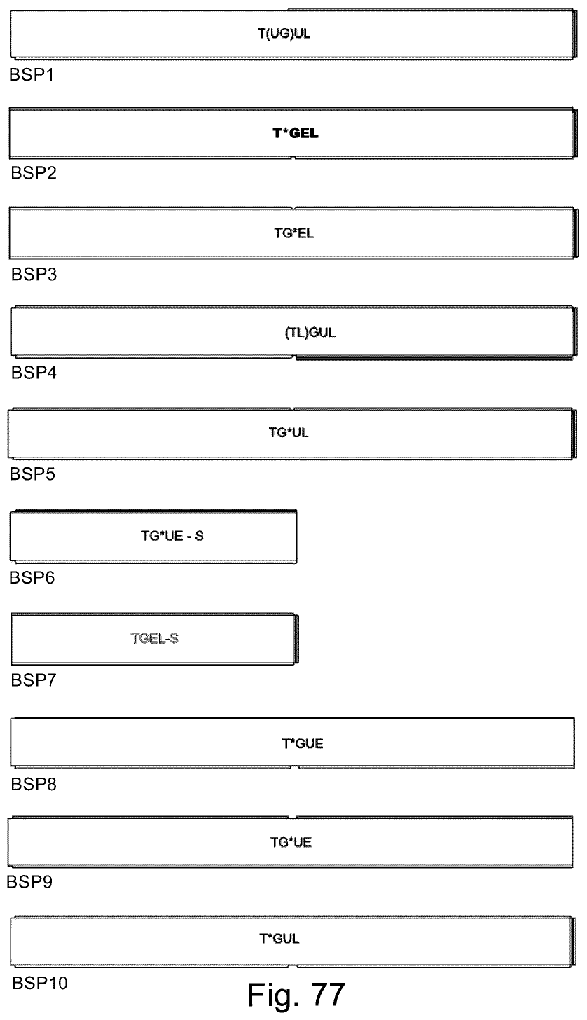

FIG. 77 is a schematic illustration of an arrangement of coupling panel types used in conjunction with the structures of FIGS. 73-76;

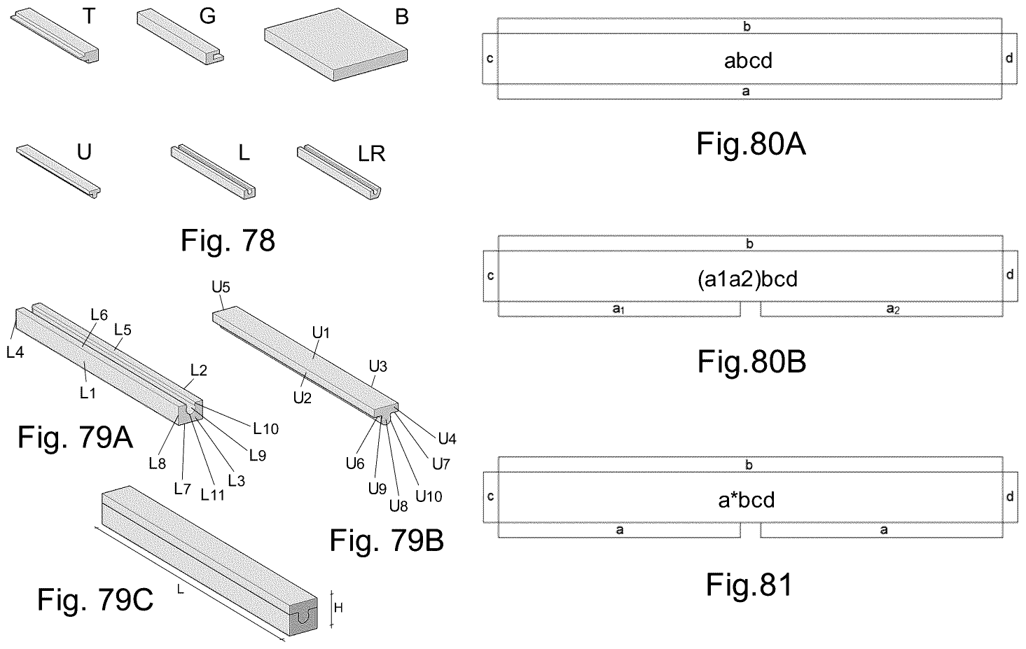

FIG. 78 is a perspective view of a plurality of profile portions from a combination of which coupling panels used in conjunction with the parquet system of FIG. 66 are able to be configured;

FIGS. 80A and 80B are an enlarged perspective view of two profile portions, respectively, shown in FIG. 79;

FIG. 80C is a perspective view of the two profile portions, including the profile portion of FIG. 80A, when combined together;

FIGS. 80A-B and 81 schematically illustrate three coupling panel types, respectively, used in conjunction with the parquet system of FIG. 66;

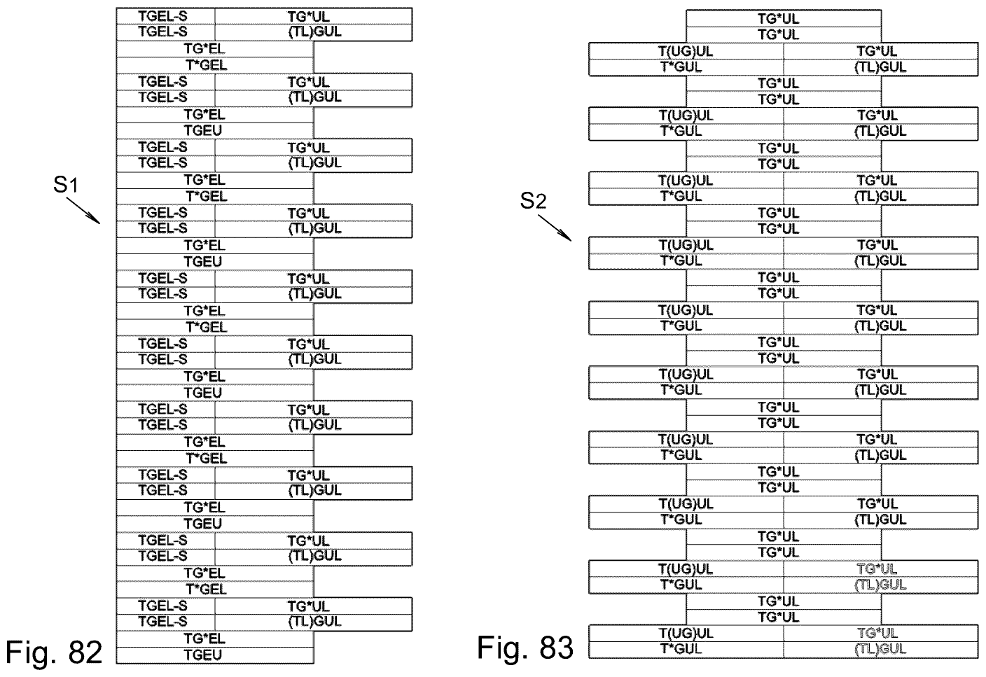

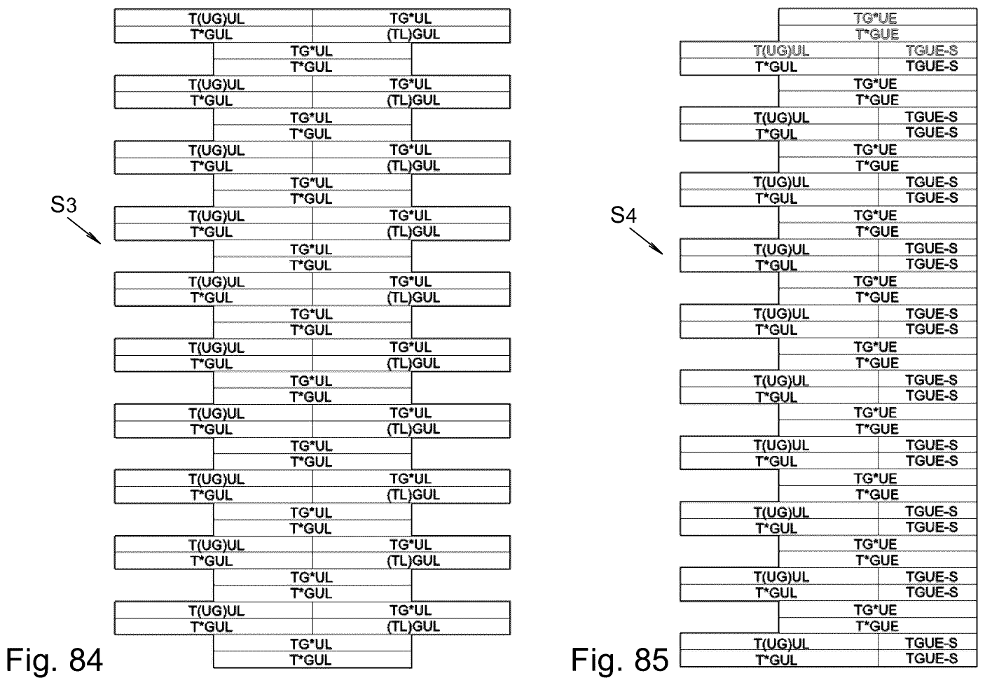

FIGS. 82-85 is a top view of four different structures, respectively, schematically illustrating an arrangement of the coupling types that are used;

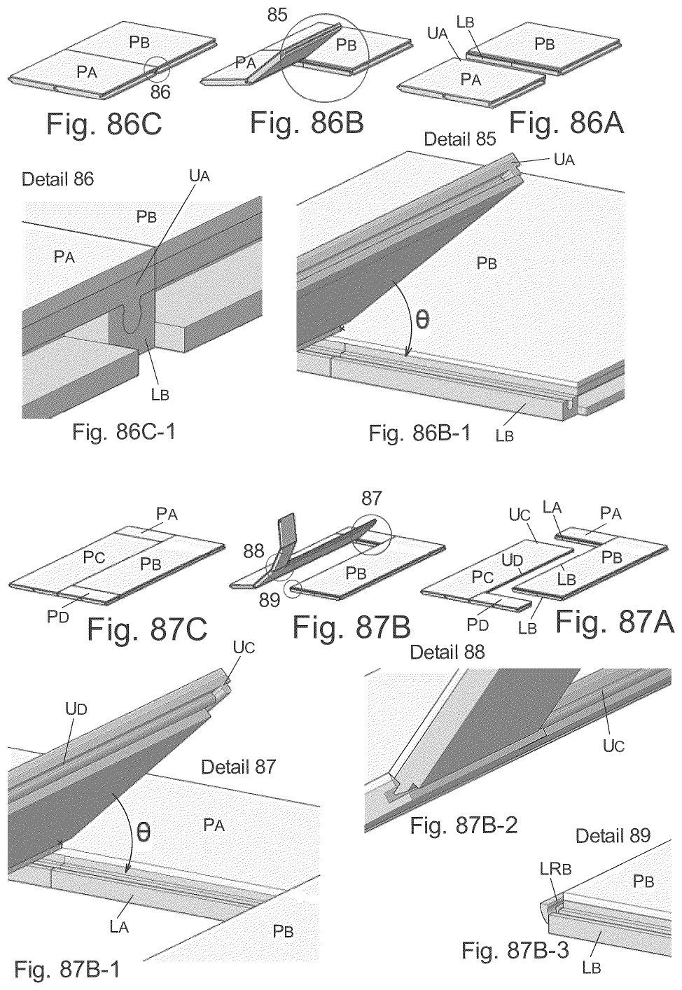

FIGS. 86A-86C are a perspective view from above of two laterally spaced coupling panels shown in three stages, respectively, of an l-connection parquet segment interconnection method, wherein FIG. 86B-1 is an enlargement of Detail 85 of FIG. 86B and FIG. 86C-1 is an enlargement of Detail 86 of FIG. 86C;

FIGS. 87A-87C are a perspective view from above of a plurality of coupling panels shown in three stages, respectively, of an r-connection parquet segment interconnection method, wherein FIGS. 87B-1, 87B-2 and 87B-3 are an enlargement of Details 87-89, respectively, of FIG. 87B;

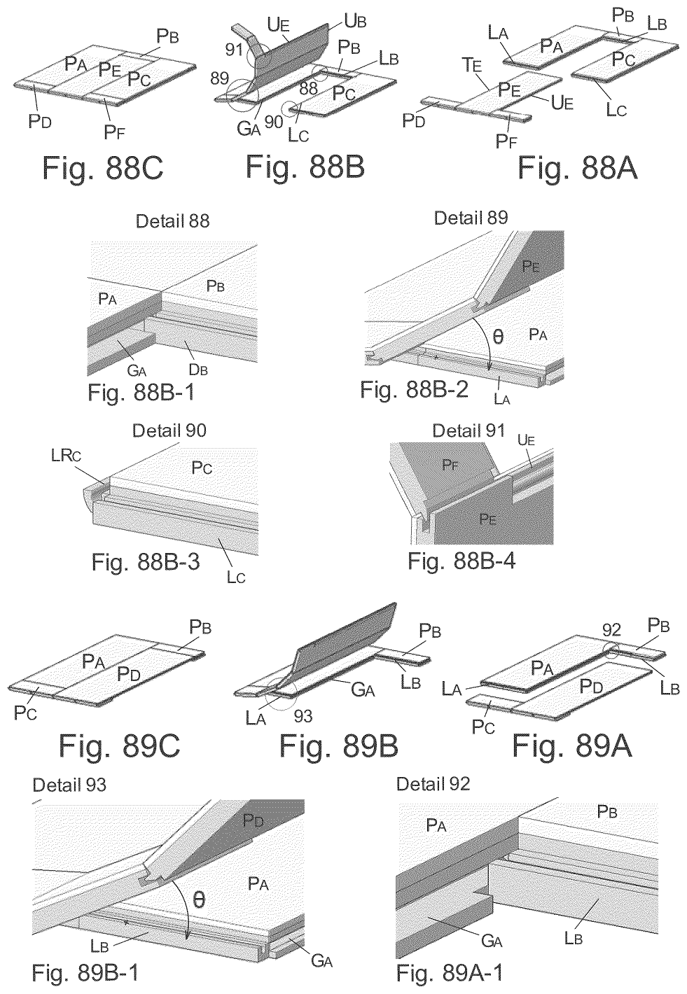

FIGS. 88A-88C are a perspective view from above of a plurality of coupling panels shown in three stages, respectively, of a U-connection parquet segment interconnection method, wherein FIGS. 88B-1, 88B-2, 88B-3 and 88B-4 are an enlargement of Details 88-91, respectively, of FIG. 88B;

FIGS. 89A-89C are a perspective view from above of a plurality of coupling panels shown in four stages, respectively, of an L-connection parquet segment interconnection method, wherein FIGS. 897B-1 and 89B-2 are an enlargement of Details 92-93, respectively, of FIG. 89B;

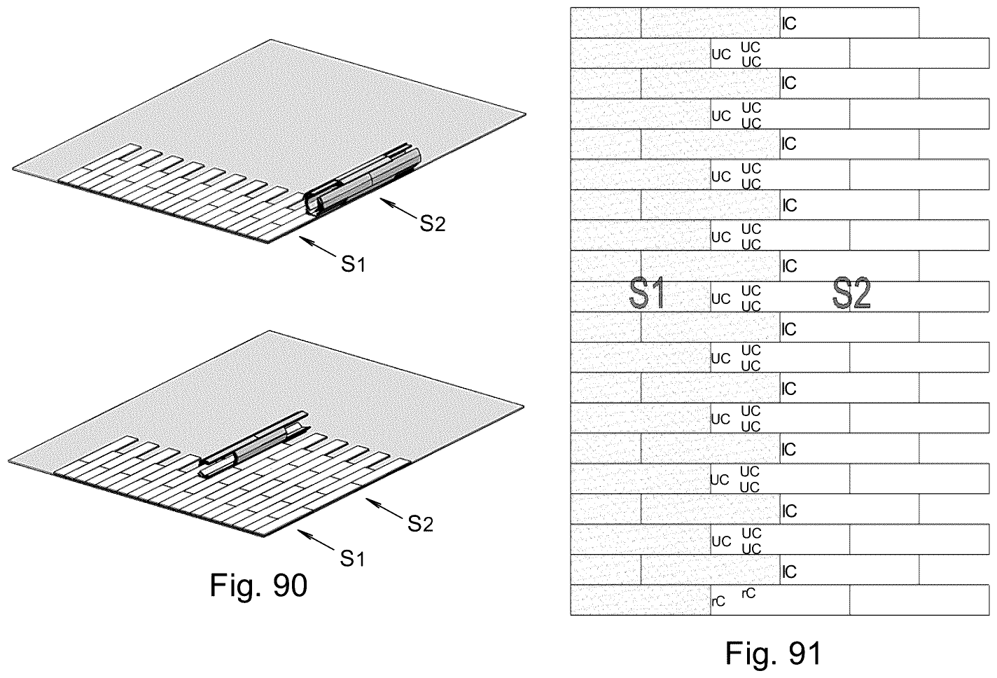

FIG. 90 is a perspective view from above of a first unrolled section and a second rolled section, showing how the second section becomes interjoined with the first section while being unrolled;

FIG. 91 is a top view of a parquet system comprising the first and second sections of FIG. 90 when interjoined, schematically illustrating various interconnection methods that are used;

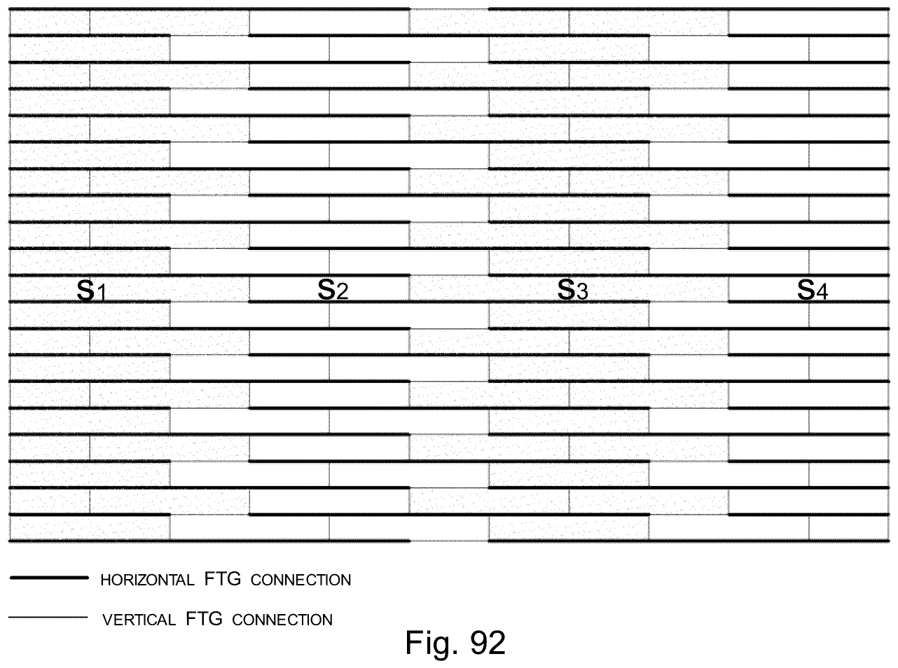

FIG. 92 is a top view of a parquet system comprising four sections when interjoined including the first and second sections of FIG. 90, schematically illustrating by bold lines the location of horizontal FTG interconnections;

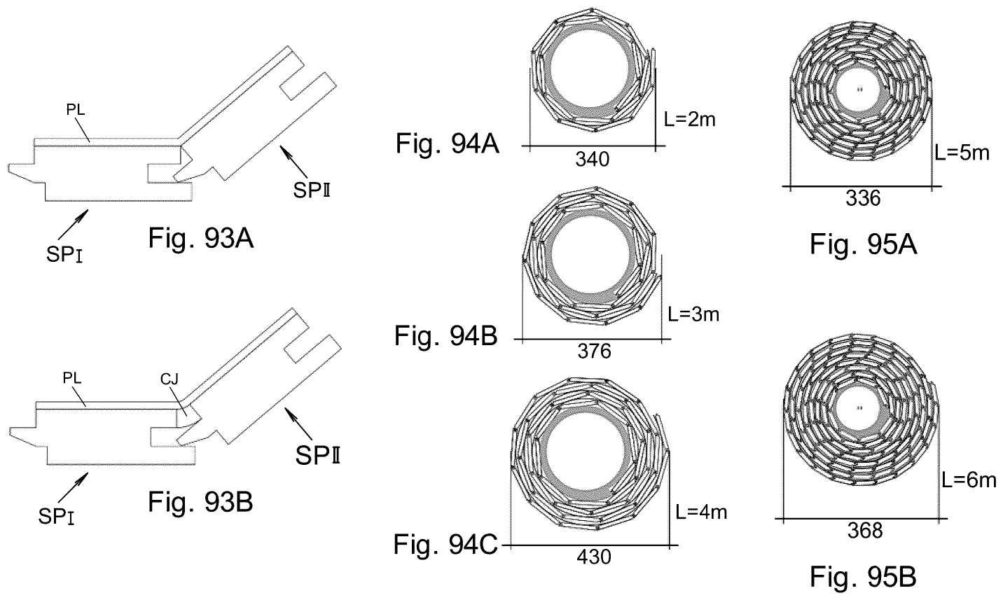

FIGS. 93A and 93B are a side view of the two interjoined coupling panels of FIG. 67A when angularly displaced one from the other, shown when interjoined by a lamination layer and a continuous joint, respectively;

FIGS. 94A-94C and 95A-95B are a side view of five structure rolls, respectively, showing the relation between the diameter of the structure roll and the length of the corresponding structure when unrolled;

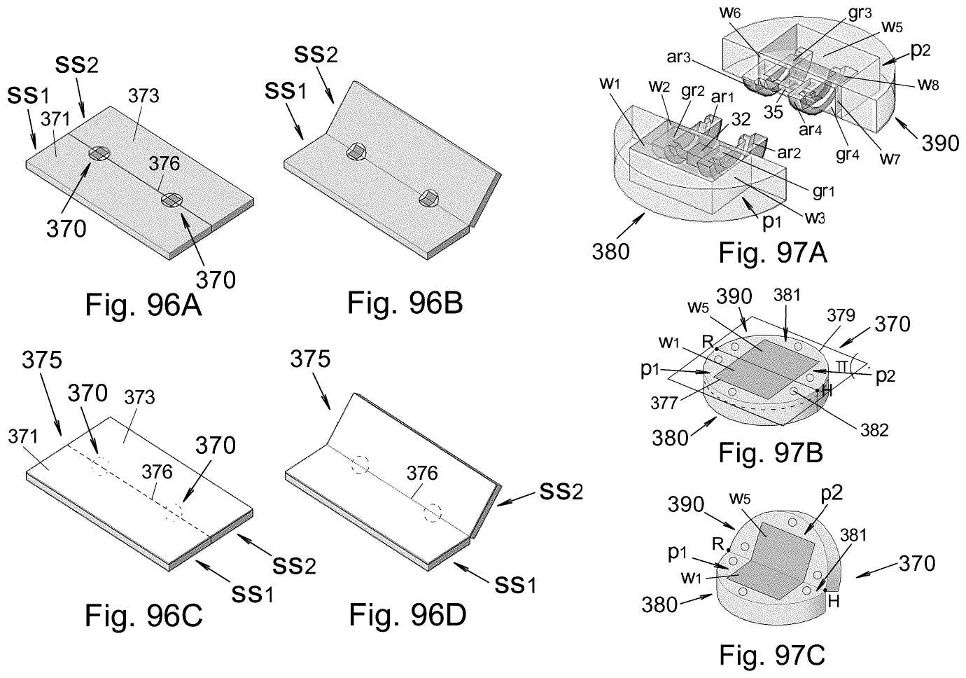

FIG. 96A is a perspective view of a continuously appearing element defined by two contiguous boards and two completely coplanar hinges, shown without a lamination layer;

FIG. 96B is a perspective view of the element of FIG. 96A, shown when the two boards are angularly displaced one from the other;

FIGS. 96C and 96D are a perspective of the element of FIG. 96A when provided with a lamination layer, shown when the two boards are set in coplanar and angularly displaced relation, respectively;

FIG. 97A is a perspective view of two separated and unconnected sections of the hinge of FIG. 96A when rendered transparent;

FIG. 97B is a perspective view of a completely coplanar hinge, including the two sections of FIG. 97A when interconnected and set in coplanar relation;

FIG. 97C is a perspective view of the two sections of FIG. 97A when interconnected and set in angularly displaced relation;

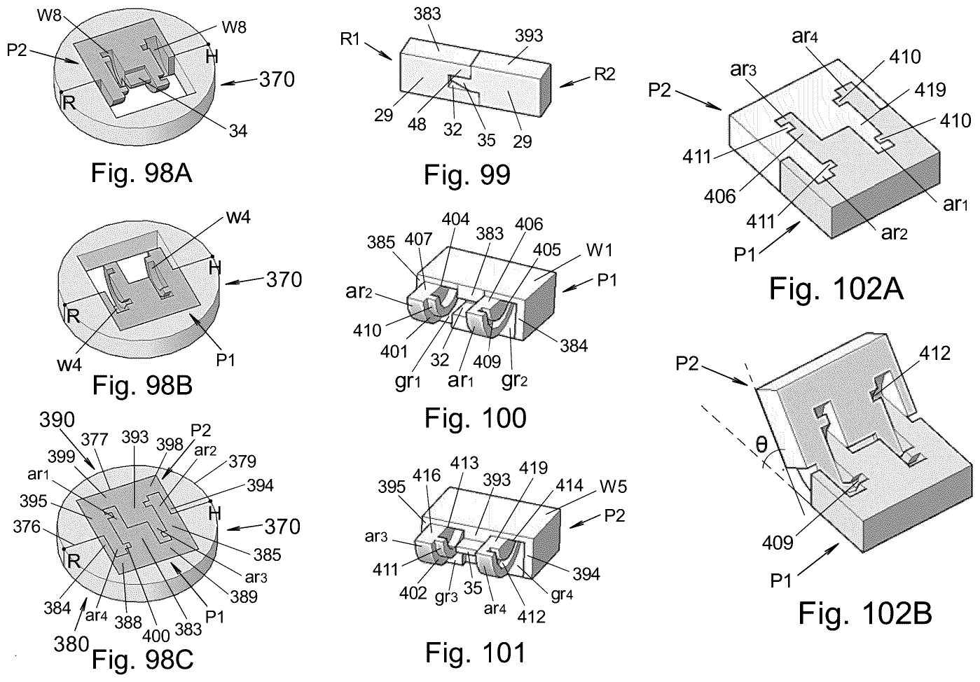

FIG. 98A is a perspective cross sectional view of the hinge of FIG. 97B, while cut along a plane parallel to its upper surface and shown without a first pivoting producing element;

FIG. 98B is a perspective cross sectional view of the hinge of FIG. 97B, while cut along a plane parallel to its upper surface and shown without a second pivoting producing element;

FIG. 98C is a perspective cross sectional view of the hinge of FIG. 97B, while cut along a plane parallel to its upper surface and shown with the first and second interconnected pivoting producing elements;

FIG. 99 is a perspective cross sectional view of the hinge of FIG. 97B, while cut along a plane perpendicular to its upper surface and showing the interconnected central rectilinear regions that constitute two coupling panels;

FIG. 100 is a perspective view of a first pivoting producing element used in conjunction with the hinge of FIG. 97B;

FIG. 101 is a perspective view of a second pivoting producing element used in conjunction with the hinge of FIG. 97B;

FIG. 102A is another perspective cross sectional view of the hinge of FIG. 97B while cut along a plane parallel to its upper surface, showing the first and second interconnected pivoting producing elements in a coplanar configuration;

FIG. 102B is a perspective cross sectional view of the hinge of FIG. 97B while cut along a plane parallel to its upper surface, showing the first and second interconnected pivoting producing elements in angularly displaced relation;

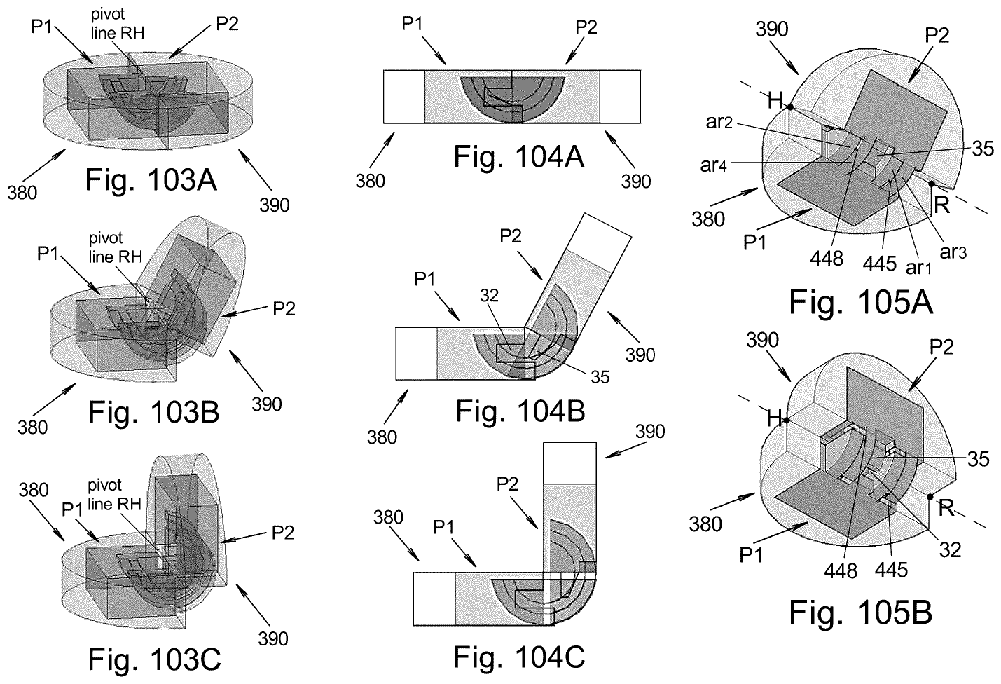

FIGS. 103A-C are a perspective view of the hinge of FIG. 97B while rendered transparent, shown in coplanar, first pivoted and second pivoted configurations, respectively;

FIGS. 104A-C are a side view of the hinge of FIG. 97B while rendered transparent to illustrate a projection of the tooth and groove of a FTG connection relative to an arcuate arm, shown in coplanar, first pivoted and second pivoted configurations, respectively;

FIGS. 105A-B are a perspective rear view of the hinge of FIG. 97B, shown in first and second pivoted configurations, respectively;

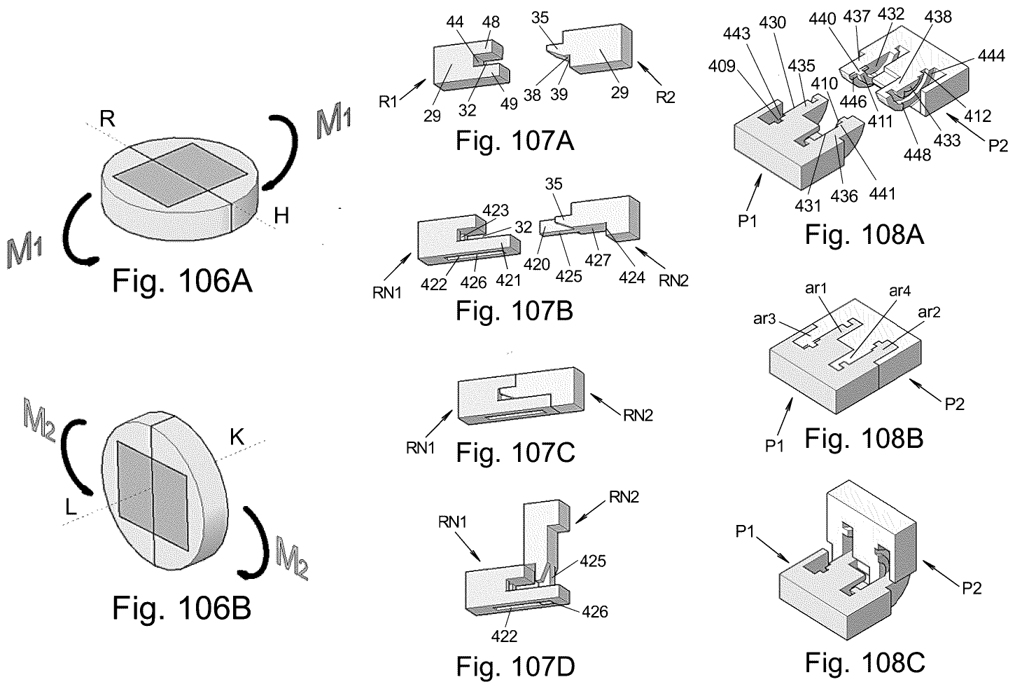

FIGS. 106A-B are a perspective view of the hinge of FIG. 97B, schematically illustrating its ability to withstand two different types of moments, respectively;

FIG. 107A is a perspective view of the two sectioned coupling panels of FIG. 99, while separated from each other;

FIG. 107B is a perspective view of the two sectioned coupling panels that have been modified relative to the sectioned coupling panels of FIG. 107A, shown while separated from each other;

FIG. 107C is a perspective view of the two modified coupling panels of FIG. 107B, shown while interconnected and set to a coplanar configuration;

FIG. 107D is a perspective view of the two modified coupling panels of FIG. 107B, shown while interconnected and set to an angularly restricted pivoted position;

FIG. 108A is a perspective cross sectional view of another embodiment of a completely coplanar hinge, while cut along a plane parallel to its upper surface and shown with two separated pivoting producing elements;

FIGS. 108B-C are a perspective cross sectional view of the hinge of FIG. 108A, while cut along a plane parallel to its upper surface and showing the two interconnected pivoting producing elements at coplanar and angularly restricted pivoted positions, respectively;

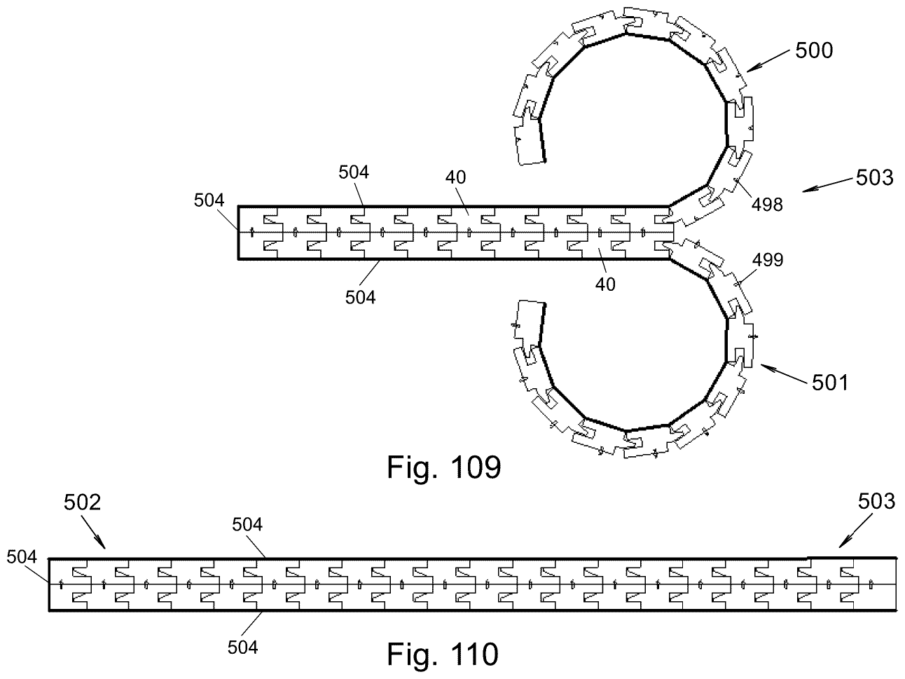

FIGS. 109 and 110 are a side view of two connecting systems that are being interconnected together during and after an unrolling operation, respectively, to produce a plate of bidirectional stiffness;

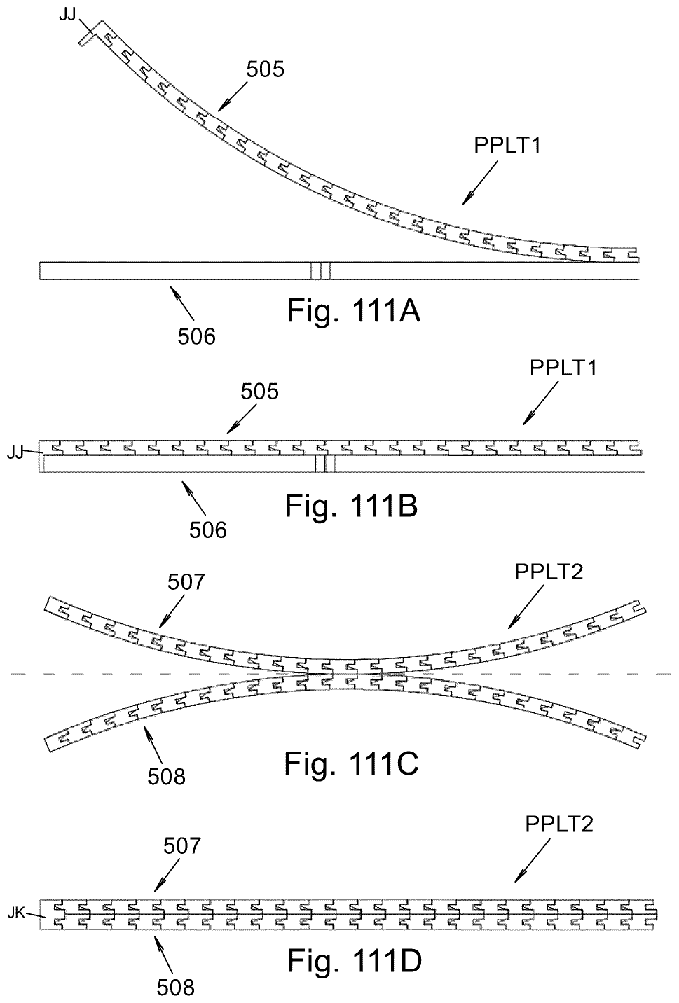

FIGS. 111A-B are a side view of a connecting system prior to, and following, a prestressing operation, respectively;

FIGS. 111C-D are a side view of two connecting systems prior to, and following, a prestressing operation, respectively;

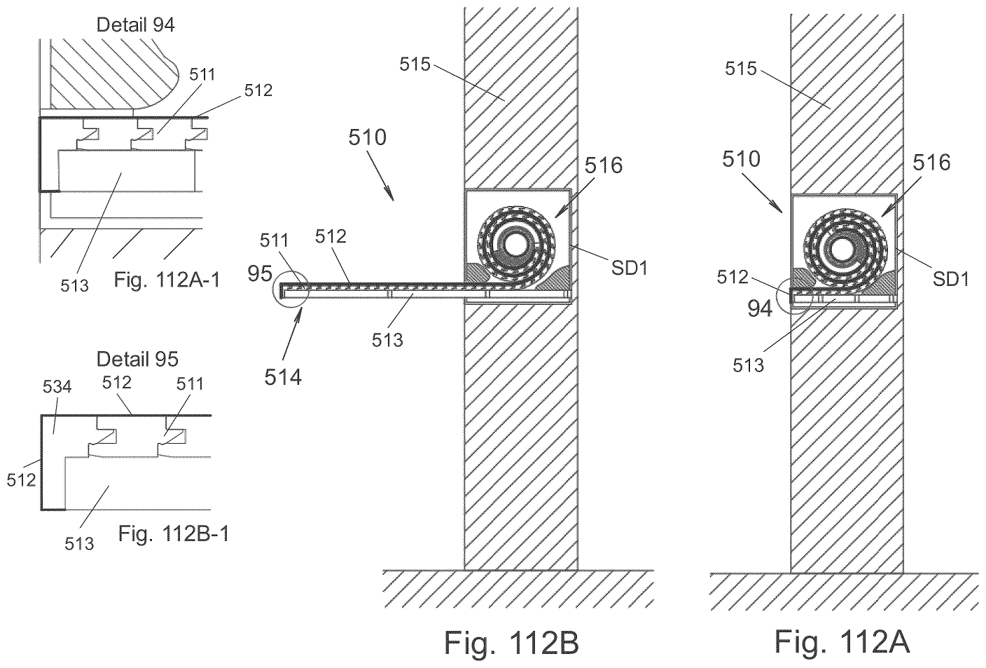

FIGS. 112A and 112B are a vertical cross sectional view of an embodiment of a pullout supporting surface system, shown when the supporting surface is retracted and extended, respectively, wherein FIGS. 112A-1 and 112B-1 are an enlargement of Details 94-95 thereof, respectively;

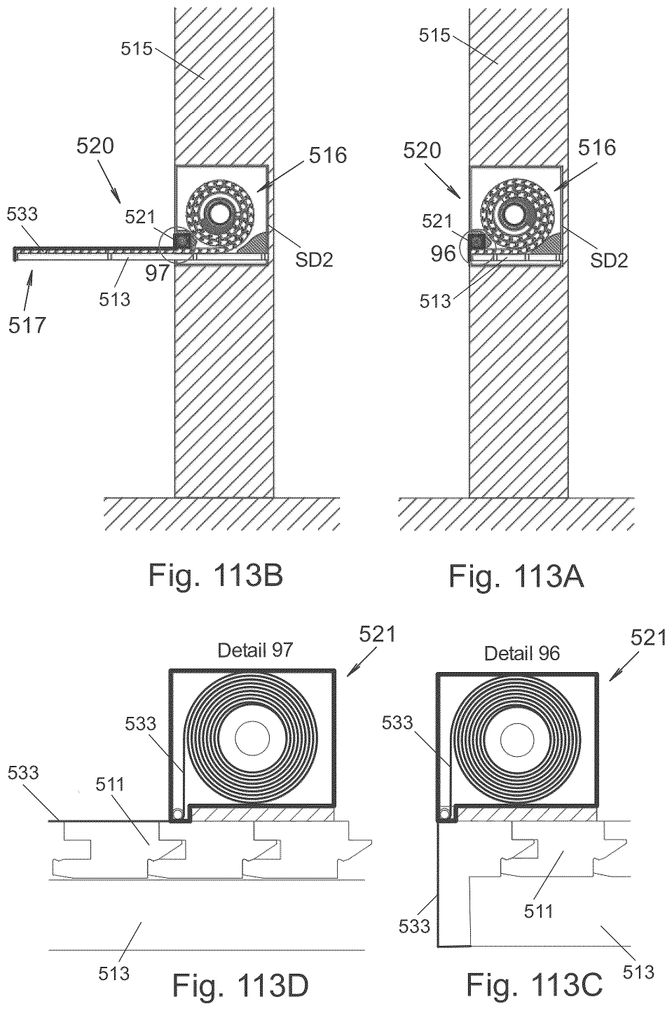

FIGS. 113A and 113B are a vertical cross sectional view of another embodiment of a pullout supporting surface system, shown when the supporting surface is retracted and extended, respectively, wherein FIGS. 113A-1 and 113B-1 are an enlargement of Details 96-97 thereof, respectively;

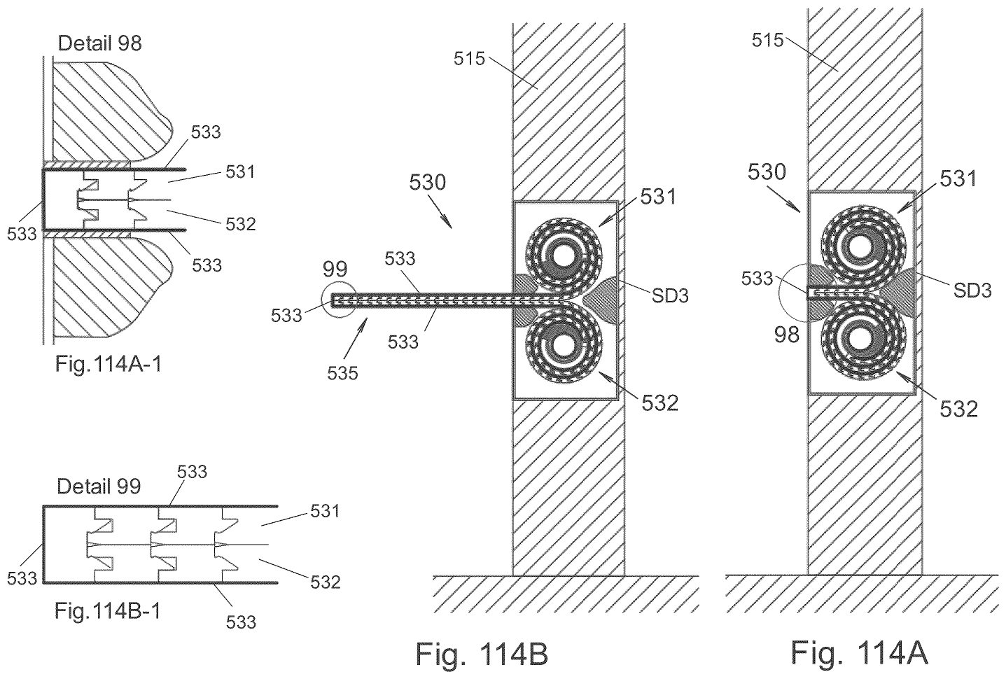

FIGS. 114A and 114B are a vertical cross sectional view of another embodiment of a pullout supporting surface system, shown when the supporting surface is retracted and extended, respectively, wherein FIGS. 114A-1 and 114B-1 are an enlargement of Details 98-99 thereof, respectively;

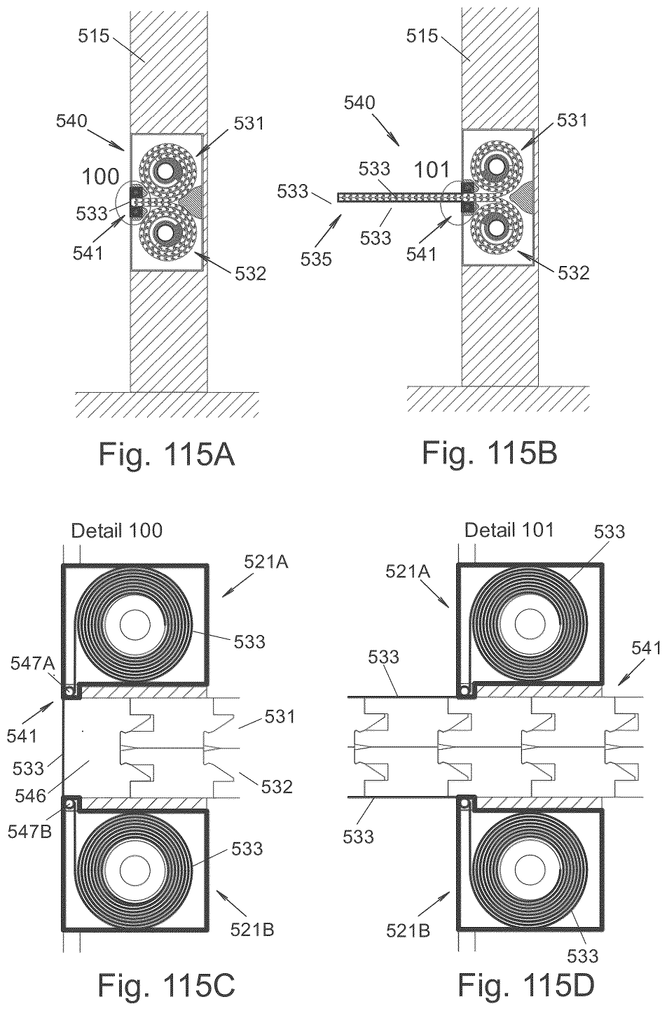

FIGS. 115A and 115B are a vertical cross sectional view of another embodiment of a pullout supporting surface system, shown when the supporting surface is retracted and extended, respectively, wherein FIGS. 115C and 115D are an enlargement of Details 100-101 thereof, respectively;

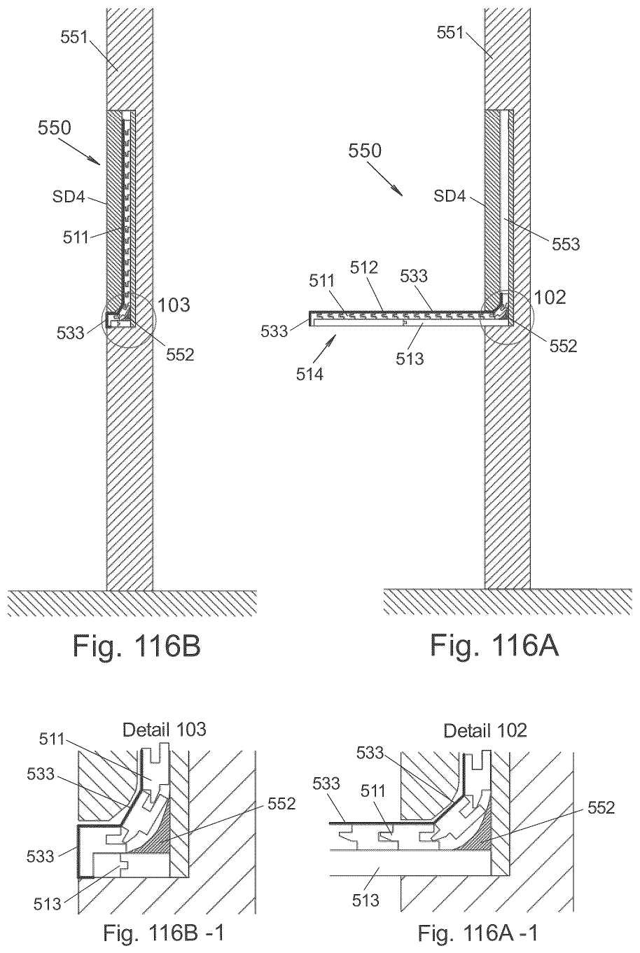

FIGS. 116A and 116B are a vertical cross sectional view of another embodiment of a pullout supporting surface system, shown when the supporting surface is extended and retracted, respectively, wherein FIGS. 116A-1 and 116B-1 are an enlargement of Details 102-103 thereof, respectively;

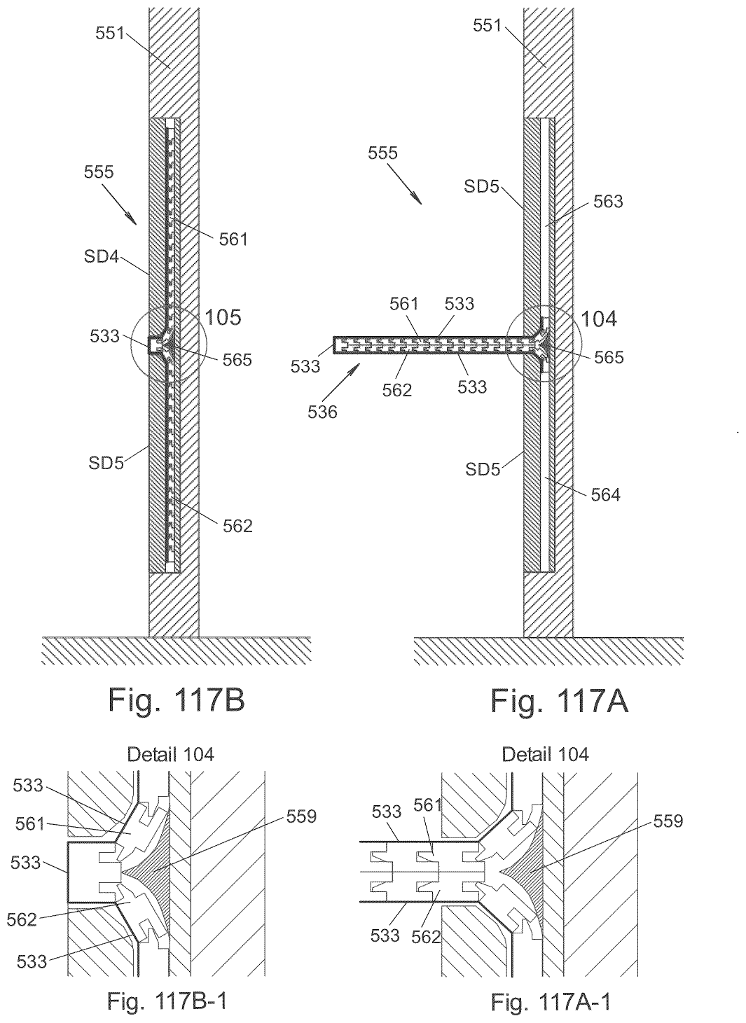

FIGS. 117A and 117B are a vertical cross sectional view of another embodiment of a pullout supporting surface system, shown when the supporting surface is extended and retracted, respectively, wherein FIGS. 117A-1 and 117B-1 are an enlargement of Details 104-105 thereof, respectively;

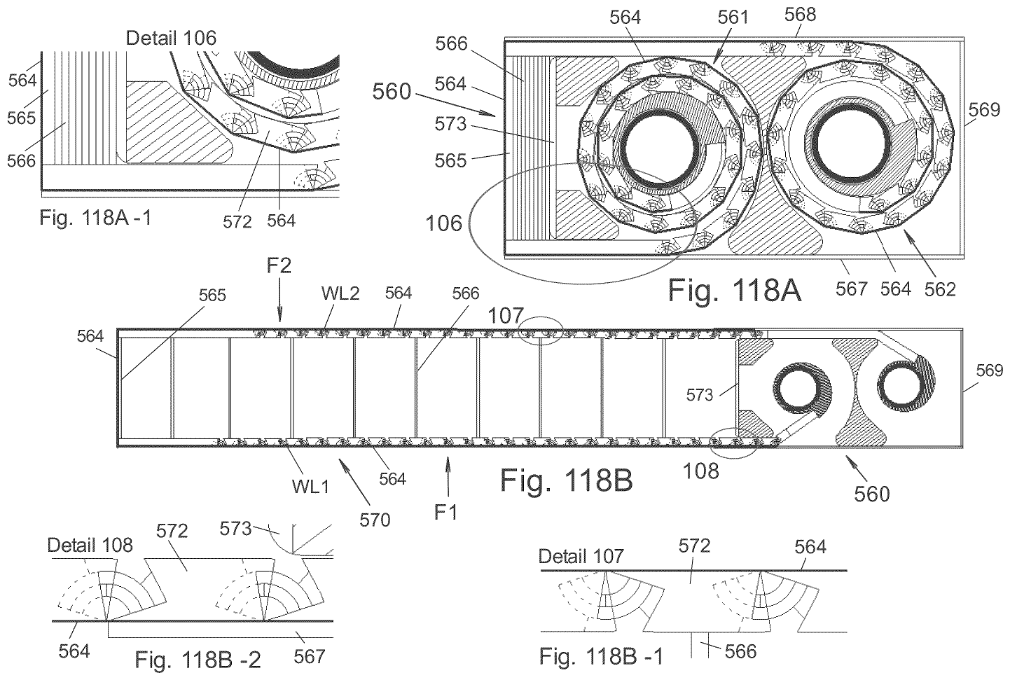

FIGS. 118A and 118B are a top view of an add-on pullout partition unit while an upper enclosure wall is removed, shown when the partition is retracted and extended, respectively, wherein FIGS. 118A-1, 118B-1 and 118B-2 are an enlargement of Details 106-108 thereof, respectively;

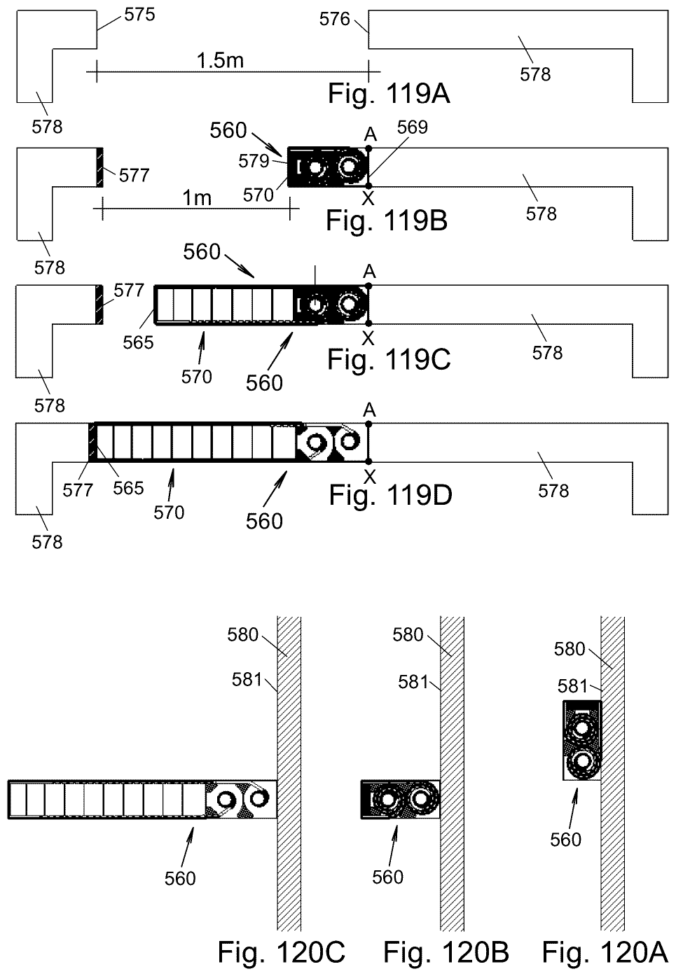

FIGS. 119A-D are a top view of a wall opening, shown completely unoccluded, when the partition unit of FIG. 118A is attached to a wall surface adjoining the opening, when the partition is partially extended, and when the partition is completely extended, respectively;

FIGS. 120A-C are a top view of a wall to which the partition unit of FIG. 118A is pivotally attached, shown when the enclosure is set at a first pivotal position, the enclosure is set at a second pivotal position, and the partition is extended when the enclosure is set at the second pivotal position, respectively;

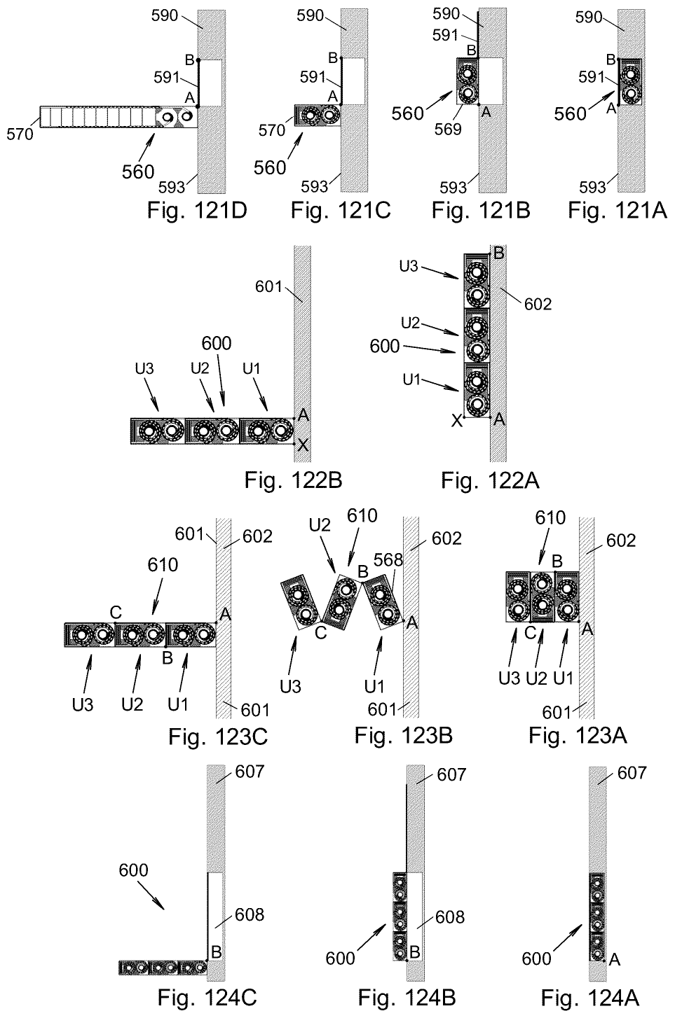

FIGS. 121A-D are a horizontal cross sectional view of a wall to which the partition unit of FIG. 118A is pivotally attached, shown when the enclosure is set at a first pivotal position and received in a cavity formed within the wall, the enclosure is pulled out of the cavity, the enclosure is set at a second pivotal position, and the partition is extended when the enclosure is set at the second pivotal position, respectively;

FIGS. 122A-B are a top view of a wall to which a system comprising three serially interconnected partition units of FIG. 118A is pivotally attached, shown when set at two different pivotal positions, respectively;

FIGS. 123A-C are a top view of a wall to which a system comprising three pivotally interconnected partition units of FIG. 118A is pivotally attached, shown in three different arrangements, respectively;

FIGS. 124A-C are a horizontal cross sectional view of a wall to which the system of FIG. 122A is pivotally attached, shown when set at a first pivotal position and received in a cavity formed within the wall, pulled out of the cavity, and set at a second pivotal position, respectively;

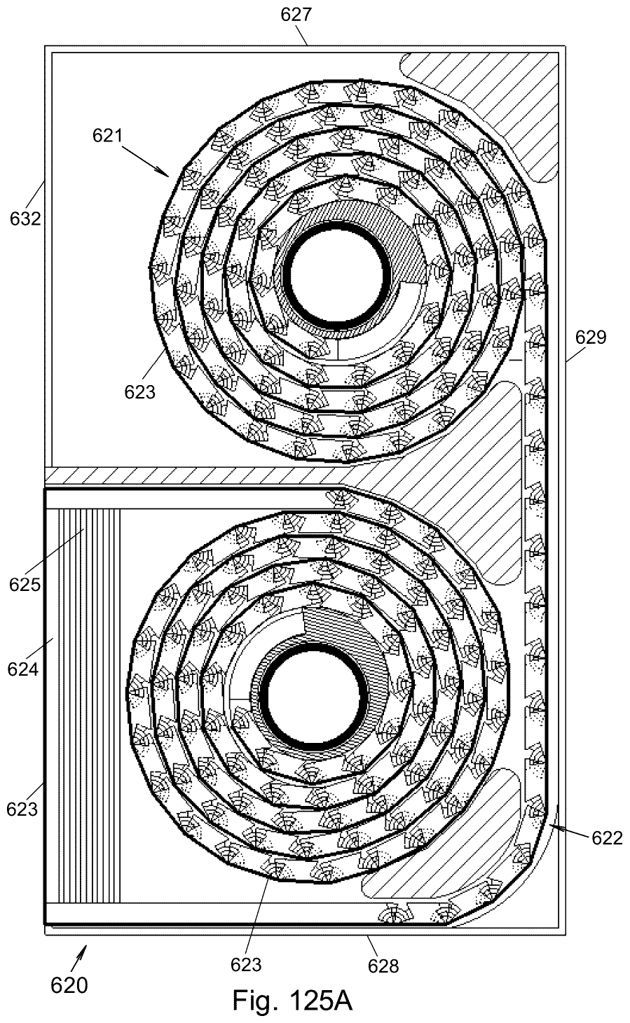

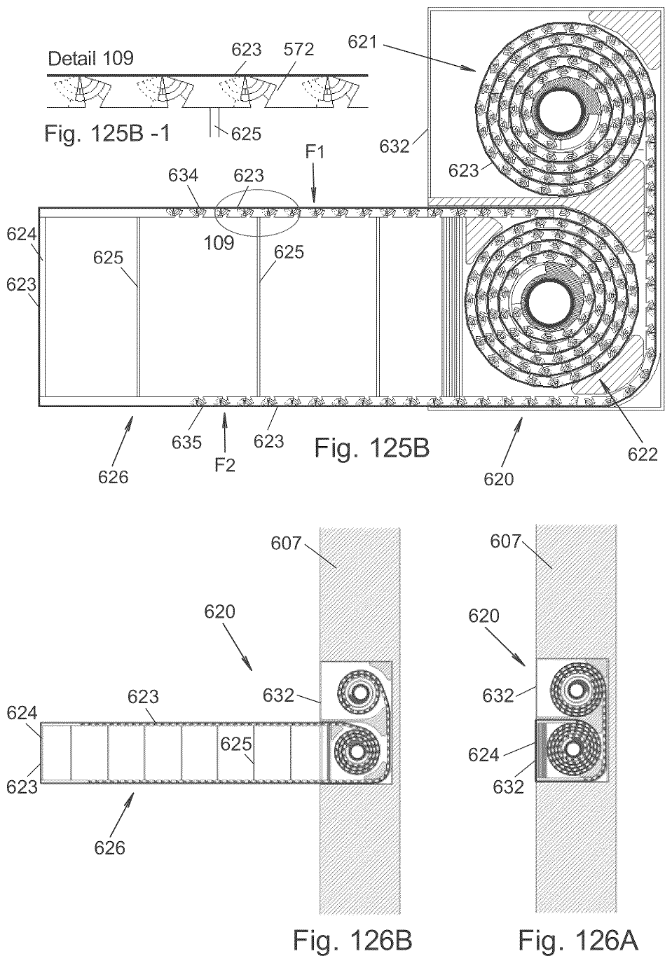

FIGS. 125A and 125B are a top view of another embodiment of add-on pullout partition unit while an upper enclosure wall is removed, shown when the partition is retracted and extended, respectively, wherein FIG. 125B-1 is an enlargement of Detail 109 of FIG. 125B;

FIGS. 126A and 126B are a horizontal cross sectional view of the pullout partition unit of FIG. 125A while received in a cavity formed within the wall, shown when the partition is retracted and extended, respectively;

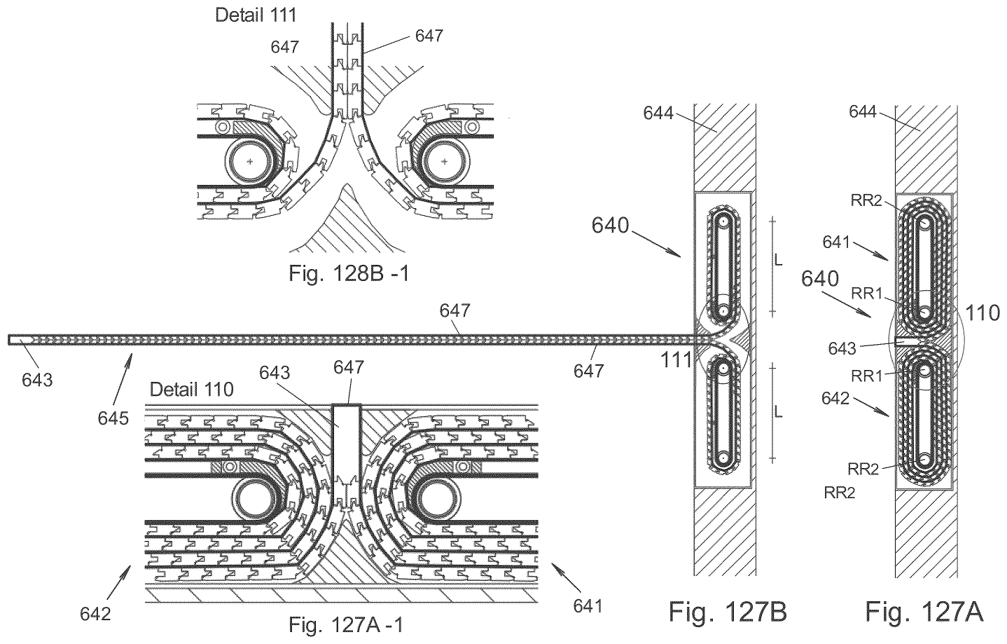

FIGS. 127A and 127B are a horizontal cross sectional view of another embodiment of a pullout partition unit while received in a cavity formed within the wall, shown when the partition is retracted and extended, respectively, wherein FIGS. 127A-1 and 127B-1 are an enlargement of Details 110-111 thereof;

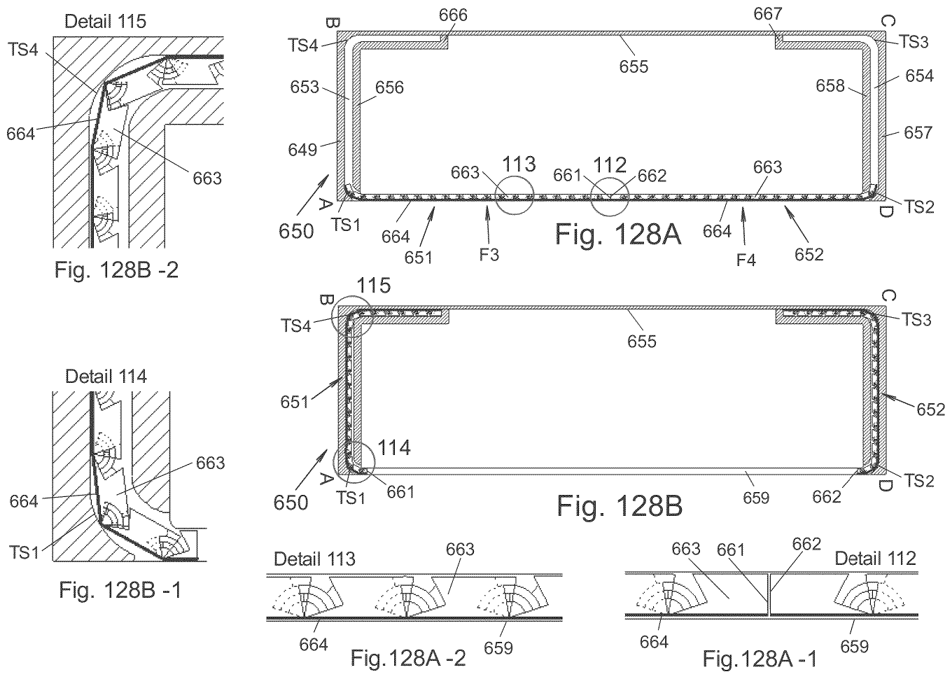

FIGS. 128A-B are a horizontal cross sectional view of a sliding-door cabinet, shown when closed and opened, respectively, wherein FIGS. 128A-1, 128A-2, 128B-1 and 128B-2 are an enlargement of Details 112-114 thereof, respectively;

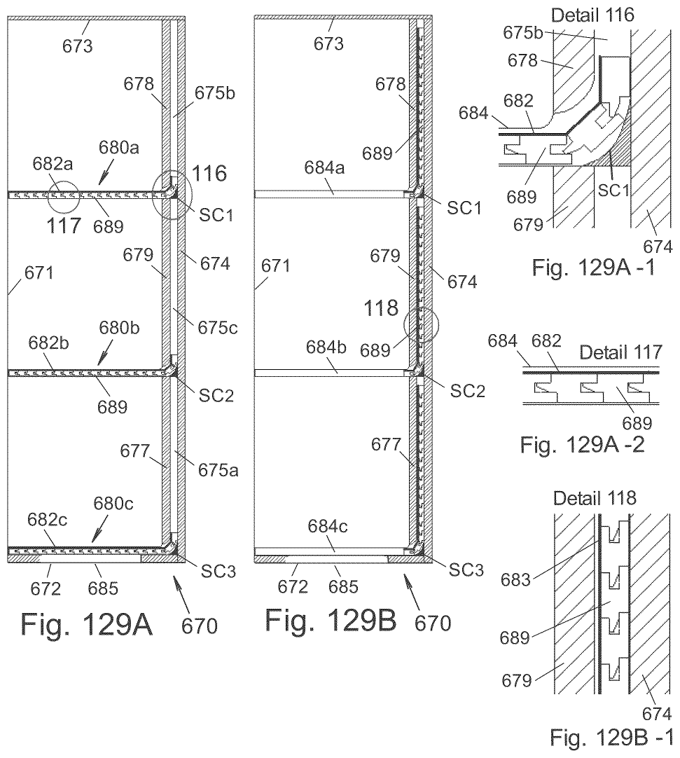

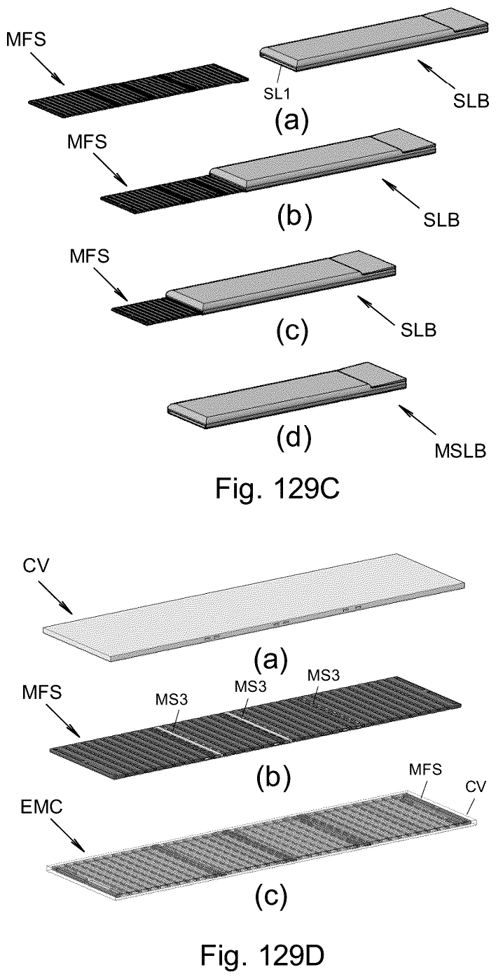

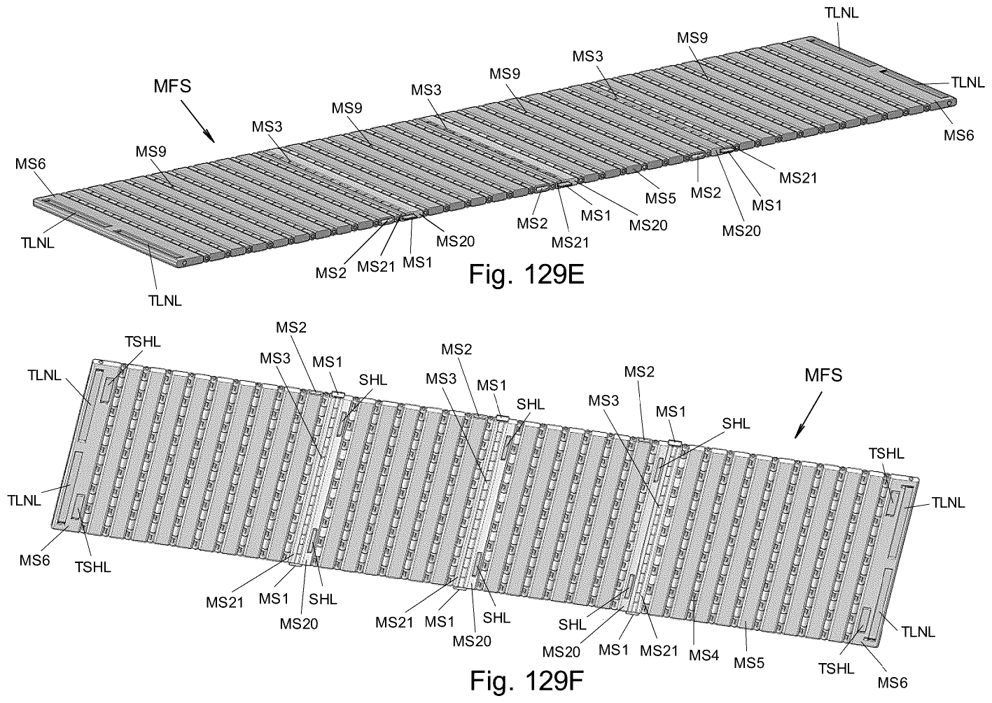

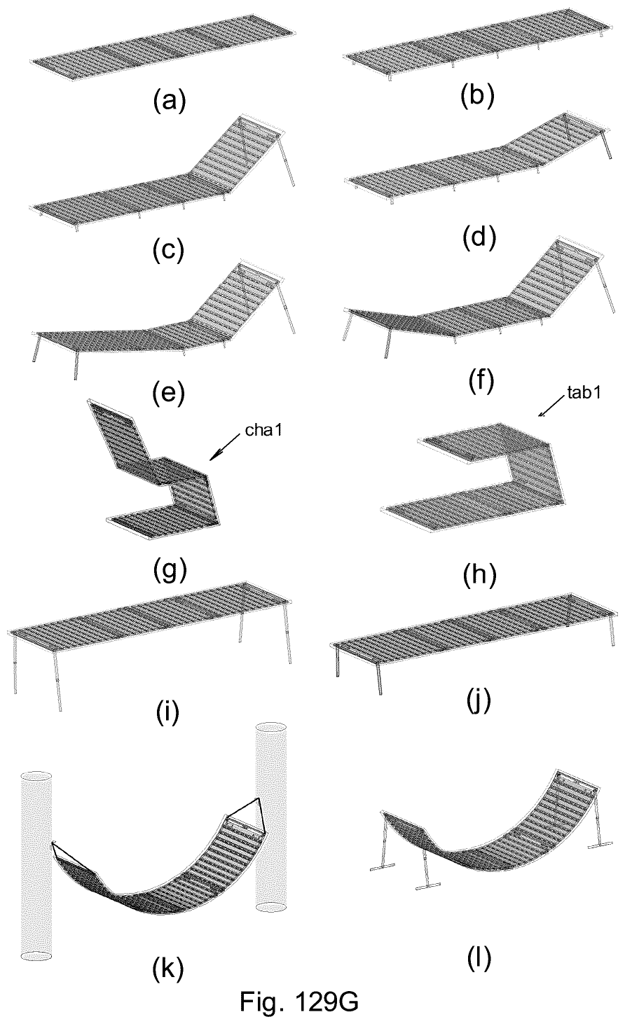

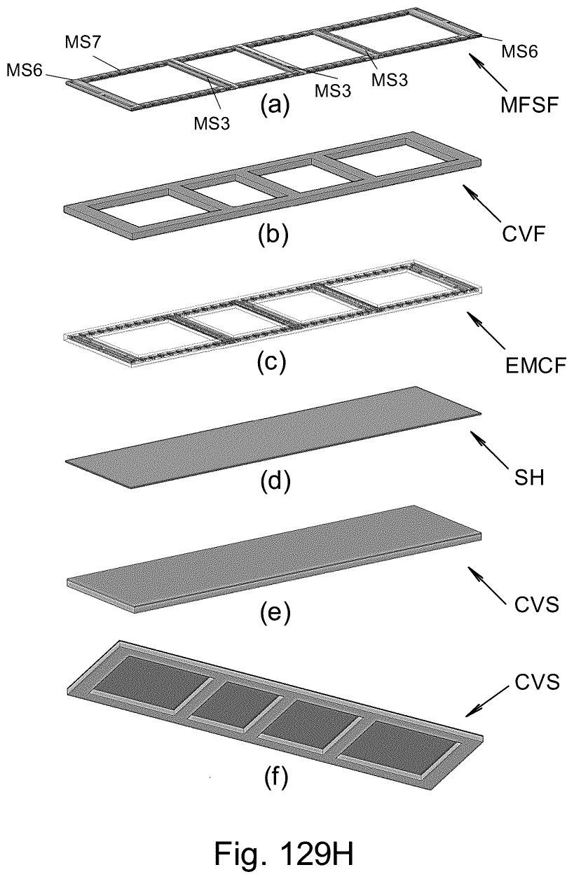

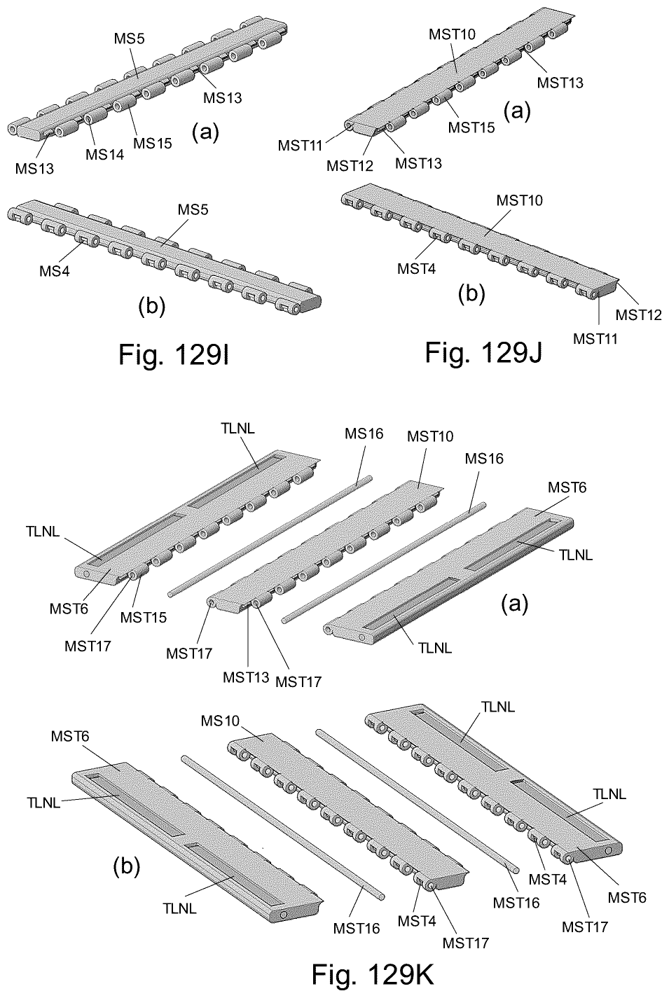

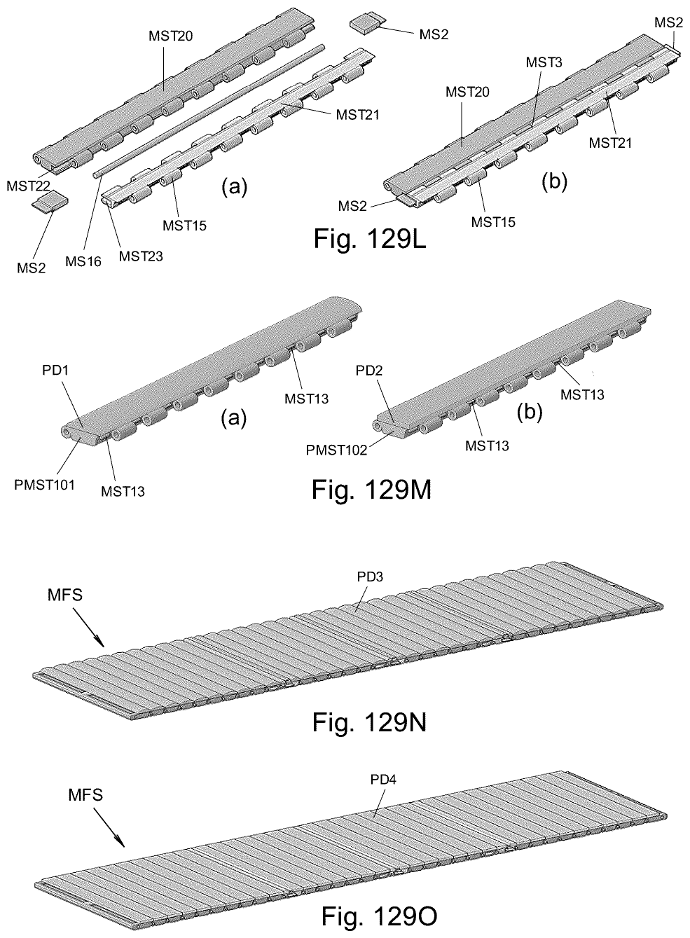

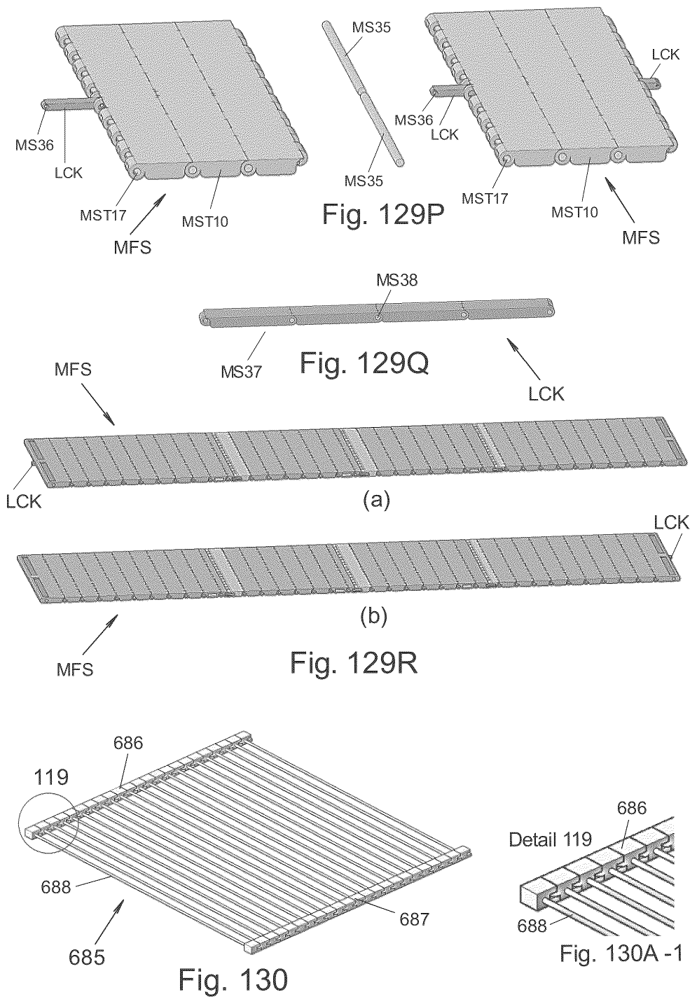

FIGS. 129A-B are a vertical cross sectional view of a cabinet with pullout shelves, shown when the shelves are extended and retracted, respectively, wherein FIGS. 129A-1, 129A-2 and 129B-1 are an enlargement of Details 116-118 thereof, respectively;

FIGS. 129C(a)-(d) are a perspective view of a leveled slotted sleeping bag and a leveled multifunctional support system, showing four stages, respectively, of a combined multifunctional sleeping bag system;

FIGS. 129D(a)-(c) are a perspective view of an enclosed multifunctional support system, wherein FIG. 129D(a) shows a leveled envelope, FIG. 129D(b) shows a leveled multifunctional support system, and FIG. 129D(c) shows the multifunctional support system when enclosed within the envelope and the envelope is rendered to be transparent;

FIGS. 129E and 129F are a perspective view of upper and lower faces, respectively, of a multifunctional support system;

FIGS. 129G(a)-(l) are a perspective view of twelve different leveled configurations, respectively, of the multifunctional support system of FIG. 129F when the enclosing envelope of sleeping bag is rendered to be transparent;

FIGS. 129H(a)-(f) are a perspective view of a framed multifunctional support system, wherein FIG. 129H(a) shows a leveled framed multifunctional support system, FIG. 129H(b) shows a leveled framed envelope, FIG. 129H(c) shows the framed multifunctional support system when enclosed within the envelope of FIG. 129H(b) and the envelope is rendered to be transparent, FIG. 129H(d) shows a leveled strengthened sheet, FIG. 129H(e) shows a top view of a strengthened framed multifunctional support system comprising the sheet of FIG. 129H(d), and FIG. 129H(f) shows a bottom view of the support system of FIG. 129H(e);

FIGS. 129I(a)-(b) are two perspective views, respectively, of an embodiment of a coupling panel suitable for restricting angular displacement in conjunction with the multifunctional support system of FIG. 129F;

FIGS. 129J(a)-(b) are two perspective views, respectively, of another embodiment of a coupling panel suitable for restricting angular displacement in conjunction with the multifunctional support system of FIG. 129F;

FIGS. 129K(a)-(b) are two perspective views, respectively, of a set of longitudinally opposed free end coupling panels used in conjunction with the multifunctional support system of FIG. 129F, shown in exploded view relative to an intermediate coupling panel;

FIGS. 129L(a)-(b) are a perspective view of two coupling panels defining an angularly unrestricted hinge, shown in exploded and assembled arrangements, respectively;

FIGS. 129M(a)-(b) are a perspective view of two coupling panels, respectively, provided with different padding elements, respectively;

FIGS. 129N and 1290 are a perspective view of the multifunctional support system of FIG. 129F that is provided with two different elongated padding members, respectively;

FIG. 129P is a perspective exploded view of a lockable multifunctional support system;

FIG. 129Q is a perspective view of an elongated bar used in conjunction with the lockable multifunctional support system of FIG. 129P;

FIGS. 129R(a)-(b) are a perspective view of the lockable multifunctional support system of FIG. 129P when leveled, shown in locked and unlocked conditions, respectively;

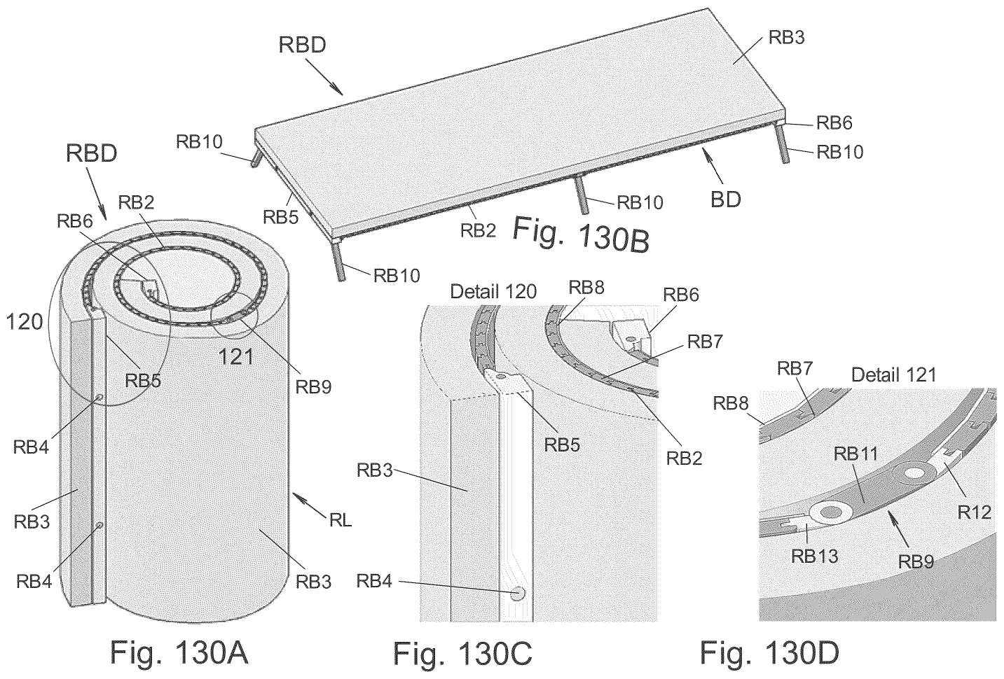

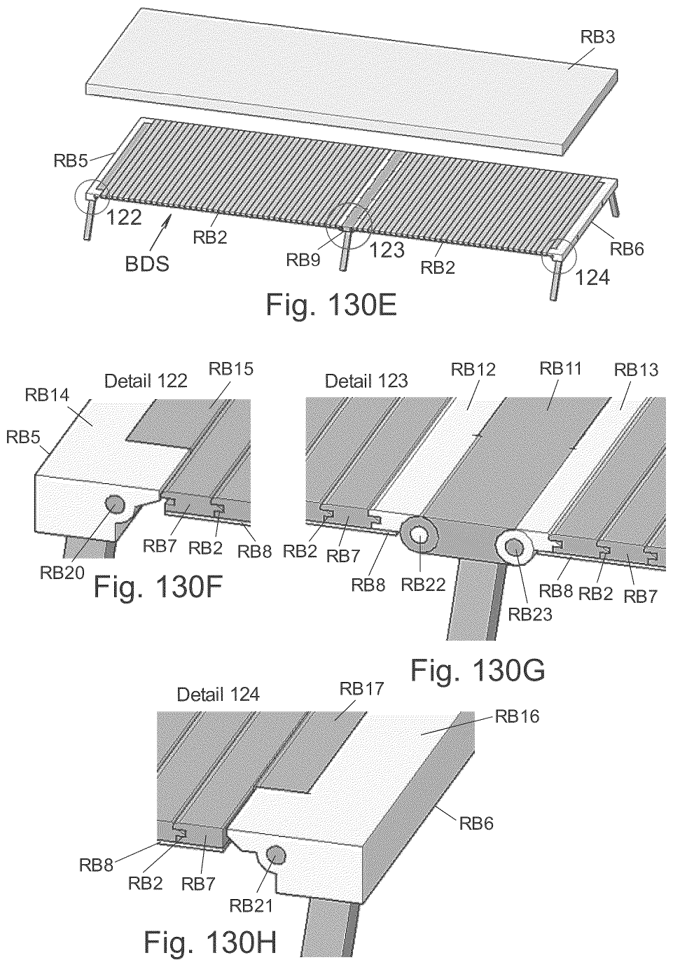

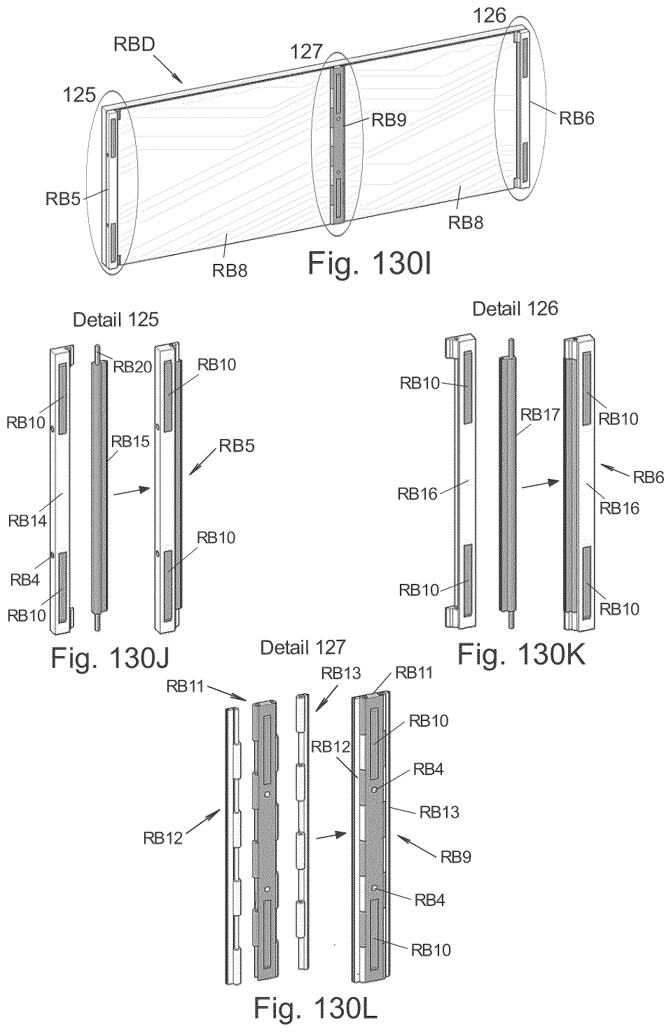

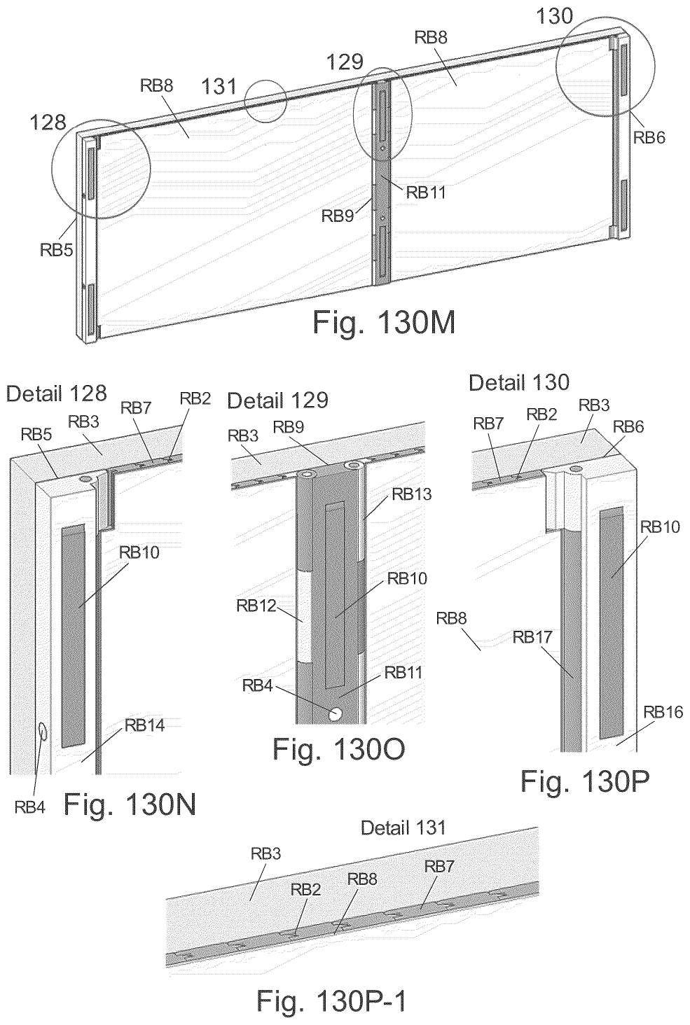

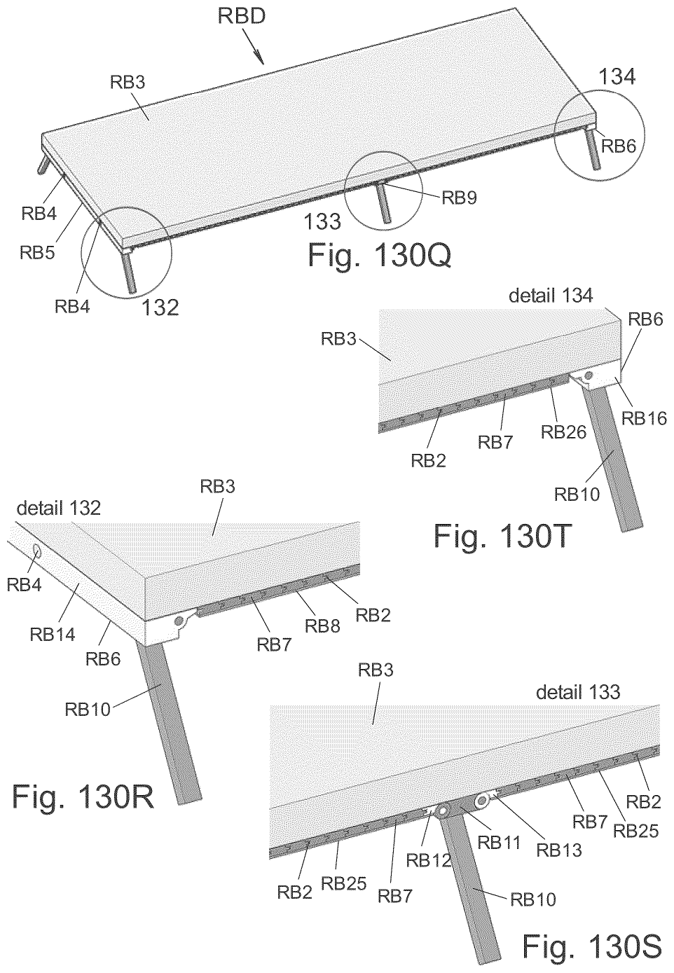

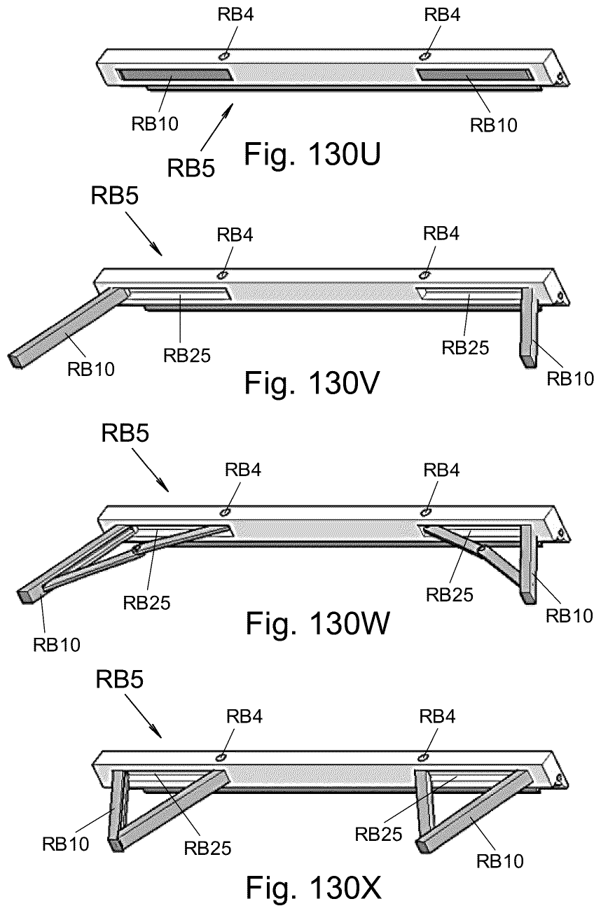

FIG. 130 is a perspective view of an embodiment of a shelf that is usable with the cabinet of FIG. 129A, wherein FIG. 130A is an enlargement of Detail 119 thereof;

FIGS. 130A-1 and 130B are a perspective view of a reconfigurable bed system shown in rolled and deployed configurations, respectively, wherein FIGS. 130C and 130D are an enlargement of Details 120-121 thereof, respectively;

FIG. 130E is an exploded view of the bed system of FIG. 130B, wherein FIGS. 130F-H are an enlargement of Details 122-124 thereof, respectively;

FIG. 130I is a perspective view of the underside of the bed system of FIG. 130B, wherein FIGS. 130J-L are an enlargement of Details 125-127 thereof, respectively, such that each of the enlargements shows both exploded and assembled views of a given support element;

FIG. 130M is a perspective view of the underside of the bed system of FIG. 130B, shown when the legs are pivoted to a closed position, wherein FIGS. 130N-P and 130P-1 are an enlargement of Details 128-131 thereof, respectively;

FIG. 130Q is a perspective view of the bed system of FIG. 130B, shown when the legs are pivoted to a deployed position, wherein FIGS. 130R-T are an enlargement of Details 132-134 thereof, respectively;

FIG. 130U is another perspective view of the support element of FIG. 130J, shown when the leg is pivoted to an undeployed position;

FIGS. 130V-X is a perspective view of the support element of FIG. 130J, shown when the leg is pivoted to a deployed position by means of three different pivoting facilitating configurations, respectively;

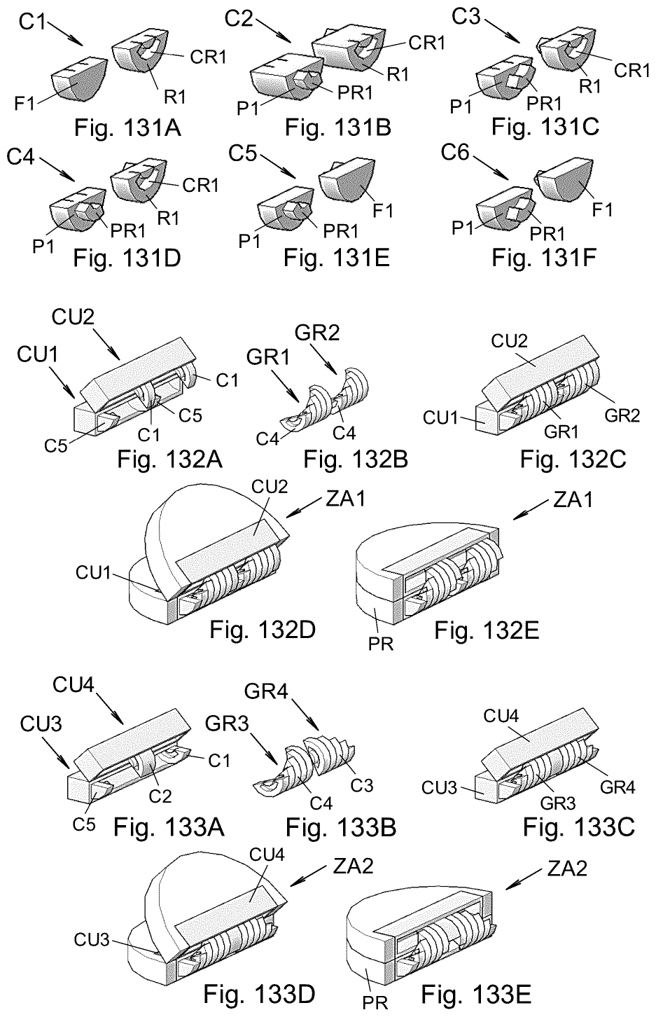

FIGS. 131A-F are a perspective view of six different arcuate arm configurations, respectively, for use in an embodiment of a completely coplanar hinge, each shown in a front view and a differently configured rear view;

FIG. 132A is a perspective view of two cuboids set at a pivoted position that are insertable in a completely coplanar hinge according to an embodiment, shown without the face-interconnected arcuate arms;

FIG. 132B is a perspective view of two groups of face-interconnected arcuate arms when set at a pivoted position, shown without the cuboids;

FIG. 132C is a perspective view of pivot producing elements, including the face-interconnected arcuate arms of FIG. 132B and the cuboids, when set at a first pivoted position;

FIG. 132D is a perspective view of an embodiment of a completely coplanar hinge set at the first pivoted position, shown with the pivot producing elements of FIG. 132C;

FIG. 132E is a perspective view of the completely coplanar hinge of FIG. 132D when set at a second pivoted position;

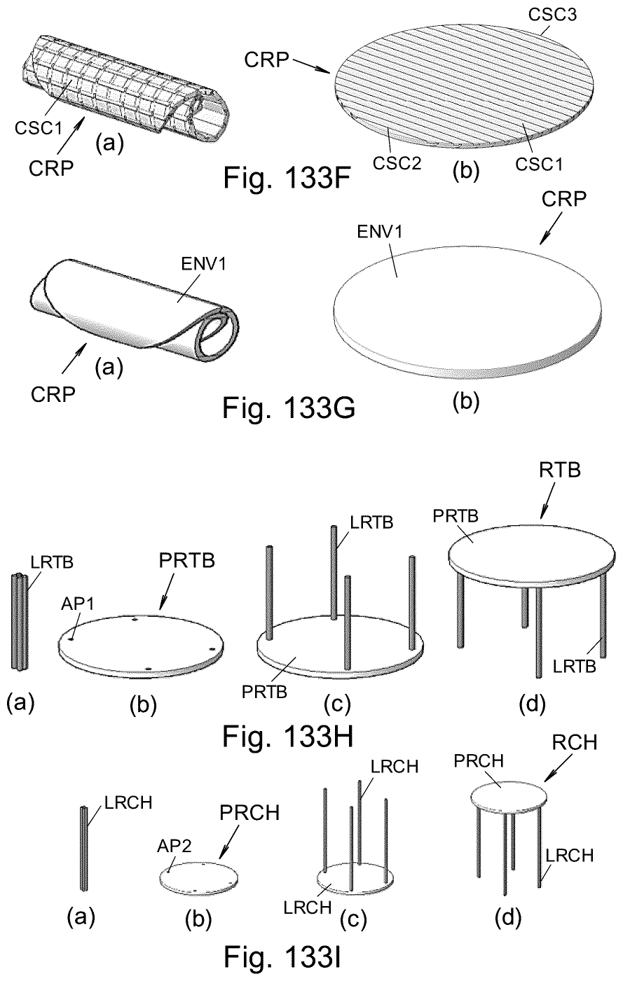

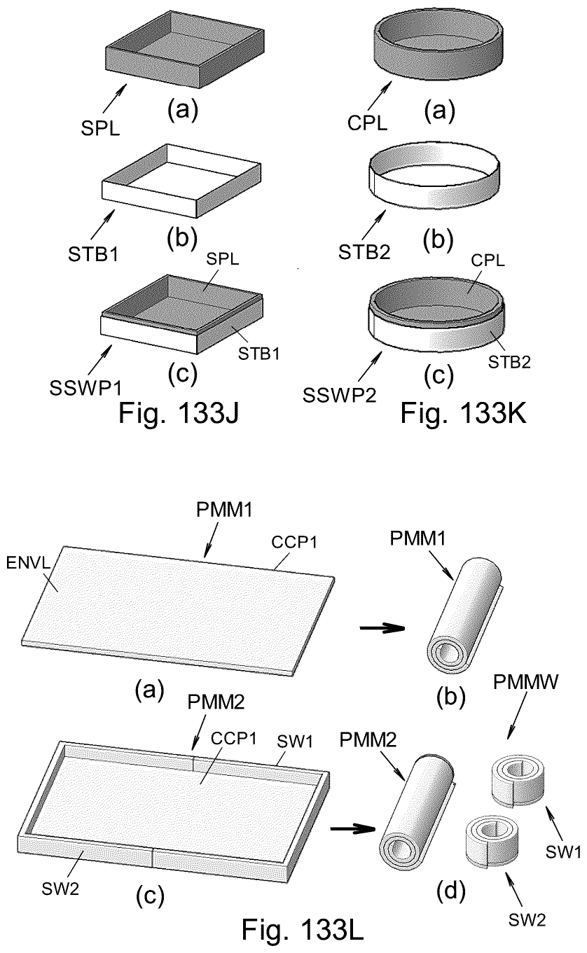

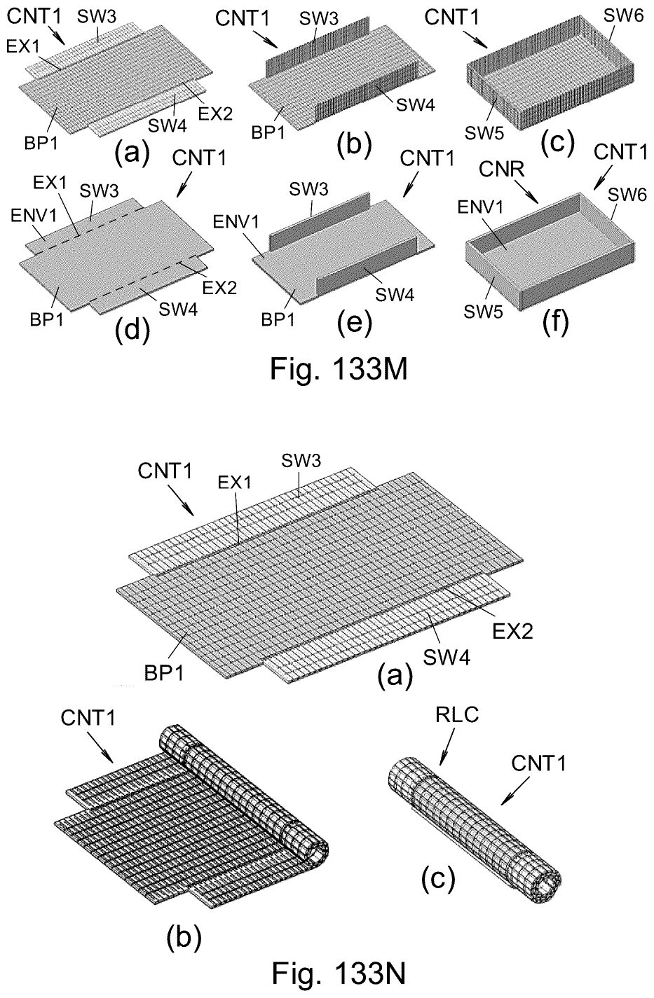

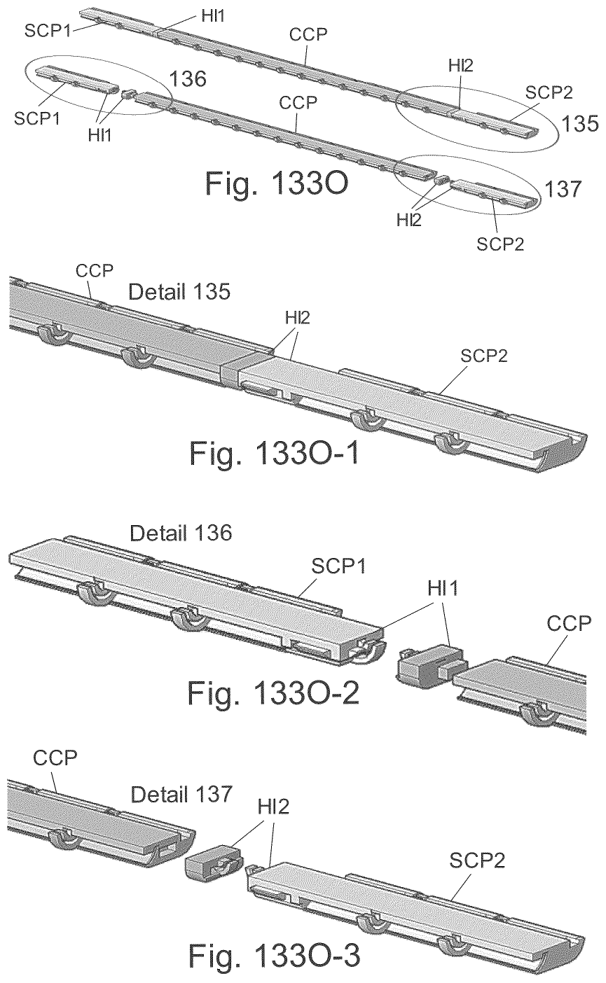

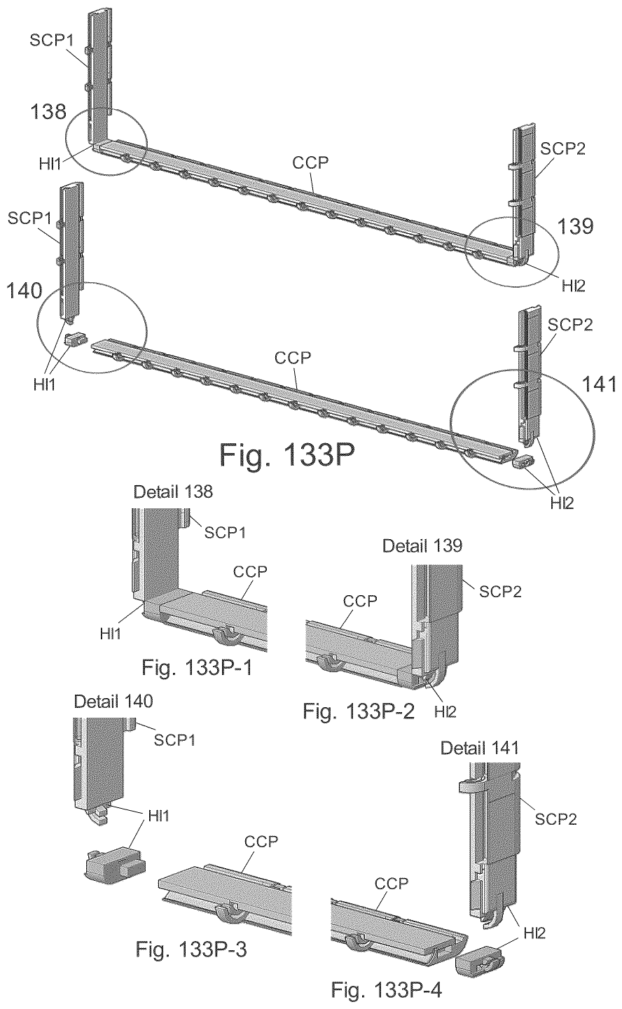

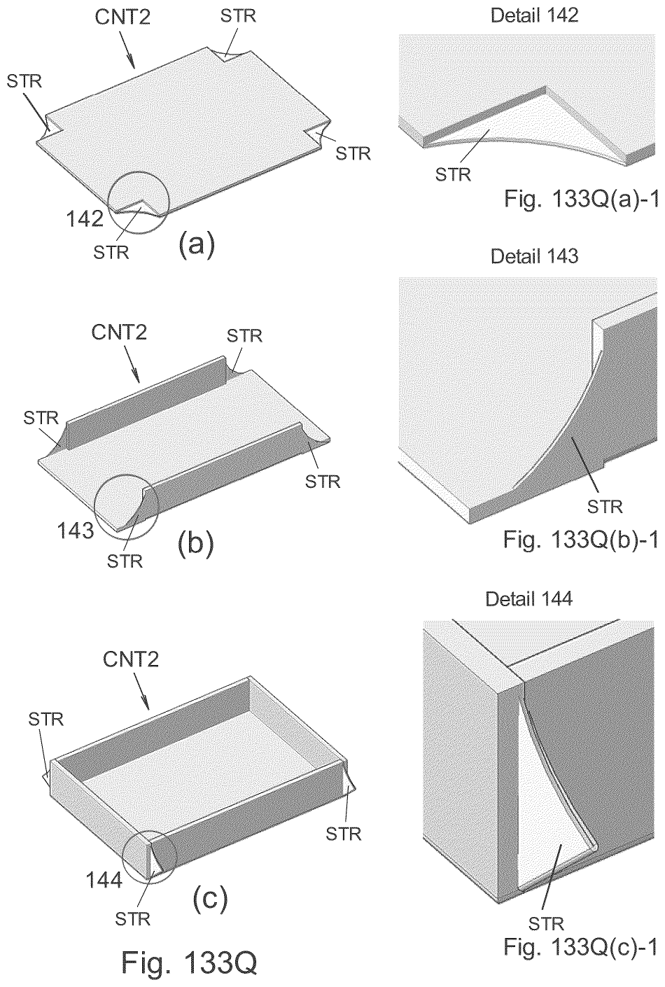

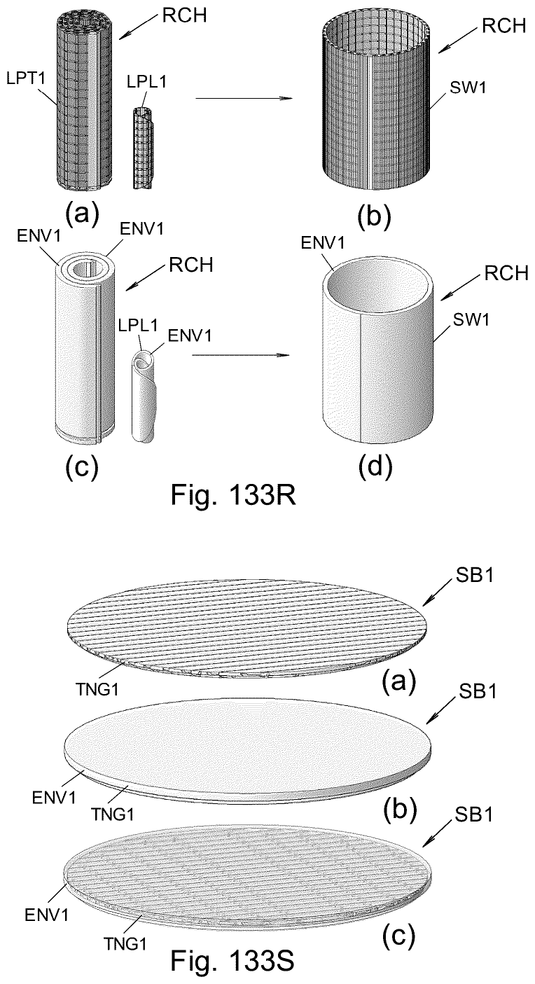

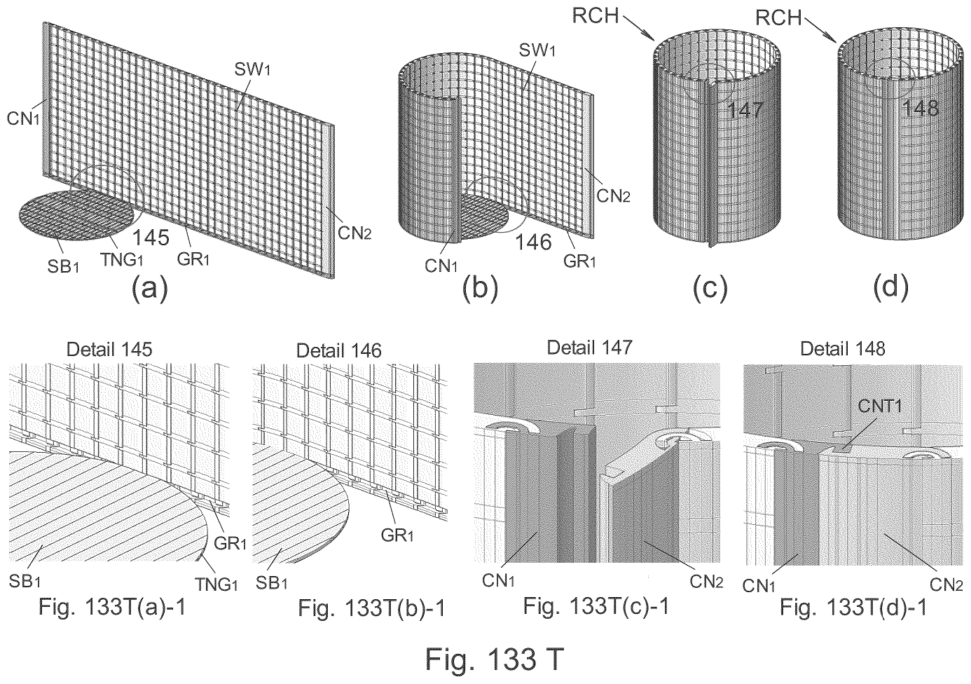

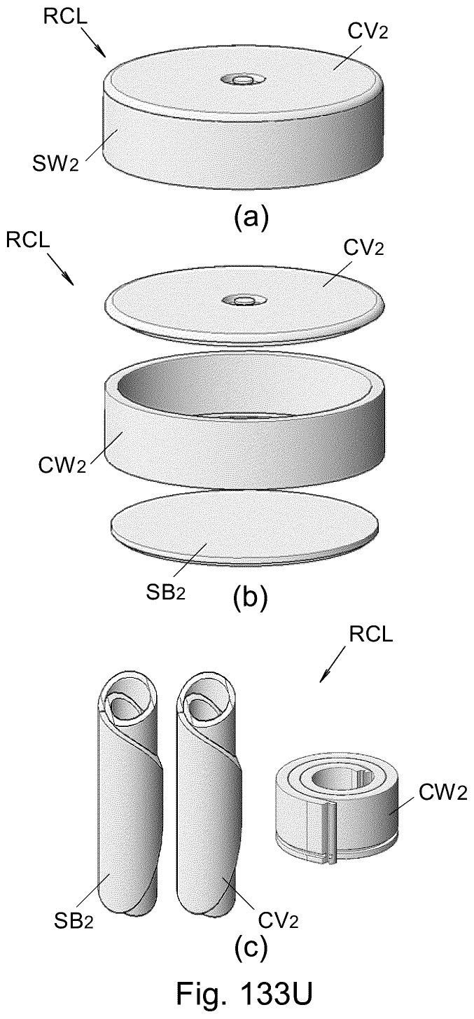

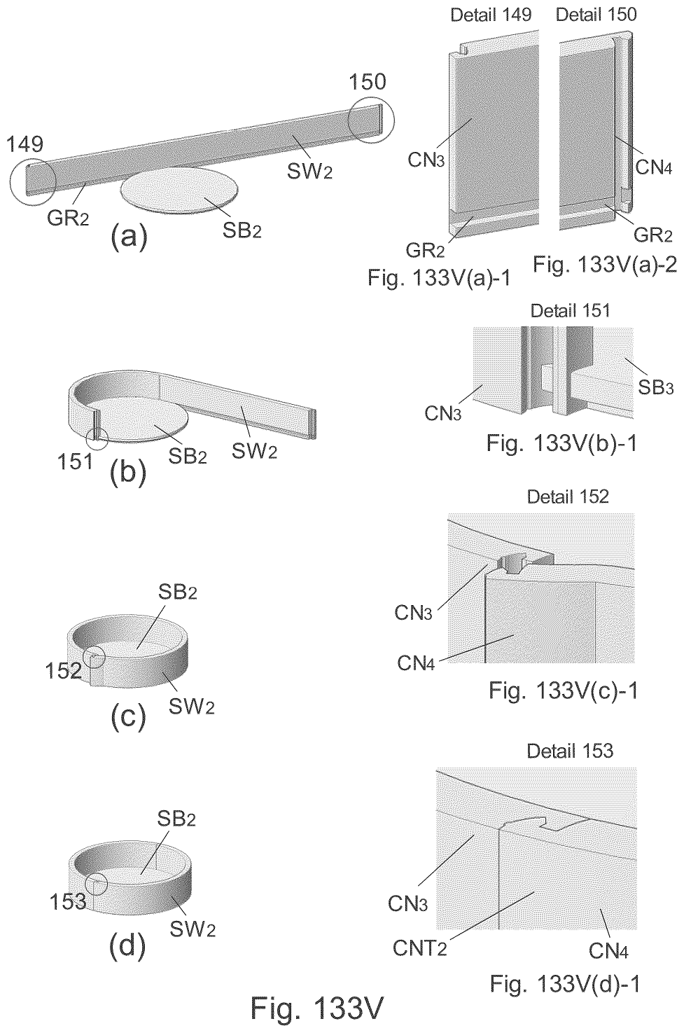

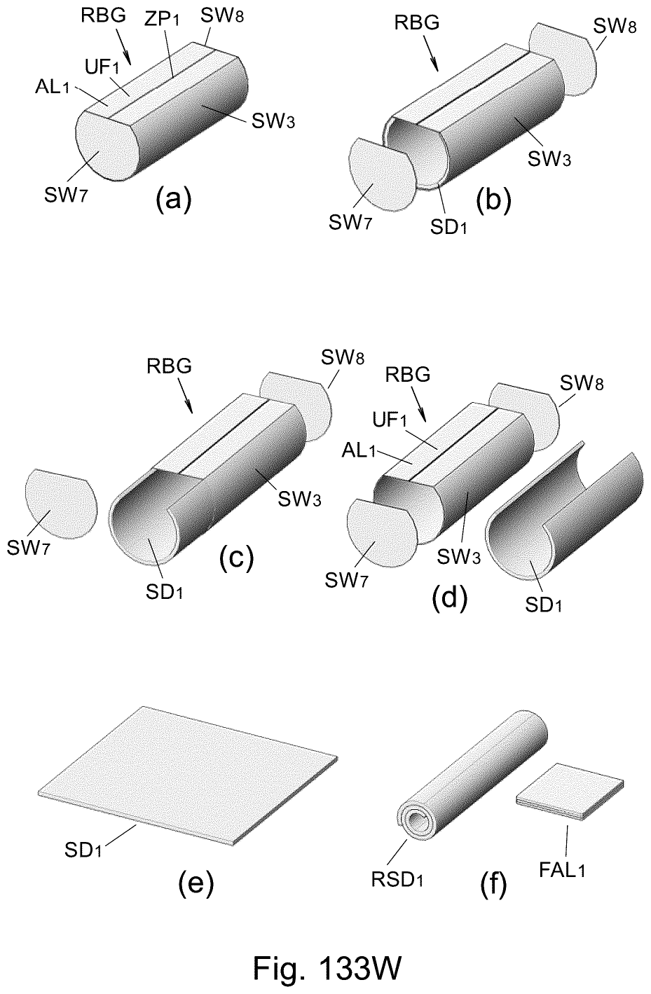

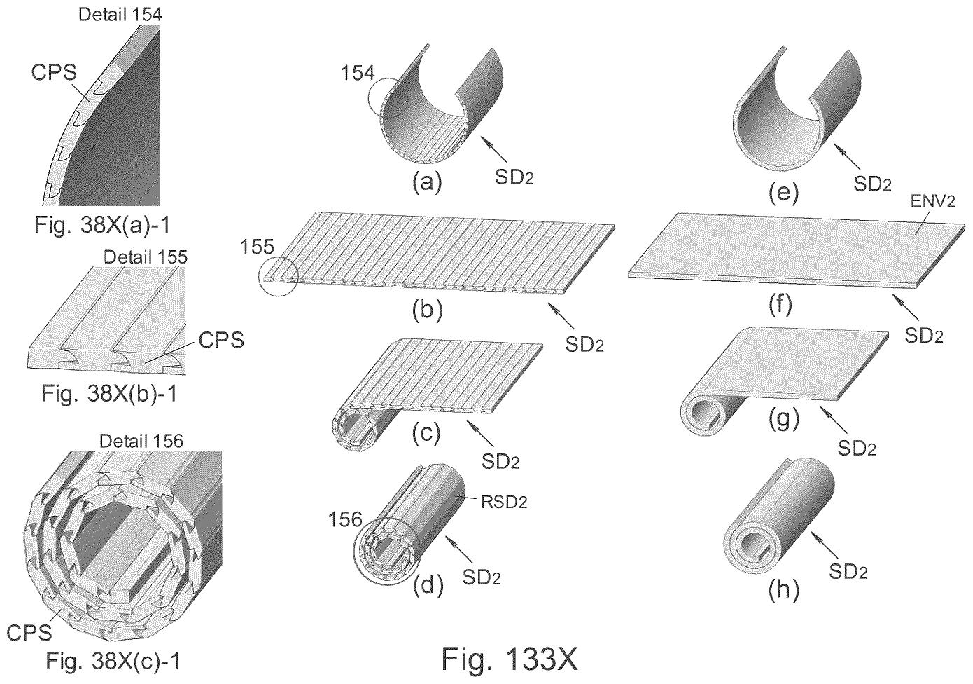

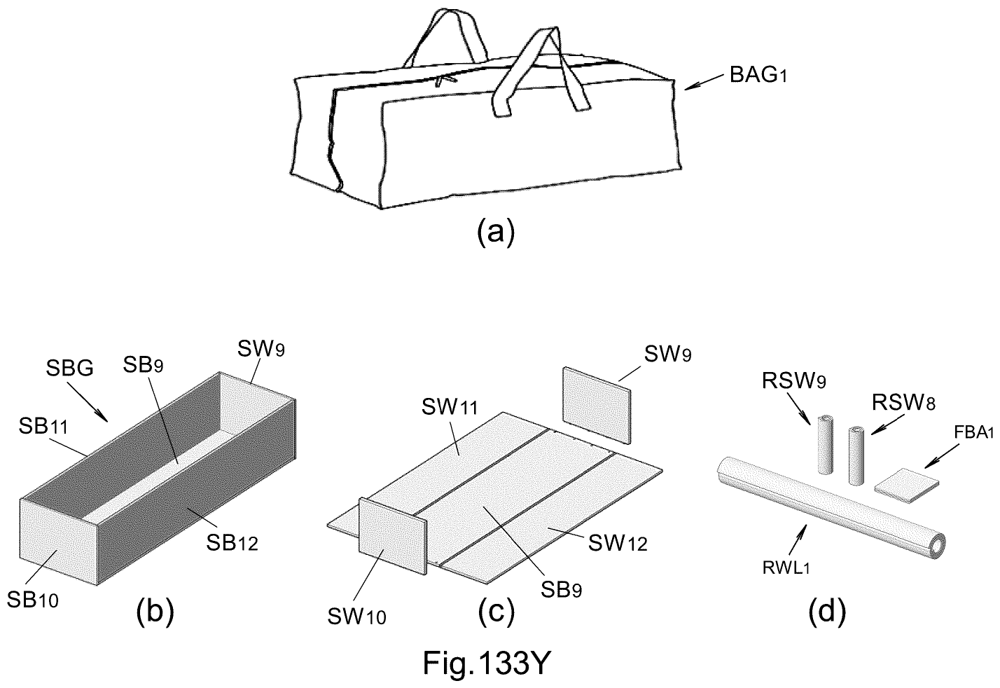

FIG. 133A is a perspective view of two cuboids set at a pivoted position that are insertable in a completely coplanar hinge according to another embodiment, shown without the face-interconnected arcuate arms;

FIG. 133B is a perspective view of two groups of face-interconnected arcuate arms when set at a pivoted position, shown without the cuboids;

FIG. 133C is a perspective view of pivot producing elements, including the face-interconnected arcuate arms of FIG. 133B and the cuboids, when set at a first pivoted position;

FIG. 133D is a perspective view of an embodiment of a completely coplanar hinge set at the first pivoted position, shown with the pivot producing elements of FIG. 133C;

FIG. 133E is a perspective view of the completely coplanar hinge of FIG. 133D when set at a second pivoted position;

FIGS. 133F(a)-(b) are a perspective view of a plate for use in a rollable table, shown in rolled and unrolled configurations, respectively;

FIGS. 133G(a)-(b) are a perspective view of a plate covered with a protective envelope for use in a rollable table, shown in rolled and unrolled configurations, respectively;

FIGS. 133H(a)-(d) are a perspective view of four stages, respectively, for assembling a rollable table in conjunction with the plate of FIG. 133F(b);

FIGS. 133I(a)-(d) are a perspective view of four stages, respectively, for assembling a rollable stool in conjunction with the plate of FIG. 133F(b);

FIGS. 133J(a)-(c) are a perspective view of a reinforced square pool, showing the pool component, the reinforcing outer band connecting system, and the assembled pool, respectively;

FIGS. 133K(a)-(c) are a perspective view of a reinforced circular pool, showing the pool component, the reinforcing outer band connecting system, and the assembled pool, respectively;

FIGS. 133L(a)-(b) are a perspective view of a rollable plate system for mixing materials according to one embodiment, shown in unrolled and rolled configurations, respectively;

FIGS. 133L(c)-(d) are a perspective view of a rollable plate system for mixing materials according to another embodiment, shown in unrolled and rolled configurations, respectively;

FIGS. 133M(a)-(c) are a perspective view of three stages, respectively, for assembling a rollable rectilinear container configured according to one embodiment;

FIGS. 133M(d)-(f) are a perspective view of three stages, respectively, for assembling a rollable rectilinear container when the apparatus of FIG. 133M(a) is covered with a protective envelope;

FIGS. 133N(a)-(c) are a perspective view of three stages, respectively, for rolling the apparatus of FIG. 133M(a);

FIG. 133O is a perspective view of one strap of coupling panels from which the apparatus of FIG. 133M(a) is comprised shown in unpivoted assembled and exploded configurations, wherein FIGS. 133O-1, 133O-2 and 133O-3 are an enlargement of Details 135-137 thereof, respectively;

FIG. 133P is a perspective view of one strap of coupling panels from which the apparatus of FIG. 133M(a) is comprised shown in pivoted assembled and exploded configurations, wherein FIGS. 133P-1, 133P-2, 133P-3 and 133P-4 are an enlargement of Details 138-141 thereof, respectively;

FIGS. 133Q(a)-(c) are a perspective view of three stages, respectively, for assembling a rollable rectilinear container configured according to another embodiment, wherein FIGS. 133Q(a)-1, 133Q(b)-1 and 133Q(c)-1 are an enlargement of Details 142-144 thereof, respectively;

FIGS. 133R(a)-(b) are a perspective view of a rollable tubular container system according to one embodiment, shown in rolled and unrolled configurations, respectively;

FIGS. 133R(c)-(d) are a perspective view of a rollable tubular container system when the apparatus of FIG. 133R(a) is covered with a protective envelope, shown in rolled and unrolled configurations, respectively;

FIGS. 133S(a)-(c) are a perspective view of a base plate used in conjunction with the container of FIG. 133R(b), shown when uncovered, when covered by a protective envelope and when the envelope is rendered transparent, respectively;

FIGS. 133T(a)-(d) are a perspective view of four stages, respectively, for assembling the container of FIG. 133R(b), wherein FIGS. 133T(a)-1, 133T(b)-1, 133T(c)-1 and 133T(d)-1 are an enlargement of Details 145-148 thereof, respectively;

FIGS. 133U(a)-(c) are a perspective view of a rollable tubular container system according to another embodiment, shown in assembled, exploded and rolled configurations, respectively;

FIGS. 133V(a)-(d) are a perspective view of four stages, respectively, for assembling the container of FIG. 133U(a), wherein FIGS. 133V(a)-1, 133V(a)-2, 133V(b)-1, 133V(c)-1 and 133V(d)-1 are an enlargement of Details 149-153 thereof, respectively;

FIGS. 133W(a)-(f) are a perspective view of a stiffened rounded bag according to one embodiment, shown in an assembled configuration and in five disassembly stages, respectively;

FIGS. 133X(a)-(d) are a perspective view of an uncovered liner according to one embodiment for use in a stiffened rounded bag, shown when leveled, unleveled, partially rolled, and completely rolled, respectively, wherein FIGS. 133X(a)-1, 133X(b)-1 and 133X(d)-1 are an enlargement of Details 154-156 thereof, respectively;

FIGS. 133X(e)-(h) are a perspective view of the liner of FIG. 133X(a) when covered by a protective envelope, shown when leveled, unleveled, partially rolled, and completely rolled, respectively;

FIGS. 133Y(a)-(d) are a perspective view of a bag system, showing a flexible bag, a connecting system for stiffening the bag, two detached sidewalls of the connecting systems, and rolled or folded components thereof, respectively;

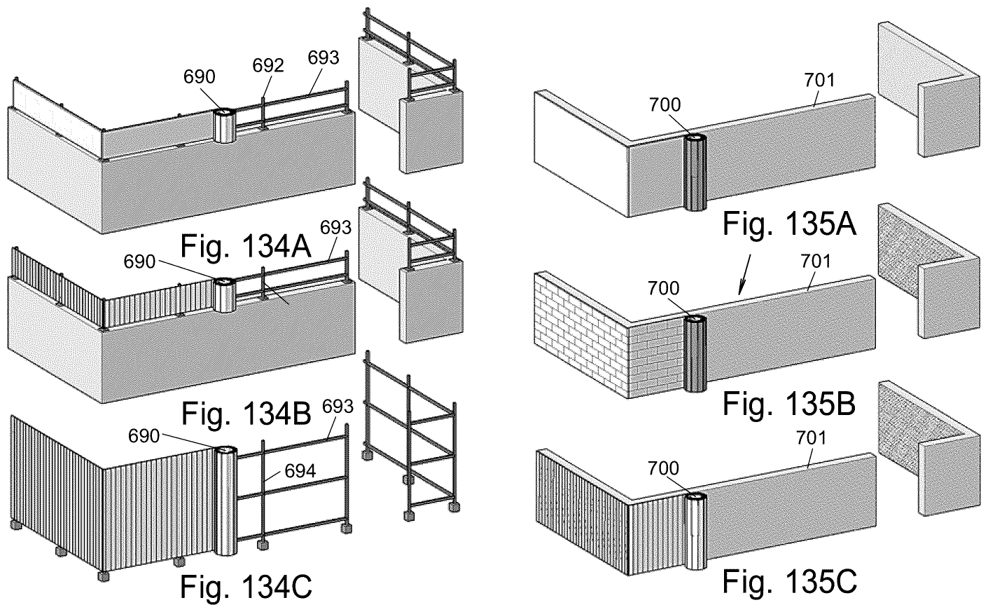

FIGS. 134A-C are a perspective view of a fence application system, showing three different rolls of a connecting system, respectively, while being applied to a fence frame;

FIGS. 135A-C are a perspective view of a fence application system, showing three different rolls of a connecting system, respectively, while being applied to a constructed wall;

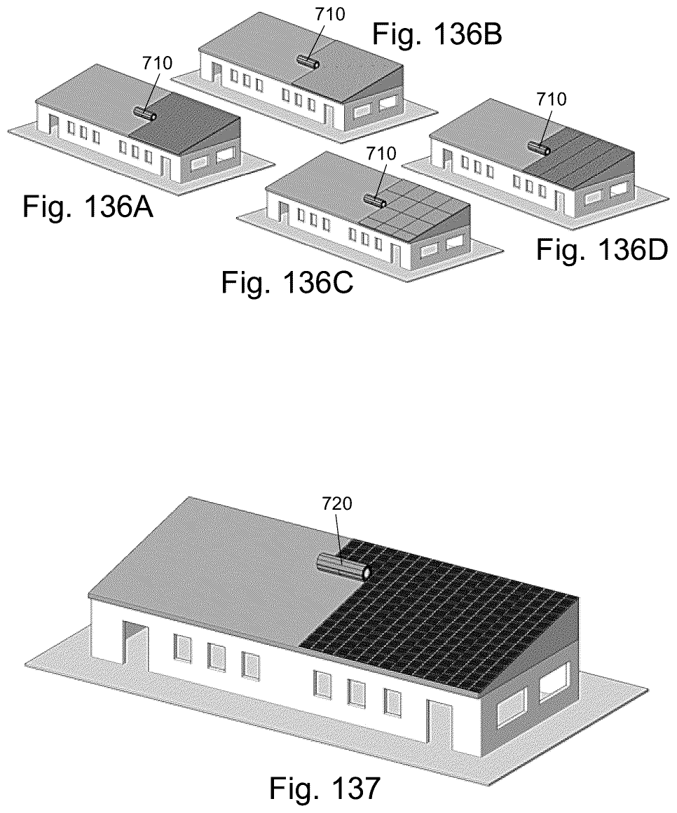

FIGS. 136A-D are a perspective view of a roofing application system, showing four different rolls of a connecting system, respectively, while being applied to a roof surface;

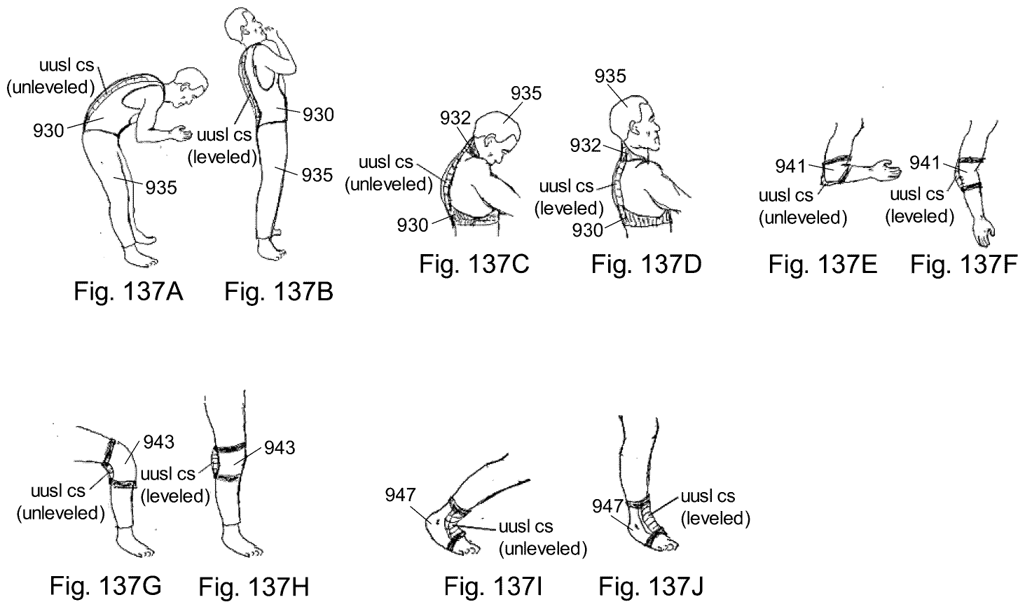

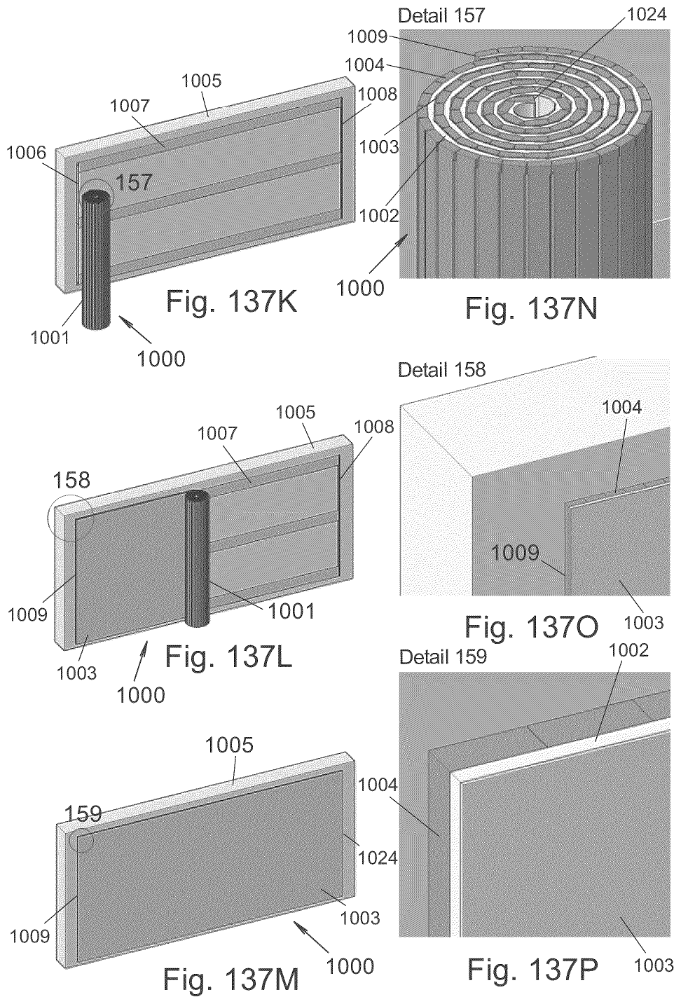

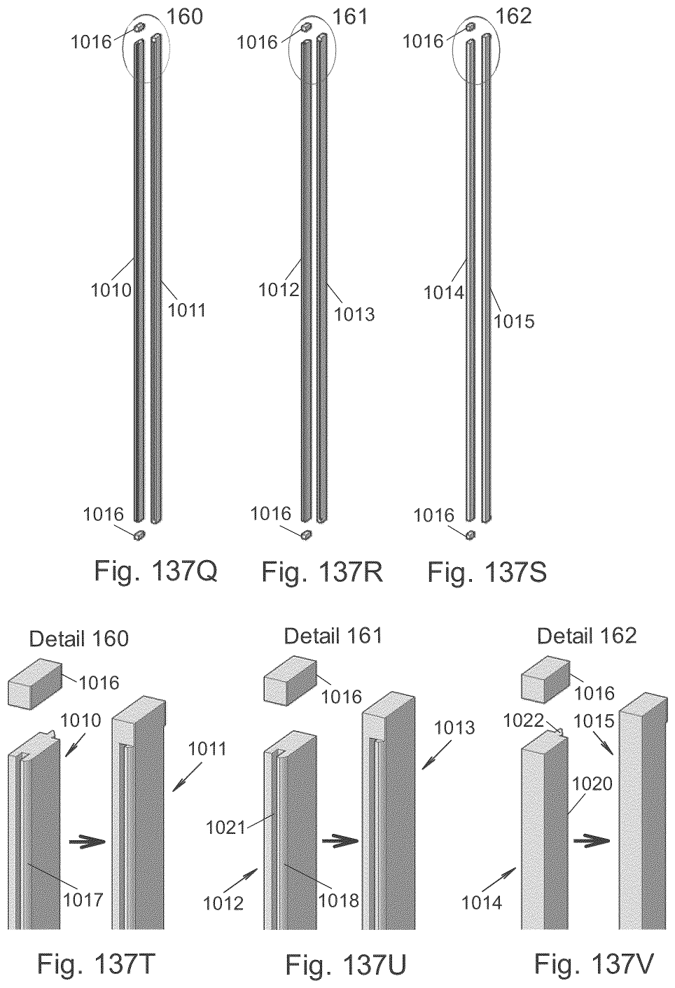

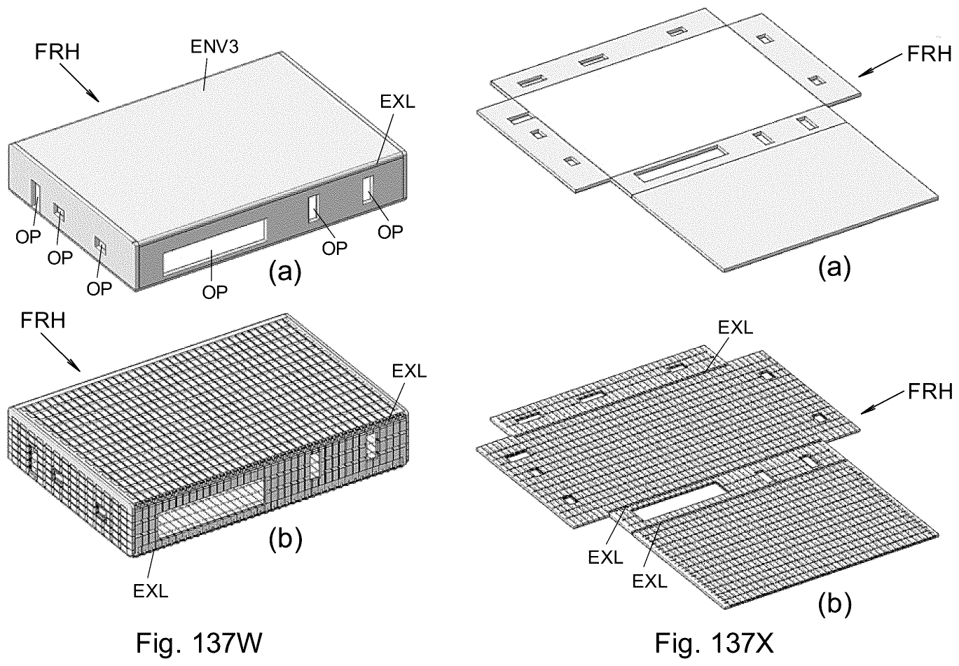

FIG. 137 is a perspective view of a solar cell sheet application system, while being applied to a roof surface;

FIGS. 137A-D are a perspective view of a safety vest, shown when worn by a user and unleveled in FIGS. 17A and 137C and leveled in FIGS. 137B and 137D;

FIGS. 137E-J are a perspective view of a safety garment, showing an unleveled elbow sleeve, leveled elbow sleeve, unleveled knee sleeve, leveled knee sleeve, unleveled ankle brace and leveled knee brace, respectively, when worn by a user;

FIGS. 137K-M are a perspective view of a rollable screen system, shown when unmounted, partially mounted, and completely mounted onto a wall, respectively, wherein FIGS. 137N-P are an enlargement of Details 157-159 thereof;

FIGS. 137Q-S are a perspective view of three coupling panels, respectively, used in conjunction with the screen system of FIG. 137K, each shown in exploded and assembled views, wherein FIGS. 137T-V are an enlargement of Details 160-162 thereof;

FIGS. 137W(a)-(b) are a perspective view of an assembled structure, shown when covered and uncovered, respectively, by a protective envelope;

FIGS. 137X(a)-(b) are a perspective view of the structure of FIG. 137W(a) in a flattened configuration, shown when covered and uncovered, respectively, by a protective envelope;

FIGS. 138A-C are a perspective view of a two-layered sheet for use as an unsegmented web;

FIGS. 139A-B are a perspective view of a four-layered sheet for use as an unsegmented web;

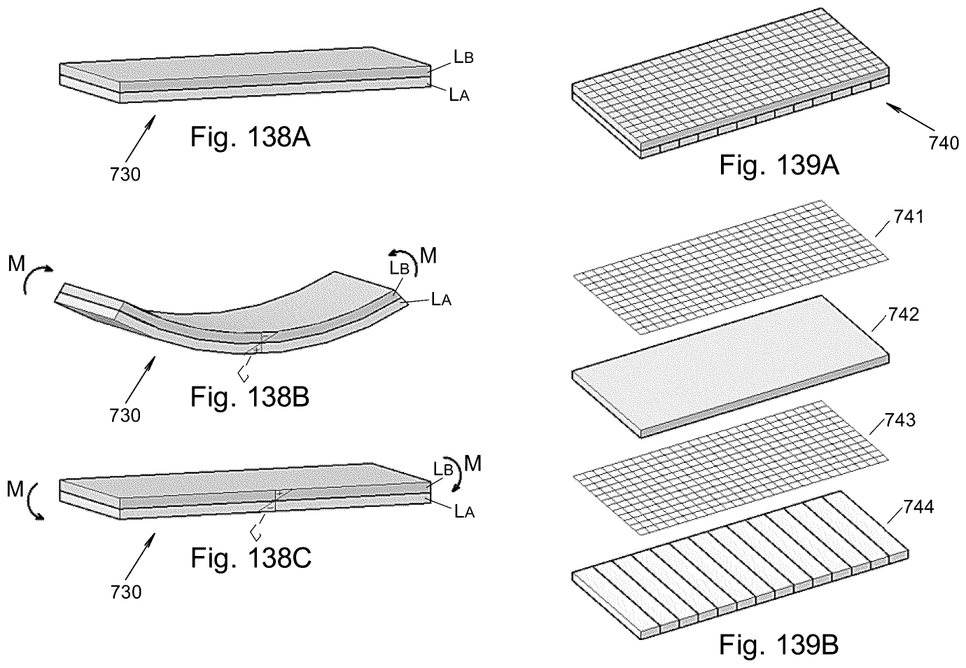

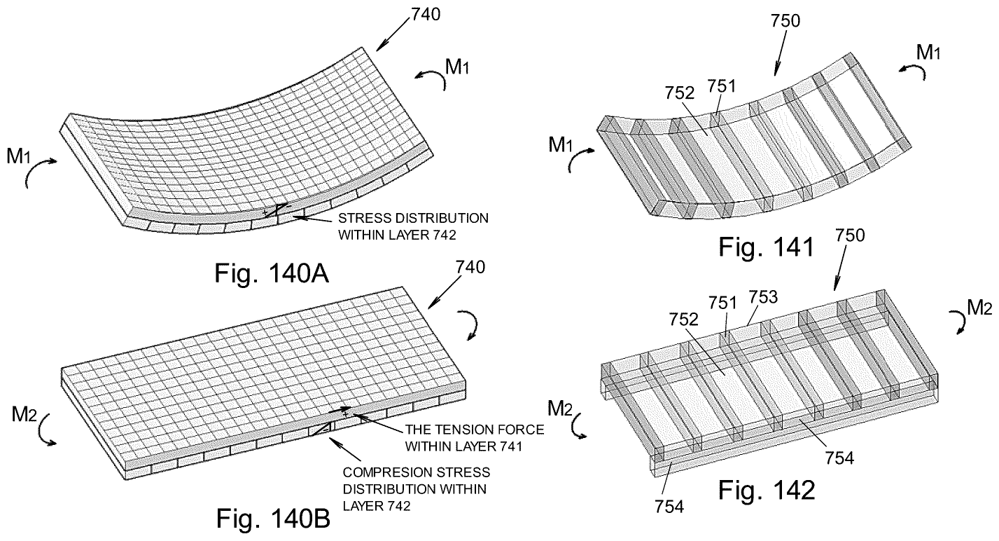

FIGS. 140A-B are a perspective view of the sheet of FIG. 139A, showing its unidirectionally bending capabilities;

FIGS. 141 and 142 are a perspective view of another embodiment of a sheet rendered transparent for use as an unsegmented web, showing its unidirectionally bending capabilities;

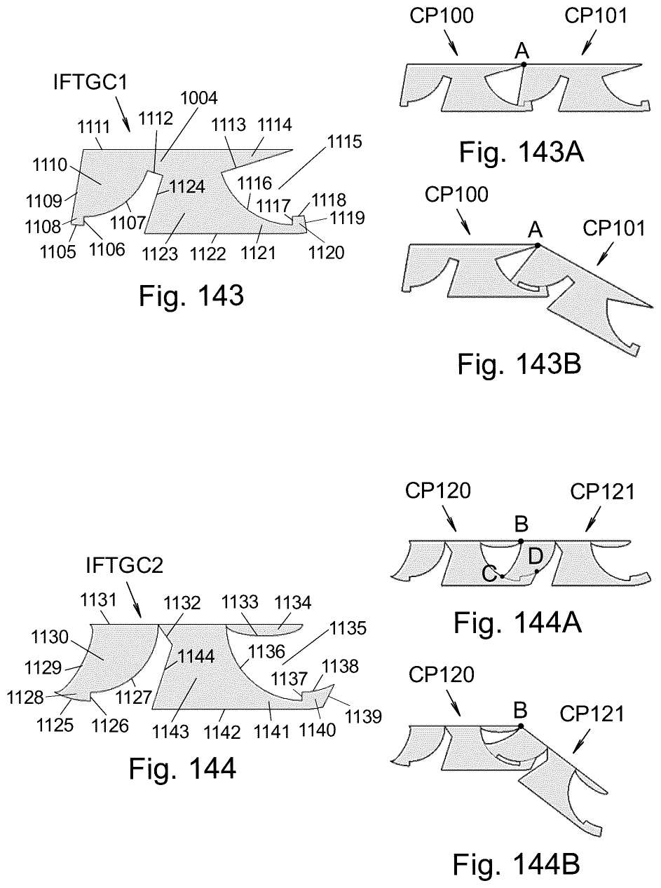

FIG. 143 is a side view of another embodiment of a coupling panel, wherein two interjoined coupling panels of which are shown in a level configuration in FIG. 143A and in an unleveled configuration on FIG. 143B;

FIG. 144 is a side view of another embodiment of a coupling panel, wherein two interjoined coupling panels of which are shown in a level configuration in FIG. 144A and in an unleveled configuration in FIG. 144B;

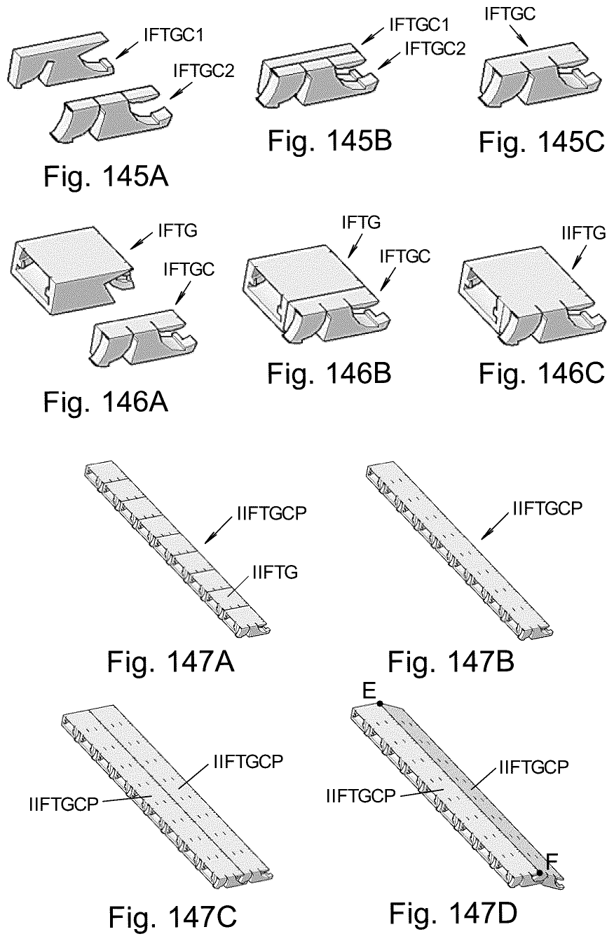

FIGS. 145A-C are a perspective view of a composite coupling panel that includes the coupling panel of FIG. 143, shown in exploded, abutting and cast views, respectively;

FIGS. 146A-C are a perspective view of a composite coupling panel that includes the composite coupling panel of FIG. 145C, shown in exploded, abutting and cast views, respectively;

FIGS. 147A-B are a perspective view of an elongated coupling panel comprising a plurality of the composite coupling panels of FIG. 146C, shown in abutting and cast views, respectively;

FIGS. 147C-D are a perspective view of two interjoined elongated coupling panels of FIG. 147B, shown in leveled and unleveled configurations, respectively;

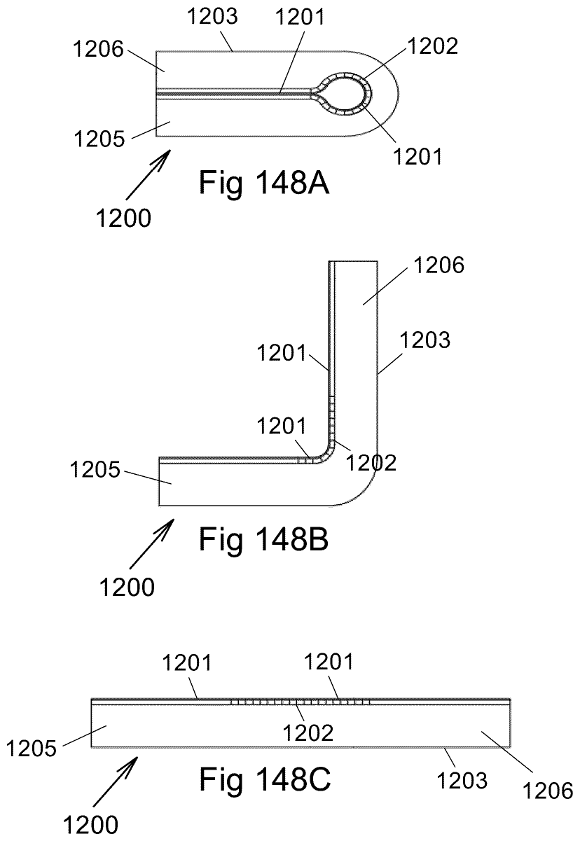

FIGS. 148A-C are a side view of a smartphone comprising a connecting system according to an embodiment, shown in completely closed, partially closed, and completely opened configurations, respectively;

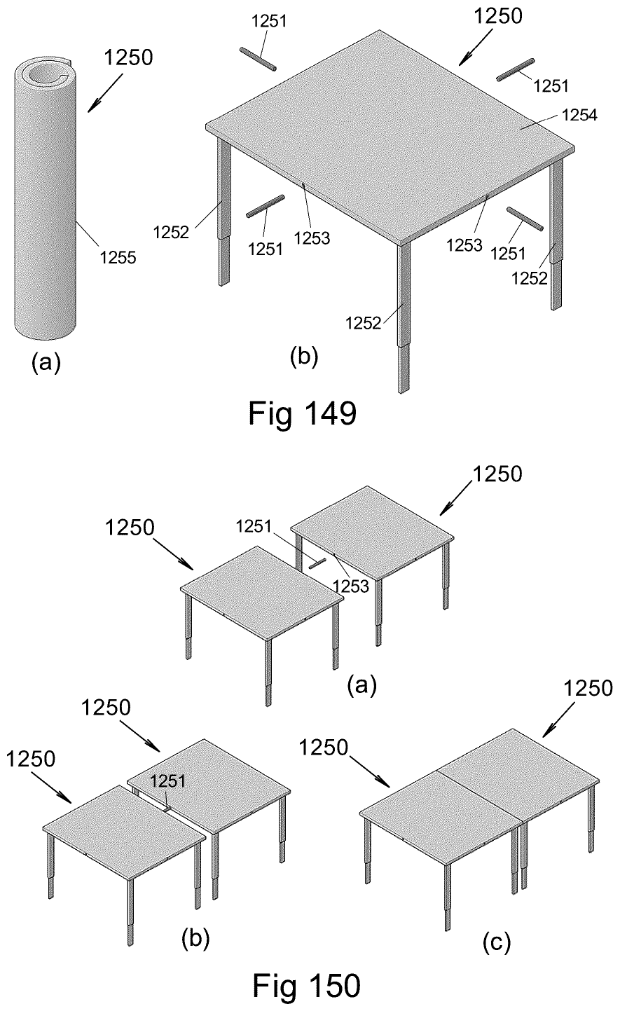

FIGS. 149(a)-(b) are a perspective view of a table system, shown in undeployed roll form and in expanded deployed form, respectively;

FIGS. 150(a)-(c) are a perspective view of three stages of stabilized and modular coupling of the table of FIG. 149(b) to an adjacent table;

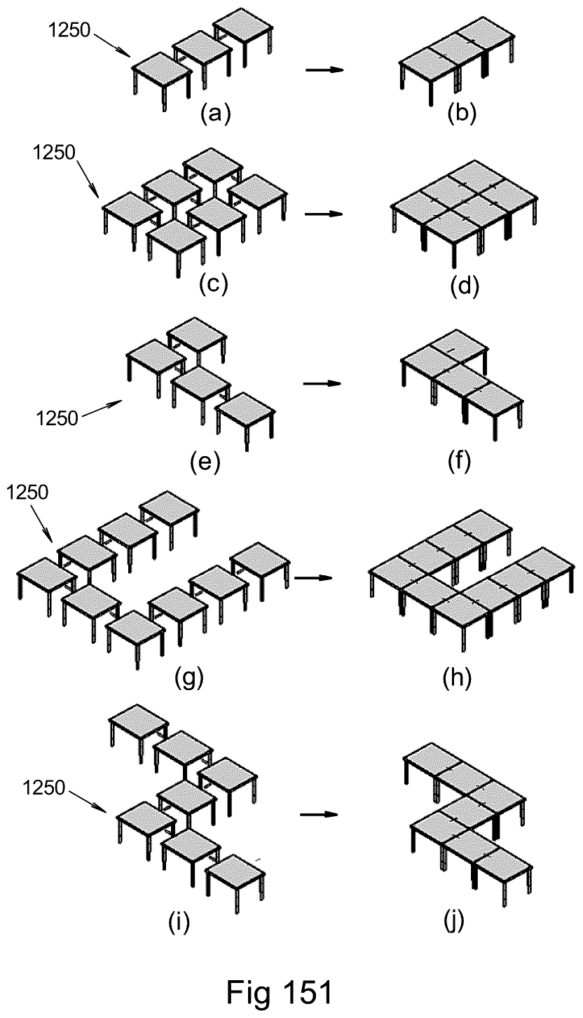

FIGS. 151(a)-(b), 151(c)-(d), 151(e)-(f), 151(g)-(h) and 151(i)-(j) are a perspective view of five different modular configurations, respectively, by which the table of FIG. 149(b) is coupled to an adjacent table, the first drawing of a pair of drawings showing the relative position of the tables prior to being coupled together;

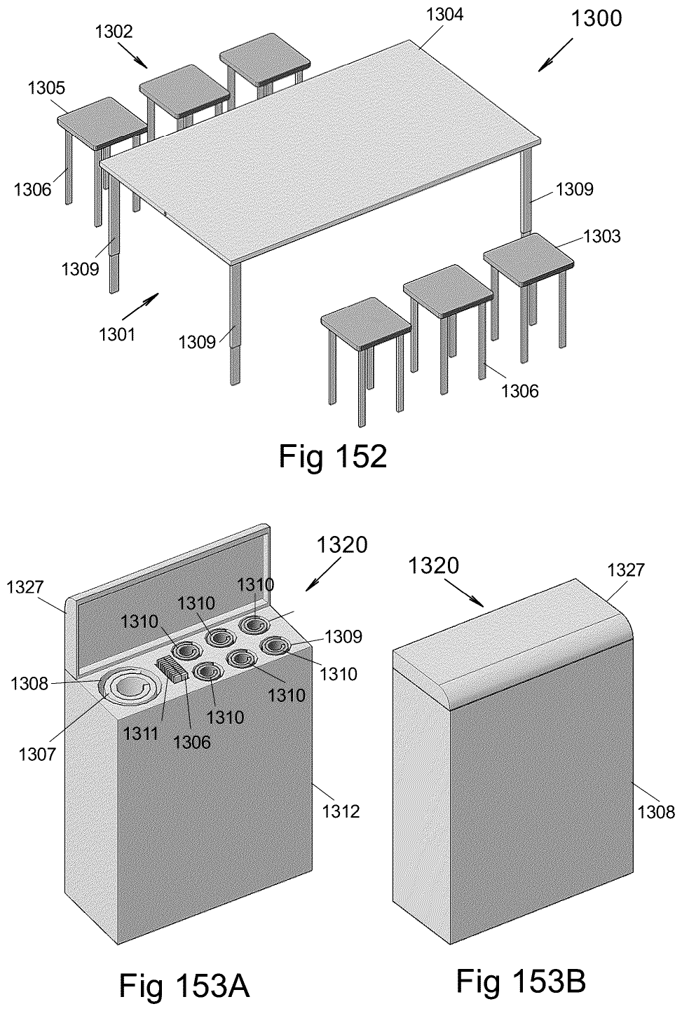

FIG. 152 is a perspective view of a table and stool system, shown when deployed; and

FIGS. 153A-B is a perspective view of a storage device within cavities of which the table and stools of FIG. 152 are stored in roll form, shown when a pivotal lid is in an opened and closed position, respectively.

### DETAILED DESCRIPTION OF THE INVENTION

A reconfigurable web, whether a segmented web or unsegmented web, comprises direction-sensitive displacement facilitating means for facilitating rolling or folding of the web in a first direction in order to be maintained in an unleveled condition and in a second direction to form a unidirectionally stiff and leveled surface. The second direction is generally, but not necessarily, opposite to the first direction. The web also comprises force transmitting means for increasing web strength so that when the web is leveled it will emulate the behavior and strength of various monolithic surfaces. A strengthened web will behave as a rigid monolithic surface, and a weakened web will behave as a flexible monolithic surface.

It would be desirable to provide a reconfigurable web that is imparted with the features of unidirectional leveling and unidirectional stiffness to produce the illusive appearance and to provide the strength of a monolithic surface when leveled. Nevertheless, the web is easily rolled or unfolded when unleveled, and remains in the rolled or unfolded configuration without having a tendency of returning to the leveled configuration in contrast to an elastic monolithic surface. Similar to monolithic elastic surfaces that have a large range of rigidity and flexibility, the web of the present invention is able to be designed with a customized level of rigidity or flexibility. A web having in a leveled position a significantly large load bearing capacity and high resistance to deformation, especially bending deformation, and a smooth appearance similar to a monolithic surface will be referred to as a “strengthened web”. A web having weaker load bearing capacity and lower resistance to deformation in a leveled position, and an appearance which is not necessarily smooth will be referred to as a “weakened web”. The definitions that distinguish between a strengthened web and weakened web have been previously presented. The web of the present invention is designed to combine those properties and consequently to pave the way for a countless number of useful applications, as will become apparent as the description proceeds.

The following description primarily relates to a segmented web arranged such that adjacent portions thereof are suitably interjoined as a connecting system to facilitate displacement in either the first direction or in the second direction, and to various implementations for the use of a segmented web. It will be appreciated that these implementations are similarly applicable to an unsegmented web, mutatis mutandis.

The unrollable unidirectionally stiff and leveled connecting system (UUSL CS) comprises a plurality of coupling panels that are each interjoined with an adjacent panel, such that at a first angular position all of the coupling panels are able to be arranged in roll form or in other arrangement so as to be subsequently unrollable, and that at a second angular position after being unrolled they are lockingly joined together to form a stiff and leveled surface. Although this description refers to a planar UUSL CS at the second angular position, it will be appreciated that the UUSL CS, after being unrolled at the second angular position, may also be designed such that the coupling panels will create any other stiff surface according to demand, such as an arcuate surface.

Five different types of coupling panels are described herein as being the constituent members of a UUSL CS and of implementations thereof, namely, a Folding Tongue and Groove (FTG) coupling panel, an Inner Axis Unit (IAU) coupling panel, an Inverse Folding Tongue and Groove (IFTG) coupling panel, a continuous joint (CJ) coupling panel and a Polygonal Middle Axis (PMA) coupling panel, each coupling panel being equipped with the corresponding constituent member. Combinations thereof and other types of coupling panels are also within the scope of the invention.

With respect to the FTG type, a common sheet is attached to an upper, generally visible surface of each of a plurality of coupling panels. Through the interaction of the common sheet, each coupling panel is able to be angularly displaced with respect to an adjacent coupling panel, such that its axis of rotation coincides with, or is located in the vicinity of, the upper surface of the plurality of coupling panels when leveled and with the common sheet. In this fashion, the plurality of coupling panels are able to be compactly stored in roll form, such as the roll 34 shown in FIG. 6, or alternatively in the form of a planar surface, when unused, and to be rolled or unrolled unidirectionally as shown in FIGS. 7-8 to produce a coplanar stiff and leveled continuous surface 42 when covered by an esthetically appealing common sheet or a composite surface 42a when not covered by a common sheet, although the unrolled coupling panels may assume other configurations as well such as a curved configuration, depending on the desired shape of the surface. Tears and folds are prevented from appearing in the common sheet as the plurality of FTG coupling panels shown in any of FIGS. 4, 17, 18, and 21A are configured to resist the transmission of forces to the common sheet when subjected to bending, shear forces and high axial forces. Despite their ability to undergo angular displacement, two adjacent coupling panels of a strengthened web, when unrolled, are able to be joined sufficiently strong together so as to ensure structural stability and the development of only small deformations when loaded.

As shown in FIGS. 9A-C, the unrolled coupling panels may be designed to be in a curved configuration and prestressed while unrolled, to almost completely avoid bending deformations when supported only at one edge and loaded, due to the preloaded initial strains and accordingly the stresses which developed within the CS. When prestressed, the CS will have low deformations even under high loads while maintaining a low thickness of the coupling panels. Furthermore, when supported, the prestressed CS significantly decreases the dimensions of needed support elements due its high self-contained load bearing under low deformations.

IAU (Inner Axis Unit) coupling panels are configured with an inner axis unit illustrated in FIGS. 26A-26B, FIGS. 27A-27C, FIGS. 28A-28B, and FIGS. 29A-29B providing an axis of rotation that is coincident with, or slightly spaced from, the generally visible main web face surface of the coupling panels (not necessarily FTG coupling panels), in order to interconnect adjacent coupling panels and to enable their relative angular displacement when the UUSL-CS is rolled or unrolled, without or in addition to using a common sheet. When a common sheet is used, the inner axis unit functions as means to almost entirely avoid force transmission to the common sheet, excluding significantly low and negligible stresses which are generated by its own deformation.

IFTG (Inverse Tongue and Groove) coupling panels are configured with a different structure of tongue and groove relative to FTG coupling panels, as illustrated in FIGS. 35B-35C, 36A-36C, 37A-37B, and 38A. Each adjacent IFTG coupling panel, when unrolled, has an angular rotation in opposite direction relative to a counterpart FTG coupling panel, as illustrated in FIGS. 37A-37B. Consequently the use of IFTG coupling panels enables to create a UUSL CS which, when unrolled, produces the axis of rotation of the coupling panels and therefore their continuous surface located in the opposite surface of the coupling panels relative to that of the FTG coupling panels. As illustrated in FIGS. 35B and 38A as opposed to FIGS. 35A and 38B, this property enables to roll the common sheet when attached to IFTG panels in a counterclockwise direction, according to the orientation in the illustrated drawings, while the common sheet when attached to FTG coupling panels will rotate in a clockwise direction.

Conversely, if the FTG and IFTG panels were configured to rotate in the same rotational direction, the common sheet would be located at opposite edges of the FTG and IFTG panels.

CJ (Continuous Joint) coupling panels illustrated in FIGS. 32A-32B, 33C-33D and 34A-34D incorporate an elastic element interfacing between two adjacent coupling panels to produce a smoothly curved joint surface when they undergo relative angular motion. The interjoining of two adjacent coupling panels with the CJ eliminates the transmission of forces to a common sheet, if used, such that a common sheet that can be easily torn is rendered damage resistant.

Polygonal Middle Axis (PMA) coupling panels illustrated in FIGS. 50A-53 are each an angled element having two integrally formed side sections, such that when a plurality of the PMA coupling panels are serially interjoined and partially detachable, a polygonal holding structure shown in FIG. 48 is produced that is able to rotate about a vertical axis. Two peripherally adjacent PMA coupling panels are interconnected by a Peripherally Interjoinable Inner Axis (PIIA), which is a unidirectional pivot element that allows each adjacent PMA coupling panel of a roll to have a relative angular disposition when rolled and rolled, such that when the roll is leveled against a wall, each PMA coupling panel has a first section that is set in abutting relation with the wall and a second section which protrudes interiorly from the wall.

All of the aforementioned constituent members are capable of being both a direction-sensitive displacement facilitating element and a force transmitting element, although some are more suitable with respect to force transmission than with direction-sensitive displacement facilitation, or vice versa. For example, FTG and IFTG coupling panels function primarily as force transmitters, but also function as direction-sensitive displacement facilitators. IAU coupling panels function primarily as direction-sensitive displacement facilitators, but also function as force transmitters. A web or coupling panel in which FTG and IAU elements interact with each other has superior direction-sensitive displacement facilitating and force transmitting capabilities.

Although the description associates a UUSL CS with a connecting system comprising a plurality of coupling panels, it will be appreciated that a connecting system may also comprise one or more unsegmented webs. Many implementations employing a UUSL CS are likewise applicable to an unsegmented web, mutatis mutandis.

### UUSL CS

UUSL CS enable applications that were heretofore infeasible, including an unrollable parquet system, a ready to use unrollable plaster leveling system, an unrollable roofing system, an unrollable shelving system, an unrollable table or bed system, a system that is convertible from a rug or a roll of wallpaper to a unidirectionally unrollable rigid surface, plaster elements for decorating corners and arches, coplanar hinges, a fishing rod stick which can fold and be stored in a very small compact size, and under certain configurations, unrollable bidirectional stiff systems for use as a door or partition.

The coupling panels which are the constituent members of UUSL CS may be of different sizes, such as 2*5*120 cm for use by example in a parquet system or 0.5*1*10 meters for use by example in the concrete construction industry during construction of a bridge. The coupling panel may also be made of different materials, such as thin ductile panels made of wood, polymeric materials and metal that display elastic behavior when loaded, and steel or reinforced concrete elements for use in building construction whose fracture strength is standardized. To ensure that the coupling panels will be able to be satisfactorily angularly displaced when unrolled, yet be imparted with sufficient strength to withstand applied shear forces, bending moments and axial force if needed, each coupling panel is preferably manufactured with high precision, such as by casting, injection, molding, CNC machining, or any other suitable manufacturing process.

The common sheet attached to the upper surface of a coupling panel constitutes a constructive element for use only during the unrolling process, and does not have to withstand high loads. When the coupling panels are lockingly joined together, the common sheet or the inner axis is designed not to transmit the applied forces, and in some embodiments the common sheet may be disposed of after the plurality of coupling elements are unrolled. In systems which include both the common sheet and an inner axis (it might be inner axis unit (IAU) or any of the coupling panels mentioned above in which an inner axis is an integrative part of the coupling panel as will be apparent below), the common sheet will be permanently unloaded due the transfer of the forces to the inner axis whenever the coupling panels are not lockingly joined together. The common sheet may be made from paper, polymeric fabrics such as PVC and polyethylene, fiberglass, PTFE, laminated films, carbon fiber sheets, canvas, flexible iron or steel or flexible steel mesh for speedy high-load construction applications whose esthetic appearance is of less importance. The common sheet may be applied to the upper surface of a coupling panel by adhesion, assimilation, fusion, integration, or any other suitable attachment process.

### FTG Panels

One useful connecting system is a system of folding tongue and groove (FTG) coupling panels. A FTG system is adapted to join together two or more separate coupling members by a tongue protruding outwardly from one member and a groove formed in an adjacent member, such that the tongue is received within the groove to provide a locking connection following pivotal movement of adjacent members. Although each adjacent member is strongly joined together by such an arrangement, the joining together of a large number of members is a time consuming operation, particularly when, for example, a floor is to be assembled from the members.

It would be desirable to provide a FTG-based connecting system 42 as shown in FIG. 7 by attaching a common sheet to the same surface of a plurality of coupling members. Such a connecting system would allow the plurality of coupling panels to be stored as an unrollable plate or roll when unused, and to be unidirectionally unrolled when contacting a base surface or being supported at one or more edges to produce a stiff and esthetically appealing continuous surface in dramatically less time than the time needed to individually join together a plurality of separated panels. When it would be desired to remove the esthetically appealing surface, the plurality of coupling panels could be set to roll form by disengaging and angularly displacing adjacent coupling members one from the other by quickly displacing the roll in a second direction which is opposite to the first direction.

Many tongue and groove connecting systems are known from the prior art; however, none are known that comprise a common sheet attached to the same surface of a plurality of coupling panels as shown in FIG. 1 that is needed to produce a desired stress dispersing, stiff, and unidirectionally leveled system. Even if a common sheet were attached to the same surface of a plurality of prior art coupling members, the common sheet would not remain esthetically appealing due to the transmission of forces thereto that would cause unsightly folds or tears to be formed in the sheet.

FIG. 1 illustrates a typical prior art floor covering panel 10 formed with a tongue and a groove that are all formed in one piece together with the core portion 8 of the panel, relative to which are shown the forces that are applied thereto when interconnected to adjacent prior art panels 5 and 25, which are partially indicated by dashed lines and applied with a common sheet. Forward tongue 15 of panel 10 has a planar upper surface 16 that extends between points C and D, and a convex lower surface 17 that extends from extreme protruding point D to point F adjoining core portion 8. Rear groove 22 of panel 10 is delimited by planar upper surface 23 that extends between points K and L of upper horizontal wall 18, and by concave lower surface 24 that extends from point K to point I, the latter coinciding with extreme rear vertical surface 13 that adjoins lower horizontal wall 19. Extreme rear vertical surface 13 is parallel to, and positioned rearwardly from, intermediate rear surface 14 extending between points A and L, intermediate forward surface 4 extending between points F and G, and extreme forward surface 7 extending between points B and C and located forwardly to intermediate forward surface 4. Planar upper surface 2 extends between points A and B. and planar bottom surface 3 extends between points G and H.

As illustrated in FIG. 2, when prior art panels 5 and 10, for example, are subjected to bending, while being coupled together to prevent movement relative to each other, following rotation of one panel relative to the other about adjacent panel edges, forces are transmitted through the corresponding tongue 15, lower wall 19 and upper wall 18. Due to the presence of convex lower surface 17 of tongue 15 of panel 10, which bears on the concave surface of lower wall 19 of panel 5, a resultant oblique, downwardly directed force F1 acts on lower wall 19 of panel 5 at an intermediate region of arc JI and its opposed force F′1 acts on lower surface 17 of the tongue of panel 10. Since force F1 has a horizontal component of F1x, from equilibrium considerations a tensile horizontal force Fs will necessarily be developed in the common sheet and consequently longitudinal stress and deformations will be developed within the common sheet and mainly in the region of point A, as shown in FIG. 2. This deformation causes panel 10 to rotate by an angle of θ in a clockwise direction according to the illustrated orientation. The angular deformation Θ is accumulative and prevents the surface to which the common sheet is attached to be leveled. Furthermore, the common sheet would consequently be stretched due to the applied tensile stress, often leading to the tearing and detachment of the common sheet due to the relatively high strain between the common sheet and the upper surface 2 of the panel. This relatively high strain often causes the common sheet to undergo plastic deformation, reducing the appealing appearance of the common sheet due to the folds which remain following deformation.

As shown in FIG. 3, another deficiency of the prior art panel 10 is the relative vertical movement between two adjacent panels being subjected to tension. When the two adjacent panels are subjected to tension, the tensile force is adapted to displace point E of tongue 15 horizontally toward point F of lower wall 26. However, since points E and F are at different heights, an oblique resultant force F6 is developed at the area of arc EF which resists the horizontal displacement, and its vertical component F6Y pushes tongue 15 of panel 10 counterclockwise and upwardly. As a result of the relative vertical movement and shear forces, the common sheet is liable to undergo plastic deformation and detachment at the nearest region of point A. Consequently, the appealing appearance of the common sheet is reduced, as folds and even tears are visible within the common sheet of the prior art panel 10 due the plastic deformations that are developed especially under periodic loading.

Although a UUSL CS comprising the prior art FTG coupling panel 10 has the disadvantages described hereinabove, there are applications in which a UUSL CS comprising FTG coupling panel 10 is satisfactory and is also in the scope of this invention.

Reference is now made to FIG. 4, which illustrates an embodiment of a coupling panel 40 for use in a tongue and groove connecting system. The directional terms, such as “upper”, “lower”, “horizontal”, “vertical”, “forward” and “rear” refer herein to a relative orientation of coupling panel 40 when positioned on top of a horizontal underlying base surface or supported by one or more edges lying horizontally, but it will be appreciated that the invention is also applicable when coupling panel 40, or any other coupling panel, is positioned at another orientation.

Coupling panel 40 is configured with mutually parallel upper surface 46 and lower surface 47, and rectilinear, upper horizontal wall 48 and lower horizontal wall 49, defining there between rear groove 32 which is delimited by planar lower surface 41 of upper horizontal wall 48, planar upper surface 43 of lower horizontal wall 49, and vertical wall 44 extending between upper wall 48 and lower wall 49. Lower wall 49 protrudes rearwardly from upper wall 48 to facilitate the transmission of shear forces.

Forward tongue 35 located between surfaces 46 and 47 has a planar upper surface 36 extending forwardly from extreme forward surface 31 that may be collinear with surface 41, an oblique edge 37 extending downwardly from forward slightly truncated edge 33 of tongue 35, and a lower surface 38 that extends rearwardly from oblique edge 37 to intermediate forward surface 39 and that may be collinear with surface 43. Core portion 29 adjoins tongue 35, upper wall 48 and lower wall 49. Intermediate forward surface 39 is located rearwardly from extreme forward surface 31, which is substantially perpendicular to upper surface 36 of tongue 35 and to upper surface 46. Intermediate rear wall 53 parallel to vertical wall 44 extends between surfaces 41 and 46, and extreme rear wall 54 located rearwardly to intermediate rear wall 53 extends between surfaces 43 and 47.

As illustrated in FIGS. 5A-B, a protrusion A1 may be added to tongue lower surface 38 and a complementary recess A2 may be formed in upper surface 43 of lower wall 49 in order to interlock all coupling panels of the connecting system while the plurality of coupling panels are being unrolled. Although this protrusion-recess arrangement is illustrated with respect to coupling panel 40, it will be appreciated that such an arrangement is applicable to all coupling panels and for all applications described herein.

FIG. 10 illustrates a basic UUSL CS 60 which comprises two coupling panels 40A and 40B that are lockingly joined together, and a common sheet 63 attached to the upper surface 46 of each of coupling panels 40A and 40B. By virtue of this arrangement, one of the coupling panels is able to be rotated relative to the other while the axis of rotation P coinciding with the upper planar surface 46 of coupling panels 40A and 40B also coincides with common sheet 63, to facilitate the rolling or unrolling of the plurality of coupling panels while preventing the formation of unsightly tears or folds within the common sheet.

When coupling panels 40A and 40B are lockingly joined together, tongue 35 of coupling panel 40B is inserted within groove 32 of coupling panel 40A, such that upper tongue surface 36 of coupling panel 40B abuts lower surface 41 of the upper wall of coupling panel 40A and tongue lower surface 38 of coupling panel 40B abuts upper surface 43 of the lower wall of coupling panel 40A This abutting relation between pairs of right-angled elements of coupling panels 40A and 40B resists their disengagement during normal usage of system 60 and prevents high force development in the common sheet or in the inner axis when attached.

By virtue of the configuration of FTG coupling panels 40 which are the constituent members of UUSL CS 60 having a planar upper surface 43 of the lower wall, a planar lower surface 41 of the upper wall, planar upper surface 36 and planar lower surface 38 of the tongue, although extreme forward surface 31 and intermediate forward surface 39 of coupling panel 40B abut the intermediate rear wall 53 and the extreme rear wall 54 respectively, no forces are developed in those abutting surfaces and consequently from equilibrium considerations forces are transmitted from one coupling panel to another when loaded, in such a way that they are essentially not transmitted to common sheet 63. The coupling panels are designed such that contact is made between surfaces 41 and 43 of a first coupling panel and surfaces 36 and 38 of a second coupling panel, respectively, and precedes the contact between surfaces 31 and 39 and surfaces 53 and 54, respectively, thereby altogether preventing the transmission of significant forces to the common sheet.

The ability to transmit the forces from one coupling panel to another when unrolled is a significant advantage of a UUSL CS comprising FTG coupling panels or one of the other coupling panels described herein since it enables to disperse the loads in all directions and behave similarly to a monolithic plane when unrolled as illustrated in FIG. 4A, in contrast to a conventional connecting system which absorbs the loads by dispersing the loads only in one direction along its ribs as illustrated in FIG. 4B. The ability to disperse the loads similar to a monolithic plane enables a much higher load bearing capacity and significantly lower deformations especially under a concentrated force.

The FTG UUSL CS is able to satisfactorily emulate a continuous monolithic plate when unrolled and one of the FTG coupling panels 90, 120 and 140 shown in FIGS. 17, 18, and 21A, respectively, is employed.

According to the spatial structure of the FTG UUSL CS, it can be collectively cut and designed similar to a continuous plate when rolled or unrolled.

According to the spatial structure of the FTG UUSL CS, the coupling panel can be configured with additional elements as will be apparent below.

With reference also to FIG. 11A showing when coupling panels 40A and 40B are lockingly joined together, the transmitted moment M will be absorbed by vertically distributed forces generated between surfaces 41 and 43 of coupling panel 40A and surfaces 36 and 38 of coupling panel 40B, due to the elimination of the prior art concave lower surface of tongue 15 and concave upper surface of lower wall 19 shown in FIG. 1. The vertically distributed forces include the resultant force couple F1 and F2 and their reactive force couple F′₁ and F′₂. These distributed forces are transmitted between the coupling panels by shear forces that are developed in the upper wall 48 and lower wall 49 of coupling panel 40A and tongue 35 of panel 40B under bending, when coupling panels 40A and 40B are lockingly joined together. As a result of the coupling panel configuration, forces do not interact between surface 54 of coupling panel 40A and surface 39 of coupling panel 40B, and consequently transmission of forces to the common sheet or to an inner axis, when employed, is prevented.

As shown in FIG. 11B, under considerably low tension and in the absence of an inner axis unit, longitudinal stress will be developed in the common sheet 63 of connecting system 60. Since upper surface 43 of lower wall 49 horizontally abuts lower surface 38 of tongue 35, the tension will produce only longitudinal force transmission, causing longitudinal elastic strain to be developed within the upper common sheet. Consequently, as the load is removed, the common sheet will return to its initial form without any folds or tears remaining, ensuring the proper operation of the pivoting mechanism.

Adding an inner axis unit shown in FIGS. 28A-28B, 30A-30B, and 31 prevents almost entirely the longitudinal transmission of forces to the common sheet and to the lamination layer when used since, as shown in FIG. 31, the inner axis absorbs tensile forces and consequently resists transmission of forces to the common sheet and to the lamination layer when used, producing even a more reliable connecting system. With respect to certain implementations, a common sheet may be disposed of by virtue of the tensile force absorption capability of the inner axis. For an enhanced ability to bear tensile forces, another type of coupling panel, such as shown in FIGS. 18-19 and 21A, may be employed.

Eventually, moments and shear forces are transmitted entirely from core portion 29 to tongue 35 of coupling panel 40B, and from tongue 35 of coupling panel 40B to walls 48 and 49 of coupling panel 40A, without any significant tensile forces being transmitted to common sheet 63, or to an inner axis unit if employed, with the exception of negligible tensile forces that are transmitted during movement, storage, unrolling of the plurality of coupling members. Thus tears and folds are prevented from appearing in common sheet 63 when attached, and the proper operation of the pivoting mechanism is ensured by means of the common sheet or the inner axis.

As mentioned above, the axis of rotation is coincident with the upper planar surface of the coupling panel. If the axis of rotation P′ between the coupling panels were located below the common sheet 63, such as if the intermediate rear wall of a differently configured coupling panel 70 shown in FIG. 12A, being in contrast to the coupling panel configuration of the invention, were concave and the extreme front wall were convex to enable rotation along the concave surface of an adjacent coupling panel, the common sheet 63 is liable to form a fold 72 and fold upwardly above the axis of rotation P′ as shown in FIG. 12B and become detached from the upper surface of the coupling panels, or to form a permanent crease 74 and fold inwardly towards the region of the axis of rotation P′ as shown in FIG. 12C and become deformed and detached from the upper surface of the coupling panels. The appearance of the common sheet 63 would consequently become impaired, often discouraging users from displaying a tongue and groove connecting system.

In contrast, as mentioned above and shown in FIG. 13A, the axis of rotation P between coupling panels 40A and 40B is coincident with the upper surface of the coupling panels and with the lower surface of common sheet 63. Consequently, a crease Q formed within common sheet 63 when coupling panels 40A and 40B are angularly displaced, and that which overlies axis of rotation P remains attached to coupling panels 40A and 40B and is not overly strained. Since the strain developed within crease Q remains in the linear elastic regime as shown in FIG. 13B, the portion of common sheet 63 that corresponds to crease Q will return to its original shape without a change in its appearance or functionality once coupling panels 40A and 40B are again lockingly joined together.

When an inner axis unit is applied, the center of rotation will remain at point P and the stresses developed in the common sheet will be significantly more negligible and be derived only from strain caused due to angular displacement.

The location of an inner axis unit, which may be combined with any coupling panel described herein, may be selected so that the center of rotation is advantageously pinpointed at a desired location in the vicinity of the web face. The selected location may be spaced outwardly from the web face, coincide with the web face, or be spaced inwardly from the web face in the direction of the core. The ability to ensure that the axis of rotation will be located at a desired point, for example ensuring that the axis of rotation of each adjacent coupling panel will be located at the axis of rotation of the common sheet or the lamination layer, will decrease the inner strain and accordingly the inner stress within the common sheet or the lamination layer. By using an additional elastic layer with a very low modulus of elasticity between the common sheet and the main face of the coupling panels, in addition to urging the axis of rotation of an adjacent coupling to coincide with the location of the axis of rotation of the common sheet or of the lamination layer, allows the common sheet or the lamination layer to fold naturally around its own axis of rotation and accordingly to keep its appealing appearance and functionality even under repeatable relative angular displacement of the coupling panels. When the common sheet is a flexible television sheet or a flexible sheet of photovoltaic cells. such ability has much significance.

FIG. 14 illustrates the geometrical considerations relating to an FTG unrolling operation. Even though coupling panels 40A and 40B are lockingly joined together to resist their disengagement during normal usage as described above in relation to FIGS. 10 and 11A, one coupling panel may advantageously be angularly displaced relative to the other about axis of rotation P.

As indicated by arrows 69 and 70, this arrangement of lockingly joined coupling panels 40A and 40B allows the coupling panels to be angularly displaced about axis of rotation P according to the illustrated orientation. The movement of tongue 35 of coupling panel 40B relative to upper wall 48 and lower wall 49 of coupling panel 40A is unrestricted in direction 70 through the action of radius PW that traces arc WT. Similarly, the movement of coupling panel 40A relative to tongue 35 of coupling panel 40B is unrestricted in direction 69. In a direction opposite to arrows 69 and 70, the angular displacement of tongue 35 of coupling panel 40B is restricted due to contact between (a) upper tongue surface 36 of coupling panel 40B and the lower surface of the upper wall 48 of coupling panel 40A, and (b) tongue lower surface 38 of coupling panel 40B and upper surface 43 of the lower wall 49 of coupling panel 40A. Using the FTG coupling panels shown in FIGS. 17, 18 and 21A enhances the ability of the coupling panels to restrict the angular displacement due to an additional structure which will be described hereinafter. A FTG connecting system is consequently unidirectionally unrollable since, when leveled, a coupling panel can be easily angularly displaced in one rotational direction and behave as a monolithic plate which has a resistance to deformations in the opposite direction.

Length PT defines a minimum radius R of rotation that would result in contact between the tongue of coupling panel 40B and upper surface 43 of the lower wall 49 of coupling panel 40A when coupling panel 40B rotates about axis of rotation P. To prevent such contact, the end of the tongue's upper surface 36 is located at a distance less than R from the axis of rotation P, while the intersection W of the lower surface of the upper wall 48 and vertical wall 44 of the groove, within which the tongue is introduced, is spaced from axis of rotation P by a distance equal to or greater than the radius of rotation R. Interference-free rotation is also made possible by ensuring that the distance between each point on oblique surface 37 and axis of rotation P is less than or equal to R while the distance between horizontal surface 43 and axis of rotation P is larger than or equal to R.

It is therefore understood that, for example, upper tongue surface 36 or tongue lower surface 38 constitutes force transmitting means while its length constitutes direction-sensitive displacement facilitating means.

FIG. 15 illustrates a roll 34 formed from a plurality of coupling panels 40, each of which is shown at a different angular disposition, providing a correspondingly different depth and angle of introduction of the tongue 35 into the groove 32 of an adjacent coupling panel, in order to achieve a compact rolled formation. The overlap of tongue 35 and groove 32 at each adjacent pair of the plurality of coupling panels ensures the ability of the roll to be unrolled. The common sheet is not shown in FIG. 15, in order to emphasize that each pair of adjacent coupling panels is angularly displaced about a common axis of rotation P regardless of whether a common sheet attached. In the absence of a common sheet, inner axis units (IAU) or CJ joints must be installed in order to produce the pivoting mechanism.

FIGS. 16A-B illustrate an unrolled tongue and groove system 80 wherein a plurality of coupling panels 40 are unidirectionally lockingly joined one to another, being fixedly supported at the left edge of the connecting system at edge AA and unattached at the right edge thereof such that a downwardly directed concentrated load F_{L} is applied to the first right coupling panel. This extreme load combination is intended to demonstrate the loads that each coupling panel need to withstand. Load F_{L} is transmitted through each target coupling of the plurality of coupling panels by a shear force F1 which has a constant magnitude equal to load F_{L}. In addition, a moment is developed which increases in magnitude as the distance from load F_{L} increases.

The following load analysis of a target coupling panel is representative of connecting system 80. In order to maintain connecting system 80 in a state of equilibrium, the sum of the moments derived from the external forces that act on the target coupling panel must be equal to the inner moment derived from force couple F1 and F2 counteracting each other. Thus:

$$( L 1 \times F 2 ) - ( L 2 \times FL ) = 0 \qquad ( Equation 1 )$$

When Equation 1 is rearranged, the following equation is produced:

$$F 2 = ( L 2 / L 1 ) \times FL \qquad ( Equation 2 )$$

Since the sum of the forces acting on system 80 must be likewise equal in order to maintain a state of equilibrium, it therefore follows:

$${F}_{1} = {F}_{2} + {F}_{L} , \qquad ( Equation 3 )$$

or when Equation 2 is substituted:

$${F}_{1} = ( ( {L}_{2} / {L}_{1} ) \times {F}_{L} ) + {F}_{L} = ( 1 + ( {L}_{2} / {L}_{1} ) ) \times {F}_{L} \qquad ( Equation 4 )$$

It is evident from Equation 2 that the load F_{L} is magnified by a factor of L₂/L₁ as it is transmitted to the upper surface 36 of the target coupling panel tongue 35, It is also derived from Equation 4 that the load FL is magnified by a factor of 1+(L₂/L₁) as it is transmitted to the lower surface 38 the target coupling panel tongue 35. therefore The tongue is subjected to a very large sheer forces and bending moment and need to be strengthened.

Since L2>>L1, L₂/L₁ is significantly greater than 1, the resultant forces F₁ and F₂ are significantly large and F1≈F2. Although their opposed forces F′₁ and F′₂ which are exerted respectively on lower wall 49 and upper wall 48 of the adjacent coupling panel are also substantially equal, the lower wall which is longer than the upper wall is subjected to a larger banding moment which is liable to lead to the failure of the coupling panel. Strengthening of the upper wall and especially of the lower wall of a coupling panel will withstand such a large bending moment.

Three additional FTG coupling panels that help in achieving a durable connecting system will now be described.

FIG. 17 illustrates coupling panel 90, which is additionally strengthened with respect to coupling panel 40 of FIG. 4 and consequently can resist significantly larger moments while reducing bending deformations. FIG. 18 and FIG. 21A illustrate coupling panels 120 and 140, respectively, which are further strengthened and have an additional mechanism, as described hereinbelow, for enabling the coupling panel to absorb large axial forces in addition to the ability to resist larger moments and shear forces while reducing bending deformations. Similarly to coupling panel 40, all of the following three coupling panels prevent stress from being developed in IAUs and in the common sheet when leveled and loaded.

Coupling panel 90 is shown in FIG. 17 whose tongue 95, upper wall 98 and lower wall 99 are shortened with respect to the counterparts of coupling panel 40 illustrated in FIG. 4 decrease the moment that is acting on tongue 95 and considerably decrease the magnitude of stress within tongue 95 and lower wall 99. Lower wall 99 is afforded increased moment and shear force rigidity by being provided with an oblique surface 104 that extends upwardly from the forward edge of its planar upper surface 103 to the vertical wall 102 of groove 92, thus increasing the thickness and moment of inertia of lower wall 99. Oblique surface 104 is substantially parallel to oblique edge 97 of tongue 95. The shortened tongue 95 is much more rigid and enables a lower moment to be developed therealong in comparison to tongue 35 of coupling panel 40, depending on the length of the thin forward section of tongue 35 that has been truncated.

Other features of coupling panel 90 are similar to those of coupling panel 40, namely (a) core portion 99a adjoins tongue 95, upper wall 98 and lower wall 99, (b) substantially equal height of groove 92 and tongue 95 to facilitate contact between upper tongue surface 116 and the upper wall lower surface 96 of an adjacent coupling panel, and between tongue lower surfaces 97 and 118 and lower wall upper surfaces 104 and 103, respectively. and (c) the ability of tongue 95 to undergo interference-free rotation within the groove 92 of the adjacent coupling panel. To ensure the interference-free rotation, the length of the planar tongue upper surface 116 is less than the maximum radius of rotation R, which is equal to the distance of a perpendicular line from axis of rotation P to the planar tongue lower surface 118. Also, the distance between each point on oblique edge 97 and axis of rotation P is less than R. Lower wall upper surface 103 may be collinear with tongue lower surface 118.

FIG. 18 illustrates coupling panel 120, which is identical to coupling panel 90 of FIG. 17, with the exception of the provision of a recess 121 within upper wall 128 and a complementary protrusion 133 added to tongue 125 that functions as additional force transmitting means. Recess 121 is defined by an oblique surface 123 extending upwardly from the forward edge of the shortened upper wall lower surface 126 relative to that of coupling panel 90, an extended vertical wall 129 of groove 122 relative to that of coupling panel 90 that extends upwardly from the forward edge of oblique surface 104 of lower wall 99, and a surface 134 perpendicular to vertical wall 129 and extending between the upper edge of the latter and oblique surface 123. In order to accommodate protrusion 133, a shortened upper tongue surface 136 relative to that of coupling panel 90 is provided, and an oblique surface 137 extends upwardly from surface 136 to the upper horizontal surface 138 of protrusion 133.

FIG. 19 illustrates three coupling panels identical to coupling panel 120, coupling panel 120A being shown by solid lines and its two adjacent coupling panels 120B and 120C being shown by dashed lines. By virtue of the provision of the protrusion-recess arrangement, when coupling members 120A and 120B are subjected to bending, four resultant forces F₁, F₂, F₃ and F₄ and their opposed forces F₁′, F₂′, F₃′ and F₄′, respectively, interact between the abutting tongue 125 of coupling panel 120A and lower wall 99 and upper wall 128 of coupling panel 120B. Forces F1, F2 and F3Y and their opposed forces resist bending similarly to force couple F1 and F2 in connecting system 60 as shown in FIG. 11A. In addition to the vertical force couples provided by system 60, the presence of the protrusion-recess arrangement induces the application of a horizontal force component F_{3X} and its opposed F′_{3X}, a compressive horizontal force F4 and its opposed F′4. Forces F′_{3X} and F4 are applied on surface 123 and surface 119 of coupling panel 120A, producing an additional force couple F′_{3X} and F₄ which significantly improves bending resistance by utilizing the high tensile bearing capacity of the upper wall 128 of coupling panel 120B and the high compressive bearing capacity of the lower wall 99 of coupling panel 120A. Core 99b functions as a monolithic surface whose upper portion is compressed and whose lower portion is tensioned. Although the lower wall is compressed by force F₄, no forces are transmitted to a common sheet or to an inner axis unit, due to the stiffness of the upper wall 128 which applies the opposite force F′_{3X} needed by equilibrium considerations while preventing pivotal movement which would transfer the forces to the common sheet as explained above and shown at FIG. 2. Another advantage of coupling panel 120 is the ability to resist axial forces due to the horizontal component F_{3X} of force F₃ created by the abutting surfaces of recess 121 and protrusion 133 of coupling panels 120B and 120A, respectively.

As illustrated in FIGS. 20A-B, by using the spatial structure of coupling panel 120 of FIG. 18, it is possible to strengthen the upper wall 128 in one embodiment by forming a recess 121 and protrusion 133 at discrete regions of upper wall 128 and tongue 125, respectively, to produce coupling panel 127, instead of providing them as a single elongated element throughout the upper wall and tongue, while still having the advantages brought above.

The additional mechanism generated by the additional tensile and compressive force couples F₃ and F₄ developed in the lower and upper walls of the coupling panels reduces the magnitude of the resultant couple forces F₁ and F₂ which act vertically on the lower and upper walls of the coupling panel, and consequently, significantly reduce bending deformations caused by the accumulative bending deformation of the coupling panels.

FIGS. 21A-21B illustrates coupling panel 140 which is identical to coupling panel 90 of FIG. 17, with the exception of the provision of a plurality of longitudinally spaced, i.e. spaced along the long dimension, arcuate wing protrusions 142 that protrude upwardly from upper tongue surface 116, and of a plurality of longitudinally spaced holes 144 formed in a portion of upper surface 146 overlying upper wall 98. As a result, coupling panel 140 has significantly improved bending and shear resistance since it is configured with the structure of coupling panel 90 at both section A-A shown in FIG. 22 and section B-B shown in FIG. 23 that is characterized by high moment and shear resistance due the mechanism described above with respect to coupling panel 90. In addition, as detailed below, each wing protrusion 142 curving upwardly from the projection of tongue 95 and receivable in a corresponding hole 144 improves moment and shear resistance, provides high axial force resistance, and prevents the transmission of forces to a common sheet or an inner axis unit when the UUSL CS is unrolled.

Section B-B of coupling panel 140 shown at FIG. 23 shows a wing protrusion 142, configured with a concave surface 147 that extends from upper tongue surface 116 and extreme forward surface 111 to upper wing surface 149, which may be coplanar with upper surface 146. Also shown are convex surface 147a of the wing protrusion that extends from the projection of oblique tongue surface 97 at edge BC to upper wing projection surface 149, lower concave surface 104a of arcuate groove 144 extending from the intersection E of oblique groove surface 104 and wall 102 to upper panel surface 146, upper convex surface 96a of arcuate groove 144 extending from intersection F of upper wall lower surface 96 and intermediate rear wall 93 to the upper surface 146.

FIG. 24 illustrates the inner forces transmitted between adjacent coupling panels 140A and 140B shown to be cut along section A-A, which are the same as those described with respect to coupling panel 90. Coupling panels 140A and 140B are therefore designed for high moment and shear force bearing capacity.

FIG. 25 illustrates inner forces that are transmitted between adjacent coupling panels 140A and 140B shown to be cut along section B-B. When the coupling panels are subjected to moments and shear forces, three resultant forces F1, F3, and F4 and their opposed forces F′1, F′3, and F′4 interact between the abutting surfaces of the coupling panels and resist the load similarly to coupling panels 120A and 120B described above, with the significant advantages derived from the ability of the wing protrusions to transfer the majority of force F₃ to the upper wall as a horizontal force component F_{3X} that produces a tensile force instead of inducing bending of the upper wall similar to monolithic plate. Consequently the bending bearing capacity of the coupling panel is improved while vertical deformations derived from bending, which are accumulative and would prevent the UUSL CS from being leveled under large loads, are significantly reduced.

A significant advantage of coupling panel 140 when loaded, is its ability to emulate the development of strain and stress in a monolithic plate, such that its upper region experiences tensile stress and its lower region experiences compressive stress.

An additional significant advantage of coupling panel 140 relates to its ability to resist high axial forces through the configuration of the curved and interconnected wing protrusions that are able to produce a major force component F_{3X} from the resultant force F₃ and transmit the axial force to the upper wall of the adjacent coupling panel by tension.

Furthermore, the configuration of coupling panel 140 facilitates the interconnection of each adjacent coupling panel since the tongue of a first coupling panel remains coupled with the groove of a second coupling panel throughout a long range of relative angular displacement, thereby enhancing the reliability of the rolling and unrolling operation of the UUSL CS.

Coupling panel 140 may be optionally modified in several ways, such as by—
a) modifying the structure of the wing protrusions 142;
b) changing selected dimensions of each wing protrusion 142 and the spacing between adjacent wing protrusions according to design demands and constraints; and
c) utilizing the spatial structure of the coupling panels to provide different coupling panel combinations and more reinforced coupling panels.

### Inner Axis Unit (IAU)

FIGS. 26A-26C illustrate the inner axis unit (IAU) structure, which is an alternative strong interconnection of adjacent coupling panels. Similar to the interconnection by the common sheet, the axis of rotation P as illustrated in FIGS. 27A-27C is coincident with the upper planar surface of the plurality of coupling panels.

An inner axis unit A1, in both an assembled and exploded perspective view, is illustrated in FIG. 26A-26C. The inner axis unit comprises two semicircular end plates IN1 and IN2, and intermediate semicircular plate IM interposed between plates IN1 and IN2. Plates IN1 and IN2 are each configured by an outer planar face IN7, a semicircular protrusion IN3 that inwardly protrudes from the inner face of the corresponding plate defined by surfaces IN8 and IN9 and that has a radius significantly smaller than that of the plate, planar terminal ends IN4 and IN5 of each protrusion IN3 that is coplanar and continuous with upper plate surface IN11, a thin and narrow extension IN6 inwardly protruding from the inner face of the corresponding plate and laterally extending in each direction from terminal end IN4, and exterior semicircular face IN10 extending between the inner and outer faces.

Intermediate plate IM is configured with a semicircular recess IM1 that is recessed from each face IM5 and IM6 thereof and that is adapted to interact with a corresponding protrusion IN3, an upper planar face IM2, a semicircular and thin recessed extension IM3 of recess IM1 that is recessed by a significantly smaller depth from the corresponding intermediate plate face IM5 or IM6 than recess IM1 and that extends from upper face IM2 to at least the majority of recess IM1, and the curved outer surface IM7.

The inner axis unit is assembled by inserting the protrusion IN3 and protrusion extension IN6 of end plates IN1 and IN2 into the corresponding recess IM1 and recess extension IM3, respectively by a small clearance. Since each protrusion IN3 and protrusion extension IN6 is dimensioned to be angularly displaced within a corresponding recess IM1 and recess extension IM3 respectively, end plates IN1 and IN2 are able to be angularly displaced relative to intermediate plate IM as shown in FIG. 26C. This angular displacement is restricted in the counterclockwise direction, according to the illustrated orientation, due to the presence of protrusion extension IN6. Such an angular restriction is of importance when the inner axis unit is embedded within adjacent coupling panels.

FIGS. 28A-28B illustrate the assembly of IAU coupling panels by mounting of inner axis unit A1 into cavities H1 and H2 formed in rectangular section coupling panels C1 and C2, respectively. During the mounting, end plates IN1 and IN2 are both connected to a wall of cavity H1, and intermediate plate IM is connected to a wall of cavity H2. The connection can be done by intense adhesion, mechanical means, fusion or any other suitable means well known to those skilled in the art. Consequently, IAU coupling panels C1 and C2 are able to be angularly displaced relative to each other, as shown in FIGS. 29A-29B, while the axis of rotation is coincident with the upper surface of the coupling panels since, as shown in FIGS. 27A-27C, semicircular protrusion IN3 and semicircular recess IM1 constitute an arc subtending an angle of less than or equal to 180 degrees whose axis of rotation located at point P coincides with the visible plane of the coupling panels.

When the upper surface of IAU coupling panels C1 and C2 are coplanar as shown in FIG. 29A, adjacent panel facing walls H3 and H4 of IAU coupling panels C1 and C2, respectively, are in abutting relation with each other and restrict the clockwise angular displacement of one of the panels. In addition, upper plate surface IN11 of end plates IN1 and IN2 and an adjoining wall H5 of cavity H1 are in abutting relation with each other and restrict the relative angular displacement of the adjacent coupling panels.

FIGS. 30A-B illustrate an IAU CP (Inner Axis Unit) coupling panel comprising two longitudinal rectilinear panels connected together with a plurality of equally spaced IAU's embedded therewithin.

FIG. 30C illustrates a UUSL CS comprising, narrow bands of IAU coupling panels which are embedded perpendicularly to a plurality of adjacent bands of FTG coupling panels. The inner axis unit functions as additional force transmitting means in addition to the force transmitting means provided by a FTG coupling panel, as well as functioning as direction-sensitive displacement facilitating means. Consequently, a strong and very mechanically reliable UUSL-CS whose axis of rotation is coincident with the upper surface of the connecting system is able to be provided. Additional types of UUSL CS embedded with IAU bands are applicable and are in the scope of the invention.

Additional components which enable to establish a strong connection of the coupling panels and the IAU are applicable and are also in the scope of this invention.

### Continuous Joint (CJ)

FIGS. 32A-32B illustrate a continuous joint CJ, in exploded and assembled perspective views, respectively. As shown in the figures, a joint CJ comprises a thin elongated elastic cuboid strap ST, one face of which ST1 is interconnected to wall 53 of coupling panel 40A and a second face ST2 parallel to the face ST1 which is interconnected to wall 31 of coupling panel 40B. The interconnection between strap ST and the coupling panels may include mechanical means, fusion, assimilation, very strong adhesion, or by any other suitable process that will ensure a strong and long-lasting connection.

A significant advantage of joint CJ defined by strap ST and shown in FIG. 33C, in comparison to a common sheet junction (CSJ) shown in FIG. 33A or an inner axis junction (IAJ) shown in FIG. 33B, is the location of its axis of rotation CR1. Center of rotation CR1 has been marked as a single point for the sake of simplicity, but in reality the location of the axis of rotation of each point of non-circular curve BAC coinciding with the upper CJ surface is different, being proximate to CR1. Axis of rotation CR1 is significantly spaced from the upper surface of the adjacent coupling panels and is not coincident with the upper surface of the adjacent coupling panels. In contrast, axis of rotation CR2 of joint IAJ and axis of rotations CR3 of joint CSJ are coincident with the upper surface of the adjacent coupling panels. When the two coupling panels are rotated, a curve BAC produced by the elastic strap ST is a curve with a continuous curvature, e.g. parabola.

As shown in FIGS. 33A-33B when the axis of rotation is coincident with the upper surface of the adjacent coupling panels, a relative angular displacement of the adjacent coupling panels will generate a sudden discrete change in slope of the two coupling panels at the axis of rotation. When the axis of rotation is located above the upper surface of the adjacent coupling panels, on the other hand as illustrated in FIG. 33C, the relative angular displacement of the adjacent coupling panels will produce a continuous curvature (i.e. continuous change of the slope) having an arc length BAC of the strap surface extending between the two upper surfaces 46 of the adjacent coupling panels.

The use of continuous joint CJ is advantageous when the common sheet is used for an ornamental purpose and is very thin and gentle and cannot bear the relative low forces which developed in the common sheet during the rolling and unrolling process, or when the common sheet or the lamination layer is not sufficiently elastic, such that each sudden discrete change in slope is liable to cause the appearance of unappealing folds in the common sheet or in the lamination layer. As illustrated in FIGS. 34A-34B, the use of joint CJ enables to implement a wide range of common sheets and sensitive lamination layers almost independently of the strength or elasticity of the sheet, due to its ability to avoid almost entirely force transmission to the common sheet and to the lamination layer and due to its continuous curvature. Consequently, continuous joint CJ functioning as additional force transmitting means or as direction-sensitive displacement facilitating means will help preserve the appealing appearance of the common sheet and of a lamination layer when used.

When a coupling panel comprises both an inner axis junction and a continuous joint as shown in FIG. 33D, the location of its axis of rotation CR2 is advantageously able to coincide with the axis of rotation of the common sheet, lamination layer or both while benefiting from continuous curvature during angular displacement.

It will be appreciated that any coupling panel described herein can be used in conjunction with continuous joint CJ in order to produce a UUSL CS. Also, easy to manufacture rectilinear coupling panels REC1 and REC2 shown in FIG. 34C may be formed with any suitable recess and complementary strap, such as the rectilinear recess and complementary rectilinear CJ shown in FIG. 34C, or alternatively with one or more recesses RC1 shown in FIG. 34D having a rectilinear central region and a plurality of longitudinally spaced uniform recesses laterally extending from the central recess, to provide a simple and reliable connection for strap ST. Additional recesses RC2 may also be provided to assist in anchoring strap ST. As shown in FIG. 34E, recesses RC2 may have T-shaped recesses laterally extending from the central recess. Alternatively or additionally, recesses RC2 may be configured with various uniform or non-uniform formations extending towards and in the depth or to the sides of coupling panels REC1 and REC2, for example a deep recess that is parallel to the main face, in order to enhance the anchoring of joint CJ to coupling panels REC1 and REC2. Additional methods of anchoring strap CJ to coupling panels REC1 and REC2 are also applicable and are also in the scope of the invention.

### Inverse Folding Tongue and Groove (IFTG)

As described above and illustrated in FIG. 35A, the pivoted coupling panel of two adjacent FTG coupling panels of a UUSL CS can have a relative angular displacement Θ₁ in one rotational direction and be restricted in the opposite rotational direction in order to have a leveled surface when the UUSL CS is unrolled.

FIG. 35B illustrates an Inverse Folding Tongue and Groove (IFTG) coupling panel which facilitates relative angular displacement Θ₂ in one rotational direction and angular restriction in the opposite rotational direction, allowing a UUSL CS comprising IFTG panels to be rolled and unrolled in the opposite directions to a UUSL CS comprising counterpart FTG coupling panels with respect to an applied common sheet, while the upper surface of the coupling panels remains continuous as illustrated in FIGS. 38A-38B.

There are many applications for which a tongue and groove connection with a relative angular rotation is needed, one of them will described in detail below.

FIGS. 36A-36C illustrate an embodiment of an Inverse Tongue and Groove (IFTG) coupling panel which is configured with mutually parallel upper face IF1 and lower face IF2, side faces IF3 and IF4 which may be perpendicular to upper and lower faces IF1 and IF2, forward inclined face IF23, and rearward hollowed inclined face IF17. Rearward face IF17 has two opposed walls IF15 and IF16 which are contiguous with side faces IF3 and IF4, respectively, and between which the cavity of groove GR is provided. Each of side faces IF3 and IF4 is configured with a first sharp-angled triangular upper wall IF7 that points away from the core IF5 to accommodate tongue TN and with a second sharp-angled triangular upper wall IF9 extending between interior walls IF13 and IF14 and pointing towards rearward face IF17 to accommodate elements defining groove GR.

Tongue TN is configured with forward inclined face IF23, opposed tongue side faces F21 and F22 which are preferably non-perpendicular to forward face IF23, and a rearwardly disposed arcuate wall IF18. Arcuate wall IF18 laterally extends between tongue side faces F21 and F22 and circumferentially extends between lower face IF6 of the upper wall IF7 of side faces IF3 and IF4 and forward face IF23, subtending an angle of approximately 90 degrees. Tongue TN is connected to solid core IF5, located generally between side faces IF3 and IF4 and to the side of the groove, at the oblique lower face IF6 of upper wall IF7 and from the side by corresponding protruding portion IF8, which is contiguous with both lower face IF6 of upper wall IF7 and the forward inclined face of face IF3. Tongue side faces F21 and F22 are formed with arcuate recesses IF19 and IF20, respectively, which also circumferentially extend from lower face IF6 of upper wall IF7 to forward face IF23. At a circumferential terminal edge of recesses IF19 and IF20, protrude from the recess surface narrow protrusions IF27 and IF28, respectively, by a dimension that is significantly less than the depth of the recess in such a way that one side of the protrusion is coplanar with face IF23. If so desired, protrusions IF27 and IF28 may be factory produced in other ways, such as being formed at an intermediate region within recesses IF19 and IF20, respectively, or not being coplanar with face IF23.

Groove GR is an interspace within which a tongue TR of an adjacent coupling panel is receivable and angularly displaceable. Groove GR is defined by two opposed arcuate protrusions IF25 and IF26 which protrude from interior faces IF13 and IF14 of side faces IF3 and IF4, respectively, and from arcuate face IF12 contiguous therewith and located therebelow. Protrusions IF25 and IF26 extend circumferentially from the inclined interior face IF11 defining upper wall IF9 to the exterior inclined and hollowed face IF17, in a circumferential direction opposite to that of arcuate tongue recesses IF19 and IF20 provided in the same coupling panel. Protrusions IF25 and IF26 may be configured respectively with thin upper arcuate faces IF46 and IF47, lower arcuate faces IF48 and IF49, and main faces IF42 and IF43 substantially perpendicular to the upper and lower faces. When a tongue TR of an adjacent coupling panel is positioned within groove GR, the groove protrusions IF25 and IF26 are receivable within the tongue recesses IF19 and IF20, respectively, to facilitate relative angular displacement therebetween.

Stopper elements IF29 and IF30, which may be removable or alternatively permanently secured, are fitted at a terminal end of arcuate protrusions IF25 and IF26, respectively. Each of the stopper elements IF29 and IF30 may be of a rectilinear configuration and fitted in complementary recesses IF44 and IF45 formed in walls IF15 and IF16, respectively, so that their exterior face IF37 and IF38, respectively, will be coplanar with rearward inclined face IF17. The width of stopper elements IF29 and IF30 may be equal to the width of protrusions IF25 and IF26, respectively, and the stopper elements may be held by a screw or any other suitable and strong connection within the corresponding recess. Lower wall IF10 may be formed with a notch IF31 removed from rearward face IF17 for a short extent, being configured by two parallel faces IF32 and IF33 extending between faces IF17 and IF34 that are perpendicular thereto. The width of notch IF31 is substantially equal to the width of protruding portion IF8 in addition to a small clearance, allowing protruding portion IF8 to pass through notch IF31 without interference when tongue TN is being angularly displaced with respect to groove GR.

FIGS. 36D-E illustrate a method for interconnecting adjacent IFTG coupling panels. As shown in FIG. 36D, IFTG coupling panel IFTG1 comprises two parts IFTGPT1 and IFTGPT2 wherein part IFTGPT2 includes a built in stopper elements. Accordingly as illustrated in FIG. 36E, it is applicable to interconnect the IFTGPT1 coupling panels in a first stage and then in a second stage to assemble the corresponding IFTGPT2 parts. The interconnection between parts IFTGPT1 and IFTGPT2 may be by mechanical, strong adhesive, or chemical means, or by any other suitable means well known to a person skilled in the art. The materials from which stopper element IFTGPT2 and coupling panel IFTGPT1 are made of may be different.

FIGS. 37A-37C illustrate two coupled IFTG coupling panels IT1 and IT2 that are angularly displaceable similarly to coupled FTG coupling panels, but in an opposite rotational direction. In order to interconnect two IFTG adjacent coupling panels, tongue TN2 of coupling panel IT2 is inserted into groove GR1 of coupling panel IT1, when the dimensions of tongue TN2 and groove GR1 are similar. When stopper elements IF29 and IF30 are removed, tongue recesses IF19 and IF20 of coupling panel IT2 are coupled respectively with groove protrusions IF25 and 126 of coupling panel IT1, and then stopper elements IF29 are IF30 are attached by screws or any other suitable means into recesses IF44 and IF45 respectively, in order to create a barrier which prevents the detachment of the coupling panels and to enable the relative angular rotation in a first direction of the coupling panels while their upper faces IF1 are coplanar.

Coupling panels IT1 and IT2 may preferably be connected at rotational axis C by a strong, unstretchable, thin and foldable strap STP which is anchored and integrated at depth within the upper surfaces IF1 (FIG. 36B) of both adjacent coupling panels thereto. A strong, unstretchable and thin common sheet which is integrated in depth within the upper surfaces IF1 (FIG. 36B) of both adjacent coupling panels may also be used to stabilize the location of the center of rotation at axis C.

An IFTG coupling panel without stopper elements IF29 and IF30 or with integrated stopper elements IF29 and IF30 is also applicable. The stopper elements may be designed to enable the interconnection of adjacent coupling panels and to disable the separation thereof.

As illustrated in FIGS. 37B-37C, since protrusions IF25 and IF26 are dimensioned to be angularly displaced within recesses IF19 and IF20 respectively, a relative angular displacement Θ in a second direction opposite to the first direction is enabled up to an angle of Θ=80. Adding a common sheet as illustrated in FIGS. 38A-38B will enable the angular displacement of the coupling panels in the second direction while preventing almost entire force transmission to the common sheet, preventing tears and folds in the sheet, and preventing the detachment of the sheet from the upper face of the coupling panels. This feature is a result of the absence of relative displacement between the common sheet and the upper surface of the coupling panels. Consequently, tears and folds in the common sheet will be prevented and the appealing appearance of the common sheet will be preserved.

A long IFTG coupling panel may be produced by a serial connection of individual IFTG coupling panels IT side to side, i.e. when side IF5 of a first coupling panel abuts side IF4 of a second coupling panel (FIG. 36B).

### Composite Coupling Panel (CCP)

FIGS. 38I-38U illustrate composite coupling panels which are produced by utilizing the spatial structure of the coupling panels.

As shown in FIGS. 38I, three different types of coupling panels RCP1, FTG1 and IACP1, for example each having a thickness of 5 mm, function as subunits that are interjoined at their side to create a composite coupling panel SF1, which is shown in FIGS. 38J and 38K and is the constituent member of elongated composite coupling panel CCP1 which is illustrated in FIG. 38O. A composite coupling panel simultaneously provides the advantages of various types of coupling panels which have been described hereinabove in detail, as well as of additional types of coupling panels when needed. Composite coupling panel SF1 has the advantages of high resistance to bending in a leveled configuration through the influence of coupling panel FTG1, a built-in inner axis through the influence of coupling panels RCP1 and IACP1, high resistance to axial forces and additional resistance to bending in a leveled configuration through the influence of coupling panel RCP1, and an improved appearance at the side through the influence of coupling panel RCP1.

FIGS. 38R-38T illustrate a UUSL CS that comprises a plurality of elongated composite coupling panels CCP1. As shown in FIGS. 38S-1 and 38T-1, a significant advantage of using composite coupling panels CCP1 is the minimal inter-panel interspace that prevents inserting a finger or any other parts of the body between adjacent coupling panels while they are being angularly displaced, thereby preventing injuries such as a smashed finger or cut skin. There is a risk of such injuries with respect to coupling panels that are configured with a relatively large cooperating interspace. Bodily injury is also able to be prevented during angular displacement of adjacent coupling panels when a plurality of the adjacent coupling panels are covered with a protective sheath.

FIG. 38L illustrates two identical but oppositely oriented coupling panels ECP1 and ECP2, which can each be used as a free side sub-coupling panel, for example added to a corresponding free side of composite coupling panel SF2 illustrated in FIGS. 38M-38N. Both of them have a rectangular section formed with a curved or inclined groove that is recessed in an inwardly positioned face, and a tongue linearly extending from the rectangular section that has a curved lower face. The tongue of a second coupling panel is insertable within the groove of a first coupling panel interconnected therewith, as shown in FIG. 38N(d). These free-side sub-coupling panelsl ECP1 and ECP2 are configured to provide an appealing appearance of a composite coupling panel at its free sides, and also to prevent injury by virtue of the minimal interspace between the two interconnected coupling panels that is gradually decreased as the tongue is increasingly inserted within the depth of the groove. Each of FIGS. 38M-38N illustrates four stages in assembling and angularly displacing two adjacent composite coupling panels that comprise a free side sub-coupling panel.

FIG. 38O illustrates elongated composite coupling panel CCP1, which comprises a plurality of adjacent composite coupling panels SF1 (FIG. 38K). Elongated end composite coupling panels EECCP1 and EECCP2 illustrated in FIGS. 38P and 38Q, respectively, and having a planar end face EF are interjoinable with one of the elongated panels CCP1 at a corresponding free side.

FIGS. 38R-38T illustrate three configurations of a system SYS1, which is a UUSL CS comprising a plurality of adjacent elongated composite coupling panels CCP1 and a coupling panel EECCP1 or EECCP2 at its free sides. System SYS1 is advantageous in terms of its strength, its built-in rotation mechanism and the interspace-minimized and consequently relatively smooth integrated rear surface SAS1 of the connecting system shown in FIG. 38T, which is designed to prevent bodily injuries. When a composite coupling panel comprises only coupling panels RCP1 and IACP1 (FIG. 38I), a UUSL CS may be provided with a continuous integrated main face surface and opposed smooth and safe integrated rear face surface, although the strength and the resistance to bending of the UUSL CS may be decreased.

FIG. 38Ua-f illustrate six additional types, respectively, of composite coupling panels, each having its advantages and disadvantages. As can be appreciated, there are endless types and combinations of composite coupling panels and of corresponding UUSL CS that can be provided and that are also in the scope of the invention.

Although not mentioned with respect to the description of various implementations below, it will be appreciated that a suitable composite coupling panel may be used as a substitute to one of the mentioned coupling panels when a safety precaution is needed.

There are innumerable applications such as folding tables, folding shelves, and folding beds for which a UUSL CS needs to be safe for use in order to avoid bodily injuries. FIGS. 38V-38X illustrate a Completely Safe coupling panel (CSC) and completely safe UUSL CS (CSU), which are recommended to use when extra precaution is needed.

FIG. 38Va illustrates two rounded coupling panels IACP1 and RCP1, which are the components of the composite coupling panel CSC illustrated in FIGS. 38Vb and 38Vc. A CSC is the constituent member of the Completely Safe coupling panels CSC1, CSC2 and CSC3, which are shown in FIG. 38W. Coupling panels CSC2 and CSC3 are free side composite coupling panels configured with a planar end face EF and coupling panel CSC1 is an intermediate composite coupling panel.

FIG. 38X illustrates a system CSU, which is a UUSL CS that is comprised of composite coupling panels CSC1, CSC2 and CSC3 illustrated in FIG. 38W. As shown in FIGS. 38Xa-38Xb, for each configuration of system CSU, whether leveled or unleveled, the rear face PF of the system which is parallel to the main face MF1 of the system is smooth and accordingly prevents bodily injuries when system CSU is used. Rear face PF of system CSU is able to be smooth by virtue of coupling panel CSC1 configured with an arcuate lower face of the tongue and an interfacing lower wall extending to rear face PF and having a minimal thickness.

As referred to herein, a “smooth face” means that there are no gaps in the face between adjacent coupling panels during rolling and unrolling operations. “Relatively smooth face” means that there are very small gaps in the face between adjacent coupling panels during the rolling and unrolling operations that do not cause bodily injuries or damage to web apparatus in contact with the face.

FIG. 38X1(b) illustrates a composite coupling panel CIFTGCP which comprises a plurality of IFTG coupling panels located side by side as shown in FIG. 38X1(a).

FIG. 38X2(d) illustrates a safety composite IFTG coupling panel CSIFTGCP. The constituent member CMIFTG of composite coupling panel CSIFTGCP is shown in FIG. 38X2(c) and comprises a thin IFTG coupling panel NIFTG and coupling panel LFR having a safety enhancing lower rounded face as illustrated in FIGS. 38X2(a)-(b)

FIG. 38Y illustrates details of a Half-Concealed and Sealed UUSL CS (HCSU).

A HCSU unit is shown in FIGS. 38Ya-b when set in rolled and leveled configurations, respectively, and is able to be assembled by inserting, for example by permanently attaching, a CSU shown in FIGS. 38Xc and 38Yc into a corresponding frame unit FU shown in FIG. 38Yd that comprises a surface NCH1 recessed from elastic frame FR1. As a result, the free end sides and each rear face, i.e. the face of each corresponding coupling panel of the CSU that is parallel to the main face, of the CSU are completely concealed and even sealed if necessary by frame unit FU, as shown in FIG. 38Yb-1, such that only the main face of the CSU is exposed. HCSU main face MF2 shown in FIG. 38Yb may remain exposed or covered by an ornamental sheet, lamination layer or both to emulate a monolithic surface. The exposed faces of frame FR1 may be also ornamental to enhance the appealing appearance of the illusive monolithic surface.

FIG. 38Z illustrates details of a Completely Concealed and Sealed UUSL CS (CCSU).

A CCSU unit is shown in FIGS. 38Za-b when set in rolled and leveled configurations, respectively, and is able to be assembled by inserting, for example by permanently attaching, a CSU shown in FIGS. 38Xc and 38Zc within an opening provided with elastic envelope ENV1 shown in FIG. 38Zd. Alternatively, protective envelope ENV1 may be produced by other suitable means. For illustrative purposes, envelope ENV1 is graphically rendered transparent, but, as appreciated, the CSU is positioned within cavity NCH2 that is enclosed by envelope ENV1 and is concealed, optionally allowing the CSU to be sealed. Main face MF3 of the CCSU unit shown in FIG. 38Zb and each outer face of envelope ENV1 can be ornamental or laminated in order to emulate the illusive appearance of a monolithic surface.

The use of a HCSU unit or a CCSU unit, or similar webs, which have a smooth or relatively smooth rear face is advantageous as it will not damage a surface of protective envelope ENV1 or elastic frame FR1 in abutment with the rear face during the rolling and unrolling operations.

Although the CSU is shown to be comprised of composite coupling panels, it will be appreciated that it could be comprised of any coupling panel described herein. Likewise a composite coupling panel may be comprised of any coupling panel, or of any combination of coupling panels, described herein.

### Composite Improved IFTG Coupling Panel (IIFTG)

FIGS. 143-144B illustrate two coupling panels IFTGC1 and IFTGC2, which are the components of coupling panel IFTGC illustrated in FIG. 145C, and which are, in addition to coupling panel IFTG, are the components of coupling panel IIFTG that illustrated in FIG. 146C. Coupling panel IIFTG is an improved IFTG coupling panel that has an improved ability to absorb lateral forces and provides a more stable location of the axis of rotation.

As shown in FIG. 143, coupling panel IFTGC1 is configured with mutually parallel upper surface 1111 and lower surface 1122, a tongue 1110 and groove 1115 that are all formed in one piece together with the core portion 1123. Tongue 1110 has a forward inclined face 1109 inward circumferential face 1107, protrusion 1008 which is located at the bottom of front face 1109 and configured with lower circumferential face 1105 and rearward linear face 1106. Groove 1115 is defined by the lower inclined face 1113 of upper wall 1114 and by the upper circumferential face 1116 of lower wall 1121.

Tongue 1110 and core 1123 are connected by a narrow neck 1004 that has an inclined lower face 1112. A narrow protrusion 1120 is located at the rear free edge of lower wall 1121 and configured with rear face 1119, upper circumferential face 1118 and a front face 1117.

As shown in FIG. 144, coupling panel IFTGC2 is configured with mutually parallel upper surface 1131 and lower surface 1142, a tongue 1130 and groove 1135 that are all formed in one piece together with the core portion 1143. Tongue 1130 has an forward arcuate face 1109, inward circumferential face 1127, a relatively wide protrusion 1125 which is located at the bottom of front wall 1129 and configured with lower circumferential face 1125 and rearward linear face 1126. Groove 1135 is defined by a lower arcuate face 1133 of upper wall 1134 and upper circumferential face 1136 of lower wall 1141. A protrusion 1140 is located at the rear free edge of lower wall 1141 and configured with rear face 1139, upper circumferential face 1138 and a front face 1137. Tongue 1130, core 1123 and upper wall 1134 are unconnected, while the ability to be positioned is mutual contact is provided by the interjoining of coupling panels IFTGC1 and IFTGC2, as will be described hereinbelow.

FIGS. 143A and 143B illustrate two adjacent IFTGC1 coupling panels CP100 and CP101, in a leveled configuration in FIG. 143A and with a relative angular displacement around axis line A. as illustrated in FIG. 143A in a leveled configuration. Face 1106 of protrusion 1108 abuts face 1117 of protrusion 1120 and accordingly the counterclockwise rotation of coupling panel CP101 and the clockwise rotation of coupling panel CP100 are prevented. In the opposite directions, as illustrated in FIG. 143B, the relative angular rotation is applicable by virtue of the ability of circumferential face 1107 of coupling panel cp101 to slide along circumferential face 1116 of coupling panel CP100.

FIGS. 144A and 144B illustrate two adjacent IFTGC1 coupling panels CP100 and CP101, in a leveled configuration in FIG. 143A, and with a relative angular displacement around axis line A in FIG. 143B. as illustrated in FIG. 143A in a leveled configuration. Face 1126 of protrusion 1128 abuts face 1137 of protrusion 1140 and accordingly the counterclockwise rotation of coupling panel CP101 and the clockwise rotation of coupling panel CP100 is prevented. In the opposite directions, as illustrated in FIG. 144B, the relative angular displacement is made possible by virtue of the ability of circumferential face 1107 of coupling panel cp121 to slide along circumference face 1116 of coupling panel CP120.

As shown in FIG. 144A, tongue 1130 of coupling panel CP121 and the lower wall 1141 of coupling panel CP120 are in abutment along the length of a large arc CD and accordingly, as shown in FIGS. 145A-1456C when coupling panels IFTGC1 and IFTGC2 and coupling panel IFTG are integrated, a coupling panel IFTGI which has a stable axis of rotation is produced.

As illustrated in FIGS. 145A-145C, tongue 1130, core 1143 and upper wall 1134 of coupling panel IFTG2 are interconnected according to the integration with the monolithic coupling panel IFTG1 and accordingly the creation of the composite monolithic coupling panel IFTGC, which as illustrated in FIGS. 146A-146C, its integration with coupling panel IFTG produce the composite coupling panel IIFTG. As shown in FIGS. 147A-B, the integration of several coupling panels IIFTG produces an elongated coupling panel IIFTGCP. FIGS. 147C-D illustrate the interconnection of two IIFTGCP in coplanar configuration at FIG. 147C, and with a relative angular displacement around a pivot line in FIG. 147D. The pivot line is advantageously able to be stable without use of a thin and foldable anchored strap.

### Multi-Directional Coupling Panels (MDC) and Multi-Directional UUSL CS (MDU)

FIGS. 38C-38H illustrate multi-directional coupling panels. When these multi-directional coupling panels are selectively interjoined, the UUSL CS systems 2DR, 3DR and 4DR illustrated respectively in FIGS. 38F, 38G and 38H are produced so as to be rollable and unrollable in two directions, three directions and four directions, respectively. The following description relates to multi-directional coupling panels that are FTG coupling panels, and the configuration of each of the tongues and grooves may be in accordance with any embodiment describes herein, for example those of coupling panel 40 of FIG. 4. Since each of the coupling panels has more than one tongue, a connecting system within which it is interjoined is able to be rolled or unrolled in more than one direction, and the coupling panels and connecting system are thus considered multi-directional.

It will be appreciated that the multi-directional coupling panels may be embodied by any other coupling panel described herein in lieu or in addition to FTG coupling panels, including composite coupling panels to prevent bodily injury during a rolling or unrolling operation. The multi-directional coupling panels may also be interconnected by direction-sensitive displacement facilitating means such as inner axis (IA), a common sheet, continuous joint (CJ) or any other rotation facilitating means which maintains the axis of rotation in any desired direction, such as coincident with the main face of the coupling panels or located in its vicinity. When other coupling panels or other direction-sensitive displacement facilitating means are employed, systems 2DR, 3DR and 4DR are accordingly modified, mutatis mutandis.

For purposes of illustration, systems 2DR, 3DR and 4DR are shown to be an array of multi-directional coupling panels that is produced with a plurality of uniform rows, but it will be appreciated that other suitable connecting system arrangements are also within the scope of the invention.

FIG. 38C illustrates coupling panel 2DCN, which is the constituent member of system 2DR. Multi-directional coupling panel 2DCN having a square main face is configured with two tongues T1 and T2 protruding from faces F1 and F2, respectively, and with two grooves G1 and G2 provided at an intermediate region of the two remaining faces. While the tongues of a first coupling panel 2DCN are interjoined with corresponding grooves of second and third coupling panels 2DCN, respectively, system 2DR is produced. System 2DR is shown in a leveled configuration in FIG. 38Fa, and is shown to be rolled in a first direction in FIG. 38Fb and in a second direction in FIG. 38Fc, the first and second directions being mutually exclusive.

FIG. 38D illustrates coupling panel 3DCN, which is the constituent member of system 3DR. Multi-directional coupling panel 3DCN consists of two interjoined sub-coupling panels 3DS1 and 3DS2, each of which having a triangular main face. While sub-coupling panel 3DS1 is configured with three tongues T3-T5 protruding from its three faces F3-F5, respectively, sub-coupling panel 3DS2 is configured with three grooves G3-G5 provided at an intermediate region of each of its three faces. Multi-directional coupling panel 3DCN is produced when tongue T4 of sub-coupling panel 3DS1 is lockingly received in groove G5 of sub-coupling panel 3DS2, allowing relative angular displacement of sub-coupling panels 3DS1 and 3DS2 about diagonal D1 of multi-directional coupling panel 3DCN. Multi-directional coupling panel 3DCN is likewise able to be interjoined with up to four other multi-directional coupling panels 3DCN with this tongue and groove arrangement.

System 3DR is shown in a leveled configuration in FIG. 38Ga, and is shown to be rolled in a first direction in FIG. 38Gb and in a second direction in FIG. 38Gc. When system 3DR is rolled in the first or second direction, all coupling panels 3DCN in a given row or column are disposed at a uniform angular disposition, as shown in FIGS. 38Gb-1 and 38Gc-2. FIG. 38Gd illustrates system 3DR when folded in a third direction whereby the two sub-coupling panels 3DS1 and 3DS2 of at least one multi-directional coupling panel 3DCN are angularly displaced one from the other, for example at the two corners shown in FIGS. 38Gd-1 and 38Gd-2, respectively. When system 3DR is rolled in the third direction, coupling panels 3DCN in a given row or column are disposed at a non-uniform angular disposition. System 3DR is shown in FIG. 38Ge to be folded in both the first direction at several rows and in the third direction at one corner.

FIG. 38E illustrates coupling panel 4DCN, which is the constituent member of system 4DR. Multi-directional coupling panel 4DCN consists of four interjoined sub-coupling panels 4DS1, 4DS2, 4DS3 and 4DS4, each of which having a triangular main face. While sub-coupling panel 4DS1 is configured with three tongues T6-T8 protruding from its three faces, respectively, sub-coupling panel 4DS2 is configured with two grooves G6 and G7 provided at an intermediate region of two of its faces F6 and F7, respectively, and with narrow tongue T9 protruding from face F8. Groove G7 is accessible at both faces F7 and F8, and support element 333 extending downwardly from the main face at face F8 is interposed between tongue T9 and a portion of groove G7. Sub-coupling panel 4DS3 has two grooves G8 and G9 provided at an intermediate region along the entire length of two of its faces. At its third face, a narrow third groove G10 adapted to receive tongue T9 of sub-coupling panel 4DS2 and a narrow tongue T10 for insertion in the portion of groove G7 adjacent to support element 333 are provided. Sub-coupling panel 4DS4 has two tongues T11 and T12 at two of its faces, respectively, and groove G11 at its third face.

Multi-directional coupling panel 4DCN is produced when tongue T7 of sub-coupling panel 4DS1 is lockingly received in groove G6 of sub-coupling panel 4DS2, tongue T8 of sub-coupling panel 4DS1 is lockingly received in groove G11 of sub-coupling panel 4DS4, tongue T12 of sub-coupling panel 4DS4 is lockingly received in groove G8 of sub-coupling panel 4DS3, and tongue T9 of sub-coupling panel 4DS2 is lockingly received in groove G10 of sub-coupling panel 4DS3 and tongue T10 of sub-coupling panel 4DS3 is lockingly received in groove G7 of sub-coupling panel 4DS2. As a result, sub-coupling panels 4DS1 and 4DS2 are angularly displaceable relative to sub-coupling panels 4DS3 and 4DS4 about diagonal D2 of multi-directional coupling panel 4DCN. Alternatively, sub-coupling panels 4DS1 and 4DS4 are angularly displaceable relative to sub-coupling panels 4DS2 and 4DS3 about diagonal D3. Multi-directional coupling panel 4DCN is likewise able to be interjoined with up to four other multi-directional coupling panels 4DCN with this tongue and groove arrangement.

System 4DR is shown in a leveled configuration in FIG. 38Ha, and is shown to be rolled in a first direction in FIG. 38Hb and in a second direction in FIG. 38Hc. When system 3DR is rolled in the first or second direction, all coupling panels 4DCN in a given row or column are disposed at a uniform angular disposition, as shown in FIGS. 38Hb-1 and 38Hc-2. FIG. 38Hd illustrates system 4DR when folded in third and fourth directions simultaneously. When one or more multi-directional coupling panels 4DCN are folded in the third direction, for example at two corners of system 4DR, two sub-coupling panels of a multi-directional coupling panel 4DCN are angularly displaced about diagonal D2, as shown in FIGS. 38Hd-1 and 38Hd-2. When one or more multi-directional coupling panels 4DCN are folded in the fourth direction, for example at two other corners of system 4DR, two sub-coupling panels of a multi-directional coupling panel 4DCN are angularly displaced about diagonal D3. When system 4DR is folded in the third or fourth direction, coupling panels 4DCN in a given row or column are disposed at a non-uniform angular disposition. System 4DR is shown in FIG. 38He to be folded simultaneously in the second direction at several rows, in the third direction at one corner, and in the fourth direction at another corner.

The leveled configuration of each multidirectional UUSL CS may be designed to various configurations which are not planar as shown herein.

### Unsegmented Web

Although the description above relates to a UUSL CS made of discrete coupling panels, for some implementations it may be considered advisable to use a monolithic UUSL sheet 730 shown in FIG. 138A. Sheet 730 may be comprised of two layers LA and LB, where layer LA is made of elastic material which has the ability to undergo longitudinal deformations under tension and substantially no longitudinal deformation under compression. In contrast to layer LA, layer LB is made of elastic material which has the ability to undergo longitudinal deformations under compression and substantially no deformation under tension. With a strong connection at the two abutting layers as shown, a sheet 730 is provided whose axis of rotation is located at the interface of the two layers and accordingly has the ability to bend only in one direction due to the ability of layers LA and LB to deform under tension and compression respectively as shown in FIG. 138B, and to prevent bending in the opposite direction due to the relatively zero deformation of layers LA and LB under compression and tension respectively as shown in FIG. 138C. As a result, sheet 730 may be folded or rolled in only one direction and will apply a stiff leveled surface in a predefined configuration. A plate which comprises a plurality of folding layers located in a plane that is parallel to its cross section can be used for layer LA, and a similar plate comprising additional longitudinal wires which prevent its expansion but enable its compression can be used for layer LB. Both plates may contain additional materials in order to achieve a stable structure.

FIGS. 139A-139B illustrate a semi monolithic UUSL sheet. Sheet 740 shown in FIG. 139A comprises 4 layers 741-744 which are strongly interconnected and shown in FIG. 139B. Layer 741 is a high tension bearing mesh which can fold but have relatively zero deformation under tension. Layer 742 is an ordinary elastic sheet which can have longitudinal deformations when exposed to tension or compression. Layer 742 is a high tension bearing mesh which has the same modulus of elasticity as layer 742 and accordingly has the same longitudinal deformation under identical longitudinal stress. Layer 744 is a stiff solid surface which has relatively zero deformation when exposed to compression, after being cut precisely to narrow straps e.g. by a laser.

According to the sheet orientation shown in FIG. 140A, the sheet can bend and roll clockwise or counterclockwise according to the ability of layers 742 and 743 to undergo deformation under longitudinal stress and the ability of mesh 741 to be folded. As shown in FIG. 140B, sheet 740 cannot bend or roll in the opposite direction according the inability of the straps to undergo deformation when exposed to pressure and the relatively zero deformation of mesh layer 741 when subjected to tension. Although it may not be used, mesh layer 743 prevents the development of tears in the lower face of layer 742 when sheet 740 is bent or rolled. As a result, sheet 740 is a semi monolithic UUSL CS which may be folded or rolled in one direction and create a stiff and leveled surface in a predefined configuration.

A third monolithic sheet constituting an alternative to a UUSL CS in some of the applications described herein is sheet 750 shown in FIG. 141. Sheet 750 comprises longitudinal stiff straps 751 which are interconnected and embedded within elastic material 752 such as in a pouring process while the elastic material is in a liquid state. As a result, after the hardening of the elastic material, sheet 750 which can bend to both sides in x direction but cannot bend in y direction is generated. This type of sheet may be rolled in x directions and as illustrated in FIG. 142 according to the stiffness of straps 751 may be stiff and leveled when supported to the length of his lateral free edges 753 and 754 by supports 755 and 756 or by any other suitable means. When the elastic material 751 is non-transparent, straps 751 are obviously unseen. When the elastic material 751 is transparent, straps 75 may be produced with the same or other material which has the same transparency but configured with much higher modulus of elasticity in order to have a stiff and unseen straps.

Although the description relates mainly to a UUSL CS which has the ability to be covered by a lamination and to create the appealing illusive appearance of a regular monolithic sheet regardless to its inner structure, the additional means introduced hereinabove with respect to an unsegmented web are also in the scope of the invention.

### Link Material Leveling System

In the implementation of an interior or exterior link material leveling system of FIGS. 39-56, the time needed to apply and level plaster, gypsum or other types of link material onto walls, such as concrete walls, is dramatically reduced relative to prior art means. Although the following description relates to an interior system, it will be appreciated that the invention is likewise applicable to an exterior system.

A hand held implement such as a trowel is generally used to apply and level plaster according to prior art methods. Since the thickness of the applied plaster cannot be accurately defined, and since the thickness of the applied plaster usually varies from one wall region to another following performance of an attempted leveling operation due the non-uniform nature of arm strokes, the time consuming prior art leveling operation is usually repeated in order to attempt to achieve a leveled surface.

Nowadays, there are more advanced and quicker methods of covering walls and ceilings at a construction site such as by advanced machinery and the use of monolithic boards. Each method has advantages and disadvantages, leaving room for improvement.

Covering even surfaces with rolls is widespread, but it is heretofore unknown to use rolls or foldable or flexible sheets in order to cover uneven surfaces. The present invention presents a method for simultaneously leveling and covering both even and uneven surfaces by means of an UUSL CS and particularly with the use of rolls.

As illustrated in FIG. 39, plaster may be speedily and uniformly applied onto an even or uneven wall of a building using the apparatus of the present invention. The plaster, or other link material such as cementitious material, is applied, preferably speedily, to an exposed wall by means of a pneumatic spray unit such as a compressor in step 152, or by any other suitable plastering machine, for example with an approximate 2-cm thickness. While the applied link material remains in a semi-solid form prior to solidification, a force is differentially applied in step 154 to an elongated sheet.

Although the description below relates mainly to walls, the description is also relevant for any coverable surface, mutatis mutandis.

In one embodiment, the force is applied by a UUSL CS comprising a rigid unidirectionally unrollable sheet, for example one formed with a plurality of identical cavities, such that each vertically adjacent cavity wall is sequentially and differentially brought in force applying relation with the wall of the building to which the link material has been applied. The rigid cavity wall, during application of the force, compresses the applied link material and urges the compressed link material in step 156 to flow into adjoining cavities whose cavity walls are sequentially brought into contact with the link material against the wall. The excess link material is pushed and driven along the wall, and the excess link material that will be used may be manually removed during or after application of the sheet with manual or mechanical means. Upon solidification of the link material, the interior decorative surface of the sheet remains uniformly leveled in step 158, being parallel to the interior surface of the wall of the building by virtue of the uniformly sized cavity walls, while the sheet is secured to the wall of the building.

FIGS. 40-45 illustrate one embodiment of an unrollable link material leveling system that employs a UUSL FTG CS, according to any of the embodiments described herein, which have preferably undergone a modification as will be described hereinafter.

The terms “interior surface” and “exterior surface” below mean the side of a surface which faces the room and the side of a surface which is in abutting relation with a wall (or ceiling), respectively, the exterior surface generally being closer to the exterior of the building.

FIGS. 40 and 40A illustrate a roll 165 constituting at least a portion of the link material leveling system. Roll 165 is configured as a sheet 167 having an uninterrupted surface 166, which may be an ornamental surface adapted to face the interior of a room, and a plurality of vertically extending cavities 168 wherein rounded T-shaped inter-cavity protrusions are formed on the exterior face of surface 166 to prevent bending of sheet 167 relative to a vertical plane. The cavities 168 extend from the upper surface 169 of the roll to a bottom surface thereof. Sheet 167 may be made of many different types of materials, such as polymeric materials, fiberglass, carbon fibers, bamboo, a cast material, complex materials and cement materials, and having specific thermal and acoustic characteristics, in accordance with desired functional needs, for example resembling a plaster texture. Roll 165 also has a plurality of vertically spaced and horizontally extending reinforcement bands 161a-e to prevent bending of sheet 167 relative to a horizontal plane, each reinforcement band consisting of a UUSL FTG CS comprising a plurality of coupling panels 170. Roll 165 may have standard dimensions, for example 2m×2.6 m, although a roll having other dimensions, particularly a very long roll, is advantageously possible. The rounded T-shaped inter-cavity protrusions contribute to the vertical stiffness of sheet 167 and the combination of both horizontal and vertical stiffness enable the leveled implementation of the sheet.

With respect to prior art techniques for applying link material, in contrast, the manipulation of large monolithic boards such as plasterboard having standard dimensions, e.g. 260*120 cm, onto wall 182 is unwieldy and involves a time-consuming process unless the board is attached to the wall at only several discrete points. When the exterior area of the board is entirely attached to the wall by the link material and correction is needed, the boards tend to break during removal attempts due to the adhesion forces that interact between the board and the wall, usually requiring the cooperation of more than one worker during a significantly long-duration time-consuming operation. Smaller plates are sometimes used, but such operations are even more time consuming.

As described hereinabove, the most significant advantage of the ability to roll the leveling system is the storability, portability and the ability to be effortlessly leveled and secured onto an uneven wall of very long sheets. Another advantage of the rollable leveling system is that sheets of a very large surface area, particularly very long sheets which facilitate the covering of an entire wall and even an entire interior face of a room without need of any prior art interfaces such as patches and sand for unifying smaller-sized coverings, may be used. In addition, the interior face of the sheet may be very rapidly, precisely and efficiently painted or provided with an ornamental design and even laminated in conjunction with a protective layer in the factory by an industrial process. Consequently, the duration of the very long time-consuming operations will also be significantly reduced at the site. The protective layer may be removed at any stage after sheet 167 is applied.

It is also possible with suitable equipment to cover an entire even or uneven exterior wall, for example the entire exterior wall of a multi-story building, by a single sheet, such as one that is unrolled downwardly from a highest region of the wall, thus reducing the physical activities and the duration of the operations needed for covering exterior walls relative to the prior art.

The processes described hereinabove, whether made manually or by automatic means, can dramatically reduce the time consuming procedure of even and uneven wall covering.

When there are openings in the wall, such as doors, windows, and electric sockets, the sheet may be applied onto the wall, and can be subsequently easily cut to the length of the opening edges in order to remove the unneeded pieces of sheet.

FIG. 40A illustrates the structure of sheet 167 when rolled, that is formed with a plurality of longitudinally spaced cavities 168 and that accommodates the attachment thereto of a corresponding reinforcement band 161a.

A first surface of each coupling panel 170 of the FTG UUSL CS is not visible, and is attached, for example adhesively attached, to sheet 167, and a second surface 174 thereof parallel to the first surface is positionable in abutting relation with a wall of the building. Even though each coupling panel 170 of the UUSL CS is attached to the rigid sheet 167, the sheet is afforded sufficient flexibility to facilitate an unrolling operation, and a subsequent rolling operation if needed.

As shown in FIGS. 42A and 42B when sheet 167 is unrolled, the FTG coupling panels 170 of the UUSL FTG CS are lockingly joined together and urge the sheet to be leveled horizontally. Sheet 167 is also leveled vertically due the stiffness of the rounded T-shaped inter-cavity protrusions 187. Consequently, sheet 167 is leveled in all directions when unrolled.

The ability to roll the link material leveling system has many benefits in terms of storability, portability and the ability to be effortlessly secured to a wall or ceiling by a single worker, particularly when the anticipated weight of sheet 167 is only a few kg since the majority of the link material is sprayed on the wall prior to the application of roll 165.

The leveled application of interiorly facing surface 166 onto wall 182 is shown by a top view in FIG. 41, following application of link material 186 onto wall 182 while a previous sheet 184 is already interfaced with wall 182 by means of link material 186 and is leveled. Sequential rolled sheet 187 is attached to previous sheet 184 by the insertion of terminal tongue 184a of sheet 187 into terminal groove 184b of sheet 184 and the unrolling of sheet 187 against the wall while being forced to contact the wall. FIG. 41 illustrates the unrolling process of sheet 187 while part of the roll is already applied. The unapplied sheet portion in the remaining roll 165′ has a vertical axis BA and the inter-cavity protrusions 187b are gradually more spaced from wall 182, as they are closer to remaining roll 165′. During application of a tangential unrolling force UNF to roll 165′, the unrolling force is transmitted through the height of roll 165′, causing inter-cavity protrusions 187i-k to be pushed against the accumulated link material 186′. Inter-cavity protrusions 187i-k protrude into the link material and, according to their instantaneous angular displacement, induce a compressive force cmp1 onto link material 186, forcing a portion thereof to flow into cavities 168i-k. The excess link material that has not flown into a cavity is pushed along the wall by roll 165′ in response to compressive force cmp2 induced by the link material that has already flowed into cavities 168i-k and to the unrolling force UNF. Through this process, the gap between the adjacent inter-cavity protrusions, e.g. inter-cavity protrusions 187h-j, and wall 182 gradually decreases while a uniform volume of link material 186 is received in each cavity 168 to ensure that sheet 187 will be secured to wall 182 while being leveled. This procedure is repeated while unrolling force UNF continues to be applied and additional inter-cavity protrusions are sequentially and differentially brought in force applying relation with wall 182.

Due to the differential application of link material, unrolling force UNF is advantageously of a sufficiently low magnitude so as to be applied by a single worker and is substantially uniform throughout the height of the roll by virtue of the roll stiffness. The link material is easily leveled by virtue of the stiffness of the vertical T-shaped inter-cavity protrusions 187b and of the vertically spaced UUSL FTG CS reinforcement bands.

As explained above and shown in FIG. 42A, the presence of the plurality of longitudinally spaced cavities 168 produces corresponding rounded T-shaped inter-cavity protrusions 187. Each rounded T-shaped inter-cavity protrusion 187 may be of the same height as the adjacent cavity 168, has a relatively thin exterior surface 193, and provides a sufficiently large moment of inertia to prevent bending of sheet 167 relative to a vertical plane. A truncated and rounded cavity wall 196 which extends from an adjacent exterior surface 193 to the thinnest sheet region 198 of a corresponding cavity 168 may subtend an angle of greater than 90 degrees and less than or equal to 180 degrees, and preferably less than or equal to 160 degrees, to completely prevent detachment of sheet 167 from a wall after the link material solidifies and the sheet is securely anchored to the wall.

Upper surface 169 of sheet 167 is shown to be substantially perpendicular to the exterior surface 193 of each inter-cavity protrusion 187, which is abuttable with a wall of the building, although upper surface 169 may be configured in other ways as well. A plurality of vertically spaced, longitudinally extending recesses 195 are formed in sheet 167. Each recess 195, which is rectangular, is recessed from the exterior surfaces 193, and has a depth less than the sheet thickness between interior surface 166 and an exterior surface 193.

A recess 195 is bounded from above and below by the extreme vertical edge of each exterior surface 193 and by the extreme vertical edge of a cavity wall 196. With respect to each cavity 168, the thickness of sheet 167 decreases from a maximum thickness at exterior surface 193 to a minimum thickness at the centerline 198 of cavity wall 196. Centerline 198 having a minimum sheet thickness represents a sheet region that is most weakened, and therefore most flexible.

Recess 195 is also bounded interiorly by surface 166. Recess 195 divides the portion of exterior surfaces 193 shown in the figure to two groups 197a and 197b, wherein corresponding exterior surfaces 193 of groups 197a and 197b are aligned and coplanar.

FIG. 42B illustrates a portion of an opened sheet 167 when a reinforcement band 161 is inserted in a corresponding recess and the first surface of each coupling panel 170 is attached to interior surface 166. The second surface of each coupling panel 170 is preferably coplanar with the exterior surfaces 193.

FIG. 43 illustrates a completely opened sheet 167 that is provided with a plurality of reinforcement bands, e.g. reinforcement bands 161a-e. Each coupling panel is preferably positioned such that its axis of rotation is aligned with the cavity wall centerline 198 (FIG. 142A) from above and below, to ensure that the flexibility of the sheet will be maximized at the sheet region in contact with the axis of rotation of the coupling panel. Thus the roll is advantageously able to be rolled and unrolled even though it is reinforced.

FIGS. 44A-B illustrate uninterrupted interiorly facing surface 166 of a completely opened sheet 167 while showing the plurality of inter-cavity protrusions 187 and a cavity 168 between each pair of adjacent inter-cavity protrusions 187.

FIG. 45 illustrates the longitudinal unidirectionally pivoting mechanism used in conjunction with the link material leveling system. As shown, the UUSL FTG CS constitutes a horizontally extending reinforcement band which is installed in a corresponding longitudinal recess 195 (FIG. 42A) in such a way that the axis of rotation adjoins a thinnest sheet region 198 that is positioned within the corresponding cavity 168. This arrangement enables angular displacement of the coupling panels and of the sheet despite the significant large vertical stiffness of the rounded T-shaped inter-cavity protrusions 187 which ensure the vertical leveling of the sheet when unrolled. The remaining thin layer of the sheet in the longitudinal recess 195 constitutes the common sheet, thus completing the structure of the pivoting mechanism. In the process of rolling and unrolling of the connecting system only linear elastic crease Q shown in FIG. 13A develops along cavity centerline 198 (FIG. 42A), and consequently interiorly facing surface 166 of the sheet remains esthetically appealing even during the process of alternate rolling and unrolling of roll 165 (FIG. 40).

As shown at FIG. 45, coupling panel 170 is similar to a FTG coupling panel 40 of FIG. 4 but with an addition of recess 171 formed at the edge of surface 43 and the complementary protrusion 172 formed at surface 38 of tongue 35.

Protrusion 172 is configured to be received within, and locked to, recess 171 of the adjacent coupling panel following angular displacement about axis of rotation P when the surface 174 of the two coupling panels and the adjoining exterior sheet surfaces 193 are in abutting relation with the wall of the building, to achieve temporary weak locking of each adjacent coupling panel which will become a permanent strong connection as the link material hardens. This additional locking helps to stabilize the sheet portion which has already been applied to the wall and leveled, yet with a substantially low effort allows the sheet to be removed by an opposite angular rotation of the sheet when correction is needed, prior to the solidification of the link material.

If for some reason a correction has to be made before the link material has solidified, coupling panel 170 is easily rotated in an opposite rotational direction about axis of rotation P without contacting the building wall due to the differential detachment which minimizes the adhesion forces that interact between the wall and the detached portion of the sheet according to the rolling process.

Any other coupling panel, whether or not described herein, which enables to create a suitable UUSL CS may also be employed in the link material leveling system.

In another embodiment shown in FIGS. 45A-B, a sheet 177, similar to sheet 167 of FIG. 42A, having a plurality of longitudinally spaced cavities 168 and T-shaped inter-cavity protrusions 187 which extend entirely along the height (or the length) of the sheet but configured without any reinforcement bands may also be employed. This type of sheet becomes unidirectionally leveled in one rotational direction by external supports while being flexible in the other rotational direction. The external supports, such as longitudinally extending and leveled panels 179 that are anchored to wall 182, are coverable by applied link material 186, allowing the sheet to be leveled in a direction usually perpendicular to, but may be in any other direction different from, the direction along which the T-shaped inter-cavity protrusions 187 extend. There are therefore two different directions along which sheet 177 is simultaneously leveled when positioned against the wall, a first direction along which the T-shaped inter-cavity protrusions 187 extend and a second direction along which the external supports 179 extend, thereby facilitating the planar leveling of the sheet. The panels or other types of supports may be designed to correspond to a profile of the sheet exterior face, in order to reduce the distance between the sheet and the wall while the sheet is applied and accordingly to reduce the thickness and the quantity of the needed link material.

FIGS. 46-55 illustrate another embodiment of an unrollable link material leveling system which enables to use a simple and non-rigid sheet which is leveled by an auxiliary reusable device.

A top view of unrollable link material leveling system 205 partly applied onto the wall, which comprises elongated sheet 207 and a polygonal holding structure 210, is illustrated while both maintaining sheet 207 in a rolled form prior to being applied to building wall 182 as shown in FIG. 46A and leveling sheet 207 while it is being applied to building wall 182 as shown in FIG. 46B. Polygonal holding structure 210 is configured to be set either to a retracted condition or to an expanded condition. When holding structure 210 and sheet 207 therewithin is unrolled, a first section 217 of holding structure 210 acts as a base section adapted to be in abutting relation with the building wall while compressing sheet 207 against the link material that already was sprayed on the wall, and the second section 218 is a reinforcing section adapted to achieve significantly improved vertical stiffness of the holding structure and consequently a leveled secured application of sheet 207 against the wall.

Sheet 207 may be configured with a plurality of vertically extending cavities and rounded T-shaped inter-cavity protrusions, as described hereinabove. Alternatively, link material leveling system 205 may comprise a sheet 208 illustrated in FIG. 47 which is configured with a plurality of exteriorly protruding protrusions 209 to facilitate the anchoring of sheet 208 within the link material without need of cavities to anchor the sheet against the wall. Any other sheet configuration which guarantees reliable strong connection of the sheet to the wall by mechanical means, chemical means, or any other means is also within the scope of the invention.

Alternatively as shown in FIGS. 47A-B, the T-shaped protrusions may be dispensed with when a cementitious material, or any other suitable material chemically, mechanically or adhesively securable to the link material, or secured in any other suitable fashion, is applied onto the exterior face 216b of a sheet 216 prior to being secured to wall 182. In this embodiment, both the exterior face 216b and interior face 216a of sheet 216 are uninterrupted. If so desired, the securing means may be applied to any sheet or web described herein, or even to one that is not described herein in order to improve the strength of the connection with the link material.

Holding structure 210 shown in FIG. 48 in a retracted condition is a UUSL PMA (Polygonal Middle Axis) CS, which is configured with a plurality of serially releasably interjoined PMA coupling panels 214a-214w. Holding structure 210 is shown in FIG. 49 when coupling panels 214a-214w are not yet interjoined with one another.

The various interjoined coupling panels create segments 214a-1, 214ab, 214bc, 214cd . . . 214vw, 214w-2 of the polygonal holding structure. In the retracted condition, each of the coupling panels is interjoined with its adjacent coupling panels and creates two segments of the holding structure. In more detail, free end coupling panel 214a creates free end segment 214a-1 and is interjoined with coupling panel 214b to create segment 214ab, coupling panel 214b is interjoined with coupling panel 214c to create segment 214bc and so on. Each segment is angled with respect to its adjacent segment, for example by 60 degrees. The segments are arranged in a coiled formation with a plurality of polygonal loops, e.g. four, such that an outer polygonal loop surrounds and encompasses an inner polygonal loop adjacent to the outer polygonal loop. The coiled formation is made possible by ensuring that the segments in each polygonal loop are substantially parallel to corresponding segments in an adjacent loop and that a segment of an inner polygonal loop is shorter than a segment of an outer polygonal loop. The angled relation of each pair of adjacent segments is generally equal throughout holding structure 210. The coiled formation provides a gap 219 between each pair of adjacent polygonal loops in which a sheet is received prior to its application on the wall.

As shown in FIGS. 51A-51C, peripherally adjacent PMA coupling panels are interconnected by a schematically illustrated pivot element PIIA (Peripherally Interjoinable Inner Axis) extending throughout the height of holding structure 210, allowing one coupling panel PMA1 to be pivotally displaced with respect to a second coupling panel PMA2.

Although not shown, the sheet is attached to the exterior face of each segment by releasable attachment means which are configured with limited strength to ensure that the sheet will remain attached to the holding structure while being applied to the building wall, and that it will become separated from the holding structure, to facilitate reuse of the holding structure when holding structure 210 is rolled back after sufficient hardening of the link material. The releasable attachment means may be selected from various means such as a weak adhesive layer and mechanical means. This arrangement ensures leveling of the sheet while being applying to the building wall.

A typical PMA coupling panel 210a of holding structure 210, which is shown in FIGS. 50A-50C, is an angled element having two integrally formed side sections 210a-1 and 210a-2 that are angularly spaced from each other. Coupling panel 210a is a PMA coupling panel in the sense that when a plurality of the coupling panels are serially interjoined as shown in FIG. 48, a polygonal holding structure is able to be produced that rotates about an axis located in a middle region thereof coinciding with the core member, which is indicated by shading. As shown in FIGS. 50A-C, side section 210a-1 of PMA coupling panel 210a is strengthened by horizontal protrusions 210a-7, usually equally vertically spaced along the height of face 210a-1 of the side section. Side section 210a-2 is configured with a plurality of vertically spaced recesses 210a-8 having substantially the same dimensions as the corresponding protrusions 210a-7, although usually provided with an additional small clearance relative to protrusions 210a-7.

As further shown in FIGS. 50A-50C, each PMA coupling panel 210a is configured with two pivot elements 210a-4 and 210a-3 extending along the height of the coupling panel, which produce an inner axis PIIA when interconnecting pivot element 210a-3 of one coupling panel to pivot element 210a-4 of an adjacent coupling panel. Inner axis PIIA comprises a plurality of serially interconnected axis units, which are preferably evenly spaced, each of which is very similar to inner axis A1 (FIG. 26A) explained above. Pivot element 210a-4 comprises a plurality of elements each of which corresponding to the recessed intermediate plate, and pivot element 210a-3 comprises a plurality of elements each of which corresponding to the protruding end plate to achieve unidirectional angular displaceable. The PIIA may also be based on any other principle as long as the axis of rotation is located along axis N.

FIGS. 52A-52B schematically illustrate the cooperation of two adjacent PMA coupling panels in both a retracted and expanded condition. Regarding the expanded condition shown in FIG. 52A, the plane 210a-5 of each of coupling panels PMA1 and PMA2 are collinear due to the angular restriction of the inner axis PIIA extending along the height of the two coupling panels. Regarding the retracted condition shown in FIG. 52B, side section 210a-2 of coupling panel PMA1 and side section 210a-1 of coupling panel PMA2 are interjoined as protrusions 210a-7 of coupling panel PMA2 are inserted into recesses 210a-8 of coupling panel PMA1. Consequently, one complete segment PSi of polygonal structure 210 is created.

FIGS. 51A-51C show an isometric view of two PMA coupling panels described hereinabove prior to their interconnection (FIG. 51A), after their interconnection in an expanded condition (FIG. 51B), and after their interconnection in a retracted condition (FIG. 51C).

Holding structure 210 is created by interconnecting and interjoining the separated PMA coupling panels shown schematically in FIG. 49 in the manner described hereinabove.

As shown in FIG. 51B and mentioned above, plane 210a-5 of coupling panel PMA1 and plane 210a-5 of coupling panel PMA2 are coplanar to create a UUSL CS, and are able to be in abutting relation with the wall when holding structure 210 is unrolled, in order to level and secure sheet 207 (FIG. 46A) or 208 (FIG. 208) while the sheet is applied to a building wall. While holding structure 210 continues to be unrolled and a reactive force is applied by the building wall, side section 210a-2 of coupling panel PMA1 is released from side section 210a-1 of coupling panel PMA2 to assume the expanded condition.

As schematically illustrated in the expanded condition of FIG. 53, the ability of a coupling panel side section to protrude obliquely is necessary to increase the stiffness of the holding structure and to function as a reinforcing section. Since side section 210a-2 (shown in FIG. 52A) obliquely protrudes from the collinear side sections 210a-1 of coupling panels PMA1 and PMA2, a reactive force applied by the oblique side section 210a-2 has a projection VC. This projection VC is orthogonal to two adjacent half side sections 210a-1 of coupling panels PMA1 and PMA2, respectively, each schematically indicated as HC. The two half sections HC combine together with projection VC to produce a T-section T-SEC, indicated by the hatch lines, of a large moment of inertia. The T-section significantly increases the vertical stiffness of the vertically oriented PMA coupling panels, and consequently provides holding structure 210 (FIG. 46B) with significantly large vertical stiffness when unrolled.

FIGS. 54A-54D illustrates the process of inserting a sheet 207 (or 208) into gap 219 of holding structure 210 (FIG. 48), before it is applied to the building wall. First, as shown in FIG. 54A, a rolled holding structure S1, whether holding structure 210 of FIG. 48 or holding structure 220 of FIG. 56, is positioned on top of a stack SP1 of sheets, such that the free end of the rolled holding structure S1 is aligned with an edge of the upper sheet. Rolled holding structure S1 is then unrolled in FIG. 54B along stack SP1, while the exterior face of the coupling panels abuts the interior face of the upper sheet, causing the wing-like stabilizing side sections of the coupling panels in the expanded condition to become exposed. When the sheet is held together with the unrolled holding structure and the releasable attachment means, the holding structure is rolled together with the upper sheet in the opposite direction, as shown in FIGS. 54C-54D. As a result, sheet 207 or 208, or any other suitable sheet, is received within the gap between each pair of adjacent loops of the holding structure as shown in FIG. 55. It is noted that the sheet is able to be held by friction between each pair of adjacent loops of the holding structure even without the releasable attachment means.

With reference once again to FIG. 46B, after link material is applied by means of a pneumatic spray unit, such as a compressor, to an exposed wall portion for speedy attachment of the sheet against the wall, a first segment associated with the free end of holding structure 210 is positioned in abutting and force applying relation with the building wall, to facilitate securing of a sheet portion attached to the first segment of holding structure 210 to the building wall. Although not seen in the figure, the polygonal holding structure 210 is mechanically stabilized, such as by a thin and vertically extending apparatus that holds the vertical edges of the previously applied sheet by pressure and is fixed in place by pressure while contacting the floor and the ceiling. This arrangement prevents transmission of any unwanted motion to the adjacent sheet which is already applied against the wall and to which the sheet currently being applied is interconnected, e.g. by a tongue and groove joint, to enable an effortless and stabilized unrolling process. Similarly, the currently applied sheet is also supported by an identical, or by the same, apparatus after being interconnected to the previous sheet in order to enable an easy unrolling operation while the lower edge of the roll is positioned slightly above the floor. After being stabilized, the holding structure is differentially unrolled about the vertical axis so that a sheet portion attached to a second segment adjacent to the first segment will be applied to the building wall. While polygonal holding structure 210 is rotated, the reinforcing section 218 associated with each segment is angularly displaced with respect to the corresponding base section 217 to externally reinforce the holding structure and consequently to provide large vertical stiffness that ensures the leveling of the applied sheet in a vertical direction. Leveling of the sheet in a horizontal direction is achieved by the angular restriction of the inner axis and protrusions 210a-7 shown in FIG. 50C. The sheet, which may be relatively simple to manufacture according to any desired shape and is consequently inexpensive, may therefore be leveled with an increased horizontal and vertical stiffness.

The differential sheet application is advantageous since, due to the aforementioned operation as shown in FIG. 46A, only a narrow and vertically extended region of sheet 207, e.g. a width of 10 cm, is in force applying relation with the building wall 182 and with the applied link material, and consequently only a relatively low force is needed to compress and drive the link material while unrolling and leveling the sheet. Moreover, a re-rolling operation to return the previously applied sheet and corresponding first and/or second sections to the rolled holding structure when correction is needed can be very low force demanding due to the need to overcome only low adhesive forces that have been activated on the narrow sheet region. In contrast, when completely removing cement or plaster board from a wall according to prior art practice, much higher adhesive forces have to be overcome during a very time consuming repair operation which may result in fracturing of a board.

In order to improve the differential application of the sheet, and accordingly to reduce the force applied to the sheet by the rolling process, a similar circular holding structure 220 shown in FIG. 56 may be employed. In holding structure 220, the IFTG (Inverse Folding Tongue and Groove) coupling panels 223 and 224 are used in place of the PMA coupling panels of holding structure 210 (FIG. 48) to enable the differential rolling and unrolling operation. The improved differential force application of holding structure 220 compared to holding structure 210 is achieved by virtue of its circular configuration which reduces the contact of the additional sheet area with the wall. The circular holding structure 220 must comprise IFTG coupling panels, and not FTG coupling panels, in order to keep the coupling panels axis of rotation N in abutting relation with the interior face of the sheet, as shown, to avoid any relative movement between surface 225 of the coupling panels and the interior face of the sheet, when the circular holding structure is rolled or unrolled. Any relative movement will cause detachment of the sheet from the holding structure and may cause fold and tears in the sheet prior to its application against the wall. One coupling panel 224 of a group of the IFTG coupling panels is thicker than the other coupling panels 223 to accommodate an elongated and arcuate projection 226 that serves as a stiffness element, similar to the function of stiffness element 218 in holding structure 210. Coupling panels 224 of holding structure 220 having an arcuate projection 226 are shown in FIG. 57. The plurality of unidirectionally unrollable IFTG coupling panels 223 and 224 together with reinforcing section 226 will therefore enable stiff leveled and improved differential application of the sheet to the building wall 182, as shown in FIGS. 58A-B.

A monolithic stiff plate having the same structure as an unrolled sheet 167 (FIGS. 42-43) with additional T-shaped inter-cavity protrusions which extend perpendicularly or in any other direction, relative to the direction of the T-shaped inter-cavity protrusions 187 in order to establish the planar stiffness of the plate, may be employed and is also in the scope of this invention. The perpendicular protrusion of the T-shaped inter-cavity protrusions may be configured with holes through which the link material is flowable as the T shaped inter-cavity protrusions are anchored within the link material while the monolithic plate is compressed against the wall.

FIG. 58C illustrates an additional embodiment of a stiff plate. Stiff plate STP1 has a thin interior surface 230 and an exterior face 231 comprising a frame of two directionally stiff elements 232, shown more clearly in FIG. 58D, instead of the T-shaped inter-cavity protrusions. Elements 232 are easily pushed into the link material after being applied to an exposed wall preferably by pneumatic spray unit. According to the stiffness of frame 232 and its deepest location within the link material upon application of plate STP1 against the wall, interior surface 230 will remain leveled and plate STP1 will remain secured to the wall upon solidification of the link material.

FIG. 58E illustrates the exterior face 233 of plate STP2, which is similar to plate STP1 except having stiff elements 234 only in a first direction, and may be folded, rolled or unrolled in a second direction which is perpendicular to the first direction. Plate ST2 may be used when it is applied to panels that are longitudinally leveled in a direction other than that of stiff elements 234 and that are anchored to the wall. Alternatively, plate STP2 may cover columns or any other one or more arcuate surfaces. The application of plate STP2 is similar to that described with respect to plate STP1 hereinabove.

Plates STP1 and STP2 may be used to cover wall regions for which the rapid application with rolls is unsuitable.

The advantages of using plates STP1 and STP2 relative to other boards include their light weight that facilitates plate repositioning with much less effort and easier securing of the plate against the wall prior to the link material solidification, quick and simple wall application, and a very strong securement against the wall upon link material solidification. Also, the small thickness of plates STP1 and STP2 which only covers and levels the link material facilitates quicker application, together with all of its benefits, of a traditional plaster board.

Plates similar to plates STP1 and STP2 that comprise T-shaped inter-cavity protrusions 187 (FIG. 44B) instead of frames 232 or 234 or plates comprising any other type of stiffened frames are also suitable and are in the scope of this invention.

The exterior face of a sheet or of a monolithic stiff surface is able to be integrated with the applied link material, with or without the aid of a holding structure, by adhesion, assimilation, mechanical means, chemical means and a combination thereof. Materials such as cement, crushed stone, thin crushed stones or any other suitable material may be used to establish a strong chemical or adhesive connection between the sheet and the link material.

As shown in FIG. 58F, a plurality of elongated apertures EA1, which may be mutually parallel, are provided in the exterior face EF1 of sheet SH1 having an inner smooth face IF1 to facilitate integration with the applied link material, without detracting from the ability of the sheet to be folded, rolled or unrolled. A material, such as the link material itself, is introduced into the apertures EA1, preferably factory-introduced, by at least mechanical means and strongly held by the walls of the corresponding aperture, although the material may be introduced into an aperture EA1 by any other suitable technique. The introduced material becomes integrated with the link material applied to a wall in situ by a strong connection, which is at least a chemical or adhesive connection.

FIG. 58G is an enlargement of one of the apertures EA1 together with the material that has been introduced therewithin, after having been solidified and anchored to the sheet, which is rendered transparent. Aperture EA1 is shown to have an arcuate cross section, subtending slightly more than 180 degrees, while the outer face OF1 of the solidified material is preferably coplanar with the exterior face EF1 of sheet SH1.

FIG. 58H illustrates the interior smooth and ungapped face IF2 and the exterior face EF2 of a sheet SH2, which is similar to sheet SH1 except having circular T-shaped apertures CA2 for receiving link material bondable material instead of the elongated apertures EA1.

In the enlargement of apertures CA2 shown together with the transparently rendered sheet of FIG. 58I, each aperture CA2 has a wide circular base CB2 located within the sheet and a thinner circular portion having an exterior face CE2 which is preferably coplanar with exterior face EF2.

Sheets designed similarly to sheets SH1 and SH2 but having other shapes and arrangements are also suitable and are in the scope of this invention.

The monolithic plates may be used to cover areas which cannot be covered by a foldable or rollable sheet. Accessories such as corners which are structured similarly as the monolithic plates need to be used in order to simplify and supplement a surface covering procedure.

A UUSL CS can also be used as a rollable, foldable or flexible system which is an unrollable leveled frame on which a monolithic plate or a roll is implemented similar to the longitudinally extending and leveled panels 179 that are anchored to wall 182 in FIG. 45A and it is also in the scope of the invention.

### Paneling System

FIGS. 59-63O illustrate a system for applying paneling material to an existing wall for use in dry construction. Although the paneling material associated with the paneling system is generally applied to an interior wall, constituting an alternative to a drywall, plasterboard and other solid panels, it may be similarly applied to an exterior wall.

The paneling system obviates the time-consuming chores normally associated with installing a drywall, including fixing the drywall by screws to upright framing elements such as studs or light-gauge steel framing, covering the screws and the interface between each adjacent boards with spackle or other patching material, sanding the interiorly faceable surface of the drywall, and painting the conditioned inner surface. The paneling system enables carrying out the paneling operations in parallel to additional operations at a building site, and enables easy application of large dimensioned paneling boards by a single worker.

A paneling system 240, according to one embodiment is a FTG UUSL CS, and is shown in FIG. 59. Paneling system 240 comprises a plurality of spaced upright framing elements 254, such as studs, which are anchored to wall 182 and are each configured with vertically spaced slits 246. The paneling system also comprises a plurality of coupling panels 40 (FIG. 4), a plurality of arcuate pins 242, and a common sheet 241 configured with paneling material. With respect to each pin 242, a first pin portion 242a is embeddable in the core region 113 of each coupling panel and the second pin portion 242b is protrudable from the lower surface 114 of a coupling panel 40. Although paneling system 240 is shown to be configured with coupling panels 40, it will be appreciated that it can likewise be configured with any coupling panel described herein. A roll 244 of the coupling panels 40 and common sheet 241 is adapted to be mounted on one or more framing elements 254 while each pin portion 242b is inserted into a corresponding slit 246 to secure the coupling panels 40 against the wall. The material provided with roll 244 may also be considered a “paneling material unit”. The plurality of pins 242 are generally equally spaced, so that when roll 244 is unrolled, each pin may be vertically coincident with a group of pins of the adjacent coupling panels.

As a result of the attachment of common sheet 241, the interiorly faceable surface of the paneling material is uninterrupted and is preferably esthetically pleasing, usually having the texture of ordinary cement plaster or white acrylic paint, although any other ornamented configuration is applicable.

As shown in FIGS. 60A-B, roll 244 has a horizontal axis, and may have a sufficient width to allow its pins 242 to be mounted on the slits 246 formed in a plurality of studs 254, and may be in abutting relation with an additional roll adapted to be mounted on a horizontally adjacent group of studs.

FIGS. 61A-61F illustrate one embodiment of the apparatus for connecting a pin 242 to coupling panel 40.

FIG. 61A is an isometric view of a pin 242 while embedded within coupling panel 40, showing the rounded protruding pin portion 242b, although a pin having a different configuration such as one that is pointed may also be employed. FIGS. 61B-61F show pin related components, their interconnection, and the interconnection of pin 242 to core 113 of coupling panel 90.

As shown in FIG. 61D, pin 242 comprises two arcuate portions 242a and 242b. Pin portion 242b is serrated, being defined by teeth 271 shown in FIG. 61C, and is insertable by pressure into serrated aperture 272 shown in FIG. 61E, which is formed in the coupling panel core 113. Aperture 272 is sized to provide a small clearance 274, as shown in FIG. 61F, after pin portion 242b is inserted to a full extent into the aperture. The depth of aperture 272 is less than the thickness of the coupling panel; for example, when the thickness of the coupling panel is 2 cm, the depth of aperture 272 is 1.7 cm. Protruding pin portion 242a protrudes through aperture 268 provided in thin plate 263, shown in FIG. 61B, which covers serrated aperture 272.

This arrangement of serrated pin portion 242b and serrated aperture 272 facilitates the releasable connection of pin 242 to the coupling panel as shown in FIG. 61F, so that the pin will be able to be easily coupled within a slit 246 shown in FIG. 59, yet allows pin 242 to be detached from the coupling panels when correction to a mounting position of the coupling panel is needed, as shown in FIG. 63B.

Each protruding pin portion 242a may be configured with two wings 274a and 274b which are compressible inwardly while pin portion 242b is being inserted into a slit 246 of stud 254 (FIG. 59) and expandable after the insertion has been completed, to enable the anchoring of roll 244 against framing elements 254 when unrolled.

As exemplary structure of framing element 254 is illustrated in FIGS. 62A-62C. As shown in FIG. 62A, rail 254a has a thin trapezoidal shape with a wall 256 which is mounted, such as by being drilled, to the existing building surface, and narrow walls 264a and 264b substantially parallel to wall 256 and connected by two narrow inclined walls 247a and 247b to wall 256. As a result, grooves 259a and 259b are produced which enable the connection of slitted profile 254b shown in FIG. 62B to the rail. Slitted profile 254b has a U-shaped profile with substantially parallel side walls 251a and 251b, front wall 270, wing 260a comprising thin rectangular angled wall 261a, and wing 260b comprising thin rectangular angled wall 261b. A plurality of longitudinally and equally spaced slits 246 are formed along the height of wall 270, and each slit extends almost entirely along the width of wall 270 and is adapted to receive a corresponding pin. Holes 250 may be formed along the length of each of side walls 251a and 251b for material reduction and to enable transferring of sanitary and electric systems.

Each assembled framing element 254 shown in FIG. 62C comprises two elements, rail 254a shown in FIG. 62A and slitted profile 254b shown in FIG. 62B. At first, rail 254a, which may be a thin upright made of aluminum or any other suitable material, is anchored to the wall by screws and then slitted profile 254b is mounted onto rail 254a by forcing wings 260a and 260b into grooves 259a and 259b, respectively. By virtue of this connection, movement of slitted profile 254b is prevented with the exception of a vertical translation along the length of rail 254a by virtue of the ability of wings 260a and 260b to slide along within grooves 259a and 259b, respectively. Slits 246 located along the height of front wall 270 of slitted profile 254b are thin and have a width up to approximately 7 cm.

The ability to slide wings 260a and 260b together with the slits 246 along rail 254a enables the insertion of each protruding pin portion 242b into a corresponding slit even if the rail 254a were incorrectly mounted onto the building walls.

A framing element 254 positioned at an extremity of the paneling system may be configured slightly differently than other framing elements, to improve its esthetic appearance. As shown in FIG. 60A-1, the illustrated rail and slitted profile have side walls 254as and 254bs that are perpendicular to building wall. Nevertheless, the extreme slitted profile is able to slide along the corresponding extreme rail since its wings are angled in a different direction, or alternatively are differently configured, with respect to framing elements positioned in an intermediate region of the paneling system.

By unrolling roll 244 upwardly as illustrated in FIG. 63A while a pin 242 is received in each corresponding slit 246, a paneling material unit can be quickly mounted without requiring any other installation operations, with the exception of applying and enhancing patching material to the interface between a pair of adjacent paneling material units so that the interface will be concealed. Due the resemblance of the interface between each pair of paneling material units, the last operation can be done quickly by a device designed especially for this purpose. Roll 240 may be sufficiently wide in order to cover the entire wall by a single roll and avoid the interface between adjacent boards.

On the other hand, if a construction worker needs to make a correction, a coupling panel already mounted onto wall 182 may be re-rolled onto roll 244, as shown in FIG. 63B, causing the pin 242 of the re-rolled coupling panel to become detached therefrom and to remain coupled within the slit within which it was previously inserted.

It will be appreciated that pin 242 may also be formed as a monolithic part together with the coupling panel or with stud 254.

The ability of providing the paneling material in compact roll form is advantageous to a construction worker in that a large number of substantially planar paneling material units, when roll 244 is unrolled, may be compactly stacked one on top of the other while being transported, such as by truck, to a construction site, and then one of the paneling material units is rolled and individually carried by a construction worker to the wall on which it is to be mounted. The construction worker is also able to individually and effortlessly mount the paneling material unit on a row of pins and to unroll the paneling material unit until it is completely mounted on the corresponding group of pins. The mobility of the paneling material units as a roll significantly increases the ability of the worker to navigate easily in a congested area of the construction site, walk on scaffold, walk through narrow corridors, door openings, attic openings and more. As a result, the use of roll 244 enables the continuation of the building process in parallel to the construction of walls and ceilings, and consequently decreases the construction time of a building project.

The paneling material unit may be constituted by the material from which a rigid panel is made, yet is able to be formed such as by a cutting operation to assume the configuration of any of the coupling panels described herein. Typical materials include fiber-cement material, aluminum composite material plastic material and bamboo. The roll 244 therefore is a UUSL CS which may comprise a plurality of interlocked, rigid, relatively lightweight and unidirectionally unrollable coupling panels. The interiorly faceable surface of the paneling material is generally a common sheet that is applied to all the coupling panels.

Alternatively, the paneling material unit may be constituted by a completely flexible material that facilitates easy to perform rolling and unrolling operations.

Although paneling system 240 of FIGS. 59 and 60 is shown to be configured with vertical framing elements 254 anchored to an existing wall 182, it will be appreciated that the paneling system is similarly applicable to the use of oblique framing elements. Wall 182 may accordingly be a building surface of any desired orientation, generally of a vertical orientation, but may also be horizontal such as for applying paneling material to a slanted or even curved floor or ceiling.

A support member SM configured with a concave support surface 257 and two opposed vertical legs 258 between which support surface 257 is interposed, as shown in FIG. 60A-3, is adapted to contact a rolled paneling material unit 244. When vertical framing elements are employed, roll 244 is placed on support member SM, which is located at the bottom of the wall. The lowest two or three rows of pins 242 are inserted into their corresponding slits 246 that are located close to the bottom edge of the framing elements 254 and then the rest of the roll is unrolled upwardly to be completely mounted. When a pin 242 of the lower coupling panel is not located aligned exactly with its corresponding slit 246, slitted profile 254b slides on rail 254a as explained hereinabove so that it will be located at the right position. Once the pins protruding from the lower coupling panel 40 are aligned with their corresponding slits, the system is calibrated. After the first two or three rows of pins are urged into their corresponding slit, roll 244 can be unrolled upwardly to be completely mounted. The wide width of slits 246 ensures that each pin will be inserted into its corresponding slit even when framing elements 254 are not accurately anchored against the wall.

Support member SM is shown to have two stationary legs 258 in contact with the underlying floor surface, but it will be appreciated that the support member may be configured with displacing means such as a hoist that are in movable contact with support surface 257 to facilitate an unrolling operation. Support number SM may comprise a manual mechanism or electric motor to facilitate elevation of surface 257 during roll mounting.

FIG. 63A illustrates the insertion of pins 242 into their corresponding slits 246 when roll 244 is being unrolled along studs 254. As shown, wings 274a and 274b are compressed during insertion of their pin 242 into the corresponding slit 246. Once a pin is completely inserted, and its corresponding plate 263 abuts wall 270 of stud 254, wings 274a and 274b are expanded and the pin becomes anchored to wall 270. If a correction is needed, roll 244 can be rolled in the opposite direction as shown in FIG. 63B, pin 242 will remain anchored to wall 270 and pin portion 242b will be extracted from groove 272. By unrolling roll 244 once again, each pin will return to its groove and the paneling system will be anchored back against the wall.

After the entire application of roll 244 along the wall, unless it is rolled in the opposite direction beginning with its free edge, removal of one or a group of adjacent coupling panels is an impossible task due to the unidirectional stiffness of the coupling panels and the distributed location of their axis of rotation. Consequently, the stability and permanence of the unrolled plurality of coupling panels enable operations such as picture hanging, shelving, cabinet anchoring to the walls, cabinet hanging on the walls similarly to similar fixation operation performed with respect to a monolithic wall.

The paneling system of the present invention employing a rollable and unrollable paneling material unit provides a distinct advantage with respect to use of a drywall in that the paneling material unit is reusable during performance of a maintenance operation, such as repair of a leaky pipe that passes through the sidewall of the rails. While a drywall has to be cut such as with a saw in order to access a malfunctioning element and to be subsequently repaired and patched upon conclusion of the maintenance operation, the malfunctioning element is conveniently able to be accessed with use of the paneling system by simply detaching the interface between a pair of adjacent paneling material units and rolling the paneling material unit that conceals the element in need of repair. Upon conclusion of the maintenance operation, the paneling material unit is simply unrolled and the interface between a pair of adjacent paneling material units is repatched.

It will be appreciated that the paneling system may be used for applying paneling material not only onto an existing wall, but also onto a metal frame vertically extending from the floor to ceiling that is normally used for supporting a plasterboard or other drywall during the construction of an inner wall by dry construction. A frame element 254 (FIG. 59), such as a stud or a post, by which paneling material is mountable as described hereinabove may be attached to, or constitute a constructive element of, the metal frame.

In other embodiments, different connecting elements in lieu of pins 242 and different connectable regions instead of slits 246 and apertures 272 may be employed. For example, each connecting element may be embodied by adhesive means, such as any link material which can establish a sufficiently strong interconnection between the flat exterior face of the coupling panel and the flat interior face of the frame element to which it is attached. The exterior face of the coupling panels may be designed in various ways such as in wavy form in order to increase the contact area with the link material. The use of adhesive means is also significantly advantageous in that a roll 244 of coupling panels can be applied directly on even or uneven walls.

FIG. 63C illustrate vertically oriented stud 281 and a differently oriented coupling panel 283 which are configured to be both mechanically and adhesively connected together. A stud 285 adapted to be positioned at an end of the paneling system, and also mechanically and adhesively connected to coupling panel 283, is also illustrated.

Coupling panel 283 is identical to coupling panel 40 (FIG. 4) or alternatively to other coupling panels such as coupling panel 90 (FIG. 17), but which is formed with an aperture 280 longitudinally extending though core 113 and recessed from surface 46. Aperture 280 may have an arcuate horizontal cross section that subtends an angle greater than 180 degrees. Stud 281 is configured with one or more longitudinally extending, arcuate apertures 282 having an angle greater than 180 degrees and that are recessed from their interior surface.

In use, a plurality of spaced studs 281 are mounted onto a wall. A roll 244 (FIG. 60A-3) comprising a plurality of coupling panels 283 each having an aperture 280 is employed, and is positioned such that each aperture 280 faces, and extends at an angle across all of, the stud apertures 282. Alternatively, each aperture 280 is unaligned with the stud apertures 282. Link material is applied onto the interior face 284 of each stud 281, and consequently when roll 244 is force applied against the wall onto studs 281, the link material is urged to flow into apertures 280 and apertures 282. A very strong and reliable mechanical connection at each confluence of apertures 280 and 282 is produced upon solidification of the link material. Differently shaped apertures, such as T and dovetail shaped configurations, are also suitable and are in the scope of this invention.

The use of such adhesive connecting elements and connectable regions allows for considerable flexibility during the placement of roll 244 against the frame elements or directly against the wall since the roll need not be positioned at a specific position relative to the frame elements. Also, a large range in thickness of link material is able to be applied in order to produce a leveled interior sheet even if the frame elements have been inaccurately mounted. The mechanical connection that results from these adhesive means is a very strong connection which may be similar to the strong connection established by pins or even by screwing drywall boards against the studs.

When using adhesive means, the paneling material can be applied directly to the building wall, whether the wall is a monolithic surface or built by a frame.

The paneling material may be applied by rolling the roll 244 horizontally. Manipulating a roll 244 is advantageous by virtue of the ability to store, reposition and apply a very long paneling covering with minimal interfaces and accordingly to obviate the time consuming prior art operations of patching and sanding. Paneling material having a pre-painted or any other esthetically pleasing ornamental design, which may also have a removable laminated protective layer, is also able to be employed.

The mechanical connection described hereinabove is also able to be implemented with respect to monolithic boards and is in the scope of this invention.

FIG. 63D illustrates the ungapped interior face 300 and the recessed exterior face 301 of a monolithic board MB1, which is configured with a plurality of elongated and spaced arcuate apertures 302 having an angle larger than 180 degrees, each vertically extending throughout the height of the exterior face of the board. Although the board is made of a material such as plaster that is prone to cracking or crumbling when an elongated aperture is formed in the prefabricated board, such damage to the board is advantageously able to be mitigated or altogether eliminated when a strap 303, e.g. plastic or elastic, is embedded within the wall of each corresponding aperture 302. Strap 303 generally has the same geometrical shape as the corresponding aperture 302, and serves to support the aperture wall and to absorb the stress which develops therewithin, thereby restoring or even enhancing the original force bearing capacity of the board.

Apertures 302 may be cut when board MB1 is supported by a plurality of supports and then a strap 303 is anchored or otherwise inserted within aperture 302 in order to support the wall of a corresponding aperture. Alternatively, a strap may be attached to the board prior to the aperture formation.

Strap 303 may be integrated within the monolithic board at any stage during the production of the wall to avoid the process of aperture formation within an unrecessed board.

A strap which is similar to and has the same functionality as strap 303 may be anchored to the interior face of the board in the site or during an industrial process to avoid formation of an aperture 303.

Each strap 303 may have a lip 311 at its terminal ends that longitudinally extend throughout the length of the corresponding aperture 302. Each lip 311 may sufficiently laterally extend from the corresponding aperture 302 in order to enable a strong connection with the thin paper layer (not shown) that constitutes the outer layer of board MB1. Lip 311 is generally flush with exterior face 301. When board MB1 is not a plasterboard, a strap may be unnecessary.

FIG. 63E illustrates monolithic board MB2 which is identical to monolithic board MB1 except for the widthwise orientation of elongated arcuate apertures 306 and straps 307, which are identical to arcuate apertures 302 and straps 303 respectively of FIG. 63D. Monolithic board MB2 also has an ungapped interior face 304 and a recessed exterior face 305.

FIG. 63F illustrates the mounting of board MB1 on horizontal studs 281, which are secured to wall 308. As shown in the enlargement of FIG. 63G-2, shown when board MB1 is in force applying relation with link material 309 which has been previously applied to studs 281, although the link material may also be applied to the board, link material 309 is urged to flow into apertures 282 of studs 281 and into apertures 302 of board MB1. A junction of the link material within apertures 282 and 302 constitutes, in addition to the adhesion, a very strong and reliable mechanical connection upon the solidification of link material 309.

FIG. 63H illustrates the mounting of board MB2 on vertical studs 281, which are anchored to wall 308. As shown in the enlargements of FIGS. 631-63K, shown when board MB2 is in force applying relation with link material 309 which has been previously applied to studs 281, although the link material may also be applied to the board, link material 309 is urged to flow into apertures 282 of studs 281 and into apertures 306 of board MB2. A junction of the link material within apertures 282 and 306 constitutes in addition to the adhesion a very strong and reliable mechanical connection upon the solidification of link material 309.

FIGS. 63L, 63M-1 and 63M-2 illustrate the mounting of board MB1 directly onto an exposed wall 308. Firstly, link material 309 is applied to the exterior face 301 (FIG. 63D) of the board at some discrete points while ensuring that the entire length of each aperture 302, or discrete points within the entire length of each aperture 302, is able to receive the link material. Secondly, board MB1 is compressed and leveled against the wall, urging the link material to flow into apertures 302. Accordingly in addition to the adhesion or the chemical connection, a strong mechanical connection is established between the board and the link material upon the solidification of the link material.

FIGS. 63N and 63O illustrate the mounting of board MB1 directly onto an exposed wall 308 wherein the link material is applied to the entire surface of the wall corresponding to the surface area of the board. Firstly, the link material 309 is applied and leveled as much as possible, preferably with use of a notched trowel. Secondly, apertures 302 are filled with the link material, and thirdly, the board is compressed and leveled against the wall. Accordingly in addition to the adhesion or the chemical connection, a strong mechanical connection is established upon the solidification of the link material.

The anchoring of straps 303 and 306 within the monolithic boards may be produced in many ways, and the anchored straps are also in the scope of the invention.

Straps 303 and 307 may be integrated within the monolithic board at any stage during the production of the wall to avoid the process of aperture formation within an unrecessed board.

A strap which is similar to and has the same functionality as straps 303 and 307 may be anchored to the interior face of the board in the site or during an industrial process to avoid formation of apertures 302 and 306.

Boards and studs having differently configured or positioned apertures 302 within the exterior surface of the board are suitable and are also in the scope of this invention.

### Parquet System

FIGS. 64-95B illustrate a parquet system 310 configured with a UUSL CS comprising FTG-based coupling panels that are modified for use in a parquet system, as will be described hereinafter. Parquet system 310 is adapted to be rapidly unrolled on top of a large surface floor or other suitable leveled surfaces, frames or rails, in order to significantly reduce the time consuming application of a prior art parquet floor.

As will become apparent below and illustrated in FIG. 64, system 310 comprises a plurality of rolls, each of which being a UUSL CS having plurality of coupling panels connected by a removable upper sheet RS (FIGS. 72A-C). Upper sheet RS needs to be removed after a roll is entirely unrolled to create a regular parquet floor having separated parquet segments, and enables assembly and disassembly of individual parquet segments during the covering operation and due to maintenance considerations.

FIGS. 64-65 illustrate four typical structures S1, S2, S3 and S4 of system 310 when partially unrolled on a base surface BS1 in FIG. 64 and entirely unrolled on the base surface BS1 in FIG. 65. Each structure typically has a length of 4 meters and a surface area of 6 to 7 square meters, and comprises 30 parquet segments. Exemplary dimensions of a parquet segment are 1.2 meters length and 0.2 meters width.

FIG. 66 schematically illustrates how typical structures S1-S4 are interjoined in an exemplary system 310 to cover a large floor area. First 4 typical sections S1 are applied sequentially to the length of a floor free edge to create first band BI of the covering, then 4 typical sections S2 are sequentially applied and create second band B1 of covering which is continuously interjoined in coplanar fashion with the parquet segments of band BI. Similarly, 4 typical section S3 are interjoined to create band B2 which is continuously interjoined in coplanar fashion with parquet band B1. Depending on the surface area, additional bands of typical structures S1 and S2 are similarly applied in coplanar fashion in order to complete the covering of the floor. A final band BF of 4 typical sections S4 are sequentially applied in coplanar fashion to the length of the opposed free edge of the floor while continuously interjoined with a band of typical sections S3.

When the dimensions of the floor do not accurately match, combinations of complete typical structures S1-S4, or other similar typical structures, may be considered, as well as cutting the typical structures or adding single parquet segments along the free edges of the surface to accommodate the actual dimensions of the base surface.

FIG. 67A illustrates a single parquet segment PR of a typical structure without its lamination layer. As shown in the figure, parquet segment PR comprises two FTG coupling panels SP_{I} and SP_{II} having the same length and half the width of a parquet segment PR. The smaller width of each coupling panel enables typical structures S1-S4 to be rolled and unrolled as a compact roll. FIG. 67B illustrates the structure of parquet segment PR with the addition of its lamination layer PL, which interconnects coupling panels SP_{I} and SP_{II} and provides the desired single parquet appearance of parquet segment PR, and enables coupling panels SP_{I} and SP_{II} to undergo relative displacement as shown in FIG. 68.

FIG. 69 illustrates the various coupling panels SP1-12 of the unrolled portion of typical structure S1, without the parquet lamination layer PL which interconnects each pair of coupling panels SP in a parquet segment and without the removable layer RS which acts as a common sheet and enables the rolling and unrolling of typical structure S1. FIG. 70 illustrates typical structure S1 when partially unrolled, provided with the lamination layer PL of each parquet segment PR and without the removable layer RS. FIG. 71 illustrates typical structure S1 partially unrolled while provided with the removable upper layer RS.

FIGS. 72A-72D illustrate a side view of typical structure S1, indicating five parquet segments P1, P2, P4, P5 and P7 and shown while angularly displaced in FIG. 72A and after being unrolled and still connected by the removable common sheet RS in FIG. 72B. The removal of common sheet RS is illustrated in FIG. 72C, and the coplanar interconnected parquet segments after the removal of the common sheet are illustrated in FIG. 72D.

As shown in FIG. 72B, parquet segment P1 comprises two coupling panels SP1 and SP2 which are interconnected by parquet lamination layer PL1, parquet segment P2 comprises two coupling panels SP3 and SP4 which are interconnected by parquet lamination layer PL2, parquet segment PR4 comprises two coupling panels SP7 and SP8 which are interconnected by parquet lamination layer PL4, parquet segment P5 comprises two coupling panels SP9 and SP10 which are interconnected by parquet lamination layer PL5, and parquet segment P7 comprises two coupling panels SP13 and SP14 which are interconnected by parquet lamination layer PL7. As shown in FIGS. 72A-72C, parquet segments P1, P2, P4, P5 and P7 are interconnected by a removable upper sheet RS which enables each parquet segment to be angularly displaced relative to an adjacent parquet segment.

FIG. 73 illustrates the unrolled configuration of typical structure S1, which comprises 60 coupling panels SP1-SP60, and each adjacent pair of which is similar to the coupling panels described hereinabove in FIGS. 72A-72C, being interconnected by a lamination layer to create the 30 parquet segments P1-P30. In order to enable the rolling and unrolling of typical structure S1, all of its parquet segments P1-P30 are connected with a monolithic removable upper sheet RS as shown in FIG. 71.

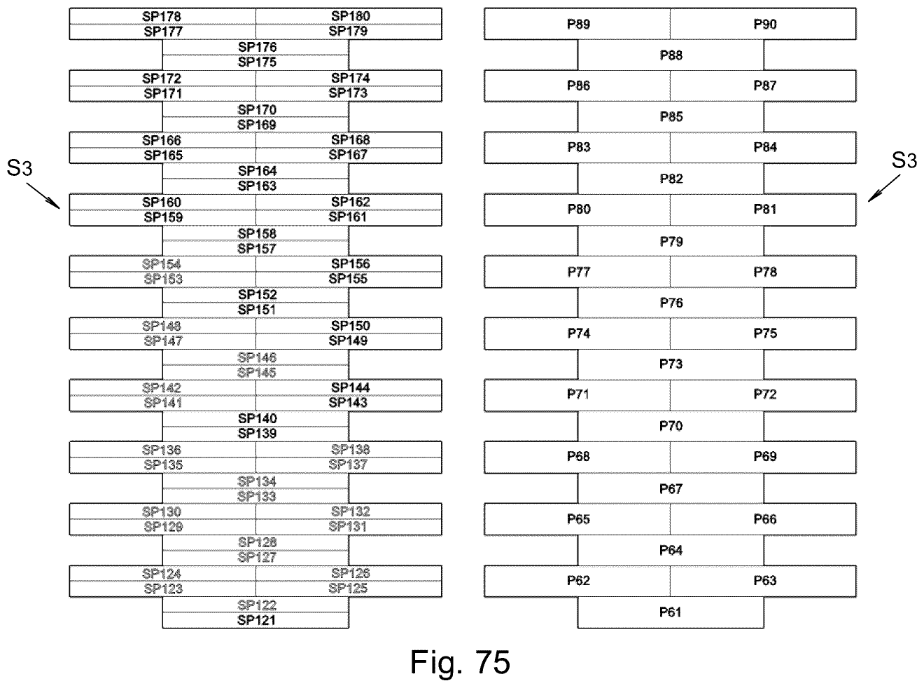

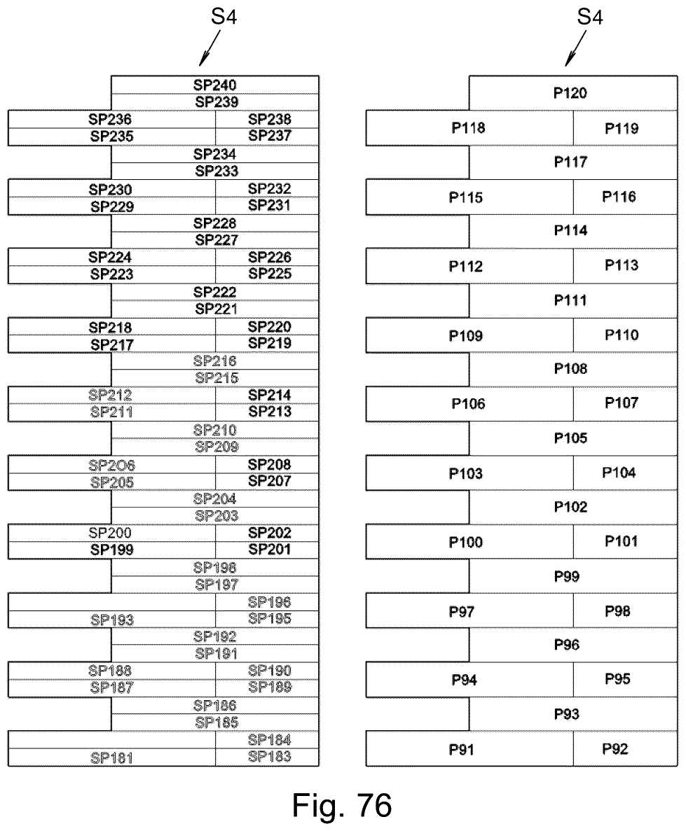

FIG. 74 illustrates the schematic structure of unrolled typical structure S2, which comprises 58 coupling panels SP61-SP120 that are able to be interconnected to create 30 parquets P31-P30. FIG. 75 illustrates the schematic structure of unrolled typical structure S3, which comprises 60 coupling panels SP121-SP180 that are able to be interconnected to create 30 parquets P60-P90. FIG. 76 illustrates the schematic structure of unrolled typical structure S4, which comprises 60 coupling panels SP181-SP240 that are able to be interconnected to create 30 parquet segments P91-P120. The structure of each parquet segment and the interconnection of the parquet segments of each typical structure S2-S4 are similar to typical structure S1.

Coupling panels SP1-SP240 are not identical, and each one of them being one of the coupling panels BSP1-BSP10 shown in FIG. 77. As illustrated in FIG. 78, each of the coupling panels BSP1-BSP10 is configured with a core B, which is an elongated rectangular portion, and with one or more of the illustrated profile portions, including groove profile G, tongue profile T, semicircular socket profile L, upper pin profile U, and arcuate socket profile LR, each of which, when employed, being contiguous and integral with, the length of core B.

Profile portion G is a groove only profile which is identical to the groove of coupling panel 40, and profile T is a tongue only profile such that its tongue identical to the tongue of coupling panel 40 (FIG. 4).

As illustrated in FIG. 79A, profile portion L is an elongated profile having two elongated parallel walls L1 and L2, two opposed small-area rectangular walls L3 and L4 which are perpendicular to walls L1 and L2, two upper elongated and coplanar surfaces L5 and L6 which are parallel to a lower elongated surface L7 and separated by a longitudinal arcuate recess L9 extending along the length of the profile portion. The height L8 of profile portion L is less than the height of core B. Recess L9 is defined by a truncated cavity wall which extends between thin elongated edges L5 and L6 and includes a short neck L10 and an arc L11 defining a portion of a circle which has an angle greater than 180 degrees and preferably less than or equal to 320 degrees, to enable a strong connection with protrusion U8 of profile portion U which is shown in FIG. 79B.

As illustrated in FIG. 79B, profile portion U is an elongated profile having elongated upper surface U1, two thin elongated walls U2 and U3 perpendicular to upper surface U1, two parallel small-area walls U4 and U5 which are perpendicular to upper surface U1 and walls U2 and U3, and two thin elongated surfaces U4 and U6 separated by an elongated protrusion U8 which extends along the length of the profile. Protrusion U8 is shaped with a short neck U9 and an arc U10 defining a portion of a circle which has an identical radius as that of the arc L11 of recess L9, while allowing for a sufficiently small clearance to enable a strong connection between profile portions L and U when they are pressed against each other and consequently enabling the insertion of protrusion U8 into recess L9. FIG. 79C illustrates profile portions U and L while interconnected. In this configuration, the height H of the combined profiles is equal to the height of core B.

It will be appreciated that protrusion U8 and recess L9 may be configured differently as long as protrusion U8 is complementary to recess L9 to resist disengagement when coupled together.

The notation for each coupling panel is indicative of its structure as illustrated in FIGS. 80A-B and 81. The illustrated designation that includes one or more of the identifiers a, a1, a2, b, c and d represents a combination of one or more of the profile portions G, T, L, U and LR that have been described hereinabove. Each of the profile portions, which may be positioned below a lamination layer, is specifically selected so as to be interjoined with a profile portion of an adjacent coupling panel in a desired fashion.

When the coupling panel is viewed from above, the first identifier indicates the type of profile portion which is positioned contiguously and integrally to the front of the core (indicated by identifier a in FIG. 80A), the second identifier indicates the type of profile portion which is positioned contiguously and integrally to the rear of the core B (indicated by identifier b in FIG. 80A), the third identifier indicates the type of profile portion which is positioned contiguously and integrally to the left of the core (indicated by identifier c in FIG. 80A), and the fourth identifier indicates the type of profile portion which is positioned contiguously and integrally to the right of the core (indicated by identifier d in FIG. 80A). The “front” of the coupling panel is defined as the face that is viewable at the free end of a rolled parquet structure if the given coupling panel were located at the free end of the structure, and the “rear” is at the opposite end. The presence of two different profile portions which are positioned contiguously and integrally at the front or at the rear will be indicated by a pair of parentheses within which the two corresponding identifiers of the profile portions, instead of a single identifier, are listed, as illustrated in FIG. 80B. The left identifier within the parentheses indicates the left profile portion and the right identifier indicates the right profile portion positioned contiguously and integrally with the core. The identifier E indicates an end coupling portion provided without a dedicated profile portion, for example having a uniform rectangular cross section from the end face and throughout the core. The asterisk identifier * listed to the right of another identifier indicates that the profile portion is cut along a limited length of the coupling panel. The profile designation of each coupling panel is listed in a central region thereof.

For example as shown in FIG. 77, the designation of coupling panel BSP1 is T(UG)UL, where the first identifier T indicates that it has a T profile portion positioned contiguously and integrally at the coupling panel front (see FIGS. 67B-2 and 67B-3), the parentheses identifier (UG) listed instead of the second identifier indicates that there is a U profile portion positioned contiguously and integrally at the left half of the rear and a G profile positioned contiguously and integrally at the right half of the rear, the third identifier U indicates that it has a U profile portion positioned contiguously and integrally to the left of the core even if a planar face is viewed (see FIG. 67B-2), and the fourth identifier L indicates that it has an L profile portion positioned contiguously and integrally to the right of the core (see FIG. 67B-3). Also, the designation of coupling panel BSP2 is T*GEL, where the first identifier T* indicates that it has a T profile portion positioned contiguously and integrally at the front of the core that is cut along a limited length of the coupling panel (see FIG. 67B-4), the identifier G indicates that it has a G profile positioned contiguously and integrally at the rear of the core, the identifier E indicates that there is no specially configured profile at the left of the core, and the identifier L indicates that it has an L profile positioned contiguously and integrally to the right of the core.

FIGS. 82-85 illustrate the profile portion designation for each SP coupling panel that is provided with typical structures S1, S2, S3 and S4, respectively. Depending on the configuration of each SP coupling panel, the lamination layer which interconnects each pair of SP coupling panels to create a single parquet segment, and the temporary common sheet which interconnects all the parquet segments, each typical structure is a UUSL CS which is able to be rolled and unrolled, while creating a stiff leveled covering for the floor.

The interconnection of two adjacent typical structures is based on one or more of four connection methods, which are referred to as an I-connection U-connection, r-connection, and L-connection, respectively, and described with reference to FIGS. 86A-89C. In order to adequately demonstrate the connection methods without having to illustrate the entire length of elongated parquet segments, only portions of some parquet segments are shown.

FIGS. 86A-86C illustrate the I-connection. FIG. 86A illustrates two separate parquet segments P_{A} and P_{B} having a U profile U_{A} and L profile L_{B} respectively that are provided along the length of their adjacent short free edge. As shown in FIG. 86B, the I-connection interconnection method is carried out by angularly locating the edge of profile U_{A} above the edge of profile L_{B} and then unrolling parquet segment P_{A} in the Θ direction in order to insert the U_{A} profile protrusion into the L_{B} profile recess. FIG. 86C illustrates parquet segments P_{A} and P_{B} with their coplanar upper and lower surfaces after being interconnected.

FIGS. 87A-87C illustrate the r-connection interconnection method. FIG. 87A illustrates coplanar interconnected parquet segment pairs P_{A} and P_{B} and interconnected parquet segment pairs P_{C} and P_{D} prior to the interconnection of the two pairs. Parquet segment P_{A} has an L profile portion L_{A} provided along the length of its long free edge and parquet segment P_{B} has an L profile portion L_{B} perpendicular to L_{A} along a half of the length of its long free edge that does not adjoin parquet segment P_{A}. Parquet segment P_{C} has a U profile portion U_{C} provided along the length of its short free edge and a U profile portion U_{D} perpendicular to U_{C} along a half of the length of its long free edge. As shown in FIG. 87B, the edge of parquet segment P_{C} which is provided with profile portion U_{C} is initially positioned obliquely relative to the edge of parquet segment P_{A} provided with profile portion L_{A}, and then parquet segments P_{C} and P_{D} are unrolled in the Θ direction in order to insert the protrusion of profile portions U_{C} and U_{D} into the recess of profile portions L_{A} and L_{B}, respectively. FIG. 87C illustrates a structure comprising parquet segments P_{A}, P_{B}, P_{C} and P_{D} while their upper and lower surfaces are each coplanar after the two parquet segment pairs have been interconnected.

FIGS. 88A-88C illustrate the U-connection interconnection method. FIG. 88A illustrate coplanar parquet segments P_{A}, P_{B}, P_{C} that are interconnected according to a U-shaped arrangement of the illustrated parquet segment portions, and parquet segments P_{D}, P_{E}, P_{F} that are interconnected according to a T-shaped arrangement of the illustrated parquet segment portions, prior to the interconnection of the U-shaped and T-shaped arrangements. Parquet segment P_{A} has a G profile G_{A} provided along a half of the length of its long free edge, parquet segment P_{B} has an L profile L_{B} provided along the length of its short free edge which is adjacent and perpendicular to profile G_{A}, parquet segment P_{C} has an L profile L_{C} provided along a half of the length of its free long edge which is adjacent and perpendicular to profile L_{B}. Parquet segment P_{E} has a T profile T_{E} provided along a half of the length of one of its long free edges, a U profile U_{B} adjacent and perpendicular to profile T_{E} at the short free edge, and a U profile U_{E} adjacent and perpendicular to profile U_{B} and provided along a half of the long free edge which is parallel to profile T_{E}.

As illustrated in FIG. 88B following the interconnection of parquet segments P_{D} and P_{A} by an I-connection interconnection method, the edge of parquet segment P_{E} provided with profile T_{E} is initially positioned obliquely relative to the length of parquet P_{A} provided with profile G_{A}. Parquet segment P_{E} is then unrolled in the Θ direction, and as a result, the tongue of profile portion T_{E} is inserted into the groove of profile portion G_{A} and the protrusion of profile portions U_{B} and U_{E} are inserted into the recess of profile portions L_{B} and L_{C}, respectively. Consequently a strong interconnection of parquet segment P_{E} to parquet segments P_{A}, P_{B} and P_{C} is achieved. FIG. 88C illustrates a structure comprising interconnected parquet segments P_{A}, P_{B}, P_{C}, P_{D} and P_{E} while their upper and lower surfaces are each coplanar.

FIGS. 89A-89C illustrate the L-connection interconnection method. FIG. 89A illustrates coplanar interconnected parquet segment pairs P_{A} and P_{B} and interconnected parquet segment pairs P_{C} and P_{D} prior to the interconnection of the two pairs. Parquet segment P_{A} has a G profile portion G_{A} provided along a half of the length of one of its long free edges and parquet segment P_{B} has an L profile portion L_{B} provided along the length of its short free edge which is adjacent and perpendicular to profile portion G_{A}. Parquet segment P_{D} has a T profile T_{A} provided along a half of the length of one of its long free edges and a U profile portion U_{B} which is adjacent and perpendicular to profile portion T_{A} along the length of its free short edge. As illustrated in FIG. 89B, following the interconnection of parquet segments P_{A} and P_{C} by an I-connection, the edge of parquet segment P_{D} provided with profile portion T_{A} is initially positioned obliquely relative to the edge of parquet segment P_{A} provided with profile portion G_{A}, and then parquet segment P_{D} is unrolled in the Θ direction. As a result, the tongue of profile portion T_{A} is inserted into the groove of profile portion G_{A} and the protrusion of profile portion U_{B} is inserted into the recess of profile portion L_{B}. Consequently, a strong interconnection of parquet segments P_{A}, P_{B}, P_{C} and P_{D} is achieved. FIG. 89C illustrates a structure comprising interconnected parquet segments P_{A}, P_{B}, P_{C} and P_{D} while their upper and lower surfaces are each coplanar.

For U and L profile portions, tongues T_{E} and T_{A}, respectively, need to be truncated, preferably along an inclined line, in order to enable tongues T_{E} and T_{A} to pass coupling panel P_{A} and to enter freely into their grooves. The cut of the tongues is minor and accordingly the horizontal FTG connection remains very strong and reliable.

All the connections may also be vertical FTG connections, with U and L profile portions, and such parquet segments are also in the scope of the invention.

FIG. 90 illustrates the process of unrolling typical structure S2 on a base surface after typical structure S1 is completely unrolled. During the process of unrolling typical structure S2, its parquet segments are interconnected with the parquet segments of typical structure S1 by the I-connection (IC), r-connection (rc), U-connection (UC) and L-connection (LC) interconnection methods which have been described hereinabove and shown in FIG. 91. Consequently, as described hereinbelow, the interconnections of the two structures in addition to the tongued and groove interconnections within each typical structure creates a very strong interconnection of all the parquet segments. The interconnection with and between additional typical structures S3, S4 or any other typical structures, which due to brevity are not described but are also within the scope of the invention, are also based on the same principles.

FIG. 92 schematically illustrates the interconnections of parquet segments for a parquet floor made of 4 typical structures S1, S2, S3 and S4. The bold lines represent horizontal FTG connections made with a coupling panel 40 (FIG. 4) and the thin lines represent vertical tongue and groove connections made by a pair of L and U profile portions or a pair of LR and U profile portions as described hereinabove with respect to I-connection, r-connection, U-connection and L-connection interconnection methods. As shown, each coupling panel is held at both of its long free edges by horizontal tongue and groove connections. Accordingly, when in contact with the floor at their free edges identically to a regular parquet floor, all the coupling panels and accordingly all the parquet segments are interconnected by a very strong connection which prevents disengagement of even a single parquet segment.

If correction is needed during the process of interconnection of parquet segments or of structures, the correction-worthy piece can be partly or entirely removed by rolling it in a counterclockwise direction, or in a direction opposite to the unrolling direction, unless the temporary common sheet RS (FIG. 72C) has been removed. If the temporary common sheet RS has been removed, it needs to be reattached in order roll back a typical structure. When a singular parquet segment needs to be replaced, it is recommended to roll back the typical structure to its location and to replace it.

If a sanitary, electrical or any other maintenance operation needs to be performed underneath a region of an unrolled structure, one or more floor tiles or other types of floor sections have to be removed. In order to facilitate rapid and harmless rolling of the parquet segments to roll form, a new temporary common sheet needs to be adhesively attached to the parquet segments. Once the parquet segments are rolled back to a roll form, the underlying floor surface is revealed and a maintenance operation is able to be performed. Upon completion of the maintenance operation, the structure-roll is able to unrolled once again.

The adhesive materials which are used to attach the temporary upper sheet are designed to have a sufficient adhesive force for holding each parquet segment during the process of rolling and unrolling the typical structure but which is limited so that it can be detached with a reasonable effort.

As described in detail above and illustrated in FIGS. 67A-67B, each parquet segment PR comprises at least two coupling panels SP_{I} and SP_{II}, which are interconnected by a lamination layer PL. If the lamination layer is of low structural strength or not sufficiently elastic, coupling panels SP_{I}, SP_{II} may be interconnected by a continuous joint CJ, as shown in FIG. 93B.

FIG. 93A illustrates the coupling panels SP_{I} and SP_{II} when interconnected by the lamination layer PL and separated by a relative angular displacement. When the lamination layer is very thin or not sufficiently elastic, folds and even tears may appear along the length of axis E1 according to the sudden change of the slope and to the strain which develops within the lamination layer during the process of rolling and unrolling of the typical structures. FIG. 93B illustrates the use of a continuous joint CJ which avoids almost entirely force transmission to the lamination layer and due to its continuous curvature it prevents the creation of folds in the lamination layer and consequently keeps the appealing appearance of the lamination layer PL.

To achieve a smoother (i.e. with a more continuous curvature), smaller-radius, and improved-density structure-roll configuration, each parquet segment may be comprised of three or more SP coupling panels, which are interconnected by an upper lamination layer acting as a common sheet applied to each individual parquet segment, and by the addition of continuous joints CJ if needed as described hereinabove. After deployment of the typical structure, the lamination layer will provide the illusive appealing appearance of a single parquet. If the parquet segment width is small enough (for example less than 10 cm), each parquet segment may be comprised of a single coupling panel.

FIGS. 94A-94C schematically illustrate a side view of three typical structures, respectively, and the arrangement of the SP coupling panels in a roll configuration when each parquet segment PL comprises two coupling panels SP, each having a width of 10 cm. Each figure demonstrates the exemplary density of the coupling panels when rolled and the exemplary length L of the structure when unrolled relative to its diameter. FIGS. 95A-95B schematically illustrate a side view of two typical structures, respectively, and the arrangement of the SP coupling panels in a roll configuration when each parquet segment PL comprises three coupling panels SP, each having a width of 6.8 cm. Each figure demonstrates the exemplary density of the coupling panels and the exemplary length L of the structure when unrolled relative to its diameter.

As shown, the roll tends to be more circular, easier to be unrolled, and the ratio of the length of an unrolled structure to the roll diameter is increased when a single parquet segment comprises a larger number of coupling panels. It is desired to reduce the diameter of a typical structure-roll to simplify the carrying and deployment of the typical structure by a single worker.

Although the description above relates to a regular crisscross parquet floor comprising coupling panel 40, the typical structures may be designed with other types of coupling panels such as any that are described herein, and the covering may be designed for other geometrical configurations and designs which are also in the scope of the invention. A method for rapidly deploying a floor covering by rolls may be performed using such an arrangement.

Since each parquet segment PR comprises one or more coupling panels SPs, it may be designed by diverse ornamental designs, geometrical shapes and sizes. Materials such as PVC carpets are also suitable to be used as a permanent common sheet which directly interconnects all the SP panels to create a vast monolithic coverage of the floor. In the last case it will be easier to roll back the entire structure when a correction is needed since the common sheet is not removed after the structure is deployed. The advantages of using the PVC carpets as a common sheet in system 310 include the ability to completely level the carpet even if the base surface is not completely leveled since system 310 is a UUSL CS, the ability to deploy the PVC parquet segments on frames instead of on monolithic surfaces, obviating the need of adhesively attaching the carpet to the floor and facilitating easy and harmless maintenance operations as described hereinabove.

System 310 with adequate typical structures may be used for covering additional surfaces such as a ceiling, inner and outer walls, sidewalks, fences etc.

The common sheet for holding all parquet segments together during rolling and unrolling operations may be located at an uppermost surface. If the common sheet is detachable, detachment may be effected by means of radiating energy that causes the temporary common sheet to become detached from the parquet segments, by chemical means or by other technological means well known to those skilled in the art.

The typical structures of the parquet floor can be delivered to the site on pallets and rolled and unrolled at the site.

A typical holding structure similar to structures 210 (FIG. 55) and 220 (FIG. 56) but without the stiffness elements can be provided to establish a proper secured implementation of the typical structure such as S1-S4 to enable a weakened adhesion of the temporary common sheet RS.

A UUSL CS can be used as a platform on which a parquet floor or any other flooring is implemented.

When a parquet segment is damaged, it may be replaced by a parquet segment having the same external dimensions and appearance. A replacement parquet segment may comprise two sub-parquets similar to parquet segment PR (FIGS. 67A-B), where sub-parquets SPI-II are able to be interconnected by an IFTG type connection, to enable the interconnection of the vertical and horizontal FTG tongue and groove connections with the adjacent parquet segments.

The replacement parquet segment can be used also in conventional parquet floors.

### Completely Coplanar Hinge for Continuous Surfaces

FIGS. 96A-108C illustrate a completely coplanar hinge 370 for continuous and uninterrupted surfaces, particularly furniture surfaces. Use of completely coplanar hinge 370 wherein an outer surface of the hinge is coplanar with an adjacent surface and its axis of rotation is coincident with, or slightly spaced from, the outer surface, provides an esthetically appealing appearance of a continuous surface, but one which is able to be folded upon demand. Completely coplanar hinge 370 may be, although not necessarily, concealed underneath a lamination covering both the outer surface of the hinge and the adjacent surface, to produce a continuous surface that is maintained unharmed and esthetically appealing when being folded, and alternatively which can be concealed by being painted.

Many implementations are envisioned for completely coplanar hinge 370. Some exemplary implementation include a closure providing a single door appearance for a cabinet comprised of two or more separated boards covered with contiguous lamination, which is able to cover all interior cabinet spaces and can be opened in order to access a desired interior cabinet space, doors or gates with unseen hinges, extensions for a dining table which create continuous surfaces when unfolded, folded tables, folding shelves, and any other structure for which a concealed or covered hinge is desired.

FIG. 96A illustrates two rectangular boards SS1 and SS2 which are interconnected by two completely coplanar hinges 370. Each of the completely coplanar hinges 370 consists of two sections, each of which adapted to being connected to a corresponding board. A pivot line 376 along which the boards SS1 and SS2 are able to be pivoted relative to each other passes through the two completely coplanar hinges 370 and coincides with the upper surface of the completely coplanar hinge and the upper surfaces 371 and 373 of boards SS1 and SS2 respectively. FIG. 96B illustrates board SS1 positioned with relative angular displacement relative to board SS2, while the upper surface of each board SS1 and SS2 is coplanar with the upper surface of the two hinge sections with which it is connected to maintain the continuity of upper surfaces 371 and 373 that adjoin pivot line 376. FIG. 96C illustrates the interconnected boards SS1 and SS2 covered by a continuous lamination or common sheet layer 375, which passes over and conceals the completely coplanar hinges 370 being indicated by dashed lines, creating the illusive appearance of a single monolithic board, yet enabling the relative angular displacement of the boards along pivot line 376, which is also indicated by a dashed line. As shown in FIG. 96D when boards SS1, SS2 are relatively angularly displaced, the lamination or common sheet is undamaged and retains its appealing appearance according to the description above.

FIGS. 97A-97C illustrate the two sections 380 and 390 of completely coplanar hinge 370 prior to being interconnected in FIG. 97A, after being interconnected in FIG. 97B and after undergoing relative angular displacement in FIG. 97C.

As shown in FIG. 97B, completely coplanar hinge 370 preferably has a circular periphery 379 that facilitates effortless insertion within a large-sized drilled recessed hole, for example having a diameter ranging from 5-12 cm, e.g. 7 cm, made with a wooden drill, but other configurations are also within the scope of the invention. Square 377 inscribed within circular periphery 379 represents the border between pivoting producing elements P1 and P2 at the interior of the square. The portion 381 of a hinge section at the exterior of the square is connectable to each one of the boards 371 and 373, for example by a fastener passing through each aperture 382.

As illustrated in FIG. 97A, pivoting producing element P1 is configured with upper wall w1, two side walls w2 and w3, two lower arcuate walls w4 (FIG. 98B), arcuate arms ar1 and ar2 that are semicircular, or whose periphery has an angular length of slightly less than or equal to 180 degrees, tongue 35 (seen more clearly in FIG. 99), grooves gr1 and 32 located between arms ar1 and ar2, and groove gr2 located between arm ar1 and side wall w2. Pivoting producing element p2 is configured with upper wall w5, two side walls w6 and w7, two lower arcuate walls w8 (FIG. 98A), arms ar3 and ar4 having an angular length of equal to or less than 180 degrees, groove gr3 located between arms ar3 and ar4 and groove gr4 located between arm ar4 and side wall w7. FIG. 97C illustrates hinge sections 380 and 390 interconnected and angularly displaced about pivot line RH which coincides with the upper wall surfaces w1 and w5 and the upper surface of the circular periphery 379. Each of the arms may have a general D-shaped configuration. Completely coplanar hinge 370 is configured to minimize stress exerted on the pivoting producing elements and to therefore ensure reliable hinge operation regardless of whether pivot line RH is disposed at a vertical orientation or at a horizontal orientation.

FIGS. 98A-98C illustrate hinge 370 cut along plane π shown in FIG. 97B. Plane π is parallel to the upper surface of the completely coplanar hinge and is located along the height of the lower surface of upper walls w1 and w5. FIG. 98A illustrates a view cut along plane π with the absence of pivoting producing element P1. FIG. 98B illustrates a view cut along plane π with the absence of pivoting producing element P2. FIG. 98C illustrates a view cut along plane π with both pivoting elements P1, P2 being shown.

As illustrated in FIG. 98C, hinge section 380 is configured with a central rectilinear region 383 that extends laterally from square 377 to pivot line RH. Central rectilinear region 383 is interposed between, and longitudinally separated from, first support element 384 and second support element 385 of the same lateral dimension as central region 383, and which are contiguous with square 377. A first arm ar1 extends laterally from central region 383 through the majority of the width of hinge section 390. A second arm ar2 extends laterally from second support element 385 through the majority of the width of hinge section 390. A narrow interface portion 388 contiguous with square 377 extends between central rectilinear region 383 and first support element 384, and a narrow interface portion 389 contiguous with square 377 extends between central rectilinear region 383 and second support element 385.

Hinge section 390 is identical to hinge section 380, and is configured with central rectilinear region 393, first support element 394, second support element 395, first arm ar3, second arm ar4, and interface portions 398 and 399. An interlocking joint 400, such as the illustrated box joint, or alternatively a dovetail joint, connects each of first arm ar1 of hinge section 380 to second support element 395 of hinge section 390, second arm ar4 of hinge section 390 to central rectilinear region 383 of hinge section 380, second arm ar2 of hinge section 380 to central rectilinear region 393 of hinge section 390, and first arm ar3 of hinge section 390 to second support element 385 of hinge section 380.

FIG. 99 illustrates a cross section of central rectilinear regions 383 and 393. As shown, rectilinear regions 383 and 393 are coupling panels R1 and R2, respectively, which are configured as a truncated coupling panel 40 (FIG. 4) so as to be lockingly joinable together and angularly displaceable one from the other, but without having to be joined with another coupling panel. Although central rectilinear regions 383 and 393 are described as being truncated coupling panels 40, any other angularly displaceable coupling panel is also within the scope of the invention.

Central rectilinear region 383 is a coupling panel R1 which is similar to coupling panel 40 (FIG. 4) configured with core portion 29, upper wall 48, lower wall 49, and groove 32 defined between wall 48 and 49, but without the tongue and the extreme forward surface. Central rectilinear region 393 is a coupling panel R2 which is similar to coupling panel 40 configured with core portion 29 and tongue 35, but without the upper and lower walls and without the groove. At the illustrated orientation, tongue 35 of central rectilinear region 393 is inserted within groove 32 of central rectilinear region 383 such that central rectilinear regions 383 and 393 are lockingly joined together, while the upper surface of tongue 35 abuts the lower surface of wall 48.

FIG. 100 illustrates pivoting producing element P1 when separated from pivoting producing element P2. Pivoting producing element P1 attached to central rectilinear region 383 is configured with an arcuate groove-formed arm ar1, which subtends an angle preferably less than 180 degrees, e.g. 160 degrees. An arcuate protrusion-formed arm ar2 of the same dimensions is attached to the surface of first support element 385 that faces the central rectilinear region. Groove 32 is located between the arms ar1 and ar2 and is formed within the central rectilinear region. A quarter circular groove gr1 is located between groove 32 and arm ar2, and a quarter circular groove gr2 is located between arm ar1 and second support element 384. Arm ar1 is formed with a recessed arcuate groove 409 that is coincident at both terminal ends thereof with upper surface 406 of the arm, and arm ar2 is formed with arcuate protrusion 410 that is coincident at both terminal ends thereof with upper surface 407 of the arm. A lower surface 404 substantially parallel to upper wall W1 and overlying protrusion 410 and groove gr1 extends from upper surface 407 of arm ar2 to central rectilinear region 383, and a lower surface 405 substantially parallel to upper wall W1 and overlying grooves 409 and gr2 extends from upper surface 406 of arm ar1 to central rectilinear region 383.

FIG. 101 illustrates pivoting producing element P2 when separated from pivoting producing element P1. Pivoting producing element P2 attached to first support element 395 is configured with an arcuate protrusion-formed arm ar3, which subtends an angle preferably less than 180 degrees, e.g. 160 degrees. Arcuate groove-formed arm ar4 of the same dimensions is attached to the central rectilinear region 393. A tongue 35 is located between arms ar3 and ar4, and is attached to the central rectilinear region. A quarter circular groove gr3 is located between tongue 35 and arm ar3, and a quarter circular groove gr4 is located between arm ar4 and second support element 394. Arm ar3 is formed with arcuate protrusion 411 that is coincident at both terminal ends thereof with upper surface 416 of the arm, and arm ar4 is formed with a recessed arcuate groove 412 that is coincident at both terminal ends thereof with upper surface 419 of the arm. A lower surface 413 substantially parallel to upper wall W5 and overlying protrusion 411 and groove gr3 extends from upper surface 416 of arm ar3 to central rectilinear region 393, and a lower surface 414 substantially parallel to upper wall W5 and overlying protrusion grooves 412 and gr4 extends from upper surface 419 of arm ar4 to central rectilinear region 393.

As shown in FIGS. 100-101, arcuate recessed-formed arm ar1 has the same dimensions as arcuate protrusion-formed arm ar3, and arcuate protrusion formed arm ar2 has the same dimensions as arcuate recessed formed arm ar4. Arcuate protrusion 411 protruding from a side face of semicircular arm ar3 has the same radius of curvature as arcuate recess 409 of arm ar1 and a width slightly less than that of recess 409. Arcuate protrusion 410 protruding from a side face of semicircular arm ar2 has the same radius of curvature as arcuate recess 412 of arm ar4 and a width slightly less than that of recess 412. Consequently as shown in FIGS. 102A-B, pivot producing elements p1 and p2 are interconnected by the insertion of protrusions 410 and 411 into recesses 412 and 409, respectively, and by the insertion of tongue 35 within groove 32. Pivoting producing elements P1 and P2 are shown in a coplanar configuration in FIG. 102A and in angularly displaced relation in FIG. 102B. The relative angular displacement of pivot producing elements p1 and p2 about pivot line RH (FIG. 97C) is made possible by the ability of protrusions 410 and 411 to slide within arcuate recesses 412 and 409, respectively, and by the free movement of tongue 35 within groove 32, as explained above in relation to FTG coupling panels.

FIGS. 102A-B illustrate pivoting producing elements P1 and P2 when cut along plane 7r (FIG. 97B) and interconnected. In a coplanar configuration, the angular displacement of pivoting producing elements P1 and P2 is restricted in counterclockwise and clockwise directions respectively according to the illustrated orientation. Such restriction is made possible by the contact between upper arm surface 406 and lower surface 413 of upper wall w5, upper arm surface 407 and lower surface 414 of upper wall w5, upper arm surface 416 and lower surface 405 of upper wall w1, upper arm surface 419 and lower surface 404 of upper wall w1 (as shown in FIGS. 100-101), and the tongue and groove connection in the central rectilinear region. On the other hand when pivoting producing elements P1 and P2 are coplanar, they can be angularly displaced in the clockwise and counterclockwise directions according to the illustrated orientation, respectively, by the ability of the arcuate protrusions 410 and 411 to slide within arcuate recesses 412 and 409, respectively, as shown in FIG. 102B, and by the free movement of tongue 35 within groove 32. The relative angular displacement of pivoting producing elements P1 and P2, and accordingly of the whole hinge, may be restricted to 90 degrees by means which will be described below.

FIGS. 103A-C and 104A-C illustrate isometric and side views, respectively, of a completely coplanar hinge that is rendered transparent. The relative position of some elements of the hinge are shown when the hinge is set at a coplanar configuration (FIGS. 103A and 104A), an angularly displaced configuration of less than 90 degrees (FIGS. 103B and 104B), and an angularly displaced configuration equal to 90 degrees (FIGS. 103C and 104C). When one of the two hinge sections 380 or 390 is set to a pivoted position, as shown in FIG. 104B, hinge section 390 for example, together with arms ar3 and ar4, is pivoted about axis of rotation RH. The arcuate protrusions are accordingly displaced along the corresponding arcuate grooves respectively while being only partially received within the grooves to facilitate the pivotal displacement of hinge section 390 relative to hinge section 380. During this angular displacement, tongue 35 gradually becomes separated from groove 32 but is permanently located between arms ar1 and ar4 as shown in FIG. 105A. As shown clearly in FIG. 104C, tongue 35 is completely separated from groove 32 when the relative angular displacement of sections 380 and 390 is 90 degrees, and as shown in FIG. 105B is still located between arms ar1 and ar4. As explained below, according to the permanent location of tongue 35 between arms ar1 and ar4, the completely coplanar hinge has a very large moment bearing capacity, when as illustrated in FIG. 106B, a moment M2 acts along axis LK.

The completely coplanar hinge can withstand a large moment M1 which acts along axis RH as shown in FIG. 106A as a result of the following three factors: (i) mainly due to the strong tongue and groove connection in the central rectilinear regions 383 and 393 as explained and shown above with respect to FIG. 99, (ii) and also due to the contact between upper surfaces 406 and 407 of arms ar1 and ar2 and the lower surfaces 413 and 414 of upper wall w5, respectively, and (iii) due to the abutting relation between upper surfaces 416 and 419 of arms ar3 and ar4 and the lower surfaces 405 and 404 of upper wall w1, respectively. The completely coplanar hinge can also withstand a large-magnitude moment M2 which acts along axis LK that is perpendicular to axis RH as illustrated in FIG. 106B, due to the stress which is developed in the abutting recessed surface of arm ar1 and protruding surface of arm ar3, and due to the stress which is developed in the abutting recessed surface of arm ar4 and protruding surface of arm ar2. The stress which acts in the abutting surfaces thereof is primarily perpendicular to the arms, which are liable to bend due to their small thickness. However, by virtue of the presence of tongue 35 which is located between the abutting parts of arms ar1 and ar4, and between the abutting parts of arms ar2 and ar3 as explained hereinabove, and the large vertical moment of inertia of the tongue, this bending is prevented even when exposed to a large moment M2.

The completely coplanar hinge also has high durability to shear forces in conjunction with a tongue and groove configuration in the central rectilinear region when the shear forces act perpendicular to the upper surface of the hinge and in conjunction with the abutting surfaces of the hinge thereof when the shear force acts perpendicular to the lateral face of the hinge.

The ability to withstand large moments and shear forces in two perpendicular directions thereof enables the large moment and shear forces bearing capacity of the hinge at each desirable direction.

There are many feasible means to restrict the relative angular displacement of sections 380 and 390 to 90 degrees, two of which are given hereinbelow.

FIGS. 107B-D illustrate first means for the relative angular displacement restriction. FIG. 107A illustrates a cross section of the central rectilinear region of hinge 390 as explained above in relation to FIG. 99, when the two coupling panels R1 and R2 are separated from each other. FIG. 107B illustrates the cross section of two modified coupling panels RN1 and RN2 for use in rectilinear regions 383 and 393 shown in FIGS. 100 and 101 that are modified relative to coupling panels R1 and R2, respectively, to enable a 90-degree restriction of one of the hinge sections. As shown, the lower wall 421 of coupling panel RN1 is more elongated than its counterpart lower wall 49 of coupling panel R1, an elongated aperture 422 is formed in lower wall 421, and a recess 423 is formed in vertical wall 44 of coupling panel R1. As also illustrated in FIG. 107B, a secondary protrusion 420 extending forwardly from extreme forward surface 31 (FIG. 4) is provided in addition to tongue 35. In coupling panel RN2, substantially rectilinear secondary protrusion 420 is integral with, and extends forwardly to, tongue 35. An intermediate wall 424 is located significantly rearwardly with respect to its counterpart wall 39 of coupling panel R2 to accommodate the structure of coupling panel RN1. The rear surface 425 of secondary protrusion 420 is coplanar and continuous with the wider rear surface 427 that is adjacent and substantially perpendicular to intermediate wall 424. All other features of coupling panels RN1 and RN2 are the same as coupling panels R1 and R2, respectively.

FIG. 107C illustrates coupling panels RN1 and RN2 when interconnected and positioned in a coplanar configuration. In this configuration, tongue 35 is received within groove 32 and secondary protrusion 420 is received within recess 423, restricting angular displacement of coupling panel RN2 for example in a clockwise direction according to the illustrated orientation. When, for example, coupling panel RN2 is subsequently angularly displaced relative to coupling panel RN1 in a counterclockwise direction according to the illustrated orientation, tongue 35 is able to be angularly displaced unrestrictedly within groove 32 according to the geometric considerations described in relation to FIG. 14. Also, secondary protrusion 420 is able to be angularly displaced unrestrictedly, while being dislodged from recess 423 and introduced into aperture 422. As shown in FIG. 107D, the angular displacement of coupling panel RN2 is limited when rear surface 425 of secondary protrusion 420 abuts the wall 426 delimiting aperture 422 that is separated by the greatest distance from core 29 of coupling panel R1. Consequently using the illustrated configuration, the angular displacement of one of the hinge sections 380 and 390 is able to be restricted to 90 degrees.

FIGS. 108A-C illustrate second means for the relative angular displacement restriction. FIG. 108A illustrates the pivoting producing elements when cut along plane 7c. Modified pivoting producing element P2 is configured with two narrow arcuate secondary recesses 444 that are recessed by a relatively small depth in side face 433 of arm ar4. Each narrow secondary recess 444 is contiguous with a different arcuate border of main recess 412 and extends along at least the majority of recess 412 from upper face 438 of arm ar4, terminating at an abutment 448 that adjoins a portion of side face 433. Modified pivoting producing element P1 is configured with two narrow and rectangular secondary protrusions 441 inwardly protruding from side face 431 of arm ar2 and laterally extending in a corresponding direction from arcuate protrusion 410. Similarly, two narrow arcuate secondary recesses 443 that are contiguous with a different arcuate border of main recess 409 and extend along at least the majority of recess 409 from upper face 435 of arm ar3, terminating at an abutment 445 (FIG. 105B) that adjoins a portion of side face 430, are recessed by a relatively small depth in side face 430 of arm ar3. Also, two narrow and rectangular secondary protrusions 446 inwardly protrude from side face 432 of arm ar3 and laterally extend in a corresponding direction from arcuate protrusion 411.

When pivoting producing elements P1 and P2 are interconnected, each of the thin and narrow secondary protrusions 446 and 441 is adapted to be received in, and slide along, a corresponding one of the arcuate secondary recesses 443 and 444. Pivoting producing element P2 is restricted to an angular displacement of 90 degrees as shown in FIG. 108C when a secondary protrusion 441 of arm ar2 contacts an abutment 448 of arm ar4 and a secondary protrusion 446 of arm ar3 contacts an abutment 445 of arm ar1.

FIGS. 105A-B illustrate the rear view of the coplanar hinge which is configured with secondary recesses and secondary protrusions, showing a relative angular displacement of hinge sections 380 and 390 of less than 90 degrees (FIG. 105A) and a 90 degrees relative angular displacement (FIG. 105B). As shown in FIG. 105B when the relative angular displacement is equal to 90 degrees, additional relative angular displacement is restricted due to the contact between secondary protrusions 441 and 446 and abutments 448 and 445, respectively.

Although a restriction to a relative angular displacement equal to 90 has been described hereinabove, a restriction to other angular displacements is also applicable and within the scope of the invention.

The rear of the hinge may be concealed according to the use, and the concealed rear is also in the scope of the invention.

It will be appreciated that the hinge is able to be adjusted, for example with added adjustment means to take into account mounting inaccuracies.

It will be appreciated that the hinge may comprise more than two pivoting producing elements, and be based on the same principles as described above.

It will be appreciated that any other direction-sensitive displacement facilitating means described herein may be employed to produce a hinge similar to the previously described completely coplanar hinge 390 which is reliable, has a high force bearing capability, and has an axis of rotation coinciding with, or spaced from above or below, the main web face.

FIGS. 131A-133E illustrate another embodiment of a completely coplanar hinge wherein each of the two types ZA1 and ZA2 of a completely coplanar hinge enables a relative 180-degree angular displacement of the engaged hinge sections. In this embodiment, the pivot producing elements include a plurality of arcuate arms, which may be, but not necessarily, identical and that are face-wise interconnected throughout the length of the pivot axis between the two hinge sections. Each pair of adjacent arms are interconnected to each other, generally by a relatively large-clearance protrusion-groove connection, which enables each arm pair to be individually angularly displaced by a relatively small angular displacement, e.g. of approximately 20 degrees. While the two hinge sections are being pivoted, each pair of arcuate arms may be caused to be disposed at a different angular disposition, resulting in a relatively large difference in total angular disposition, for example 180 degrees between a first arcuate pair and a last arcuate pair positioned along the pivot axis.

Various arcuate arms C1-C6 are illustrated in FIGS. 131A-131F, respectively, for use in pivoting a hinge ZA1 or ZA2. An exemplary arrangement of the front and rear faces of each arcuate arm is shown, whereby arm C1 is configured with a flat face F1 and a recessed face R1 formed with an arcuate recess CR1, arms C2-C4 are configured with recessed face R1 and protrusion-formed face P1 provided with arcuate protrusion PR1 formed at three different angular dispositions relative to the upper face of the arm, respectively, and which may have an angular length that is 30 degrees shorter than the angular length of arcuate recess CR1, and arms C5-C6 are configured with a flat face F1 and a protrusion-formed face P1 with arcuate protrusion PR1 being formed at two different angular dispositions relative to the upper face of the arm, respectively.

It will be appreciated that any other suitable arrangement of the front and rear faces, including differently configured face-wise interconnected members that are individually angularly displaceable, is also in the scope of the invention.

FIGS. 132A-132E illustrate the structure of completely coplanar hinge ZA1 that is capable of undergoing relative angular displacement of greater than 90 degrees in FIG. 132D and relative angular displacement of 180 degrees in FIG. 132E.

The pivot producing elements, or inner mechanism, of hinge ZA1 are illustrated in FIGS. 132A-132C. As shown in FIGS. 132A and 132D, two cuboids CU1 and CU2 are integrated with the two hinge sections, respectively. Cuboid CU1 is equipped with two arms C5, and cuboid CU2 is equipped with two arms C1. Cuboids CU1 and CU2 are interconnected by two identical groups GR1 and GR2 that each comprises five abutting arcuate arms C4, as illustrated in FIG. 132B. Each adjacent arcuate arm C4 may be displaced one from the other by a relative angular difference of up to 30 degrees and may also be disposed at the same relative angular disposition as arcuate arms C5 and C1 of cuboids CU1 and CU2, respectively.

FIG. 132C illustrates the interconnection of cuboids CU1 and CU2 by the two groups GR1 and GR2. According to this configuration, cuboids CU1 and CU2 may undergo a relative angular displacement ranging from 0-180 degrees, while maintaining a very stable and accurate connection by virtue of the long arc of protrusion PR1 and the large abutting surface of each adjacent arcuate arm.

As illustrated in FIGS. 132D-132E, completely coplanar hinge ZA1 preferably has a circular periphery PR to facilitate effortless insertion within a drilled recessed hole, although other periphery configurations are also within the scope of the invention. Protrusion PR1 and correspondingly recess CR1 may be designed in any other suitable configuration, such as a T-shape or a dovetail shape, which enables a strong and undivided connection of the arcuate arms C1-C6.

FIGS. 133A-133E illustrate the structure of completely coplanar hinge ZA2 when undergoing relative angular displacement of greater than 90 degrees in FIG. 133D and relative angular displacement of 180 degrees in FIG. 133E. The pivot producing elements of hinge ZA2 are illustrated in FIGS. 133A-133C. As shown in FIGS. 133A and 133D, two cuboids CU3 and CU4 are integrated with the two hinge sections, respectively. Cuboid CU3 is equipped with two arcuate arms C1 and C5, and cuboid CU4 is equipped with arcuate arm C2. Cuboids CU3 and CU4 are interconnected by two groups GR3 and GR4, wherein group GR3 comprises 5 abutting arcuate arms C4, and group GR4 comprises 5 abutting arcuate arms C3 as illustrated in FIG. 133B. Each adjacent arcuate arm C3 or C4 may be disposed one from the other by a relative angular difference of up to 30 degrees and may also be disposed at the same relative angular disposition as the end arcuate arms C1 and C5 of cuboid CU3.

FIG. 133C illustrates the interconnection of cuboids CU3 and CU4 by the two groups GR3 and GR4. According to this configuration, cuboids CU3 and CU4 may undergo a relative angular displacement ranging from 0-180 degrees, while maintaining a very stable and accurate connection by virtue of the long arc of protrusion PR1 and the large abutting surface of each adjacent arcuate arm.

As illustrated in FIGS. 133D-133E, completely coplanar hinge ZA2 preferably has a circular periphery PR to facilitate effortless insertion within a drilled recessed hole, although other periphery configurations are also within the scope of the invention.

It is also envisioned to add a FTG connection to completely coplanar hinges ZA1 and ZA2 similarly to completely coplanar hinge 390 (FIG. 97A) in order to enhance their reliability and in order to achieve a very high load bearing capacity when the hinge is leveled.

### Additional Implementations

The following description relates to additional non-limiting implementations of a reconfigurable web, which are described in brief.

FIGS. 109 and 110 illustrate system 503 comprising two FTG UUSL CS 500 and 501. Each coupling panel 40 of UUSL CS 501 is configured with a pin 499 that protrudes from its upper surface, in order to be interconnected with a corresponding groove 498 formed in the lower surface of each coupling panel 40 of UUSL CS 500 when the two connecting systems are being unrolled, in accordance with the illustrated orientation. Corners of the coupling panels 40 may be slightly curved or chamfered to prevent interference with a corresponding coupling panel of the other connecting system during an unrolling operation. System 503, by the interconnection thereof as shown in FIG. 109, may function as a completely stiff column, beam or surface 502 as shown in FIG. 110, which may be used in a variety of applications. The lamination layer 504 in addition to the bidirectional stiffness of system 503 produces the illusive appearance of regular columns and surfaces.

The plate produced when the UUSL CS is unrolled is usually very thin, and is similar to a thin monolithic plate that may be deflected under high loads. A prestressing process will enable the UUSL CS plates to have improved features as compared to monolithic plates and to eliminate almost entirely the plate deformation even when subjected to high loads. When supported and prestressed, the plate will absorb the majority of the load and will be enabled to significantly decrease the dimensions of the supports. Under sufficiently large prestressing, the plate can bear by itself (without using any supports) high loads without any visible deformations.

FIGS. 111A-D demonstrate two methods to prestress the UUSL CS plate. FIGS. 111A-B illustrate the prestressing of a UUSL CS plate 505 when supported by support 506. First, as shown in FIG. 111A, the coupling panels of plate 505 are designed to create an upwardly extending arcuate plate, and then the prestressing is achieved by means of a FTG-based securing element JJ, e.g. L-shaped, positioned at the end of plate 505. When securing element JJ is attached to the end of support 506, plate 505 is secured and caused to be a prestressed stiff surface PPLT1. FIGS. 111C-D illustrate the prestressing of bidirectionally stiff plate 502, which is illustrated in FIGS. 109-110. Firstly as shown in FIG. 111C, the coupling panels of the UUSL CS 500 and 501 are designed to create two plates of opposite curvature, such as an upwardly extending arcuate plate 507 and a downwardly extending arcuate plate 508 that may be in contact with, while being unattached to, plate 507. The prestressed stiff surface PPLT2 is produced by holding a first end of plates 507 and 508 and by means of a securing element JK adapted to be secured to the coupling panels at a second end of each of plates 507 and 508 that is opposite to the first end, as illustrated in FIG. 111D.

Surface PPLT2 may also be prestressed by any other suitable means or process which results in the configuration illustrated in FIG. 111D.

In the implementation of FIGS. 112A-118B, various embodiments of pullout support surfaces are illustrated.

FIGS. 112A-B illustrate a vertical cross sectional view of system 510, which is adapted to function as a pullout table or shelf to be pulled out from or retracted to a roll configuration by mechanical or electromechanical means and may be embedded within a wall 515.

System 510 comprises a pullable supporting surface 514 comprising upper-level FTG UUSL CS 511, which is covered by a lamination layer 512, and underlying supports such as folding or telescopic supports 513 which may be pulled out upon demand together with upper level 511. The supports 513 are able to be retracted when a plurality of interconnected and angularly displaceable links are employed, as well known to those skilled in the art. The upper level UUSL CS 511 and lower level supports 513 are shown to be fully retracted in FIG. 112A and to be partially extended in FIG. 112B.

Since the upper level 511 of supporting surface 514 is a UUSL CS, it can absorb downwardly directed vertical loads without having significant deformations. Consequently, the dimensions of the supports 513 may be reduced and designed to participate in the load absorption, while preventing the folding of the upper level 511 in response to upwardly directed loads. The upper level 511 may also be prestressed by supports 513 as explained and illustrated in FIGS. 111A-B in order to minimize the dimensions of the supports as well as the deformation of the upper level when subjected to loads. Supporting surface 514 may be pulled out to any desired length which is less than or almost equal to the maximum length of the UUSL CS 511. The ability to use lamination layer 512 provides the illusive appealing appearance of a table or of shelves made of a monolithic plate.

System 510 also comprises storable device SD1, which includes a rectilinear casing embedded in wall 515 defining an internal cavity within which a roll 516 of upper level 511 is able to be stored. A hub, which may be configured as a spindle, is rotatably mounted to the casing about which upper level 511 is rolled and unrolled. A secondary volume is located directly below the internal cavity for housing the extendable supports 513. The casing has an opening through which the upper-level UUSL CS and supports are able to be extended when set in contact with each other by means of securing element 534 provided at the end of the upper-level UUSL CS 511 and covered by an additional portion of lamination layer 512. Guiding means may be provided to ensure that the upper-level UUSL CS 511 will be extended in a horizontal disposition and without slack. Actuatably or mechanically releasable locking means are provided to ensure that the extended upper level or supports will not be subject to unwanted retraction when in use.

When electromechanical means are employed, a first motor may be used to rotatably drive the hub and a second motor may be used to extend or retract supports 513, or alternatively a single motor drives both the hub and the supports. The electromechanical means may be operated in conjunction with manual manipulation of upper level 511.

System 510 may be implemented in conjunction with any desired fixed or movable member, ensuring that the supporting surface will be vertically, horizontally or obliquely oriented. For example, the supporting surface may function as an adjustable shelf or table or as a sliding door, with or without supports 513. When not using supports 513, system 510 may comprise additional means which prevent relative angular rotation of the UUSL CS FTG coupling panels which are pulled out from storable device SD1, and enable their relative angular rotation within storable device SD1. Rails may be added to increase the stability of the door in addition to or instead of supports 513. UUSL CS 511 may be covered with an elastic envelope or by using additional devices to be laminated at its lateral free sides in order to enhance its appealing appearance. System 510 may also include additional devices and elements in order to enable the proper smooth operation of system 510 which are well known to those skilled in the art.

FIGS. 113A-D illustrate a vertical cross sectional view of system 520 which is almost identical to system 510 (FIGS. 112A-B), with the exception of one change. The external lamination 533 is not permanently attached to the upper surface of the UUSL CS 511, but rather is rolled on a spool that is rotatably mounted within secondary storable device 521 in order to be pulled out as shown in FIG. 113B, together with upper-level UUSL CS 511, which is intended to be in juxtaposition below external lamination 533, and lower-level supports 513 that are both pulled out from main storable device SD2. Secondary storable device 521 is mounted within main storable device SD2, the latter being configured similarly as SD1 of FIGS. 112A-B. Supporting surface 517 comprises the extended external lamination 533, upper-level UUSL CS 511 and lower-level supports 513.

FIG. 113A illustrates system 520 in a retracted configuration. Secondary storable device 521 is removable from main storable device SD2, and may be replaced by the user with an identical device which includes the same or a different lamination pattern, depending on ornamental or maintenance considerations. By this arrangement, the lamination layer functions also as means which separate the inner region of system 520 from its outer region and consequently maintains the cleanliness and hygiene of the inner mechanism. Similar to system 510, the ability to use lamination layer provides the illusive appealing appearance of a table or shelves made of a monolithic plate.

System 520 may be implemented in conjunction with any desired fixed member, ensuring that the supporting surface will be vertically, horizontally or obliquely oriented. For example, the supporting surface may function as an adjustable shelf or table or as a sliding door, with or without supports 513. When not using supports 513, system 520 may have additional means which prevent relative angular rotation of the UUSL CS FTG coupling panels which are pulled out from storable device SD2 and enable their relative angular rotation within storable device SD2. Rails may be added to increase the stability of the door in addition to or in place of supports 513. System 520 may be configured with an additional secondary storable device 522 (not shown) which is identical to secondary storable device 521 and located at another side of supporting surface 517. Alternatively, UUSL CS 511 may be covered individually or together with supports 513 with an elastic envelope in order to enhance its appealing appearance. System 520 also includes additional devices and elements such as a motor, transmission, axles and bearings as well known to those skilled in the art to ensure reliable operation of the system.

FIGS. 114A-B illustrate a vertical cross sectional view of system 530, which may function as a floating table or shelf to be pulled out or retracted to a roll configuration by mechanical or electromechanical means and may be embedded within a wall 515 as shown in FIG. 114A. System 530 comprises two UUSL CS rolls 531 and 532 rotatably mounted in common storable device SD3, each of which is unidirectionally stiff in an opposite stiffness direction. A stiff supporting surface 535 is produced when the two rolls are pulled out as shown in FIG. 113B. The ability of covering each UUSL CS 531 and 532 with lamination 533 provides the illusive appealing appearance of a floating monolithic surface when pulled out. System 530 may be implemented in conjunction with any desired fixed member, ensuring that the supporting surface will be vertically, horizontally or obliquely oriented. For example, the supporting surface may function as an adjustable shelf or table or as a sliding door. Rails may be added to increase the stability of the door. UUSL CS rolls 531 and 532 may be covered with an elastic envelope, in addition or in place of the UUSL CS lamination layer.

FIGS. 115A-D illustrate a vertical cross sectional view of system 540, which is identical to system 530 excluding the lamination implementation. As shown in FIGS. 115A-B, the lamination layers are able to be paid out by means of device 541, which comprises two identical secondary storable devices 521A-B that are shown in the enlargement of FIGS. 115C-D. As shown, lamination layer 533 is paid out in different rotational directions from each of secondary storable devices 521A-B located above and below supporting surface 535, respectively. When supporting surface 535 is fully retracted as shown in FIG. 115C, lamination layer 533 is fed between the compressing roller 547A provided at a bottom region of upper secondary storable device 521A and the compressing roller 547B provided at an upper region of lower secondary storable device 521B, being pressed against securing element 546 that secures the end coupling panel of connecting systems 531 and 532 together. When supporting surface 535 is extended, lamination layer 533 is increasingly paid out in response to the force applied thereon by securing element 546 and caused to be in juxtaposition with the corresponding face of the coupling panels.

Secondary storable devices 521A-B are removable, and may be replaced by the user with identical corresponding devices which each includes the same or a different lamination pattern, depending on ornamental or maintenance considerations. By this arrangement, the lamination layer functions also as means which separate the inner region of system 540 from its outer region and consequently maintains the cleanliness and hygiene of the inner mechanism. System 540 may be implemented in conjunction with any desired fixed member, ensuring that the supporting surface will be vertically, horizontally or obliquely oriented. For example, the supporting surface may function as an adjustable shelf or table or as a sliding door. Rails may be added to increase the stability of the door. UUSL CS rolls 531 and 532 may be covered with an elastic envelope, in addition or in place of the UUSL CS lamination layer.

It will be appreciated that system 540 may be employed to cover the sides of an extendable supporting surface that includes supports 513 of FIGS. 112-113.

System 540 also includes additional devices and elements such as a motor, transmission, axles and bearings as well known to those skilled in the art to ensure reliable operation of the system.

FIGS. 116A-B illustrate a vertical cross sectional view of system 550 constituting a pullout table or shelf which may be embedded within a thin wall 551. As shown in FIG. 116A, system 550 is configured with storable device SD4 and supporting surface 514 identical to that of system 510 (FIG. 112B). Instead of retracting the coupling panels of the UUSL CS 511 into a roll configuration when unused, the coupling panels are displaced mechanically or electromechanically along arcuate slope 552 into a vertical slit 553 formed within the thickness of storable device SD4 as shown in FIG. 116B. Optionally, a secondary storable device for providing an external lamination may be added, as explained in relation to system 520 (FIG. 113B), instead of using a permanent lamination 512. System 550 may be implemented in conjunction with any desired fixed member, ensuring that the supporting surface will be vertically, horizontally or obliquely oriented. For example, the supporting surface may function as a sliding door. Rails may be added to increase the stability of the door. UUSL CS 511 may be covered with an elastic envelope, in addition or in place of the lamination layer. Storable device SD4 may have an extension which may be perpendicular to wall 551 when the face of the door opening is not entirely adjacent to the wall.

FIGS. 117A-B illustrate a vertical cross sectional view of system 555, which may function as a pullout floating table or shelf and may be embedded within a thin wall 551. As shown in FIG. 117B, system 555 comprises storable device SD5, two identical FTG UUSL CS 561 and 562 located in a mirror orientation in order to have opposite stiffness directions and consequently to achieve a stiff supporting surface 536 without using any additional underlying supports. Supporting surface 536 may be pulled out to any desired distance which is less than or almost equal to the maximum length of each UUSL CS. When unused, each UUSL CS can be retracted by being displaced mechanically or electrically along a corresponding arcuate slope 559 into one of the vertical slits 563 and 564 which are formed within storable device SD5 as shown in FIG. 117A. In compensation for the lack of external supports and high loads that may be act on supporting surface 536, the FTG UUSL CS 561 and 562 preferably need to be prestressed in order to avoid any deformations as explained above. The lamination 533 provides the illusive appealing appearance of a monolithic surface. Optionally, a secondary storable device for providing an external lamination may be added, as explained in relation to system 540 (FIG. 115B), instead of using a permanent lamination 533. System 555 may be implemented in conjunction with any desired fixed member, ensuring that the supporting surface will be vertically, horizontally or obliquely oriented. For example, the supporting surface may function as an adjustable shelf or table or as a sliding door. Rails may be added to increase the stability of the door. UUSL CS 561 and 562 may be covered with an elastic envelope, in addition or in place of the lamination layer. Storable device SD5 may have an extension which may be perpendicular to wall 551 when the face of the door opening is not entirely adjacent to the wall.

In the implementation illustrated in FIGS. 118A-130, various embodiments of pullout vertical and horizontal partitions are illustrated.

FIGS. 118A-B illustrate a top view of system 560, which may function as an add-on pullout door or partition unit. The partition 570 is shown to be retracted in FIG. 118A and extended in FIG. 118B.

System 560 comprises two vertical-axis and longitudinally spaced rolls 561 and 562 on which are wound, and between which extend, a single IFTG UUSL CS having lamination layer 564. Rolls 561 and 562 are housed in a dedicated enclosure and are rotatably mounted onto upper and lower horizontal walls of the enclosure. The enclosure is configured with two side walls 567 and 568, a rear wall 569, and a front guide wall 573 connected to the upper and lower walls and parallel to rear wall 569. Front guide wall 573 is laterally spaced from the front edge of side walls 567 and 568 to enable extension of the partition through the corresponding opening defined between guide wall 573 and side walls 567 and 568. The UUSL CS is provided with a front coupling panel 565, also covered with lamination 564, which may have suitable interface means to assist in extending and retracting the partition. The use of IFTG coupling panels instead of FTG coupling panels is necessary due to the presence of lamination 564 on the interior face of the coupling panels 572 and to the direction of rotation of the coupling panels with respect to rolls 561 and 562.

When partition 570 is extended, rolls 561 and 562 rotate in opposite rotational directions to allow the length of each UUSL CS from the corresponding hub to front coupling panel 565 to be increased. Retraction of the partition without slack is made possible by various possible means such as a spring loaded hub, a mechanical actuator kinematically connected to suitable transmission, and electromechanical driving means such as a motor and electric actuator.

To prevent bowing of the coupling panels 572 of the UUSL CS defining partition 570 when fully or partially extended, system 560 also comprises a plurality of interconnected and longitudinally expandable stiffening elements 566 that cooperate with the extended coupling panels. Each stiffening element 566 laterally extends from a coupling panel 572 at a first side of partition 570 to an opposing coupling panel at a second side of partition 570. The contact of each stiffening element 566 with the first and second sides of partition 570 helps to counteract side forces such as side forces F1 and F2 to which the extended partition is subjected and to thereby prevent formation of local deformations in walls WL1 and WL2 of the partition when subjected to side forces F1 and F2 respectively. By virtue of the presence of the bowing-preventing stiffening elements 566, the extended partition 570 has the illusive appealing appearance of a monolithic surface.

A compressible element such as accordion-type bellows or a group of vertically spaced cords is attached between each pair of adjacent stiffening elements 566. Also, a compressible element is attached from a rear stiffening element 566 to front coupling panel 565 and from a front stiffening element to guide wall 573, which may be rounded and positioned rearwardly from the front edges of side walls 567 and 568 to accommodate the provision of all of the stiffening elements. When partition 570 is initially extended, the first compressible element is extended to its maximum length to cause the first stiffening element 566 to be positioned in stiffening contact with walls WL1 and WL2 of the partition. Similarly when the partition is increasingly extended, the second compressible element is extended to its maximum length to cause the second stiffening element 566 to be positioned in stiffening contact with walls WL1 and WL2 of the partition. Each end of the stiffening elements 566 may be slidable along a corresponding longitudinally extending rail attached to the underside of the upper wall and/or to an upper side of the lower wall, or formed within an end profile portion of the coupling portions when configured as composite coupling panels, or may slide directly on the floor. These rails when used ensure that the stiffening elements will be able to be longitudinally displaced relative to the coupling panels and also positioned in stiffening contact with the two opposing sides of the partition.

It will be appreciated that any other suitable type of stiffening elements may be employed.

FIGS. 119A-D illustrate a top view of system 560 for use as a door which may be installed in an opening of a wall without the need of a slit within the wall, as conventionally practiced in the art of pullout doors. FIG. 119A is an upper view of wall 578, which is configured with two faces 575 and 576 that adjoin the opening. As shown in FIG. 119B, rear wall 569 of the enclosure of system 560 is attached to face 576 of the opening, and a thin elongated profile 577 which functions as a doorpost is attached to face 575 of the opening. As shown in FIGS. 119C and 119D, partition 570 has the illusive appearance of a monolithic thick door when pulled out. Optionally, a few simple adaptations may be made to install completely coplanar hinges or any other suitable hinges along the length of axis line AX (or with a suitable adaptation relative to axis line AX) as illustrated in FIGS. 119B-D in order to use system 560 as a pivoting door after partition 570 is extended and locked or in order to enable the rotation of system 560 to the sides when a wide object needs to be delivered through the opening. In order to use system 560 as a pivoting door, the shape of doorpost 575 and the shape of front face 579 of system 560 need to be modified in order to accommodate the closing and opening of the door. Many adaptations may be added and are also in the scope of the invention.

FIGS. 120A-C illustrate a top view of system 560 used as a partition. The enclosure of system 560 is shown in FIG. 120A when in a standby condition and attached to wall 580 by hinges such that side wall 568 (FIG. 118A) of the enclosure abuts face 581 of the wall. In order to use the partition, the enclosure is angularly displaced 90 degrees as shown in FIG. 120B, enclosure rear wall 569 is attached and anchored to wall 580, and then the partition is extended as shown in FIG. 120C.

FIGS. 121A-D illustrate a horizontal cross sectional view of system 560 when the enclosure is embedded within a wall 590. As shown in FIGS. 121A-B when the partition is retracted, the enclosure is located within a niche 592 in the wall and covered by a hidden or decorative door 591, which is attached to wall 590 by completely coplanar hinges or any other suitable hinges that are located along the length of axis line B. In order to use the partition, door 591 is pivotally opened, the enclosure is pulled out from niche 592, angularly displaced 90 degrees by hinges that are also pulled out with system 560 and are located along the length of axis AB, rear wall 569 (FIG. 118A) is attached and anchored to wall face 593 as shown in FIG. 121c, and then, as shown in FIG. 121D, partition 570 is extended. In order to ensure that face 593 of wall 590 will remain esthetically pleasing while using the partition, door 591 may be closed back to conceal niche 592 as shown in FIGS. 120C-D.

FIGS. 122A-B illustrate a top view of system 600 which is configured with a serial interconnection of three identical units U1, U2 and U3, each of which being a system 560, although any other number of units may be employed, in order to produce a longer partition when needed. As shown in the figures, the interconnection of each adjacent unit is achieved by connecting front coupling panel 565 (FIG. 118A) of one unit to a rear wall 569 of an adjacent unit. When units U1-U3 are unused, a corresponding side wall of each unit is positioned in abutting relation with wall 602, as shown in FIG. 122A. In order to use the partition, the interconnected units U1-U3 are angularly displaced by 90 degrees with hinges which are located along the length of axis AX, and rear wall 569 of unit U1 is attached and anchored to surface 601 of wall 602. Upon linearly displacing the front coupling panel of unit U1 such as by means of an electromechanical actuator, the extended partition of unit U1 applies a force onto the rear wall of unit U2 and causes unit U2 to be displaced along the same length as the extended partition of unit U1. Similarly, when the partition of unit U2 is extended, unit U3 is displaced forwardly by the same distance as the extended length of the partition of U1. Thus the composite partition defined by system 600 is able to be extended to a length which is equal to three times the length of the single partition of system 560 (FIG. 118B). System 600 is modular and may contain more or less units in order to achieve different lengths of the composite partition according to the requirements.

FIGS. 123A-C illustrate a top view of system 610 which is identical to system 600 with the exception of the different interconnecting arrangement of units U1, U2 and U3. As illustrated in FIG. 123A when unused, only side wall 568 of unit U1 is in abutting relation with face 601 of wall 602 and the other units are positioned in parallel adjacent relation to each other. As shown in FIG. 123B, adjacent units are hingedly connected to each other at an adjacent corner without being interconnected in any other way. In order to extend the partition, unit U3 is pulled and units U1, U2 and U3 are displaced and rearranged as illustrated FIG. 123C, such that a front coupling panel 565 (FIG. 118A) of one unit is urged to abut a rear wall 569 of an adjacent unit and the three units are set in a linearly extending arrangement. By linearly displacing the corresponding front coupling panels of system 610, the composite partition may be linearly extended to a length which is equal to three times the length of the single partition of system 560 (FIG. 118B). System 610 is modular and may contain more or less units in order to achieve different lengths of the composite partition according to the requirements.

FIGS. 124A-C illustrate a top view of system 600 which is able to be embedded within a niche 608 formed in wall 607 identically to the way described and illustrated above in relation to system 560 of FIGS. 121A-D.

FIGS. 125A-B illustrate system 620 which may function as a long pullout partition. As shown in FIG. 125A, system 620 comprises two vertical-axis rolls 621 and 622 rotatably mounted onto an upper and lower horizontal wall of a dedicated enclosure. On rolls 621 and 622 are wound, and between which extend, a single IFTG UUSL CS having lamination layer 623. The axis of the two rolls 621 and 622 are laterally separated so as to be substantially perpendicular to the longitudinal direction along which the partition is to be extended, in order to maximize the dimensions of the rolls and consequently the length of the partition. Partition 626 is shown to be retracted in FIG. 125A and partially extended in FIG. 125B.

The enclosure is configured with two side walls 627 and 628, a rear wall 629, a front wall 632 parallel to rear wall 629 that laterally extends for a sufficient length to conceal only roll 621, and a front guide wall (not shown) parallel to rear wall 629, which is similar in structure and function to guide wall 573 of FIG. 118A. The UUSL CS is provided with a front coupling panel 624, also covered with lamination 623, which laterally extends between the end web portion associated with each of the rolls 621, similar to front coupling panel 565 of FIG. 118A, and which may have suitable interface means to assist in extending and retracting partition 626.

System 620 also comprises a plurality of interconnected and longitudinally expandable stiffening elements 625 that cooperate with the extended coupling panels of UUSL CS as described above in relation to FIG. 118B.

It will be appreciated that any other suitable type of stiffening elements may also be employed.

FIGS. 126A-B illustrate system 620 when partition 626 is embedded and concealed within a niche formed in wall 607 during unuse of the system in FIG. 126A, and when partition 626 is partially extended from wall 607 in FIG. 126B.

FIGS. 127A-B illustrate a horizontal cross sectional view of system 640, which may function as a long and thin partition 645 that can be embedded within a thin wall 644. As shown in FIG. 127A when unused, two elliptical rolls 641 and 642 of corresponding FTG UUSL CS provided with a lamination layer 647 are wound about a pair of rollers RR1 and RR2 that are spaced by a distance L between their centers. The distance L is selected to enable a long retracted partition to be wound about a pair of rollers RR1 and RR2 when being rolled and to be stored inconspicuously within wall 644 regardless of whether the wall is thick or thin.

A securing element 643, which is also covered with lamination layer 647 to provide the illusive appealing appearance of a monolithic plate, interconnects the two connecting systems in order to be displaced in unison. When it is desired to extend partition 645, securing element 643 is pulled out from the cavity in wall 644 to a desired distance, as illustrated in FIG. 127B, generally in conjunction with motorized apparatus. The tensile force applied on securing element 643 is transmitted to the two connecting systems and causes the coupling panels to be displaced about the corresponding rollers RR1 and RR2, until the number of coupling panel layers wound about the rollers is increasingly reduced, such as from three layers in FIG. 127A to two layers in FIG. 127B. When partition 645 is very long, the partition may be stabilized to avoid deformations by extending through rails or by being provided with external supports, preferably releasable supports that hold the partition by pressure against the floor and the ceiling in accordance with its large length to thickness ratio. Optionally, partition 645 may be configured with pins 499 and grooves 498 similarly to the support surface illustrated in FIG. 110 to maintain partition stiffness similar to a monolithic plate.

FIGS. 128A-B illustrate a sliding-door cabinet 650 having two identical doors 651 and 652, each made of an IFTG UUSL CS, which may open completely and have the stiffness and the illusive appealing appearance of a monolithic door.

As shown in FIG. 128A, cabinet 650 is configured with a rear wall 655, a left side L-shaped outer wall member 649 having a first portion extending from corner A at the cabinet front to corner B at the cabinet rear and a second portion extending from corner B to rear wall 655 and collinear therewith, and a right side L-shaped outer wall member 657 having a first portion extending from corner D at the cabinet front to corner C at the cabinet rear and a second portion extending from cornet TS3 to rear wall 655 and collinear therewith. A left side L-shaped inner wall member 656 is positioned adjacent to left side L-shaped outer wall member 649, such that an interspace 653 is defined therebetweeen and the first portion of member 649 is substantially parallel to the first portion of member 656 and the second portion of member 649 is substantially parallel to the second portion of member 656. A right side L-shaped inner wall member 658 is positioned adjacent to right side L-shaped outer wall member 657, such that an interspace 654 is defined therebetweeen and the first portion of member 658 is substantially parallel to the first portion of member 657 and the second portion of member 658 is substantially parallel to the second portion of member 657. The second portion of inner members 656 and 658 may be formed with abutments 666 and 667, respectively.

Doors 651 and 652, when the cabinet is closed, are substantially parallel to rear wall 655 and terminal accessible ends 661 and 662 thereof, respectively, are in contact with each other at the middle of the cabinet opening. The length of the doors is sufficiently long to allow a short portion thereof to be received within the corresponding interspace. The IFTG coupling panels 663 of doors 651 and 652 are slidable in a lower rail 659 and an upper rail (not shown) fixed to a front cabinet member, and the upper and lower rails may be partially curved. To facilitate speedy angular displacement of doors 651 and 652 when opened and closed, each corner of interfaces 653 and 654 is configured with one of the curved region TS1-TS4 to enable the insertion of doors 651 and 652 within their corresponding interfaces.

As shown in FIG. 128B, doors 651 and 652 are received within interspaces 653 and 654, respectively, when the cabinet is opened. When the cabinet is opened, the doors as well as the inner and outer cabinet members are configured to allow terminal accessible door ends 661 and 662 to protrude from the corresponding interspace even when the inaccessible door ends are in contact with the corresponding abutment. In order to close the cabinet, doors 651 and 652 are pulled out partially or completely from the corresponding interspace by manipulating terminal accessible door ends 661 and 662, respectively.

By virtue of the interconnection between the IFTG coupling panels, horizontal loads F3 and F4 shown in FIG. 128A, which act on the doors from the outside the cabinet, will be dispersed in all directions similar to a monolithic plate, providing the strength of a monolithic door. In order to achieve stable doors which are resistant to bending deflections, additional means such as springs (not shown) may be added to the IFTG coupling panels 663 in order to stabilize and lock the coupling panels when doors 651 and 652 are pulled out from the corresponding interspace. When the IFTG coupling panels are covered with a lamination layer 664, the illusive appealing appearance of a monolithic stiff door is provided. Although not shown, additional embodiments relying on the same principles described hereinabove are envisioned whereby for example only one cabinet door, doors having different dimensions, or even cabinets with more than two doors, are also in the scope of this invention. Cabinets such kitchen cabinets having sliding doors which can be opened and closed laterally, vertically, or in any other desirable direction, having the same structure as cabinet 650 except for the location and the orientation of the doors are also applicable and are also in the scope of the invention.

FIGS. 129A-B illustrate durable cabinet 670 with two pullout shelves 680a and 680b that enable easy reconfiguration of the inner space of the cabinets and optionally lower shelf 680c which, when retracted, enables to clean the surface below the cabinet through the opening 685 underlying the shelf. Cabinet 670 is configured with a plurality of side walls or vertical partitions each having a front face 671, a bottom wall 672, a top wall 673, a rear wall 674, lower opening 685, and coplanar inner plates 677-679 that define thin corresponding interspaces 675a-c, respectively, between rear wall 674 and an inner plate. If so desired, one or more of inner plates 677-679 may be dispensed with. An inner space of the cabinet is defined by two coplanar and laterally spaced horizontally oriented narrow rails 684a, 684b and 684c, each mounted on a corresponding side wall or vertical partition and extending rearwardly from a front face 671 to the bottom of a corresponding inner plate. Shelves 684a, 684b and 684c each comprising a FTG UUSL CS of interconnected coupling panels 689 which are provided with lamination layers 682a, 682b and 682c, respectively, are effected as shown in FIG. 129A after having been independently pulled through the corresponding interspace and slid along the corresponding pair of rails. When shelves 682a and 682b are unused in order to increase the volume of a desired inner space, they are able to be retracted into the corresponding interspaces as shown in FIG. 129B. To enable the insertion of shelves 680a, 680b and 680c into their corresponding interfaces when retracted, rear wall 674 may be configured with interspace-facing curved regions SC1, SC2 and SC3, respectively, adjacent to the rear terminal end of the corresponding rail. Likewise, the bottom of the corresponding inner plate may be configured with a complementary curved region to enable smooth movement of coupling panels 689 while shelves 680a, 680b and 680c are being extended or retracted.

It will be appreciated that the inner space of cabinet 670 may be additionally reconfigurable when a vertical partition is made of a FTG UUSL CS. The vertical partition may be retracted into a horizontal interspace defined between bottom wall 672 and an inner plate added on top of bottom wall 672, in similar fashion as the retraction of a shelf into a vertical interspace as described above. Parallel interfaces according to the use may be needed.

By virtue of the ability of the FTG UUSL CS to disperse vertical loads in all directions, shelves 680a, 680b and 680c are characterized by a high load bearing capacity and by small deformations, similar to regular monolithic shelves. The application of laminations 682a, 682b and 682c also advantageously provides the illusive appealing appearance of conventional monolithic shelves.

In other embodiments, portions of cabinet 670 are able to be modified with various openings such as with a screen, wire mesh or other type of openwork construction in order to facilitate a cleaning operation. When bottom wall 672 is configured with such openwork construction, a cleaning implement is able to pass through, or be in communication with, an opening in order to clean underneath the bottom wall. When an inner plate is added on top of the bottom wall, the inner plate is also configured with the openwork construction to accommodate the manipulation of the cleaning implement. The openings formed in bottom wall 672 are able to be covered by a connecting system based shelf 680c that is slidable along interspace 675a provided between inner plate 677 and rear wall 674 and along a pair of rails 684c in contact with the bottom wall. Also, inner plates 677-679 may be configured with openwork construction in order to ensure the cleanliness of interspaces 675a-c, respectively.

Cabinet 670 has an uncomplicated configuration, and by virtue of its simplicity, any existing cabinet may be easily upgraded with the inner plates and rails to provide a pullout capability. The inventive concept described hereinabove may also be implemented with suitable adaptations with respect to various permanent or temporary storage devices such as refrigerators, ovens, and dishwashers, and may enable to create a durable storage device with diverse automated programs suitable for use in smart houses.

In the embodiment shown in FIG. 130, a foldable ventilated wire shelf 685, or other foldable non-continuous shelves, can be used to slide along the interspaces and rails of cabinet 670. Each side of shelf 685 is configured with two UUSL connecting systems 686 and 687 at its two sides, respectively. A bar 688 extends from each coupling panel of side 686 to a corresponding coupling panel of side 687.

FIGS. 129C-129H illustrate a rollable or foldable multifunctional support system MFS for use as a component of a sleeping bag or tent. System MFS is any reconfigurable web whether or not disclosed herein, having diverse leveled configurations for which it can function as a unidirectionally stiff surface, a chair, a table, or an adjustable bed or hammock according to the desire of the user.

Multifunctional support system MFS may be embedded within at least one pocket of a sleeping bag or a tent while maintaining the ability of the sleeping bag or the tent to be rolled and unrolled or folded and unfolded.

Multifunctional support system MFS can be partially or completely located within or placed exteriorly to the sleeping bag or the tent.

Multifunctional support system MFS may be a web constructed of any suitable number of coupling panels arranged such that each pair of interconnected adjacent coupling panels may undergo relative angular displacement in a predefined range which enables the multifunctional support system to be rolled and unrolled or folded and unfolded. During deployment, a restriction of movement between adjacent coupling panels causes the multifunctional support system to become leveled in a predefined configuration.

Multifunctional support system MFS may include additional components such as rods or plates configured such that adjacent components may have a restrictive relative angular displacement which enables the multifunctional system to be rolled and unrolled or folded and unfolded. During deployment, the restriction of movement between adjacent components of the multifunctional system enables the leveling of the multifunctional system in a predefined configuration.

Multifunctional system MFS may include one or more pairs of adjacent components which are interconnected with adjustable hinges, and which facilitate a change in the range of their relative angular displacement in order to achieve diverse configurations for which the multifunctional system is leveled when deployed. It is also applicable that each pair of adjacent components of multifunctional system MFS will be interconnected with adjustable hinges, which enable to change the range of their relative angular displacement.

By adjusting at least one particular adjustable hinge, multifunctional support system MFS can achieve diverse leveling configurations such as a stiff plane, chair, table, adjustable bed and hammock. The adjustment of the adjustable hinges may be performed manually or by electromechanical means.

The interlocking of an adjustable hinge of the multifunctional system which enables a particular leveling configuration of the multifunctional system may be performed manually or electromechanically, for example by inserting pins into corresponding holes of the interconnected components of the adjustable hinge or by any other suitable mechanism.

Multifunctional support system MFS may function as a separate device or as a component of any suitable system, or alternatively as a versatile system such as for domestic use or for versatile sea or pool equipment. During use of multifunctional support system MFS as sea or pool equipment, one portion of the multifunctional system, preferably a half portion, may be folded on top of the other portion and the free edges of the two portions may be connected together in order to create a bi-directionally stiff surface that enables the user to float or surf in the water, when permitted by the weight and geometry of the multifunctional support system.

Multifunctional support system MFS may be a rollable or foldable frame to which a flexible sheet that is sufficiently strong to support the weight of an adult human weight is attached.

Multifunctional support system MFS may include extendable components such as adjustable telescopic legs or foldable legs and rods in order to implement its diverse functionality. A multifunctional support system component may be a rollable web or a stiff panel.

Multifunctional support system MFS may be covered by an envelope. As shown in FIG. 129D, the multifunctional system MFS may be completely embedded within an envelope CV, rendered transparent, as shown in FIG. 129D(c).

Multifunctional support system MFS may include a wired or remote electromechanical control system that enables the leveling of system MFS in diverse configurations. Various electromechanical systems or accessories, which may be removable, may be stored within the multifunctional system elements, and may include equipment for locking the multifunctional system in one of many configurations.

Multifunctional support system MFS may be connected to a sleeping bag or a tent in at least one point by one or more releasable or unreleasable connecting means such as straps, wires and mechanical connectors. Alternatively, multifunctional system MFS may be rolled and unrolled or folded and unfolded with a sleeping bag or tent without being connected to the sleeping bag or the tent.

Multifunctional support system MFS may comprise means for storing, absorbing or extracting electric energy such as charged batteries, solar cells and wires. Input or output ports such as USB ports or any other available ports may be provided in order to charge and operate electric devices or in order to store electric energy from an external device.

Multifunctional support system MFS may include or be comprised from a material that can absorb, store or emit heat.

Various types of multifunctional support systems MFS, which are made of at least one type of interconnected component, are also applicable and are within the scope of the invention.

### Multifunctional Sleeping Bag

FIGS. 129C(a)-(d) illustrate a sleeping bag SLB having a pocket SL1 in which a multifunctional support system MFS is inserted in order to create a multifunctional sleeping bag system MSLB. Sleeping bag system MSLB can be rolled or folded according to the ability of multifunctional support system MFS to be rolled or folded. Multifunctional support system MFS may create a stiff or flexible layer that separates the user from the underneath surface on which the sleeping bag is deployed. As shown in FIGS. 129D(a)-(c), multifunctional support system MFS may cooperate with an envelope CV in which it is able to be embedded to produce an enclosed multifunctional support system EMC, as transparently illustrated in FIG. 129D(c).

It will be appreciated that a dedicated mattress may be inserted within the pocket SL1 of sleeping bag SLB shown in FIG. 129C(a) in lieu of the multifunctional support system.

FIGS. 129E-129F illustrate the upper and lower faces of multifunctional support system MFS, respectively. Multifunctional support system MFS is a rollable web that comprises a plurality of interconnected coupling panels MS5 and a free end coupling panel MS6 interconnected to a coupling panel MS5 at a free end of the web. The angular displacement of one coupling panel to another is made possible by a hinge MS3 or MS9.

A coupling panel MS5 shown in FIGS. 129I(a)-(b) has a non-continuous web face, for example being configured with a rounded rectangular cross section. A plurality of spaced and aligned uninterrupted tubular knuckles MS15, each configured with a central receiving through hole MS14, is tangentially connected to a first side of coupling panel MS5. A protruding part MS13, e.g. of triangular cross section, is interspersed throughout the first side such that a knuckle MS15 is interposed between two protruding parts MS13. Tangentially connected to a second side of coupling panel MS5 are a plurality of spaced and aligned tubular knuckles each configured with a central recessed or removed portion MS4. A pin MS16 shown in FIG. 129K(a) is inserted through the knuckles when interrupted knuckles of a first coupling panel MS5 are set in aligned relation with uninterrupted knuckles MS15 of a second coupling panel to facilitate angular displacement. A hinge MS9 imparts two adjacent coupling panels MS5 with unidirectionally stiff characteristics. Protruding part MS13 is adapted to be received within recessed or removed portion MS4 in such a way to restrict angular displacement when the web is leveled and rotated in a first rotational direction and to be separated from the recessed or removed portion when the web is rotated in the second rotational direction to enable unrestricted angular displacement.

Alternatively, a coupling panel MST10 shown in FIGS. 129J(a)-(b) may be used to restrict angular displacement. Coupling panel MST10 is identical to coupling panel MS5 including the interrupted and uninterrupted knuckles and the protruding parts, but is configured with two integral thickened lateral extensions MST11 and MST12 at one web face defining for example a trapezoidal cross section that provides increased circumferential attachment of each knuckle to the coupling panel. The components of thickened coupling panel MST10 are identified by an additional identifier for purposes of clarity, such as knuckle MST15 in comparison to knuckle MS15 of coupling panel MS5.

Unrestricted angular displacement is made possible when hinge MS3, also shown in FIG. 129L(b), is assembled from uninterrupted knuckles MS15 protruding from first and second coupling panels MS5 or MS10.

After two of more web sections are angularly displaced by hinges MS3 to define a desired angle, such as shown in FIGS. 129G(c)-(h), the angularly displaced web sections may be fixed in position by using coupling panels MST20 and MST21 shown in FIGS. 129L(a)-(b). Coupling panel MST20 is configured similarly as coupling panel MS10 of FIG. 129J(a) but without the protruding parts. In addition, coupling panel MST20 is configured with a longitudinally extending wall at one side that defines a U-shaped slot MST22. Coupling panel MST21, which is narrower than coupling panel MST20, is configured with a U-shaped slot MST23 and with a main web face that is wider than the width of U-shaped slot MST23. A limited portion of U-shaped slot MST23 is adapted to be inserted within, and to be angularly displaced relative to, U-shaped slot MST22 of coupling panel MST20 to define a common locking chamber. When a restrictor MS2 is inserted in the locking chamber so as to be in restricting communication with U-shaped slots 22 and MST23, such as at the longitudinal ends of the hinge, angular displacement of coupling panels MST20 and MST21 is restricted or altogether prevented. Restrictor MS2 has a dedicated shape that corresponds to the shape of the locking chamber that is defined when two adjacent web sections are angularly separated by a specific angle. Restrictor MS2 may be removed from the locking chamber and positioned in a non-restricting holder MS1 (FIG. 129F) when it is desired that the hinge MS3 be angularly displaced freely.

Free end coupling panels MST6 are shown in FIGS. 129K(a)-(b) to be configured with interrupted knuckles to provide restricted angular displacement with an adjacent coupling panel MST10, only one being illustrated, and with two telescopic long foldable legs TLNL. Alternatively, short foldable legs TSHL may be operatively connected to a free end coupling panel MST6 as shown in FIG. 129F. Foldable legs SHL may be operatively connected to the underside of an intermediate hinged coupling panel MST20, for use in raising the bottom face of system MFS and also of sleeping bag system MSLB above the underneath surface on which multifunctional support system MFS or sleeping bag system MSLB is deployed. Accordingly, multifunctional support system MFS or sleeping bag system MSLB is able to be leveled when the underneath surface on which they are deployed is rugged or inclined. A short leg, for example having a length of 2 cm, may be permanently attached to the lower face of one or more intermediate hinged coupling panel MST20 so that the latter will be ensured of being spaced from underlying rugged terrain.

A bottom face of one or both of multifunctional support system MFS and sleeping bag SLB may be provided with padding material to absorb jagged edges of the underlying terrain. The padding material that is provided is of the type that is able to be rolled or folded together with multifunctional support system MFS or sleeping bag SLB. Additionally or alternatively, an upper face of one or both of multifunctional support system MFS and sleeping bag SLB may be provided with such padding material. The padding material may be individually affixed to each coupling panel, for example a rounded padding element PD1 shown in FIG. 129M(a) of a flattened padding element PD2 shown in FIG. 129M(b). When the web is leveled, the presence of a padding element on each coupling panel MST10 provides continuous padding PD1 or PD2 on the corresponding face of the web. Alternatively, a single padding member may be affixed to the entire MFS by virtue of the closeness of adjacent coupling panels provided by each thickened coupling panel MST10, for example padding member PD3 shown in FIG. 129N that is fabricated from a plurality of padding elements PD1 or padding member PD4 shown in FIG. 129O that is fabricated from a plurality of padding elements PD2.

To assist side-sleepers and those who shift positions while sleeping to remain snuggled within sleeping bag system MSLB despite the leveling function of multifunctional support system MFS, multifunctional support system MFS may be loosely connected such as at an intermediate region to sleeping bag SLB. Thus multifunctional support system MFS will provide rigidity while permitting the sleeper to shift positions together with sleeping bag SLB. Also, multifunctional support system MFS may comprise a plurality of multidirectional coupling panels such as multi-directional coupling panels 4DCN shown in FIG. 38E or alternatively may be constructed of an unsegmented web, to facilitate a change in position. If so desired, a sleeping bag may be configured with a plurality of pockets. A smaller sized MFS may be inserted in at least one of these pockets. In one embodiment, the smaller sized MFS may be a narrow strip. A plurality of strips, for example of equal length may be loosely connected one to another.

An elongated bar LCK comprising a plurality of stabilizing and rotatable bars MS37 that are axially interjoined along axis of rotation MS38 is insertable within aligned holes passing through all coupling panels MST10 of multifunctional support system MFS in order to be stabilized, as illustrated in 129P-R. When each axis MS38 of a bar MS37 coincides with the axis of a coupling panel through which it passes, multifunctional support system MFS is not inhibited by the bar. However, when each axis MS38 of a bar MS37 does not coincide with the axis of a coupling panel through which it passes, angular displacement of a coupling panel is prevented by the presence of a bar that extends between two adjacent coupling panels and the MFS becomes locked, i.e. the web is unable to be angularly displaced.

FIG. 129R(a) illustrates MFS while elongated bar LCK passes through its entire length. In this drawing, each axis MS38 of a bar MS37 is aligned with a corresponding axis of a coupling panel, the bar length being selected to correspond to the dimensions of a coupling panel through which it passes.

When elongated bar LCK is slightly shifted such that an end of each bar is misaligned with the axis of a corresponding coupling panel, angular displacement of a coupling panel is prevented by the presence of a bar that extends between two adjacent coupling panels and MFS becomes locked. By displacing the opposie side of elongated bar LCK as shown in FIG. 129R(b), the process is reversed and the axes MS38 of a bar MS37 become once again aligned with those of the corresponding coupling panels and multifunctional support system is able to be angularly displaced.

It will be appreciated that interjoined stabilizing bars may be used in conjunction with many other webs described herein when the coupling panels have been suitably modified.

Multifunctional support system MFS may include another adjustable device instead of hinge MS3 which enables to achieve diverse leveled configurations of multifunctional support system MFS and of sleeping bag system MSLB.

Multifunctional support system MFS may include another adjustable device instead of hinge MS3 which enables to achieve a sealed multifunctional support system when using an envelope CV.

FIGS. 129G(a)-(l) transparently illustrates some usable leveled configurations of enclosed multifunctional system EMC or alternatively of sleeping bag system MSLB.

As shown in FIG. 129G(a), system EMC or MSLB may function as a stiff or rigid surface which separates the user from the underneath ground on which the system is deployed. FIGS. 129G(b)-(f) illustrate the ability of system EMC or MSLB to function as an adjustable bed. FIG. 129G(g) illustrates the ability of system EMC or MSLB to function as a chair. FIGS. 129G(h)-(j) illustrate the ability of system EMC or MSLB to function as a table. FIGS. 129G(k)-(l) illustrate the ability of system EMC or MSLB to function as a hammock.

Multifunctional support system MFS or its components may be removed from the sleeping bag or inserted into the sleeping bag, being completely or partially located within the sleeping bag, such as being entirely or partially concealed within the sleeping bag.

A multifunctional support system MFS is suitable to be set to one or more leveled configurations. Multifunctional support system MFS may be divided to several multifunctional support systems. Multifunctional support system MFS may have a wired or remotely controlled electromechanical device to facilitate one of many various leveled configurations or alternatively a plurality of identical leveled configurations of sleeping bag system MSLB.

Multifunctional support system MFS may be separated from the sleeping bag or connected to the sleeping bag at a discrete number of points.

The following features are also applicable:
A sleeping bag fabricated without multifunctional support system MFS and having at least one pocket within which a multifunctional support system is insertable.
A sleeping bag fabricated without a multifunctional support system MFS having connecting means by which a multifunctional support system is connectable to the sleeping bag.
A sleeping bag having other types of multifunctional support systems which are made of at least one interconnected component.

FIGS. 129H(a)-(f) illustrate a multifunctional support system MFSF that is configured as a frame. Multifunctional support system MFSF is identical to multifunctional support system MFS, with the exception that coupling panels MS5 of multifunctional support system MFS (FIG. 129F) are replaced by shorter border coupling panels MS7 and by connecting means between hinges MS3 and free side coupling panels MS6 of multifunctional support system MFSF in order to create a frame. System MFSF can be embedded within envelope CVF as transparently illustrated in FIG. 129H(c). A flexible and sufficiently strong sheet SH capable of supporting the weight of a human may be strongly attached directly to the upper face of system MFSF or to the upper face of system EMCF to produce a strengthened system CVS as shown in top view in FIG. 129H(e) and in bottom view in FIG. 129H(f). Multifunctional support system MFSF has the same leveled configurations as multifunctional support system MFS and can function, be connected, embedded and used identically as multifunctional support system MFS.

The reconfigurable web of a multifunctional support system may be a strengthened or weakened web, or any other unidirectionally stiff web which facilitates proper functionality of the multifunctional support system. Multifunctional support systems having one or more leveled configurations are also suitable.

### Multifunctional Tent

A tent is configured with a floor having at least one pocket in which a multifunctional system such as multifunctional system MFS or a component of the multifunctional system is inserted in order to separate the user from the underneath surface on which the tent is placed. Thus a stiff, flexible or foldable dividing layer is provided between the user and the underneath surface. The multifunctional system may also provide the entire or partial structure of the tent. The multifunctional system may be comprised of at least one unidirectionally configurable web.

A multifunctional system component may be rolled and unrolled or folded and unfolded together with the tent.

The multifunctional system may include extendable legs such as telescopic legs for raising the tent floor or the entire tent above the underneath surface on which the tent is placed, so that the tent floor will be leveled when the underneath surface on which the tent is placed is rugged or inclined.

The multifunctional system used for the tent floor may be set to diverse leveled configurations such as those illustrated in FIG. 129G. The multifunctional system may comprise a wired or remotely controlled electromechanical system to achieve the different configurations of the tent or of the tent floor.

The multifunctional system or its components may be removed from or added to the tent.

The multifunctional system may be separated from or connected to the tent at a discrete number of points.

A tent having at least one pocket is envisioned that lacks the multifunctional system, but which enables insertion therein of the multifunctional system or other connecting means adapted to connect the multifunctional system to the tent.

FIGS. 129H(a)-(f) illustrate a multifunctional system for use as a frame.

### Rollable Beds and Tables

In the implementation of FIGS. 130A-1-130X, various embodiments of reconfigurable and rollable beds are illustrated.

FIGS. 130A-1-130B illustrate reconfigurable bed system RBD in two configurations, as a roll RL and as a bed BD set in a deployed position to provide a flat mattress RB3. As shown in FIGS. 130A-1-130D, system RBD includes a UUSL CS RB2 which functions as a reconfigurable stiff and leveled bed base BDS, and a mattress RB3. UUSL CS RB2 comprises FTG coupling panels RB7, thin elastic layer RB8, two end support elements RB5 and RB6, and central support element RB2. System RBD comprises 6 legs RB10, which are each pivotally coupled to one of end support elements RB5 and RB6 and central support element RB9 by being rolled or folded.

FIGS. 130E-130H illustrate bed base BDS and its components. As shown in FIG. 130F, end support element RB5 comprises stationary element RB14 and freely rotatable element RB15 which are interconnected by hinge RB20. Opposite end support element RB6 illustrated in FIG. 130H comprises stationary element RB16 and freely rotatable element RB17 which are interconnected by hinge RB21. Central support element RB9 illustrated in FIG. 130G comprises stationary element RB11 and two rotatable elements RB12 and RB13 which are interconnected to stationary element RB11 by hinges RB22 and RB23, respectively. Each one of the rotatable elements is interjoined to its adjacent coupling panel by a regular FTG connection as explained above in relation to the structure and function of an UUSL CS. Thin elastic layer RB8 which functions as a common sheet of the UUSL CS and as an esthetic protective layer is seen clearly in FIGS. 130F-130H.

FIGS. 1301-130P-1 illustrate the bottom of system RBD when unrolled. The completely unrolled common sheet RB8 of UUSL CS RB2 is shown in FIGS. 1301 and 130M. End support elements RB5 and RB6 including their sub-components are shown in FIGS. 130J and 130K, respectively. Central support element RB9 and its sub-components RB11, RB12 and RB13 are shown in FIG. 130L. The free angular displacement of rotatable elements RB15 and RB17 within stationary elements RB14 and RB16, respectively, and the free angular displacement of rotatable elements RB12 and RB13 with respect to stationary element RB11 is necessary in order to prevent moment development in end support elements RB5 and RB6 and in central support element RB9, and in order to prevent development of a moment which tends to make the upper face of the UUSL CS RB2 tense when system RBD is leveled.

With reference to FIGS. 130J-130P, each leg RB10 pivotally coupled to an end support element RB5 or RB6 and to a central support element RB9 is storable, when folded, in a corresponding recess RB25 shown in FIG. 130V. A spring loaded button RB4 shown in FIGS. 130J and 130L and more clearly in FIGS. 130N-1300 and 130U needs to be pressed in order to cause the corresponding leg RB10 to be pivoted to a deployed position. The deployed legs RB10 need to be manually pivoted in order to be returned to a stored condition within the corresponding recess RB25.

FIGS. 130Q-130S Illustrate system RBD in a leveled condition after legs RB10 are outwardly pivoted. FIG. 130U illustrates legs RB10 in a retracted condition. FIGS. 130V-X illustrate three different pivoting facilitating configurations, respectively, for each leg.

In order to reduce the storage area when base element BDS and mattress RB3 are not permanently connected, base BDS may be stored separately as a much thinner roll, or to be folded and stored similarly to a blanket. An air mattress or a mat may be optionally used instead of a regular mattress in order to significantly reduce the storage area when system RBD is unused.

The sides and faces of system RBD may be optionally covered with elastic materials in order to enhance its safe use and its appealing appearance.

In other embodiments, IFTG coupling panels may be employed instead of FTG coupling panels in order to adhere mattress RB3 or a mat to the entire upper surface of bed base BDS. Alternatively, other types of coupling panels RB9, including composite coupling panels and completely safe coupling panels, may be employed.

FIGS. 133F-1331 illustrate systems RTB and RCH, which are a rollable table and a rollable stool, respectively. Both embodiments preferably comprise system CCSU (FIG. 38Z) to comply with safety requirements.

FIGS. 133F(b) and 133G(b) illustrate an undeployed circular plate CRP for use as an upper plate PRTB shown in FIG. 133H(d) and upper plate PRCH shown in FIG. 133I(d) of deployed table RTB and stool RCH, respectively. Plate PRTB and plate PRCH are identical except for their different dimensions. FIG. 133F(a)-(b) illustrates plate CRP when set to rolled and undeployed unrolled configuration, respectively. FIGS. 133G(a)-(b) illustrate plate CRP when set to rolled and undeployed unrolled configurations, respectively, when additionally provided with a protective envelope ENV1. As shown in FIGS. 133H-1331, table RTB and stool RCH have the same structure except for their different dimensions.

FIGS. 133H(a)-(d) illustrate the assembly of rollable table RTB by inserting each leg LRTB into one of the corresponding four apertures AP1 that are formed in the underside of plate PRTB. The insertion of legs LRTB into apertures AP1 can be done by screwing or pushing each leg into its aperture. The insertion and removal of legs LRTB into and out of their corresponding apertures AP1 may be carried out by a suitable mechanism which establishes a strong connection between legs LRTB and plate PRTB. FIG. 133H(d) illustrates assembled table PRTB while being supporting by its legs. Similarly, FIGS. 133I(a)-(d) illustrate the assembly of rollable stool RCH by inserting each leg LRCH into one of the corresponding four apertures AP2 that are formed in the underside of plate PRCH. The insertion of legs LRCH into apertures AP2 can be done by screwing or pushing each leg into its aperture. The insertion and removal of legs LRCH into and out of their corresponding apertures AP2 may be carried out by a suitable mechanism which establishes a strong connection between legs LRCH and plate PRCH. FIG. 133I(d) illustrates assembled stool RCH while being supported by its legs. In both embodiments when not used, the legs and the rolled or folded upper plates can be stored separately. The configuration of plates PRTB and PRCH can be designed in other geometric forms and with other web types.

FIGS. 133J(a)-(c) illustrate system SSWP1, which is a pool made of elastic configurable side walls which are reinforced with a UUSL CS in order to achieve stable and stiff side walls. FIG. 133J(a) illustrate a pool SPL made of elastic configurable material, which may be inflatable. In order to preserve the square formation of pool SPL when loaded with water or any other liquid, the pool is strengthened with a surrounding UUSL band STB1 shown in FIG. 133J(b) in order to produce system SSWP1 shown in FIG. 133J(c). The UUSL band STB1 also prevents the deformation of the sidewalls of pool SPL when subjected to hydraulic pressure. When exposed to hydraulic pressure, the sidewalls of the pool are subjected to bending forces and also to high axial forces. Accordingly, a UUSL CS having a high axial stress bearing capacity needs to be used as an implementation of band STB1. When system SSWP1 is unused, band STB1 can be folded or rolled in order to achieve high portability and to reduce the storage space.

FIGS. 133K(a)-(c) illustrate an identical system SSWP2, with the exception of the geometric circular shape of the pool. The circular shape of the pool produce mainly axial forces and accordingly a UUSL CS with high axial force bearing capacity needs to be used. From safety and durability considerations, it is recommended to use a system CCSU (FIG. 38Z) for band STB2.

FIGS. 133L(a)-(d) illustrate systems PMM1 and PMM2, which comprise a Plate for Mixing Materials.

System PMM1 is illustrated in unrolled and rolled configurations in FIGS. 133L(a) and 133L(b), respectively, and comprises a plate CCP1 which is a completely concealed and sealed UUSL CS, such as system CSU (FIG. 38X), adapted to prevent the penetration of mixed materials into the UUSL CS and the resulting damage. The use of system PMM1 provides a stiff surface for mixing materials which can be easily folded or rolled when unused. The face of plate CCP1 on which the material is mixed is preferably the face of system PMM1 which is parallel to its main face so that a stiff face can be used for the mixing operation. The interconnection between the UUSL CS coupling panels may include CJ joints. An envelope ENVL may comprise a durable elastic material in order to absorb any knocks that result from the mixing process while maintaining the intactness of system PMM1. The materials from which envelope ENVL is produced are dependent on the use and may be planned to repel the dried mixing material. The face of plate CCP1 on which the material is mixed may optionally be covered with an additional layer that protects the envelope from local knocks and repels the dried mixing material. The size of system PMM1 may range from the size of a few square centimeters for mixing materials such as epoxy glues and oil paints up to a few square meters for mixing cementitious materials.

As illustrated in FIGS. 133L(c) and 133L(d), additional systems CSU other types of UUSL CS functioning as pivotal sidewalls SW1 and SW2 are individually interconnectable with a corresponding border of plate CCP1 in order to produce system PMM2. FIG. 133L(c) illustrates system PMM2 when assembled and the individual connecting systems are interconnected. FIG. 133L(d) illustrates system PMM2 when disassembled and the individual connecting systems are rolled. The interconnection of sidewalls SW1 and SW2 to plate CCP1 preferably needs to be sealed in order to avoid outward leakage of materials from system PMM2 during the mixing operation.

Both systems PMM1 and PMM2 may be produced in other shapes such as circular or ellipsoid shapes and from other types of UUSL CS. The interconnection of sidewalls SW1 and SW2 to main plate CCP1 may be as described hereinbelow with respect to system CNT1.

FIG. 133M illustrates system CNT1, which is adapted to provide a rollable container CNR, shown in FIG. 133M(f) when assembled, that comprises main plate BP1 and two identical lateral plates SW3 and SW4 interconnected to main plate BP1 along the length of opposed axis lines EX1 and EX2 constituting a main plate border, respectively. Main plate BP1 is also interconnected to transversal plates SW5 and SW6. Plates BP1 and SW3-SW6 are preferably comprised of a system CCSU (FIG. 38Z).

System CNT1 is shown in three stages of assembly or disassembly in FIGS. 133M(a)-(c) without being covered by envelope ENV1 and while covered with envelope ENV1 in FIGS. 133(d)-(f), respectively. Two orthogonal sidewalls, such as SW4 and SW6, are releasably interconnected by suitable means well known to those skilled in the art, such as by a plurality of pins protruding from one edge of a first sidewall and complementary apertures formed in an adjacent edge of a second sidewall which are suitably configured to facilitate detachment of the pins with an integral appendage or by an external implement.

In order to roll container CNR from the assembled condition shown in FIGS. 133M(c) and 133M(f), sidewalls SW5 and SW6 are firstly flattened to the configuration shown in FIGS. 133M(b) and 133M(e). Secondly, sidewalls SW3 and SW4 are laterally flattened, and thirdly system CNT1 which is illustrated without envelope ENV1 in FIGS. 133N(a)-(c) is rolled to a roll RLC. The process is reversed in order to re-assemble container CNR. Although not shown in the figures, system CNT1 can be folded and then rolled in order to produce a shorter roll.

FIGS. 133O and 133P illustrate means for interconnecting a sidewall to a base plate to facilitate pivotal displacement of a sidewall and therefore assembly of a container.

A typical elongated strap that is representative of system CNT1 (FIG. 133M) is illustrated. The strap includes an intermediate composite coupling panel CCP that is representative of main plate BP1, and two side composite coupling panels SCP1 and SCP2, which are representative of sidewall plates SW3 and SW4, respectively. Coupling panel CCP is pivotally interconnected to coupling panels SCP1 and SCP2 by composite coupling panel hinges H11 and H12, respectively. Similar hinges are used to interconnect adjacent straps of system CNT1. The strap is shown in a flattened unpivoted configuration in FIG. 133O and in a folded pivoted configuration in FIG. 133P.

FIGS. 133Q(a)-(c) illustrate container CNT2, which is identical to container CNT1 of FIG. 133M with the exception of the addition of four triangular elastic straps STR that connect each pair of adjacent sidewalls in order to prevent leakage from the assembled container. The size and the shape of straps STP may be changed according to the need. Straps STR may be an integral part of an envelope. Container CNT2 can be used as a PMM for mixing materials when the sidewalls are pivoted. It will be appreciated that other types of UUSL CS instead of a system CSU may be employed in order to produce such a container.

In the implementation of FIGS. 133R-133V, two embodiments of rollable containers are illustrated. System RCH illustrated in FIG. 133R is related to a rollable container configured with a high peripheral wall, and system RCL illustrated in FIG. 133U is related to a rollable container configured with a short peripheral wall. The dimensions of both systems may range from the order of square millimeters to the order of square meters, and may be used as kitchen implements such as drinking glasses, bowls, pots, dinner plates, and food containers. Systems RCH and RCL may also be used as bags, barrels, industrial containers, garbage cans, flowerpots, toy containers, pools, devices for mixing materials, and for any other suitable use of a regular container. Some advantages of systems RCH and RCL include their good portability and the small volume that they occupy when stored and unused, especially when a large number of containers are desired to be used, large-sized containers are desired to be used, or when they are of a good portability and require small storage volume such in the case of travel kitchen toolkits.

As illustrated in FIG. 133R, system RCH comprises two rolls LPL1 and LTP1, and each of these rolls may be a system CSU (FIG. 38Z) or another type of UUSL CS. Roll LPL1 when leveled is used as a stiff baseplate SB1 (FIG. 133S) that is positioned at the bottom of the container, and roll LTP1 when leveled constitutes the rounded peripheral wall SW1 of the container that is adapted to be interconnected with baseplate SB1. It will be appreciated that baseplate SB1 may be a dedicated stiff and unrollable element that is able to be interconnected with the rounded rollable wall.

System RCH is illustrated in FIG. 133R(a) when the two rolls LTP1 and LPL1 are separately rolled and in FIG. 133R(b) in a leveled and assembled configuration, when uncovered by an envelope. FIGS. 133R(c)-(d) illustrate the two rolls when covered by envelope ENV1 in separately rolled and assembled configurations, respectively.

FIGS. 133S(a)-(c) illustrate the container base SB1 in a leveled configuration when not covered by an envelope, when covered by envelope ENV1, and when the envelope is rendered transparent, respectively.

With reference to FIGS. 133T(a)-(d) which illustrate various stages of assembling system RCH shown when uncovered by the envelope, the edge of base plate SB1 is conditioned with a plurality of circumferentially spaced tongues TNG1 that facilitate interconnection with corresponding grooves GR1 formed at the bottom of container peripheral wall SW1. Firstly, as shown in FIG. 133T(a), after rolls LTP1 and LPL1 (FIG. 133R(a)) are unrolled, a tongue TNG1 protruding from baseplate SB1 is inserted into a corresponding groove GR1 positioned at the bottom of the rectangular peripheral wall SW1, or alternatively peripheral wall SW1 can be shaped in other ways. Secondly, as shown in FIG. 133T(b), peripheral wall SW1 becomes attached to baseplate SB1 while protruding upwardly therefrom upon sequentially inserting the remaining unattached tongues TNG1 into the corresponding grooves GR1 until baseplate SB1 is completely surrounded by the leveled peripheral wall SW1, as shown in FIG. 133T(c). Thirdly, two coupling panels CN1 and CN2, which are positioned at the free edges, respectively, of the unrolled peripheral wall SW1, are interconnected by a tongue and groove connection to constitute a connector CNT1, as shown in FIG. 133.T(d). After the baseplate and peripheral wall are leveled and engaged to each other, a stable container is accordingly produced. System RCH may comprise a cover CV1 similar to a container cover CV2 which is described hereinbelow.

The protective envelope covering baseplate SB1 may be adapted to cling to each tongue TNG1 protruding from the baseplate to facilitate insertion of each tongue into a corresponding groove GR1 when both baseplate SB1 and peripheral wall SW1 are covered by an envelope. Alternatively, the baseplate may not be configured with the tongues, but rather the envelope may be integrally formed with the tongues, so that when the envelope is secured to the baseplate, each tongue will be able to easily inserted into a corresponding groove.

FIGS. 133U-133V illustrate a system RCL, which is a rollable rounded container having a relatively small ratio of peripheral wall height relative to the width, e.g. diameter, of the base plate. With the exception of the significant difference between the ratio of peripheral wall height relative to the base plate width, container RCL is completely identical to container RCH of FIG. 133R(b).

FIGS. 133U(a)-(b) illustrate container system RCL in assembled and exploded views, respectively. Container system RCL comprises baseplate SB2, peripheral wall SW2, and a container cover CV2, which may also be comprised of a system CSU. FIG. 133U(a) illustrates system RCL when each component is in a leveled configuration and interconnected. FIG. 133U(c) illustrates system RCL when each of baseplate SB2, peripheral wall SW2, and cover CV2 are disassembled and set to a rolled configuration.

As illustrated in FIG. 133V, the bottom of peripheral wall SW2 is configured with a plurality of groove GR2, and the edge of baseplate SB2 is configured with a plurality of protruding tongues. Peripheral wall SW2 is also configured with two free end coupling panels CN3 and CN4 to define connector CNT2 when coupled together. FIGS. 133V(a)-(d) illustrate various stages of assembling system RCL, which are identical to the various stages for assembling system RCH. It is appreciated that other types of UUSL CS instead of system CSU may be employed to produce system RCL.

A system such as system RCH or RCL can be used as a sealed container, e.g. for a use as a swimming pool. When the system is not sealed, it may be assembled and afterwards covered by a sealed sheet which covers and abuts its inner sides and accordingly prevents leakage of a liquid which is introduced within the interior of the container. A larger container may be produced by serially interconnected two or more CSU systems in order to define a base plate or peripheral wall of desired dimensions.

FIGS. 133W-133X illustrate system RBG, which is a longitudinally extending rounded bag comprising an external layer AL1 primarily made of flexible material such as cloth which may be foldable, and a stiff liner SD1. Stiff liner SD1 is adapted to be inwardly positioned with respect to, and in contact with, flexible external layer AL1, and is generally configured as a CSU system (FIG. 38X) comprising composite coupling panels CSC1. Liner SD1 is circumferentially extending when leveled to provide the stable rounded shape of the bag when in use.

Bag RBG is illustrated in FIG. 133W(a) when set to a deployed configuration and shown without its handles or shoulder straps. External layer AL1 comprises rounded peripheral wall SW3, substantially planar face UF1 continuous with peripheral wall SW3 but which may be made from a different material therefrom, a zipper ZP1 positioned in an intermediate region of, and extending along the length of, face UF1 to access the interior of bag RBG when unzipped, and lateral planar sidewalls SW7 and SW8 which may be releasably coupled to stiff liner SD1 or to an element of external layer AL1. As shown in FIG. 133W(d), the leveled liner SD1 may be C-shaped so as to subtend an angle greater than 180 degrees, for example 130 degrees. The two free edges of liner SD1 may be secured to each other at each longitudinal end of the liner with use of a suitable securing element to ensure structural stability of bag RBG.

Various stages for disassembling a deployed bag RBG will now be described. Firstly, as shown in FIG. 133W(b), sidewalls SW7 and SW8 are detached or folded to a side. Secondly, liner SD1 is pulled out from external layer AL1, as shown in FIG. 133W(c), and separated therefrom, as shown in FIG. 133W(d). Thirdly, liner SD1 is flattened, as shown in FIG. 133W(e), and then rolled in an opposite direction to a rolled RSD1 configuration, as shown in FIG. 133W(f). Alternatively, liner SD1 may be folded. External layer AL1 may be folded to a much smaller configuration FAL1 than the size of the rolled or folded liner, as also shown in FIG. 133W(f). Consequently, liner roll RSD1 and the folded external layer FAL1 can be stored in a small storage region. Bag RBG can be reassembled when needed by a reverse process.

FIG. 133X illustrates inwardly positionable stiff liner SD2 which is identical to liner SD1 of FIG. 133W, with the exception that it comprises a plurality of non-composite FTG-type coupling panels CPS which are sufficient for the current purpose of stiffening the peripheral wall of bag RBG. A coupling panel CPS is similar to a coupling panel RCP1 (FIG. 38I), although it is configured with a slightly rounded main face and rear face opposite to the main face that facilitate the rounded leveled configuration shown in FIG. 133X(a)-1. Additionally, a coupling CPS is configured with a tongue having a curved upper surface and a complementary curved surface delimiting the groove that extends to the main face. In this fashion, the curved surfaces and the minimal inter-panel interspace prevent injuries.

FIGS. 133X(a)-(d) illustrate the process of rolling inwardly positionable liner SD2 from a leveled configuration to a rolled configuration RSD2 without use of a protective envelope, and in FIGS. 133X(e)-(h) when liner CD2 is covered by protective envelope ENV2. Other types of UUSL CS may also be employed in order to produce bag RBG, and such a bag is also in the scope of the invention.

FIGS. 133Y(a)-(d) comprises a bag system comprising a flexible rectilinear bag BAG1 made of fabric or elastic material and a rectilinear connecting system SBG for stiffening bag BAG1 when introduced within its interior and in contact therewith. As illustrated in FIG. 133Y(b), system SBG is a rollable or foldable stiff box having interconnecting sidewalls SW9-SW12 and baseplate SB9 comprised of system CSU. When bag BAG1 is intended to be unused, system SBG is first removed from bag BAG1, and then, as illustrated in FIG. 133Y(c), sidewalls SW9 and SW10 are separated from the interconnected unit of baseplate SB9 and flattened sidewalls SW11 and SW12. Finally, as illustrated in FIG. 133Y(d), the interconnected unit of baseplate SB9 and sidewalls SW11 and SW12 is rolled to a rolled configuration RWL1, sidewalls SW9 and SW10 are individually rolled to roll configurations RSW8 and RSW9 respectively, and bag BAG1 is folded to a much smaller folded configuration FBA1. Consequently, the bag system can be stored in a small-volume storage region. It will be appreciated that other types of UUSL CS instead of system CSU may be employed in order to produce system SBG.

Each type of bag BAG1, such as a schoolbag, roof bag, suitcases, and travel bags, may be configured with a stiffening facilitating system SBG in order to improve the bag's functionality, portability and storability.

Any other stiff or rigid part of the bag, such as rigid straps, waist belts, back support, and internal stiff partitions, may also be implemented as a UUSL CS in order to improve its functionality, portability and storability.

The UUSL CS stiffening system SBG may be positioned within a dedicated interspace defined by two plies of bag BAG1.

FIGS. 134A-C illustrate an IFTG UUSL CS which is configured as a roll 690 functioning as a fence. Roll 690 is capable of being rapidly applied by suitable means such as fasteners or adhesion onto a frame which comprises spaced vertical posts 692 and at least two spaced horizontal rails 693 extending across the posts as illustrated. Roll 690 may be applied onto only one side of the frame as illustrated, or alternatively may be applied for esthetic considerations onto both sides of the frame, i.e. the building facing side and the street facing side, in order to completely conceal the coupling panels. The coupling panels may be provided with a lamination layer (or may be concealed and painted or laminated) as illustrated in FIG. 134A, or alternatively without a lamination layer as shown in FIGS. 134B-C. By adequate adaptations, the fence may be configured with spaces between the coupling panels. A bypass slit within coupling panels is also applicable. Roll 690 may be applied onto posts 692 which are anchored to a concrete wall for example as shown in FIGS. 134A-B or onto posts 694 which are anchored to the ground as shown in FIG. 134C. When roll 690 is applied onto both sides of the frame, the frame may be configured only with posts to take into account the unidirectional stiffness of the roll. Any other adequate frame or support for roll 690 is also applicable.

FIGS. 135A-C illustrate a UUSL CS which is configured as a roll 700 for rapid and esthetic covering of an even or uneven prefabricated fence 701 made of concrete or other suitable materials. The application of the roll may be done with or without an auxiliary device as explained above with respect to the link material leveling system after manually applying the link material or by means of a pneumatic spray unit. The roll may have a lamination layer, or may be concealed and decorated, in order to provide an ornamented covering as shown in FIGS. 135A-B, or may be provided without a lamination layer as shown in FIG. 135C in order to benefit from a natural look of the coupling panels, which may be produced from diverse materials, colors, shapes and dimensions.

A UUSL CS system may be implemented as flooring for a concrete floor after or prior to hardening of the concrete or in order to enable an easier leveling of the floor.

FIGS. 136A-D illustrate a UUSL CS which is configured as a roll 710 functioning as a rapid and esthetic covering of a roof. As shown in the figures, the covering of the roof is achieved by placing roll 710 on a regular constructed surface of the roof. One sheet is positioned with a small overlap to a previously positioned sheet and then is unrolled to complete the implementation. The lamination layer comprises materials of very high durability and may be of any desired ornamental design, four of which being illustrated in FIGS. 136A-D, respectively. The resulting roof cover is durable and esthetically appealing, taking into account the unidirectionally stiffness of the UUSL CS.

FIG. 137 illustrates a UUSL CS configured as a roll 720, which includes an unrollable solar cell sheet. The sheet comprises a plurality of solar cells which are embedded within or applied upon the coupling panels of the UUSL CS and enable a rapid covering of a roof or any other surface by solar cells. Electric or electronic apparatus associated with the solar cells may be housed in a cavity or holes formed in one or more of the coupling panels. Roll 720 may be applied onto an existing roof or upon a regular constructed element of the roof. Instead of using coupling panels which extend through the entire length of roll 720, two thin straps of a UUSL CS each located at a corresponding side of the roll on which thin panels of solar cells are supported may be optionally employed. Additional straps may be optionally used according to construction considerations. According to the unidirectional stiffness of the sheet, the resulting covering of the roof is stiff and planar. When maintenance operations are needed, the unrollable solar cell plate may easily roll back into a roll configuration and then unrolled again when the maintenance operations are completed. When the roof on which roll 720 is applied is rough and unleveled, an unrollable solar cell sheet comprising coupling panels made of sheet metal fixing may be used as well known to those skilled in the art, and is also in the scope of this innovation.

In other embodiments, a UUSL CS comprising water repellent materials, including bituminous materials as unidirectionally stiff and leveled bituminous sheets, or in addition to bituminous sheets, in order to produce a sealed surface with an appealing appearance may be used.

FIGS. 137A-J illustrate various safety garments, each of which functioning as protective means for a user, such as motorcycle riders, babies, weight lifters, porters, scaffolders, and people with muscular dystrophy, arthrofibrosis or joint hypermobility syndrome. The safety garment generally comprises a undirectionally stiff web, such as a UUSL CS, enabling unrestricted movement in one direction and prevents movement in the opposite direction when the web is leveled. The UUSL CS may be concealed or covered by orthopedic soft materials for the convenience of the user.

A safety suit such as a safety vest 930 is shown in FIGS. 137A-D. The mobility of the user 935 is unrestricted in FIGS. 137A and 137C when the UUSL CS is unleveled, and is restricted in FIGS. 137B and 137D when the UUSL CS is leveled. For a motorcycle rider, for example, the vertically oriented UUSL CS, maintains the back in a substantially straight condition when falling backwards following impact without restricting mobility while riding. The back may be able to be maintained in a substantially straight condition when the front and rear surfaces of each coupling panel are non-planar. The use of a web with diverse directions of curvature is suitable in order to emulate the curve of the back and the neck.

Safety garment 930 may be advantageously secured to the motorcycle seat or to the motorcycle helmet. Alternatively, safety garment 930 may be configured with supports that are engageable with the motorcycle rider, such as shoulder supports 932 shown in FIGS. 137C-D.

The safety garment may also be embodied by a safety belt, safety harness, elbow sleeve 941 shown in FIGS. 137E-F, knee sleeve 943 shown in FIGS. 137G-H, ankle brace 947 shown in FIGS. 1371-J, and a finger sleeve and wrist guard that comprise a undirectionally stiff web.

Such a safety garment, particularly an elbow sleeve or a wrist guard, may constitute a joint of a robot, for example a humanoid robot.

The various segments of the UUSL CS are able to be attached within a safety suit of a motorcycle rider, a bullet-proof protective vest or a full or partial body suit, a safety harness of a construction worker, dedicated clothing of small children, or attached to a child chair and/or helmet, with suitable dimensions and shapes to support the back and neck in similar fashion as a backrest and also to prevent SBIS caused by excessive backward movement of a baby's head. For example, a UUSL CS may be attached to a layer of a safety garment with high-strength threads or adhesives, or by a protective sheath, for example made of plastic, which prevents separation of the segments when subjected to an excessive load. The protective sheath may also be provided with a layer that prevents protrusion of one of the segments into an internal organ.

The rollable system may be permanently attached to the holding structure or, alternatively, may be detachable from the holding structure.

A similar holding structure to holding structure 220 which is configured without stiffness elements, but with FTG coupling panels instead of IFTG coupling panels, and leveled in an adequate circular configuration, can be used. When the stored rollable system is completely stored within the holding structure, i.e. without any element thereof protruding outwardly from the holding structure, the main web face is able to be interiorly facing. The holding structures 210 and 220 of FIGS. 55 and 56, respectively, can be produced without the stiffness elements in order to roll, store and support rollable systems such as a rollable television, screen, art object, and advertisement sign while being protected and undamaged within the gap between adjacent loops, optionally with an additional protective layer which is located together with the rollable system within the gap, when rolled. The holding structure without the stiffness elements is preferably modified in order to maintain the original structure of the holding structure. Each of said rollable systems is able to be unrolled and leveled when the holding structure is unrolled.

FIGS. 137K-V illustrate system 1000 which is a very large dimensioned rollable screen, e.g. 2.4*5 m, that may extend along the entire length of a wall 1005 of the given room. System 1000 enables easy portability and a stiff leveled mounting of large screens by a single person.

As shown in FIGS. 137K and 137N-137P, system 1000 comprises a holding structure 1001 based on a UUSL CS, a flexible screen 1003 protectively held within the gap between adjacent loops of the holding structure, and a thin elastic layer 1002 interfacing between the UUSL CS and flexible screen 1003 such as by adhesion. Holding structure 1001 comprises FTG coupling panels 1004 which are preferably interjoined by an inner axis (not shown in the figures), a continuous joint (not shown in the figures), or by both, being located along the length of the interjoined portions of each two adjacent coupling panels. Such interjoining means enable a strong reliable connection of the holding structure coupling panels and the relative angular displacement of each two coupling panels in order to create the desired gap of the holding structure. Elastic layer 1002 is needed in order to facilitate independent displacement of the screen relative to the main face of holding structure 1001 in order to prevent the development of excessive stress within screen 1003 while being rolled and unrolled.

As shown in FIGS. 137K-137M, the free edge 1009 of holding structure 1001 is anchored to a first free edge 1006 of a support element 1007 which has been previously installed onto wall 1005. Exemplary anchoring means include an interiorly facing protrusion formed at the first free edge 1006 of support element 1007 and a complementary groove formed at least at the free edge 1009 of a coupling panel 1004 provided with holding structure 1001. After the protrusion is inserted within the groove to facilitate coupling, or other type of anchoring, of holding structure 1001 to support element 1007, holding structure 1001 may be easily unrolled and leveled along the length of wall 1005. Finally, the second free edge 1024 of holding structure 1001 is anchored to the second free edge 1008 of support element 1007. Whenever is needed, holding structure 1001 may be easily unrolled in a reverse process and stored or mounted in another place.

FIGS. 137Q-137V illustrate FTG coupling panels 1011, 1013 and 1015 which are the constituent members of rollable screen system 1000. As shown in FIG. 137Q, a typical coupling panel 1011 for use in a rollable screen system is configured with a main FTG coupling panel portion 1010 and two thin rectilinear extension portions 1016 integrally formed with the upper and lower ends, respectively, of main coupling panel portion 1010. This configuration of coupling panel 1011 achieves an appealing appearance of the edges of the holding structure when system 1000 is unrolled. FIG. 137R illustrates a free end side coupling panel 1013 which is configured with main coupling panel portion 1012 having a groove 1021 without a tongue and two rectilinear extension portions 1016. FIG. 137S illustrates a free end sides coupling panel 1015 which is configured with main coupling panel 1014 having a tongue 1022 without a groove and rectilinear two extension portions 1016. As shown in FIGS. 137T-137V, corners 1017, 1018 and 1020 of coupling panels 1011, 1013 and 1015, respectively, may be rounded in order to reduce the sharpness of holding structure 1001 and to avoid injuries while using system 1000. Other types and combinations of coupling panels may be employed as well in conjunction with system 1000.

In other embodiments, system 1000 is configured with one or more of the following features:
i. friction based anchoring means;
ii. electric locking means for example electrically controlled internal pins that are locked by a wired or wireless command after the holding structure is unrolled;
iii. a single holding structure is applied onto more than one wall, while a holding structure portion extending from one wall to another may be curved and may be anchored at the corner between the two walls;
iv. a single holding structure is applied onto a wall and a column when leveled, or onto two or more columns or any other constructed element, while the curvature of a given holding structure portion extending in the middle of a room is able to be customized for example by means of a combination of FTG and IFTG coupling panels;
v. all or some of the coupling panels of the holding structure are CSC coupling panels;
vi. apparatus or accessories which keep the holding structure leveled after being unrolled, such as a bar fixed to each coupling panel or to extreme coupling panels, and also for use as a backing for screens which are not applied onto walls;
vii. able to being adapted to a smaller screen;
viii. a storage device, optionally mobile or embedded within a wall, within which system 1000 is housed and comprising an electromechanical device for selective extension and retraction of the holding structure vertically, horizontally or in any other desired straight or curved direction, for use in conjunction with rollable screens and particularly rollable television screens;
ix. the holding structure is prestressed similarly to surface PPLT1 of FIG. 111B or surface PPLT2 of FIG. 111D, with or without additional supports, for use as a stiff back for rollable screens, particularly those extending from a storage device, while providing the appealing appearance of a regular smooth back face;
x. one of the prestressed surfaces or a lamination layer is housed in an enclosure, such as secondary storable device 521 of FIG. 113C, for example while being mounted on a spool, and is then attached after the flexible screen is separately unrolled;
xi. additional elements which enable storage of screen related electric devices within the structure of system 1000;
xii. a rollable television which is able to be pulled out from a storable device and enables manual or electromechanical control of the curvature of the screen, including a predefined curved configuration, e.g. by using wired or wirelessly controlled motors that control the relative angular position of each two adjacent coupling panels and a piston controlled by motors that enables the locking of the coupling panels according to their ability to increase the frictional force between each adjacent coupling panel; and
xiii. the holding structure may not have a built-in gap.

Rollable or foldable devices for mobile phones using a small dimensioned UUSL CS are also applicable. The device may include a storable apparatus in which the screen is stored when unused. The pull in and out mechanism may be manual, electromechanical, or both.

FIGS. 137W-137X illustrate system FRH, which is a rollable and foldable structure, for example shown to be rectilinear, made of a few CSU plates (FIG. 38X) that are interconnected with hinges that are pivotal along the length of axis lines EXL. System FRH is illustrated in its assembled configuration, with and without protective envelope ENV3 in FIGS. 137W(a) and 137W(b), respectively. FIGS. 137X(a) and 137X(b) illustrate the structure in its flattened configuration with and without system envelope ENV3, respectively. After being flattened, system FRH can be folded or unrolled into a roll configuration. The inner walls of system FRH configured with an opening can also be made also from system CSU, and can be assembled and disassembled in order to enable the rolling and unrolling (or folding and unfolding) of system FRH. The opening OP at the sides of system FRH remains undamaged and intact during the rolling and unrolling process. Electric and sanitary elements can be integrated within the CSU systems including within CCSU system coupling panels. It is applicable to use other types of UUSL CS instead of system CSU in order to produce system FRH and it is also in the scope of the invention. The ability to roll and unroll system FRH significantly increasing the portability and its assembling rate.

In each application of this invention, mechanical and electromechanical means, with wired or wireless control, may be used in order to lock (i.e. disable relative movement of the web components) and strengthen the web in each configuration of the web.

In each system and application of this invention, the rolling, unrolling, folding and unfolding operations can be done manually or electromechanically by means that are located within or outside the UUSL CS including means that are located within the UUSL CS coupling panels and it is also in the scope of the invention.

In each application of this invention, a desired UUSL CS may be replaced by other types of UUSL CS, and an envelope such as envelopes ENV1 or ENV2 or FR1 of the UUSL CS may be added or removed.

It will be appreciated that a UUSL CS may be folded and then rolled, or alternatively rolled and then folded.

For at least some embodiments of a UUSL CS described herein, elements may be locked to prevent additional displacement in any desired configuration and by mechanical or electromechanical means well known to those skilled in the art.

In other implementations, a UUSL CS, preferably a frame similar to frame MFSF, CVF, or CVF of FIG. 129H, may be used as a rollable or foldable platform for drawings or pictures, such as a canvas drawings or pictures, to facilitate simplified portability and storability, especially when the drawing or picture has very large longitudinal dimensions(e.g. 2.5 m*6 m or larger). The frame for drawings or pictures preferably lacks any legs or adjustable hinges, and preferably a gap between two adjacent loops when being rolled.

Additionally, the following implementations are envisioned:
1. Systems similar to systems 510, 520,530, 540 with minor adaptations including diverse leveling configurations when unrolled may be used as a roof over doors or roof over windows which are very easy to install by anchoring the systems thereto within the wall or exterior to the wall located above the opening. The pulling out or pushing in of the sheet from its aperture may be executed manually or electromechanically with wired or wireless remote control including smartphone control applications.
2. Each implementation may include a diverse pre-planned friction power between adjacent coupling panels and between interconnected elements which contained in the application, according to the need.
3. Each implementation may include suitable types of coupling panels which have not been described herein.
4. In order to distribute the stress within a cross section of a coupling panel described herein, the profile of the coupling panel may be minimized and duplicated to the height of the coupling panel with the required adaptations that keeps the functionality of the coupling panel.
5. At least one motor may be installed within adjacent coupling panels (e.g. between an inner axis) and between coupling panel and a component of an implementation, in order to enable wired or remote control upon relative rotation of adjacent coupling panels and relative rotation of adjacent components, and accordingly to enable wired or remote control upon configuration of the entire web. By a wired or remote control, motors may also lock the web in a desired configuration. An implementation which contains a predefined configuration of the web is also applicable. The method may be implemented for each relevant application described herein and on a segmented sheet which is not a web.
6. In all implementations in which a web or an embodiment that contain a web (such as partitions) is extracted from a storable device, the web or the embodiment may be designed to create an arcuate surface.
7. A system similar to bed RBD with telescopic legs RB10 may be implemented to produce a rollable table which can also be folded and stored as a blanket.
8. Coupling panels 283 may have chemical or mechanical means which enable them to be permanently interconnected as a monolithic plate at a predefined time after their implementation.
9. Each implementation, according to the need, may include releasable locking means (such as protrusion A1 and recess A2 illustrated in FIG. 5A) or permanent locking means.
10. Each implementation may include a sound mechanism (e.g. a mechanism which produces a distinctive sound such as a knocking sound when a coupling panel become leveled), in order to easily recognize when a coupling panel became leveled.
11. A web may be used as a rollable covering for holes, channels, pits etc. and may be covered above with materials such as liquids and sand.
12. The web may comprise a discrete number of webs (i.e. sub-webs) which can be rolled and unrolled as a singular web and also separately.
13. A few layers of strengthened web can constitute a stiff surface with a very high load bearing capacity and a negligible vertical deflection especially when the layers of the strengthened webs are connected by pins which are vertical to the main face of the webs, and enabling the transmission of shear stress between the strengthened webs.
14. The dimensions of the needed webs may be measured by a smartphone application and can be transferred by the application to a factory.
15. A vertical reinforcement band may be employed with or without horizontal reinforcement bands.
16. A strengthened or weakened web which comprises FTG and IFTG coupling panels may be provided in order to create a web that has a curvature in two different directions. The interconnection of FTG AND IFTG coupling panels is made possible by using a coupling panel having tongue 35 or groove 32 in one side and tongue TN or groove GR in its opposite side.
17. A strengthened or weakened web may be provided which comprises multi-directional coupling panels having in their free sides profiles such as tongue 35, groove 32, tongue TN and groove GR, in order to create a web that has a curvature in more than two different directions.
18. A parquet system may be produced by using multi-directional coupling panels.
19. Strengthened or weakened webs may be employed to produce traditional embodiments which using rolls such as roller shutters and gates.
20. As illustrated in FIGS. 148A-C, a tiny UUSL CS 1202 can be used as a stiff foldable platform for a screen 1201 of a foldable smartphone 1200, in order to achieve a smooth screen without a crease during the use of the phone. The UUSL CS 1202 may have different directions of curvature according to the natural curvature of screen 1201. Friction between the coupling panels of the UUSL enables a stable platform for the screen at any relative angular displacement of panels 1205 and 1206. UUSL CS 1202 may have more than one leveled configuration in order to enable a stiff platform for a different relative angular displacement of coupling panels 1205 and 1206, and may use external support. An additional elastic layer similar to elastic layer 1002 in system 1000 may also be used. A UUSL CS may also be used for the connection of panels 1205 and 1206 (not shown) in order to achieve a smooth appearance of their external face.
21. A tiny system 1000 may be used for smartphone screens.
22. A compact laundry device is applicable by using shelf 685 that is illustrated in FIG. 130 as the surface of systems 510, 530, 550, and 555. A few bars 688 may be removed according to the need. Wires may be used instead of bars 688.
23. A pullout device (e.g. system 510) which may be installed at the rear of a vehicle which in extract configuration enables to carry more than one bicycle or and other cargo. The device may include tying and anchoring means.
24. Web with a changing curvature that may include coupling panels which at one side have a tongue or groove of an FTG panel and at a second side a tongue or groove of an IFTG panel.
25. A tent configured with reconfigurable webs, such as multi-directional webs.
26. Sleeping bag or tent comprising a reconfigurable web that permits the user to sleep without feeling the uneven underlying ground surface.
27. Support surface for solar dishes that are rollable and facilitate control of the curvature with manual or electromechanical means.
28. A reconfigurable web configured as an unrollable portable screen. The portable screen structure may be preferably identical to the structure of system 1000 with adequate adaptations such as smaller size and support means which enable the fixing of the employed screen in the open space. The portable screen may be comprised of a flexible television sheet that is attached to the main face of any reconfigurable weakened or strengthened web described herein.
29. A reconfigurable web configured as an unrollable portable roll of photovoltaic cells, whether built into a coupling panel or in the form of a common sheet or any other type of sheet. The structure of the portable roll may be preferably identical to the structure of system 1000, provided with a sheet instead of the flexible television sheet and with adequate adaptations such as smaller size and support means which enable the fixing of the employed roll in the open space. The portable roll of photovoltaic cells may be comprised of a sheet that is attached to the main face of any of any reconfigurable weakened or strengthened web described herein.
30. Composite IFTG coupling panels, wherein each of the composite IFTG coupling panels comprises a plurality of the IFTG coupling panels that are each interjoined to an adjacent IFTG coupling panels at their side.
31. An IFTG coupling panel or a composite IFTG coupling panels, wherein the stopper elements are external to the IFTG coupling panel.
32. Each coupling panel described herein having stopper elements installed after the interconnection of the coupling panels.
33. Each coupling panel described herein which comprises two or more separable components.
34. A reconfigurable strengthened or weakened web configured as a window rolling shutter or door rolling shutter, with or without a common sheet or a lamination layer. The common sheet or the lamination layer may be replaceable.
35. In all embodiments, the common sheet or the lamination layer may be a sheet of photovoltaic cells or a rollable screen such as a display screen, wherein the sheet or screen is capable of being pulled out from an exterior device.
36. A foldable surfboard comprising at least one inner axis or at least two coupling panels of a strengthened or weakened web.
37. A rollable or foldable table, illustrated in FIGS. 149(a)-151(k) as system 1250. System 1250 comprises an upper plate 1254, which is a reconfigurable and unidirectionally stiff and leveled web having a continuous or non-continuous main face, and legs 1252. Plate 1254 is preferably sealed or laminated, and legs 1252 are preferably foldable telescopic legs, similar to legs TLNL of system MFS in FIG. 129F. Legs 1252 may be extendable and foldable when system 1250 is rolled to a roll configuration 1255. System 1250 may be a modular system, for example by adding holes 1253, preferably in the middle of each side face of plate 1254 as shown in FIG. 149(b). A plurality of interjoined connecting bars 1251 are insertable within aligned holes of two adjacent plates 124 to facilitate a fast and stable connection of adjacent systems 1250, as illustrated in FIGS. 150(a)-150(c). Various modular configurations of combined systems 1250 are illustrated in FIG. 151(a)-151(k).
38. A set of rollable or foldable stools and table is illustrated in FIG. 152 as system 1300. Table 1301 having plate 1304 and legs 1309 is similar to the rollable table of system 1250. Each stool 1302 comprises a plate 1305, which is a reconfigurable and unidirectionally stiff and leveled web having a continuous or non-continuous main face, and legs 1306. Plate 1305 is preferably sealed or laminated, and legs 1306 are preferably foldable telescopic legs. A compact storage device 1320, e.g. rectilinear, having a pivotal lid 1327 is shown in FIGS. 153A-B. Rolls 1307 and 1310 to which an undeployed table and undeployed stools 1302 are reconfigured are storable in cavities 1308 and 1309, respectively, of storage device 1320. Detachable stool legs 1306 may be separated from each corresponding plate 1305 and then stored in a cavity 1311 of storage device 1320. Legs 1306 may be a telescopic or foldable leg similar to those of table 1301. The number of tables 1301 or stools 1302 as well as the structure of the storage device may be different according to the needs. System 1300 may include back rests, which are also reconfigurable and unidirectionally stiff and leveled webs having a continuous or non-continuous main face that are connectable to a corresponding stool in order to be converted to a chair and storable as a roll in a corresponding cavity of a storage device. Other configurations of the table and chairs such as the table tab1 of FIG. 129G(h) or the chair cha1 of FIG. 129G(g) are also in the scope of the invention. It will be appreciated that plates 1304 and 1305 may be conventional monolithic plates which can be stored separately from legs 1309 and 1306, respectively, in a dedicated storage device. This feature is also in the scope of this invention.

For any implementation described herein, the web may be substituted with a reconfigurable and unidirectionally stiff and leveled web having a non-continuous main face, whenever applicable.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A reconfigurable web having opposite web faces including a main web face, said web comprising:
direction-sensitive displacement facilitating means provided within a thickness of said web for facilitating rolling or folding of at least one portion of said web in at least one direction to form a unidirectionally stiff and leveled surface; and
force transmitting means which is suitable to set said web at a predetermined configuration by which said web, when leveled, is rollable or foldable in the at least one direction and stiff in at least one other direction,
A. wherein said web is a first web that is segmented and further comprises additional force transmitting means which facilitate transmission of forces derived from moments, axial forces and shear forces within segments of said first web and that is imparted with all of the following characteristics:
a. said main web face is continuous or semi-continuous;
b. said first web, when comprising a common sheet or a lamination layer that is attached to a continuous or semi-continuous surface of the segments, is configured to ensure that said common sheet or said lamination layer remains undamaged and undetached at any attached point and for any configuration of said first web, wherein said common sheet or said lamination layer, when used, provides an illusive appearance of a monolithic plate;
c. said first web is capable of comprising both said additional force transmitting means and said common sheet or said lamination layer while being configured to prevent transmission of forces to said common sheet and to said lamination layer, when used and when said first web is subjected to moments, axial forces producing tensile or compressive forces, or shear forces, at any configuration of said first web;
d. said first web is configured to transmit axial forces producing tensile or compressive forces, shear forces and moments within the segments exclusively by using the additional force transmitting means in any configuration of said first web; and
e. stress within said first web is dispersable in more than one direction at any configuration of the first web; or
B. wherein said web is a second web that is segmented and further comprises a common sheet and optionally a lamination layer, and additional force transmitting means which facilitate transmission, within segments of said second web exclusively, of shear forces and moments which are derived from an attempt to displace the segments in the at least one other direction, and of axial forces producing tensile or compressive forces, when said second web is leveled, and wherein said second web is imparted with all of the following characteristics:
f. said main web face is continuous or semi-continuous;
g. said common sheet or lamination layer is attached to a continuous or semi-continuous surface of the segments, and said second web is configured to ensure that said common sheet and said lamination layer when used remains undamaged and undetached at any attached point and for any configuration of said second web, wherein said common sheet and said lamination layer when used provides an illusive appearance of a monolithic plate;
h. said second web in conjunction with said force transmitting means and with said additional force transmitting means, when leveled and subjected to shear forces and moments which are derived from an attempt to displace the segments in the at least one other direction or subjected to axial forces producing tensile or compressive forces, is configured to prevent transmission of forces to said common sheet and to said lamination layer when used;
i. said second web is configured to transmit axial forces producing tensile or compressive forces, shear forces and moments within the segments exclusively by using the additional force transmitting means when said second web is leveled and subjected to moments or shear forces which are derived from an attempt to displace the segments in the at least one other direction or subjected to axial forces producing tensile or compressive forces; and
j. stress within said second web is dispersable in more than one direction when said second web is leveled and loaded by an attempt to displace the segments in the at least one other direction or by tension or compression of said second web; or
C. wherein said web is a third web that is segmented, and further comprises a common sheet and optionally a lamination layer, and is imparted with all of the following characteristics:
k. said main web face is continuous or semi-continuous;
l. said common sheet or lamination layer is attached to a continuous or semi-continuous surface of the segments, and said third web is configured to ensure that said common sheet and said lamination layer when used remains undamaged and undetached at any attached point and for any configuration of said third web, wherein said common sheet and said lamination layer when used provides an illusive appearance of a monolithic plate;
m. said third web in conjunction with said force transmitting means is configured, when leveled and subjected to moments or shear forces which are derived from an attempt to displace segments of said third web in the at least one other direction, to prevent transmission of forces to said common sheet and to said lamination layer when used;
n. said third web is configured to transmit shear forces and moments within the segments exclusively when said third web is leveled and subjected to moments or shear forces which are derived from an attempt to displace the segments in the at least one other direction; and
o. stress within said third web is dispersable in more than one direction, when said third web is leveled and loaded by an attempt to displace the segments in the at least one other direction; or
D. wherein said web is a fourth web which is an unsegmented web.

2. The web according to claim 1, wherein the first web comprises the common sheet or the lamination layer, and wherein the additional force transmitting means are:
at least one inner axis unit mounted in a cavity formed in two adjacent segments of the first web having an axis of rotation coinciding with, or spaced from, the main web face, each of said at least one inner axis units comprising two arcuate end plates subtending an angle of less than or equal to 180 degrees, and a corresponding intermediate arcuate plate interposed between said two end plates,
wherein each of said end plates is configured with an inwardly protruding arcuate protrusion subtending an angle of less than or equal to 180 degrees and with an inwardly protruding extension, and each side of said intermediate plate is configured with a corresponding arcuate recess subtending an angle of less than or equal to 180 degrees and with a recess extension, the protrusion and extension of each of said end plates being insertable into the corresponding recess and recess extension, respectively, of said intermediate plate, to facilitate angular displacement of each of said end plates relative to said intermediate plate that is restricted by the protrusion extension; or
a continuous joint comprising an elastic and elongated strap which is interconnected to a corresponding wall of first and second adjacent segments, wherein a face of said strap develops a continuous curvature when the first and second coupling panels undergo relative angular displacement and has an axis of rotation which is spaced from the main face of the adjacent coupling panel; or
the at least one inner axis unit and the continuous joint, wherein the axis of rotation coincides with, or is spaced from, the main web face.

3. The web according to claim 1, wherein the first web or the second web, when leveled, is in emulation of a monolithic plate in the at least one other direction such that:
when the web is leveled and subjected to external axial forces, internal compressive and tensile forces resulting from the external axial forces are transmitted within the segments or the additional force transmitting means exclusively,
when the web is leveled and loaded by an attempt to displace the segments in the at least one other direction, the shear forces are transmitted within the segments or the additional force transmitting means exclusively, and
when the web is leveled and loaded in the at least one other direction, internal moments are produced by resulting internal tensile and compressive forces that are transmitted within the segments or the additional force transmitting means exclusively, wherein a cross section of each of the segments that is perpendicular to the main web face is subjected to tensile forces in a first part of the cross section and to compressive forces in a second part of the cross section.

4. The web according to claim 1, which has maximum lengthwise and axial dimensions,
wherein the first and second webs comprise direction-sensitive angular displacement facilitating means, angular force transmitting means and angular additional force transmitting means, and the third web and the fourth web comprise the direction-sensitive angular displacement facilitating means and the angular force transmitting means, for facilitating angular displacement of said web about an axis of a roll defined by said web in a first rotational direction in order to be maintained in roll form and in a second rotational direction opposite to the first rotational direction to form the unidirectionally stiff and leveled surface of a desired lengthwise dimension that is less than or equal to said maximum lengthwise dimension, when unrolled relative to a portion of said web remaining in roll form,
wherein a first of two lengthwise interjoined portions is angularly displaceable relative to a second of said two lengthwise interjoined portions about a corresponding axis of rotation coinciding with, or spaced from, the main web face,
wherein, when the web is leveled, each of a plurality of said lengthwise interjoined portions is angularly displaceable in the first rotational direction about the axis of the roll relative to an adjacent lengthwise interjoined portion and is prevented from being angularly displaced in the second rotational direction in emulation of a rigid monolithic plate.

5. The web according to claim 4, wherein a rolling direction of the first portion is opposite to the rolling direction of the second portion, the main web face of the first and second portions is located at a same face of the web, and each portion of the web when leveled, is rollable or foldable in at least one direction and stiff or rigid in at least one other direction.

6. An unrollable link material leveling system for covering even and uneven surfaces, comprising:
i. means for applying link material to an exposed constructed surface;
ii. an elongated sheet, at least a portion of which positioned in force applying relation with said constructed surface; and
iii. means for differentially applying a force to said elongated sheet which comprises at least one of the web defined rolls according to claim 4, such that said applied link material becomes compressed upon application of the force to said elongated sheet and that an interior surface of said elongated sheet becomes uniformly leveled upon solidification of said compressed link material.

7. The leveling system according to claim 6, wherein the means for differentially applying a force to said elongated sheet is a sheet holding structure,
wherein a first section of the holding structure is configured to compress and level the elongated sheet against the link material that has already been applied to the building wall, and a second section of the holding structure is configured to maintain vertical stiffness of the holding structure to ensure leveling of the elongated sheet while the elongated sheet is applied against the constructed surface,
wherein the holding structure comprises a plurality of the web defined rolls which are arranged in a coiled formation such that an outer loop surrounds an inner loop adjacent to the outer loop, to provide a gap between each pair of adjacent loops within which the elongated sheet is received prior to being applied onto the constructed surface,
wherein each of the web defined rolls comprises a plurality of coupling panels that are each interjoined with an adjacent coupling panel, and two of the coupling panels which are peripherally adjacent to each other are interconnected by a vertically oriented pivot element extending throughout a height of the holding structure.

8. A parquet system, comprising a plurality of rollable or foldable parquet segments, wherein each of said parquet segments comprises the web according to claim 1 and is interconnectable with an adjacent parquet segment upon being unrolled or unfolded.

9. A system for applying paneling material to an existing constructed surface, comprising:
a) a rollable or foldable paneling material unit comprising the web according to claim 1;
b) a stationary member associated with said constructed surface; and
c) a plurality of spaced connecting means provided with one or both of said paneling material unit and said stationary member,
wherein each of said connecting means is configured to cause a region of said paneling material unit to be connected with a corresponding region of said stationary member upon unrolling or unfolding said paneling material unit until the unrolled paneling material unit is leveled.

10. A hinge for continuous and uninterrupted surfaces, which is the first web according to claim 1, wherein said hinge comprises two sections exclusively that are pivotally displaceable one relative to the other about an axis of rotation and each of said sections comprises the direction-sensitive displacement facilitating means, the force transmitting means, and the additional force transmitting means,
wherein each of said two sections is connectable to a corresponding planar board in such a way to produce completely coplanar surfaces that include both of said two sections and said two boards when said hinge is set to an unpivoted position and the axis of rotation of said hinge is coincident with, or spaced from, a main web face of said two sections.

11. A coupling panel connecting system according to claim 1, wherein each interjoined portion of the first web, second web or third web is a lengthwise interjoined portion that is interjoined in a way such that each of a plurality of coupling panels is angularly displaceable with respect to an adjacent coupling panel about a corresponding axis of rotation which coincides with, or is spaced from, a common edge adjoining two adjacent coupling panels.

12. The coupling panel connecting system according to claim 11, which is a tongue and groove connecting system that is, when leveled, rollable or foldable in a first direction and stiff or rigid in a second direction, wherein each or most of the plurality of coupling panels is configured with a tongue and an opposed groove.

13. The coupling panel connecting system according to claim 12,
wherein each of the plurality of coupling panels is configured with a first planar surface and with a second surface parallel to said first surface, wherein the groove is formed between the first and second surfaces to define a first wall coinciding with the first surface and a second wall coinciding with the second surface, and is delimited by a planar third surface which coincides with said first wall and is parallel with the first surface, a planar fourth surface which coincides with said second wall and is parallel with the second surface, and a fifth surface extending between the first and second walls and orthogonal to the third and fourth surfaces,
wherein the fourth surface extends from the fifth surface by a longer distance than a length of the third distance from the fifth surface, so that said second wall will protrude from said first wall to facilitate transmission of shear forces through said second wall,
wherein the tongue is configured with parallel sixth and seventh surfaces, the sixth surface of the first coupling panel being completely abuttable with the third surface of the second coupling panel and the seventh surface of the first coupling panel being completely abuttable with the fourth surface of the second coupling panel, when the first and second coupling panels are lockingly joined together,
wherein shear forces are transmittable between the first and second coupling panels through the abutting third and sixth surfaces or through the abutting fourth and seventh surfaces, regardless of a location of the load, when the first web, second web or third web is leveled during an attempt to displace the coupling panels of the third web in the second direction,
wherein an intersection between the third and fifth surfaces of the second coupling panel is spaced from the corresponding axis of rotation by a distance which is equal to, or greater than, the length from the corresponding axis of rotation to the seventh surface of the first coupling panel,
wherein the interference-free rotation is facilitated when the sixth surface of the first coupling panel has a length which is less than the length of the third surface of the second coupling panel, or
wherein the interference-free rotation is also facilitated when a distance between any point on an eighth surface of the first coupling panel extending between the sixth and seventh surfaces, or extending between a ninth surface and the seventh surface, and the corresponding axis of rotation is less than the length from the corresponding axis of rotation to the seventh surface of the second coupling panel, said ninth surface is a surface which is perpendicular to the sixth surface and is a truncation of an intersection of the sixth and eighth surfaces.

14. The coupling panel connecting system according to claim 12, wherein both the tongue and the groove are arcuate and the tongue of a first coupling panel of the plurality of coupling panels is displaceable along an arcuate path within the groove of a second coupling panel of the plurality of coupling panels.

15. The coupling panel connecting system according to claim 11, further comprising:
at least one inner axis unit, wherein each of the inner axis units comprises two arcuate end plates subtending an angle of less than or equal to 180 degrees that are attached to opposite walls, respectively, of a first cavity formed within a first coupling panel, and an intermediate arcuate plate subtending an angle of less than or equal to 180 degrees that is interposed between said end plates and attached to a wall of a second cavity formed within a second coupling panel adjacent to said first coupling panel,
wherein each of said end plates is configured with a corresponding inwardly protruding arcuate protrusion subtending an angle of less than or equal to 180 degrees and each face of said intermediate plate is formed with an arcuate recess subtending an angle of less than or equal to 180 degrees within which the corresponding protrusion is receivable and rotatable,
wherein said intermediate plate, upon undergoing rotation about the axis of rotation, forces said second coupling panel to pivot relative to said first coupling panel,
wherein an axis line of the inner axis unit is an axis that coincides with, or is spaced from, the main web face; or
a continuous joint comprising an elastic and elongated strap which is interconnected to a corresponding wall of first and second coupling panels of the plurality of coupling panels, wherein a face of said strap develops a continuous curvature when the first and second coupling panels undergo relative angular displacement.

16. The coupling panel connecting system according to claim 11, wherein first and second adjacent coupling panels of the plurality of coupling panels have a completely solid and rectangular cross section, and the first and second coupling panels are interconnected by:
an inner axis unit mounted in a cavity formed in each of the first and second coupling panels, said inner axis unit comprising two arcuate end plates subtending an angle of less than or equal to 180 degrees, and a corresponding intermediate arcuate plate interposed between said two end plates,
wherein each of said end plates is configured with an inwardly protruding arcuate protrusion subtending an angle of less than or equal to 180 degrees and with an inwardly protruding extension, and each side of said intermediate plate is configured with a corresponding arcuate recess subtending an angle of less than or equal to 180 degrees and with a recess extension, the protrusion and extension of each of said end plates being insertable into the corresponding recess and recess extension, respectively, of said intermediate plate, to facilitate angular displacement of each of said end plates relative to said intermediate plate that is restricted by the protrusion extension; or
a continuous joint comprising an elastic and elongated strap which is interconnected to a corresponding wall of the first and second coupling panels, wherein a face of said strap develops a continuous curvature when the first and second coupling panels undergo relative angular displacement.

17. Apparatus comprising the reconfigurable web according to claim 1, which is selected from the group consisting of:
i. a bi-directionally rigid and displaceable surface;
ii. an extendable table or shelf which is retractable into a wall;
iii. a partition capable of being folded;
iv. a door capable of being folded;
v. a unidirectional sliding door that is slidable to a transversal end of a retaining structure;
vi. a storage structure with shelves that are capable of being folded to redefine internal storage spaces;
vii. wire shelving capable of being folded;
viii. a completely coplanar hinge that is capable of being folded up to and including 180 degrees;
ix. a unidirectionally stiff and leveled surface used for fence coverings;
x. a unidirectionally stiff and leveled surface used for roof coverings;
xi. a television or screen capable of being rolled or folded;
xii. a surface capable of being rolled or folded for rebuilding and disassembling the surface without need of discrete elements, and capable of being transported in a transportation vehicle when unleveled;
xiii. a protective garment; and
xiv. chair, table, or bed capable of being rolled and comprising the web and also legs which are storable in a core of the web when rolled, wherein one or more faces of the web are smooth or relatively smooth face to prevent bodily injuries or damage to web apparatus in contact with the smooth or relatively smooth faces during rolling and unrolling operations.

18. The apparatus according to claim 17, wherein:
the web is provided with a permanently applied or releasable lamination layer; or
the bi-directionally rigid and displaceable surface is prestressed; or
the unidirectionally stiff and leveled surface is applied to palisade fencing or to a metal fence;
or
the unidirectionally stiff and leveled surface is applied to a fence made of a concrete slab; or
the unidirectionally stiff and leveled surface used for roof coverings is maintained in roll form when undeployed; or
the unidirectionally stiff and leveled surface used for roof coverings is folded or stacked when undeployed; or
the unidirectionally stiff and leveled surface used for roof coverings comprises a plurality of photovoltaic cells.

19. The web according to claim 1, wherein the fourth web is rollable or foldable and comprises first and second layers that are attached together to constitute said direction-sensitive displacement facilitating means,
wherein when the fourth web is leveled, said first layer is longitudinally deformable under tension and substantially or entirely undeformable under compression, and said second layer is longitudinally deformable under compression and substantially or entirely undeformable under tension, such that the fourth web is capable of being rolled or folded in at least a first rotational direction and is capable of resisting deformation in at least one second rotational direction.

20. The web according to claim 1, wherein said direction-sensitive displacement facilitating means comprising one or more means selected from a continuous joint, an inner axis, a folding tongue and groove coupling panel, a folding tongue and groove coupling panel connected with said continuous joint or said inner axis, an inverse folding tongue and groove coupling panel, an inverse folding tongue and groove coupling panel connected with said continuous joint or said inner axis, a polygonal middle axis coupling panel, and a composite coupling panel comprising a plurality of coupling panel types arranged such that a side of a first coupling panel being of a first type is fixedly interjoined with an adjacent side of a second coupling panel being of a second type, a multidirectional coupling panel, and a safe coupling panel.

21. The coupling panel connecting system according to claim 14, wherein one of the first and second coupling panels of each pair of adjacent coupling panels is configured with a stopper element that restricts relative angular displacement of the first and second coupling panels in the at least one direction,
wherein each of the plurality of coupling panels is additionally configured with a stopper element which is engageable with a coupling panel region at a terminal end of the groove, wherein rotation of the first coupling panel in a second rotational direction is restricted when the tongue abuts the stopper element and remains at least partially within the groove and is unrestricted in a first rotational direction; or
wherein a coiled formation of the plurality of coupling panels is produced when angular displacement of the first and second coupling panels of each pair of adjacent coupling panels is sufficiently restricted in the at least one direction to define a radius for each half loop of the coiled formation, and wherein an outer loop of the coiled formation surrounds an inner loop adjacent to the outer loop and defines a gap between each pair of adjacent loops within which the main face of the web or of an additional web is protected and undamaged.

22. The coupling panel connecting system according to claim 14, wherein the first web or the second web comprises a plurality of peripherally adjacent and interconnected inverse folding tongue and groove (IFTG) coupling panels,
wherein each of said IFTG coupling panels has a forwardly facing tongue that is connected to a solid core and configured with two opposed tongue side faces and a rearwardly disposed arcuate wall, and a rearward face formed with a groove defined by two opposed interior faces within which the tongue of an adjacent IFTG coupling panel is receivable,
wherein one of said two tongue side faces and two groove interior faces is configured with corresponding arcuate protrusions and the other of said two tongue side faces and two groove interior faces is configured with corresponding arcuate recesses,
wherein each of said arcuate protrusions is slidably receivable within a corresponding arcuate recess to facilitate relative angular displacement between interconnected first and second IFTG coupling panels; or
wherein the first web or the second web comprises one or more composite IFTG coupling panels, wherein each of the composite IFTG coupling panels comprises a plurality of the IFTG coupling panels that are each interjoined to an adjacent IFTG coupling panels at their side; or
wherein a first portion of the first web or the second web comprises at least one foldable tongue and groove (FTG) coupling panel each configured with a tongue and an opposed groove that is lockingly joinable with an adjacent FTG coupling panel after a first FTG coupling panel has been angularly displaced with respect to an adjacent second FTG coupling panel and the tongue of a first FTG coupling panel has been completely inserted within the groove of a second FTG coupling panel,
wherein the groove of the FTG coupling panel is formed between first and second parallel surfaces to define a first wall coinciding with the first surface and a second wall coinciding with the second surface, and is delimited by a planar third surface which coincides with said first wall and is parallel with the first surface, a planar fourth surface which coincides with said second wall and is parallel with the second surface, and a fifth surface extending between the first and second walls and orthogonal to the third and fourth surfaces,
wherein a second portion of the first web or the second web comprises at least one composite inverse folding tongue and groove (IFTG) coupling panel, each of said IFTGs has a forwardly facing tongue that is connected to a solid core and configured with two opposed tongue side faces and a rearwardly disposed arcuate wall, and a rearward face formed with a groove defined by two opposed interior faces within which the tongue of an adjacent IFTG coupling panel is receivable, and wherein each of the composite IFTG coupling panels comprises a plurality of the IFTG coupling panels that are each interjoined to an adjacent IFTG coupling panels at their side,
wherein one of said two tongue side faces and two groove interior faces is configured with corresponding arcuate protrusions and the other of said two tongue side faces and two groove interior faces is configured with corresponding arcuate recesses,
wherein each of said arcuate protrusions is slidably receivable within a corresponding arcuate recess to facilitate relative angular displacement between interconnected first and second IFTG coupling panels,
wherein the first portion and the second portion of the web are interconnected by a coupling panel having a tongue or groove of the FTG coupling panel at one side and a tongue or groove of the IFTG coupling panel at a second side,
wherein, when the web is leveled, each of the FTG coupling panels is rollable or foldable in a second angular direction and stiff or rigid in a first angular direction, and each of the IFTG coupling panels is rollable or foldable in the first angular direction and stiff or rigid in the second angular direction.

23. The web according to claim 1, wherein a plurality of the webs constitute a rollable or foldable frame,
wherein the webs of the frame are optionally arranged in a coiled formation such that an outer loop surrounds an inner loop adjacent to the outer loop, to provide a gap between each pair of adjacent loops within which the main web face of the web or of an additional web is protected and undamaged.
